(19) United States
(12) Patent Application Publication
(10) Pub. No.: US 2025/0188284 A1
(43) Pub. Date: Jun. 12, 2025

(54) CAGING-GROUP-FREE PHOTOACTIVATABLE FLUORESCENT DYES AND THEIR USE

(71) Applicant: Max-Planck-Gesellschaft zur Foerderung der Wissenschaften e. V., Muenchen (DE)

(72) Inventors: Richard LINCOLN, Heidelberg (DE); Alexey N. Butkevich, Heidelberg (DE); Mariano L. Bossi, Heidelberg (DE)

(21) Appl. No.: 19/057,458

(22) Filed: Feb. 19, 2025

Related U.S. Application Data
(63) Continuation-in-part of application No. 18/579,446, filed on Jan. 15, 2024.

(51) Int. Cl. C09B 57/00; C09B 6/00; C09K 11/06

(52) U.S. Cl. CPC C09B 57/00; C09B 6/00; C09K 11/06; C09K 2211/1011; C09K 2211/1018

(57) ABSTRACT

The invention relates to novel caging-group-free photoactivatable fluorescent dyes having the structural formula I:

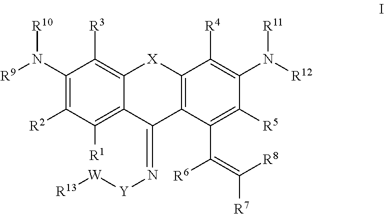

as well as to the corresponding photoactivated fluorescent dyes having the structural formula II:

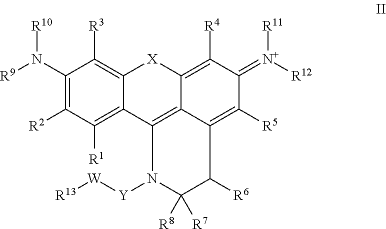

The invention further relates to the use of the photoactivatable compounds as such or after photoactivation, in particular as fluorescent tags, analytical reagents and labels in optical microscopy, imaging techniques, protein tracking, nucleic acid labeling, glycan analysis, capillary electrophoresis, flow cytometry or as a component of biosensors, or as analytical tools or reporters in microfluidic devices or nanofluidic circuitry.

### CROSS-REFERENCE TO RELATED APPLICATIONS

This application is a continuation-in-part of U.S. application Ser. No. 18/579,446, filed Jan. 15, 2024, which is a U.S. National Phase Application of PCT/EP2021/069804, filed Jul. 15, 2021, the contents of which applications are incorporated herein by reference in their entireties for all purposes.

### BACKGROUND OF THE INVENTION

Fluorescent dyes excitable with red and far-red light (λₑₓ>600 nm) are valuable tools in fluorescent microscopy techniques, due to the reduced cellular background, high penetration depth, and low phototoxicity of red light [S. Wäldchen et al. Sci. Rep. 2015, 5, 15348]. Such dyes are particularly useful in super-resolution fluorescent microscopy methods, in which dyes with high brightness, photostability, and live-cell-permeability are additionally valued.

In single molecule localization microscopy (SMLM) super-resolution microscopy methods [H. Li and J. C. Vaughan, Chem. Rev. 2018, 118, 9412-9454] such as photoactivated localization microscopy (PALM) and stochastic optical reconstruction microscopy (STORM) [S. T. Hess et al. Biophys. J. 2006, 91(11) 4258-4272; E. Betzig et al., Science, 2006, 313, 1642-1645], sporadic subsets of fluorophores must be addressed over time during the imaging process. The widely used far-red dyes are normally combined with dedicated buffers, additives, or formulations to achieve stochastic on/off behavior for imaging. These systems include the inherent on/off ‘blinking’ behavior of fluorophores (particularly cyanines) under reducing conditions [G. T. Dempsey et al., Nat. Methods, 2011, 8, 1027-1036], the sporadic interconversion between fluorescent and non-fluorescent structures of certain dye scaffolds (including rhodamines [S. Uno et al., Chem. Commun., 2018, 54, 102-105.] and cyanines [A. Martin and P. Rivera-Fuentes, Nat. Chem., 2024, 16, 28-35.]), or the stochastic binding/unbinding of fluorophores (e.g., PAINT, [A. Sharonov and R. M. Hochstrasser, Proc. Natl. Acad. Sci. U.S.A., 2006, 103, 18911-18916] DNA-PAINT, [J. Schnitzbauer et al., Nat. Protoc., 2017, 12, 1198-1228]) or other low-affinity binders.

Photoactivatable or caged dyes, by which the spatiotemporal control of the transition of a non-fluorescent molecule to a fluorophore is enabled through the controlled delivery of light, typically in the ultraviolet or visible range, provide a powerful alternative to stochastic ‘blinking’ systems in SMLM super-resolution imaging. Current approaches to photoactivatable far-red fluorophores are predominantly based on the synthetic incorporation of photolabile protecting groups that increases molecular weight labels, reduces water solubility, and can limit applications for biological imaging. A few exceptions that employ alternative minimal caging strategies include rhodamine NN [V. N. Belov et al. Angew. Chem. Int. Ed., 2010, 49, 3520-3523] and their silicon rhodamine analogues (PA-JF₆₄₆, [J. Grimm et al. Nat. Methods, 2016, 13, 985-988]), a thio-caged analogue of Nile Red (SNile Red, [J. Tang et al. J. Am. Chem. Soc., 2019, 141(37), 14699-14706]), and a photoactivatable PA-SiR dye [M. S. Frei et al., Nat. Comm. 2019, 10, 4580; K. Johnsson et al. WO2019/122269A1], in which light promoted protonation yielded the fluorescent 9-alkyl-Si-pyronine with limited chemical stability.

A general strategy for caging-group free photoactivatable dyes was described based on a light-promoted radical cascade reaction [R. Lincoln et al. Nat. Chem., 2022, 14, 1013-1020, R. Lincoln et al. WO2023/284968A1]. This process relies on the photochemical reaction of a 3,6-diaminoxanthone analogue-possessing an excited triplet state with biradical character- and a pendant alkenyl moiety. Following a 6-endo-trig cyclization, and subsequent protonation by the solvent, this photoreaction yields 9-alkoxy-pyronine fluorophores with blue to orange emission, depending on the bridging atom and auxochromic fragments. The resulting dyes and labels derived therefrom perform remarkably well in a number of super-resolution microscopy techniques including STED, PALM, and MINFLUX (minimal photon fluxes) on account of their live-cell compatibility, high brightness and photostability. Furthermore, the strategy could also be extended to 9-iminoxanthone analogues [I. Likhotkin et al. J. Am. Chem Soc. 2023, 145(3), 1530-1534] to construct photoactivatable dyes and labels with large Stokes shifts.

9-Iminopyronines with electron-withdrawing substituents on the imine nitrogen have been shown to enable pH-sensitive fluorophores with far-red emission [P. Horváth et al. J. Org. Chem. 2015, 80(3), 1299-1311; K. H. Kim et al. Chem. Sci. 2019, 10, 9028-9037; P. Horváth et al. ACS Omega 2019, 4(3), 5479-5485; D. Dunlop et al. Chem. Eur. J. 2024, 30(19), e202400024]. When directly combined with the caging-group-free photoactivation strategy of the prior art, the incorporation of the 9-acylimino moiety to the scaffold yields photoactivatable dyes with red-shifted spectral properties but with undesirable pH-dependent behavior, leading to lower biocompatibility and chemical stability, and modest photochemical efficiency.

In view of this prior art, the main object underlying the present inventions is the provision of new rationally designed caging-group-free red and far-red photoactivatable fluorescent dyes with optimal properties as labels for optical fluorescence microscopy, including SMLM, STED, and MINFLUX nanoscopy techniques, which overcome or alleviate the above shortcomings.

This object has been achieved by providing the photoactivatable dyes, the fluorescent dyes and the use thereof according to the invention.

### Definitions

The term “moiety” herein refers generally to a portion of a molecule, which may be a functional group, a set of functional groups, and/or a specific group of atoms within a molecule, that is responsible for a characteristic chemical, biological, and/or physical property of the molecule.

The term “binding moiety”, as used herein, refers to any molecule or part of a molecule that can specifically bind to a target molecule. “Specific binding” means that a binding moiety (e.g. a molecule or part of a molecule) binds stronger to a target (another small molecule, a macromolecule such as a protein or nucleic acid, an oligomeric protein, a protein aggregate such as amyloid fibrils, a receptor etc.) for which it is specific compared to the binding to other targets. A binding moiety binds stronger to the specific target if it binds to this target with a dissociation constant (k_{D}) which is lower than the dissociation constant for other targets. Preferably the dissociation constant (k_{D}) for the target to which the binding moiety binds specifically is more than 10-fold, preferably more than 20-fold, more preferably more than 50-fold, even more preferably more than 100-fold, 200-fold, 500-fold or 1000-fold lower than the dissociation constant (k_{D}) for the target to which the binding moiety does not bind specifically.

The term “C₁-C₄ alkyl” in the context of the present specification signifies a saturated linear or branched hydrocarbon having 1, 2, 3 or 4 carbon atoms, wherein in certain embodiments one carbon-carbon bond may be unsaturated and one CH₂ moiety may be exchanged for oxygen (ether bridge) or nitrogen (NH, or NR with R being methyl, ethyl, or propyl; amino bridge). Non-limiting examples for a C₁-C₄ alkyl are methyl, ethyl, propyl, prop-2-enyl (allyl), n-butyl, 2-methylpropyl, tert-butyl, but-3-enyl, prop-2-ynyl and but-3-ynyl. In certain embodiments, a C₁-C₄ alkyl is a methyl, ethyl, propyl or butyl moiety.

The term “C₃-C₈ cycloalkyl” in the context of the present specification signifies a saturated cyclic hydrocarbon having 3, 4, 5, 6, 7 or 8 carbon atoms in the cycle, wherein in certain embodiments one carbon-carbon bond may be unsaturated and one CH₂ moiety may be exchanged for oxygen (ether bridge) or nitrogen (NH, or NR with R being methyl, ethyl, or propyl; amino bridge). Non-limiting examples for a C₃-C₈ cycloalkyl are cyclopropyl, cyclopropylmethyl, cyclobutyl, cyclopentyl, cyclopent-1-en-1-yl, cyclopent-2-en-1-yl, cyclopent-3-en-1-yl, cyclopent-2-en-1-yl and cyclooctyl. In the context of the present specification, the term “cycloalkyl” also includes bicyclic and tricyclic cycloalkyls and cycloalkenyls, such as bicyclo[2.2.1]heptan-2-yl, bicyclo[2.2.1]hept-2-en-2-yl, tricyclo[4.1.0.0^{2,4}]heptan-5-yl and bicyclo[1.1.1]pentan-1-yl. In certain embodiments, a C₃-C₈ alkyl is a cyclopropyl, cyclopropylmethyl, cyclobutyl, cyclopentyl or cyclohexyl moiety.

A C₁-C₆ alkyl in the context of the present specification signifies a saturated linear or branched hydrocarbon having 1, 2, 3, 4, 5 or 6 carbon atoms, wherein one carbon-carbon bond may be unsaturated and one CH₂ moiety may be exchanged for oxygen (ether bridge) or nitrogen (NH, or NR with R being methyl, ethyl, or propyl; amino bridge). Non-limiting examples for a C₁-C₆ alkyl include the examples given for C₁-C₄ alkyl above, and additionally 3-methylbut-2-enyl, 2-methylbut-3-enyl, 3-methylbut-3-enyl, n-pentyl, 2-methylbutyl, 3-methylbutyl, 1,1-dimethylpropyl, 1,2-dimethylpropyl, 1,2-dimethylpropyl, pent-4-ynyl, 3-methyl-2-pentyl, and 4-methyl-2-pentyl. In certain embodiments, a C₅ alkyl is a pentyl or cyclopentyl moiety and a C₆ alkyl is a hexyl or cyclohexyl moiety.

The term “unsubstituted Cₙ alkyl” when used herein in the narrowest sense relates to the moiety —CₙH₂ₙ— if used as a bridge between moieties of the molecule, or —CₙH₂ₙ₊₁ if used in the context of a terminal moiety. It may still contain fewer H atoms if a cyclical structure or one or more (non-aromatic) double bonds are present.

The term “Cₙ alkylene” in the context of the present specification signifies a saturated linear or branched hydrocarbon comprising one or more double bonds. An unsubstituted alkylene consists of C and H only. A substituted alkylene may comprise one or several substituents as defined herein for substituted alkyl.

The term “Cₙ alkylyne” in the context of the present specification signifies a saturated linear or branched hydrocarbon comprising one or more triple bonds and may also comprise one or more double bonds in addition to the triple bond(s). An unsubstituted alkylyne consists of C and H only. A substituted alkylyne may comprise one or several substituents as defined herein for substituted alkyl.

The terms “unsubstituted Cₙ alkyl” and “substituted Cₙ alkyl” include a linear alkyl comprising or being linked to a cyclic structure, for example a cyclopropane, cyclobutane, cyclopentane or cyclohexane moiety, unsubstituted or substituted depending on the annotation or the context of mention, having linear alkyl substitutions. The total number of carbon and (where appropriate) N, O or other heteroatoms in the linear chain or cyclical structure adds up to n.

The term “substituted alkyl” in its broadest sense refers to an alkyl as defined above in the broadest sense that is covalently linked to an atom that is not carbon or hydrogen, particularly to an atom selected from N, O, F, B, Si, P, S, Se, Cl, Br and I, which itself may be (if applicable) linked to one or several other atoms of this group, or to hydrogen, or to an unsaturated or saturated hydrocarbon (alkyl or aryl in their broadest sense). In a narrower sense, substituted alkyl refers to an alkyl as defined above in the broadest sense that is substituted in one or several carbon atoms by groups selected from amine NH₂, alkylamine NHR, imide NH, alkylimide NR, amino(carboxyalkyl) NHCOR or NRCOR, hydroxyl OH, oxyalkyl OR, oxy(carboxyalkyl) OCOR, carbonyl O and its ketal or acetal (OR)₂, nitrile CN, isonitrile NC, cyanate CNO, isocyanate NCO, thiocyanate CNS, isothiocyanate NCS, fluoride F, choride Cl, bromide Br, iodide I, phosphonate PO₃H₂, PO₃R₂, phosphate OPO₃H₂ and OPO₃R₂, sulfhydryl SH, sulfalkyl SR, sulfoxide SOR, sulfonyl SO₂R, sulfonylamide SO₂NHR, sulfonate SO₃H and sulfonate ester SO₃R, wherein the R substituent as used in the current paragraph, different from other uses assigned to R in the body of the specification, is itself an unsubstituted or substituted C₁ to C₁₂ alkyl in its broadest sense, and in a narrower sense, R is methyl, ethyl or propyl unless otherwise specified.

It is understood that mention of moieties SO₃H or COOH or other acidic groups imply presence of the deprotonated form in the alternative, assuming appropriate conditions that allow dissociation. It is also understood that mention of amino (NH₂, NHR, NR₂) or imino (—CH═NR, —CR═NH, —CR═NR) moieties or other basic groups imply presence of the protonated form in the alternative, assuming appropriate conditions that allow protonation.

The term “amino substituted alkyl” or “hydroxyl substituted alkyl” refers to an alkyl according to the above definition that is modified by one or several amine or hydroxyl groups NH₂, NHR, NR₂ or OH, wherein the R substituent as used in the current paragraph, different from other uses assigned to R in the body of the specification, is itself an unsubstituted or substituted C₁ to C₁₂ alkyl in its broadest sense, and in a narrower sense, R is methyl, ethyl or propyl unless otherwise specified. An alkyl having more than one carbon may comprise more than one amine or hydroxyl. Unless otherwise specified, the term “substituted alkyl” refers to alkyl in which each C is only substituted by at most one amine or hydroxyl group, in addition to bonds to the alkyl chain, terminal methyl, or hydrogen.

The term “carboxyl substituted alkyl” refers to an alkyl according to the above definition that is modified by one or several carboxyl groups COOH, or derivatives thereof, particularly carboxamides CONH₂, CONHR and CONR₂, or carboxylic esters COOR, with R having the meaning as laid out in the preceding paragraph and different from other meanings assigned to R in the body of this specification.

Non-limiting examples of “amino-substituted alkyl” include —CH₂NH₂, —CH₂NHCH₃, —CH₂NHCH₂CH₃, —CH₂CH₂NH₂, —CH₂CH₂NHCH₃, —CH₂CH₂NHCH₂CH₃, —(CH₂)₃NH₂, —(CH₂)₃NHCH₃, —(CH₂)₃NHCH₂CH₃, —CH₂CH(NH₂)CH₃, —(CH₂)₃CH₂NHCH₃, —CH₂CH(NHCH₃)CH₃, —CH₂CH(NHCH₂CH₃)CH₃, —(CH₂)₃CH₂NH₂, —(CH₂)₃CH₂NHCH₂CH₃, —CH(CH₂NH₂)CH₂CH₃, —CH(CH₂NHCH₃)CH₂CH₃, —CH(CH₂NHCH₂CH₃)CH₂CH₃, —CH₂CH(CH₂NHCH₂CH₃)CH₃, —CH(NHCH₂CH₃)(CH₂)₂NHCH₂CH₃, —CH₂CH(NHCH₂CH₃)CH₂NHCH₂CH₃, —CH₂CH(NH CH₂CH₃)(CH₂)₂NHCH₂CH₃, —CH₂CH(CH₂NH₂)CH₃, —CH(NH₂)(CH₂)₂NH₂, —CH₂CH(NH₂)CH₂NH₂, —CH₂CH(NH₂)(CH₂)₂NH₂, —CH₂CH(CH₂NH₂)₂, —CH₂CH(CH₂NHCH₃)CH₃, —CH(NHCH₃)(CH₂)₂NHCH₃, —CH₂CH(NHCH₃)CH₂NHCH₃, —CH₂CH(NHCH₃)(CH₂)₂NHCH₃, —CH₂CH(CH₂NHCH₃)₂ and —CH₂CH(CH₂NHCH₂CH₃)₂ for terminal moieties and —CH₂CHNH₂—, —CH₂CH(NHCH₃)—, —CH₂CH(NHCH₂CH₃)— for an amino substituted alkyl moiety bridging two other moieties.

Non-limiting examples of “hydroxy-substituted alkyl” include —CH₂OH, —(CH₂)₂OH, —(CH₂)₃OH, —CH₂CH(OH)CH₃, —(CH₂)₄OH, —CH(CH₂OH)CH₂CH₃, —CH₂CH(CH₂OH)CH₃, —CH(OH)(CH₂)₂OH, —CH₂CH(OH)CH₂OH, —CH₂CH(OH)(CH₂)₂₀H and —CH₂CH(CH₂OH)₂ for terminal moieties and —CH(OH)—, —CH₂CH(OH)—, —CH₂CH(OH)CH₂—, —(CH₂)₂CH(OH)CH₂—, —CH(CH₂OH)CH₂CH₂—, —CH₂CH(CH₂OH)CH₂—, —CH(OH)CH₂CH(OH)—, —CH₂CH(OH)CH(OH)—, —CH₂CH(OH)(CH₂)₂CH(OH)— and —CH₂CH(CH₂OH)CH(OH)— for a hydroxyl substituted alkyl moiety bridging two other moieties.

The term “halogen” refers to one or several atoms selected (independently) from F, Cl, Br, I.

The term “halogen-substituted alkyl” refers to an alkyl according to the above definition that is modified by one or several halogen atoms selected (independently) from F, Cl, Br, I.

The term “fluoro substituted alkyl” refers to an alkyl according to the above definition that is modified by one or several fluoride groups F. Non-limiting examples of fluoro-substituted alkyl include —CH₂F, —CHF₂, —CF₃, —(CH₂)₂F, —(CHF)₂H, —(CHF)₂F, —C₂F₅, —(CH₂)₃F, —(CHF)₃H, —(CHF)₃F, —C₃F₇, —(CH₂)₄F, —(CHF)₄H, —(CHF)₄F and —C₄F₉.

The term “alkoxy” in the context of the present invention signifies an alkyl or cycloalkyl group, as defined above, connected to the rest of the molecule via an oxygen atom, such as, for example, methoxy, ethoxy, 1-propoxy, 2-propoxy, tert-butoxy, cyclopropyloxy, allyloxy, and the higher homologs and isomers such as, for example, cyclohexyloxy.

The term “C₁-C₈ alkoxycarbonyl” in the context of the present invention signifies a C₁-C₈ alkoxy group, as defined above, connected to the rest of the molecule via a carbonyl group. Some non-limiting examples of such alkoxycarbonyl are, for example, carbomethoxy —C(═O)OCH₃, carboethoxy —C(═O)OCH₂CH₃ and tert-butyloxycarbonyl (Boc) —C(═O)OC(CH₃)₃ groups.

The term “aryl” in the context of the present invention signifies a cyclic aromatic C₅-C₁₀ hydrocarbon that may comprise a heteroatom (e.g. N, O, S). Examples of aryl include, without being restricted to, phenyl and naphthyl, and any heteroaryl. A “heteroaryl” is an aryl that comprises one or several nitrogen, oxygen and/or sulphur atoms. Examples for heteroaryl include, without being restricted to, pyrrole, thiophene, furan, imidazole, pyrazole, thiazole, oxazole, pyridine, pyrimidine, thiazine, quinoline, benzofuran and indole. An aryl or a heteroaryl in the context of the invention additionally may be substituted by one or more alkyl groups.

The term “alkylaryl” in the context of the present invention a substituted alkyl in the broadest sense as defined above, substituted in one or several carbon atoms with an aryl or heteroaryl as defined above. Some non-limiting examples of alkylaryl include benzyl, 2-phenylethyl, 2-(2-furyl)ethyl and 3-(1-indolyl)propyl.

A “substituted aryl” or “substituted heteroaryl” or “substituted alkylaryl” may comprise one or several substituents as defined herein for substituted alkyl.

The term “acyl” in the context of the present invention signifies an alkyl, cycloalkyl, aryl or alkylaryl group, as defined above, connected to the rest of the molecule via a carbonyl group —C(═O)—, such as, for example, acetyl, propionyl, benzoyl, 2-furoyl, 4-methoxybenzoyl, cinnamyl, Boc-Gly-.

The term “alkylsulfonyl” in the context of the present invention signifies an alkyl, cycloalkyl, aryl or alkylaryl group, as defined above, connected to the rest of the molecule via a sulfonyl group —SO₂—, such as, for example, mesyl, tosyl, trifluoromethanesulfonyl, vinylsulfonyl, dansyl, 4-nitrobenzenesulfonyl.

“Capable of forming a hybrid” in the context of the present invention relates to sequences that under the conditions existing within the cytosol of a mammalian cell, are able to bind selectively to their target sequence. Such hybridizing sequences may be contiguously reverse-complimentary to the target sequence, or may comprise gaps, mismatches or additional non-matching nucleotides. The minimal length for a sequence to be capable of forming a hybrid depends on its composition, with C or G nucleotides contributing more to the energy of binding than A or T/U nucleotides, and the backbone chemistry.

“Nucleotides” in the context of the present invention are nucleic acid or nucleic acid analogue building blocks, oligomers of which are capable of forming selective hybrids with RNA oligomers on the basis of base pairing. The term nucleotides in this context includes the classic ribonucleotide building blocks adenosine, guanosine, uridine (and ribosylthymin), cytidine, the classic deoxyribonucleotides deoxyadenosine, deoxyguanosine, thymidine, deoxyuridine and deoxycytidine. It further includes analogues of nucleic acids such as phosphorothioates, peptide nucleic acids (PNA; N-(2-aminoethyl)-glycine units linked by peptide linkage, with the nucleobase attached to the alpha-carbon of the glycine) or locked nucleic acids (LNA; RNA building blocks methylene-bridged between 2′-oxygen and 4′-carbon). The hybridizing sequence may be composed of any of the above nucleotides, or mixtures thereof.

The term “active ester” as used herein, refers to any ester-containing compound capable of reacting with functional groups, such as an amine or sulfhydryl groups, in particular with amine and sulfhydryl groups in a biomolecule, forming a covalent bond. Some non-limiting examples of active esters are N-hydroxysuccinimidyl ester, N-hydroxysulfosuccinimidyl ester, N-hydroxyphthalimidyl ester, tetrafluorophenyl ester, and pentafluorophenyl ester. In the context of the present specification, the term “active ester” is also extended to include acyl fluorides and acyl azides.

“Structurally identical” substituents are understood as having the same number of atoms from which they are composed and the same connectivity between those atoms; for example, the substituents R⁹=isopropyl and R¹²=isopropyl are structurally identical, and the substituents —NR⁹R¹⁰=dimethylamino and —NR¹¹R¹²=dimethylamino are structurally identical.

It is understood that any position wherein H (hydrogen atom) is present it can be substituted with D (deuterium atom), in particular if such substitution improves the properties (e.g. increases photostability and fluorescence quantum yield) of the fluorescent dyes of the present invention.

Where ionizable moieties are disclosed, it is understood that any salt, particularly any pharmaceutically acceptable salt of such molecule is encompassed by the invention. The salt comprises the ionized molecule of the invention and an oppositely charged counterion. Non-limiting examples of anionic salt forms include acetate, benzoate, besylate, bitatrate, bromide, carbonate, chloride, citrate, edetate, edisylate, embonate, estolate, fumarate, gluceptate, gluconate, hydrobromide, hydrochloride, iodide, lactate, lactobionate, malate, maleate, mandelate, mesylate, mucate, napsylate, nitrate, pamoate, phosphate, diphosphate, salicylate, disalicylate, stearate, succinate, sulfate, tartrate, tosylate, triethiodide and valerate. Non-limiting examples of cationic salt forms include aluminium, benzathine, calcium, ethylene diamine, lysine, magnesium, meglumine, potassium, procaine, sodium, tromethamine and zinc.

The following abbreviations are used throughout the following text and claims: BSA, bovine serum albumin; Da, Dalton (unified atomic mass unit); DIPEA, N,N-diisopropylethylamine; DMF, N,N-dimethylformamide; DMSO, dimethyl sulfoxide; LED, light emitting diode; MINFLUX, fluorescence nanoscopy with minimal photoc fluxes; NHS, N-hydroxysuccinimide; PALM, photoactivation localization microscopy; PBS, phosphate buffered saline; PFA, paraformaldehyde; PVA, polyvinyl alcohol; SMLM, single molecule localization microscopy; STED, fluorescence nanoscopy with stimulated emission depletion; TFA, trifluoroacetic acid; THF, tetrahydrofuran.

### DESCRIPTION OF THE INVENTION

The present invention provides novel compounds which are photoactivatable bridged benzophenone derivatives of type I bearing an alkenyl subsituent (—CR⁶═CR⁷R⁸) ortho to an exocylic substituted imine double bond (C═N—Y—WR¹³) so that, upon activation with ultraviolet, visible or infrared light, they cyclize to generate the fluorescent xanthylium-type dyes II:

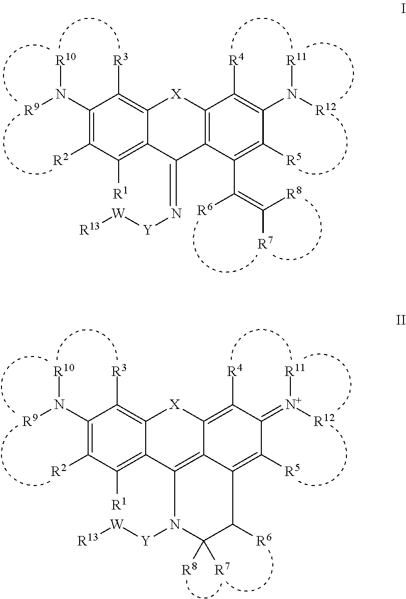

The present invention relates to novel compounds, in particular photoactivatable fluorescent dyes, which have the general structural formula I below:

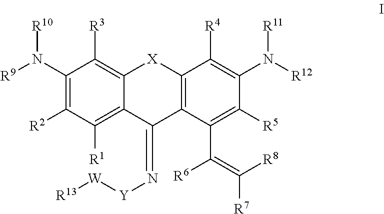

wherein:
R¹, R², R³, R⁴, R⁵, R⁶, R¹ and R⁸, independently of each other are selected from H, halogen, SO₃H, CO₂H, CN, NO₂, CO₂R, SO₂R (with R in CO₂R or SO₂R being selected from C₁ to C₄ unsubstituted alkyl), and an unsubstituted or substituted, in particular a halogen-, amino-, hydroxyl-, SO₃H— and/or carboxyl-substituted C₁-C₂₀ alkyl, C₃-C₈ cycloalkyl, C₁-C₂₀ alkoxy, C₂-C₂₀ alkylene, C₂-C₂₀ alkylyne, C₇-C₂₀ alkylaryl, phenyl and 5- or 6-membered ring heteroaryl, or a combination thereof;
   and where the substituents R⁶ and R⁷, taken together with the atoms to which they are bound, may form a 5-8 membered ring structure; and/or where the substituents R⁷ and R⁸, taken together with the atoms to which they are bound, may form a 5-8 membered ring structure;
R⁹, R¹⁰, R¹¹, R¹² are:
   a. independently selected from H, unsubstituted and substituted C₁-C₈ alkyl, C₃-C₈ cycloalkyl, C₁-C₈ acyl, C₁-C₈ alkoxycarbonyl, and C₇-C₁₂ alkylaryl, and unsubstituted phenyl or phenyl substituted by unsubstituted alkyl, halogen, alkoxy, NO₂, CO₂H, CO₂R and/or CONR₂ (with each R in CO₂R or CONR₂ being selected independently from C₁ to C₄ unsubstituted alkyl); or
   b. R⁹ together with R¹⁰ and a nitrogen atom to which they are bound, and/or R¹¹ together with R¹² and a nitrogen atom to which they are bound form a 3-7 membered ring structure; or
   c. R⁹ and/or R¹¹ are independently selected from H and unsubstituted and substituted C₁-C₈ alkyl, C₃-C₈ cycloalkyl, and C₇-C₁₂ alkylaryl; and R¹⁰ together with R² or R³ and the atoms to which they are bound form a 5-7 membered ring structure, and/or R¹² together with R⁴ or R⁵ and the atoms to which they are bound form a 5-7 membered ring structure;
   d. R⁹ together with R² and the atoms to which they are bound form a 5-7 membered ring structure, and/or R¹⁰ together with R³ and the atoms to which they are bound form a 5-7 membered ring structure, and/or R¹¹ together with R⁴ and the atoms to which they are bound form a 5-7 membered ring structure, and/or R¹² together with R⁵ and the atoms to which they are bound form a 5-7 membered ring structure;
X is independently selected from:
   a. SiR¹⁴R¹⁵ or GeR¹⁴R¹⁵ group, where R¹⁴ and R¹⁵ are each independently selected from unsubstituted and substituted C₁-C₁₂ alkyl, C₃-C₈ cycloalkyl, C₁-C₂₀ alkoxy, C₂-C₂₀ alkylene, C₂-C₂₀ alkylyne and C₇-C₂₀ alkylaryl, phenyl and 5- or 6-membered ring heteroaryl, or a combination thereof,
      or where both substituents R¹⁴ and R¹⁵, taken together with the Si or Ge to which they are attached, form a 4-7 membered ring structure;
   b. CR¹⁶R¹⁷ group, where R¹⁶ and R¹⁷ are each independently selected from H, F, CF₃, CN, OR¹⁸, COR¹⁸, CO₂R¹⁸, SO₂R¹⁸, CONR¹⁸R¹⁹ (where R¹⁸ and R¹⁹ in COR¹⁸, CO₂R¹⁸, SO₂R¹⁸, and CONR¹⁸R¹⁹ are each independently selected from unsubstituted and substituted C₁-C₁₂ alkyl, C₃-C₈ cycloalkyl, C₁-C₂₀ alkoxy, C₂-C₂₀ alkylene, C₂-C₂₀ alkylyne and C₇-C₂₀ alkylaryl, phenyl and 5- or 6-membered ring heteroaryl, or a combination thereof), unsubstituted and substituted C₁-C₁₂ alkyl, C₃-C₈ cycloalkyl, C₁-C₂₀ alkoxy, C₂-C₂₀ alkylene, C₂-C₂₀ alkylyne and C₇-C₂₀ alkylaryl, phenyl and 5- or 6-membered ring heteroaryl, or a combination thereof,
      or where both substituents R¹⁶ and R¹⁷, taken together with the C atom to which they are attached, form a 4-7 membered ring structure;
Y is independently selected from:
   a. C═O (carbonyl), C═S (thiocarbonyl) or C═NR²⁰ (iminocarbonyl) group, where R²⁰ is selected from H, unsubstituted and substituted C₁-C₁₂ alkyl, C₃-C₈ cycloalkyl, C₁-C₂₀ alkoxy, C₂-C₂₀ acyl, C₂-C₂₀ alkylsulfonyl, C₂-C₂₀ alkylene, C₂-C₂₀ alkylyne and C₇-C₂₀ alkylaryl, phenyl and 5- or 6-membered ring heteroaryl, or a combination thereof;
   b. SO₂ (sulfone) or S(═O)(═NR²⁰) (sulfoximine) group, where R²⁰ is selected from H, unsubstituted and substituted C₁-C₁₂ alkyl, C₃-C₈ cycloalkyl, C₁-C₂₀ alkoxy, C₂-C₂₀ acyl, C₂-C₂₀ alkylsulfonyl, C₂-C₂₀ alkylene, C₂-C₂₀ alkylyne and C₇-C₂₀ alkylaryl, phenyl and 5- or 6-membered ring heteroaryl, or a combination thereof;
   c. P(═O)(—OH), P(═O)(—OR²⁰) or P(═O)(—R²⁰), where R²⁰ is selected from H, unsubstituted and substituted C₁-C₁₂ alkyl, C₃-C₈ cycloalkyl, C₁-C₂₀ alkoxy, C₂-C₂₀ acyl, C₂-C₂₀ alkylsulfonyl, C₂-C₂₀ alkylene, C₂-C₂₀ alkylyne and C₇-C₂₀ alkylaryl, phenyl and 5- or 6-membered ring heteroaryl, or a combination thereof;
W is independently selected from 0, S or NR²¹, where R²¹ is selected from H, unsubstituted and substituted C₁-C₁₂ alkyl, C₃-C₈ cycloalkyl, C₁-C₂₀ alkoxy, C₂-C₂₀ acyl, C₂-C₂₀ alkylsulfonyl, C₂-C₂₀ alkylene, C₂-C₂₀ alkylyne and C₇-C₂₀ alkylaryl, phenyl and 5- or 6-membered ring heteroaryl, or a combination thereof;
R¹³ is selected from H, unsubstituted and substituted C₁-C₁₂ alkyl, C₃-C₈ cycloalkyl, C₁-C₂₀ alkoxy, C₂-C₂₀ acyl, C₂-C₂₀ alkylsulfonyl, C₂-C₂₀ alkylene, C₂-C₂₀ alkylyne and C₇-C₂₀ alkylaryl, phenyl and 5- or 6-membered ring heteroaryl, or a combination thereof, or where the substituents R¹³ and R²⁰ taken together form a 5-8 membered ring structure.

Representative examples of compounds of the general structural formula I above are substituted derivatives of 3,7-diamino-1-vinyldibenzo[b,e]silin-10(5H)-one imine (X═SiR¹⁴R¹⁵), 3,7-diamino-1-vinyldibenzo[b,e]germin-10(5H)-one imine (X═GeR¹⁴R¹⁵) and 3,6-diamino-1-vinylanthracen-9(10H)-one imine (X═CR¹⁶R¹⁷), where the substituted imine (C═N—Y—WR¹³) may represent a carbamate (Y═C═O, W═O), a thiocarbamate (Y═C=S, W═O or alternatively Y═C═O, W═S), an isourea (Y═C=NR²⁰, W═O), a urea (Y═C═O, W═NR²¹), a thiourea (Y═C=S, W═NR²¹), a guanidine (Y═C=NR²⁰, W═NR²¹), a sulfamide (Y═SO₂, W═NR²¹), an imidosulfuric diamide (Y═S(═NR²⁰)(═O), W═NR²¹), a phosphonamidate (Y═P(—R²⁰)(═O), W═O) and a phosphonic diamide (Y═P(—R²⁰)(═O), W═NR²¹) derivative.

Further novel compounds of the invention, in particular fluorescent dyes, which are obtainable by irradiation with light (ultraviolet, visible or infrared) through a one-photon absorption process or a multiphoton absorption process of any of the compounds of general formula I described above have the general structural formula II below:

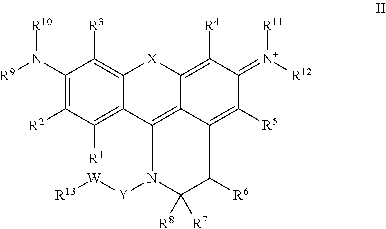

where R¹, R², R³, R⁴, R⁵, R⁶, R⁷, R⁸, R⁹, R¹⁰, R¹¹, R¹², R¹³, X, Y and W are defined as above.

Representative examples of compounds of the general structural formula II above are substituted 2,3-dihydro-1H-pyrido-fused Si-pyronine (X═SiR¹⁴R¹⁵), Ge-pyronine (X═GeR¹⁴R¹⁵) and carbopyronine (X═CR¹⁶R¹⁷) fluorophores.

In one specific embodiment, the compound of general structural formula I or II is covalently linked (particularly through any one of substituents R¹, R², R³, R⁴, R⁵, R⁶, R⁷, R⁸, R⁹, R¹⁰, R¹¹, R¹² and R¹³ or through any of the groups X, Y and W) to a binding moiety M according to the general definition above.

In a more specific embodiment, the binding moiety M is selectively attachable by covalent bond to a protein or nucleic acid, in particular under conditions prevailing in cell culture or inside of a living cell (e.g. pH ranging from 4.5 to 8.0 across different organelles, glutathione (GSH) concentration ranging between 0.5 and 15 mM, temperature between 30° C. and 38° C. for mammalian cells), particularly a moiety able to form an ester bond, a thioester bond, an ether bond, an amide or thioamide bond, a sulfide or disulfide bond, a carbon-carbon bond, a carbon-nitrogen bond such as a Schiff base, or a moiety able to react in a click-chemistry reaction with a corresponding reactive or functional group. In a more specific embodiment, said binding moiety M is selected from —COCH═CH₂, —SO₂CH═CH₂, —COCH₂I, —COC═CH, —N═C═S, —CO—NHS or another active ester, biotin, an azide or a tetrazine moiety, a diazoalkane or diazoketone moiety, a diazirine moiety, an alkyne, a strained alkyne such as a bicyclo[6.1.0]nonyne moiety or cyclooctyne moiety, a strained alkene such as trans-cyclooctene moiety or norbornene moiety or a maleimide.

In another specific embodiment, the binding moiety M is a substrate of a haloalkane transferase, particularly when M is a 1-chlorohexyl or a (3-chloropropyl)aryl moiety as exemplarily shown below:

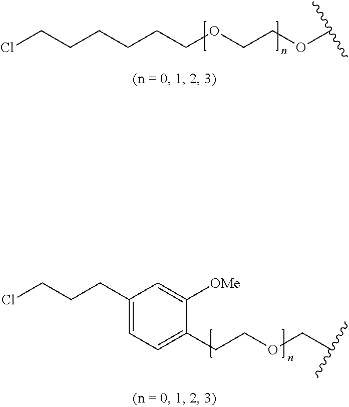

In another specific embodiment, the binding moiety M is a substrate of O⁶-alkylguanine-DNA-alkyltransferase, particularly a (substituted) O⁶-benzylguanine, O²-benzylcytosine or 4-benzyloxy-6-halo- or 4-benzyloxy-6-pseudohalo-pyrimidine-2-amine moiety (where halo group is preferably chloro, and pseudohalo group is selected preferably, but without limitation, from CN and CF₃) as exemplarily shown below:

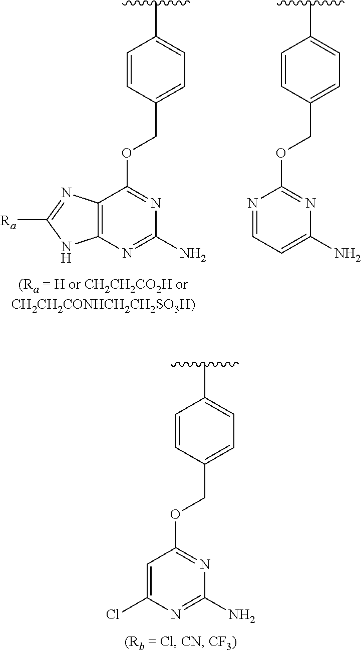

In another specific embodiment, the binding moiety M is a substrate of dihydrofolate reductase, particularly a 4-demethyltrimethoprim moiety as exemplarily shown below:

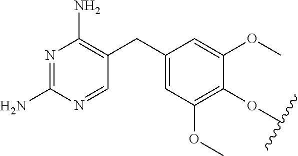 [SMILES: *Oc1c(OC)cc(Cc2cnc(N)nc2N)cc1OC]

In another specific embodiment, the binding moiety M is a moiety capable of selectively interacting non-covalently with a biomolecule (particularly a protein or nucleic acid) wherein said moiety and said biomolecule form a complex having a dissociation constant k_{D} of 10⁻⁶ mol/L or less. In a more specific embodiment, the said binding moiety M is selected from de-N-Boc-docetaxel, de-N-Boc-cabazitaxel, de-N-Boc-larotaxel or another taxol derivative, a phalloidin derivative, a jasplakinolide derivative, a bis-benzimide DNA stain, pepstatin A or triphenylphosphonium, as exemplarily shown below:

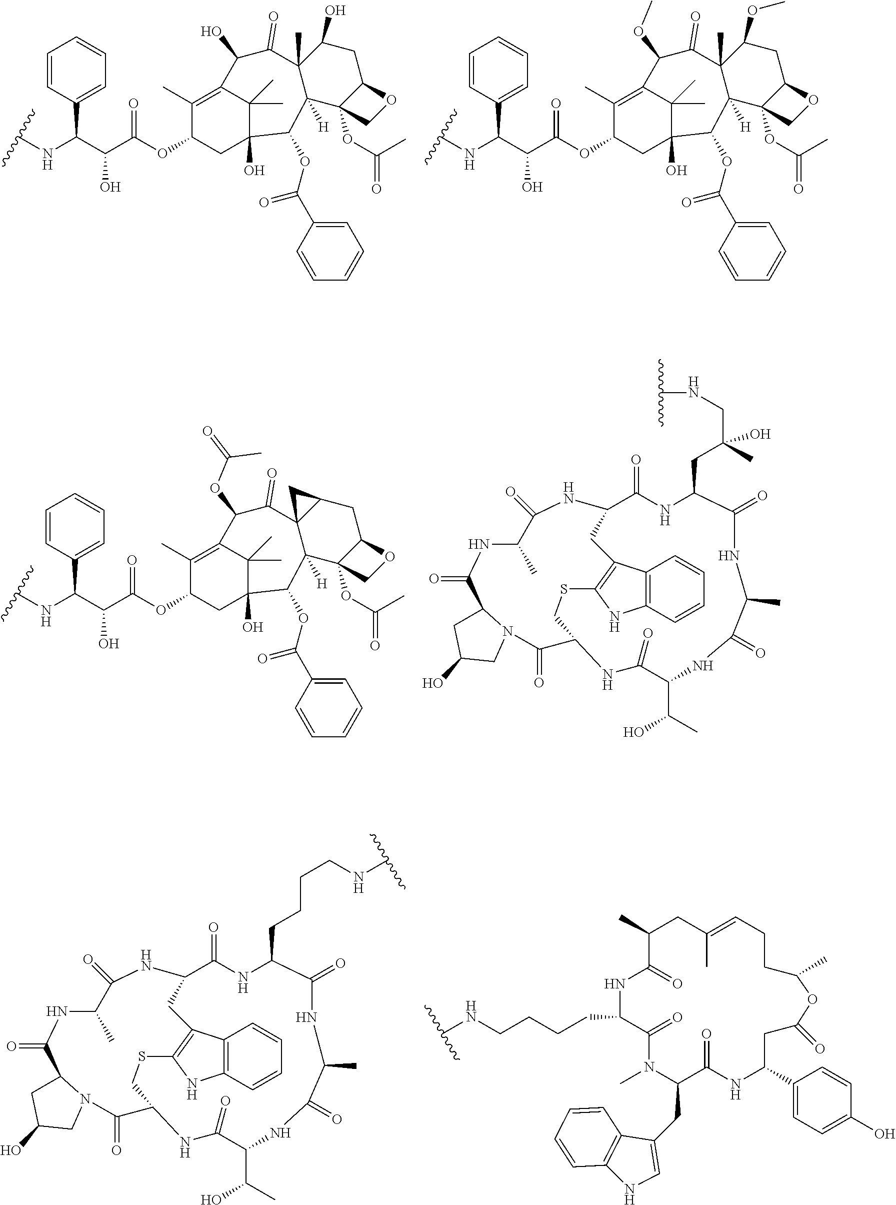

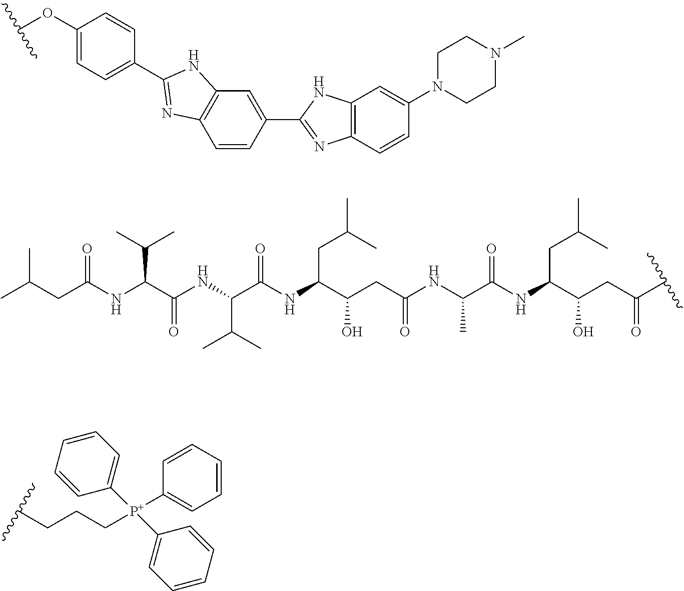

In another specific embodiment, the binding moiety M is an oligonucleotide having a sequence length between 10 and 40 nucleotides.

In another specific embodiment, the binding moiety M is a lipid, particularly a sphingosine derivative such as a ceramide, or a phospholipid such as dioleoylphosphatidylethanolamine (DOPE) or dipalmitoylphosphatidylethanolamine (DPPE), or a fatty acid.

In one specific embodiment, the compound of general structural formula I, in particular photoactivatable fluorescent dye, has one of the structural formulas I-1-I-30:

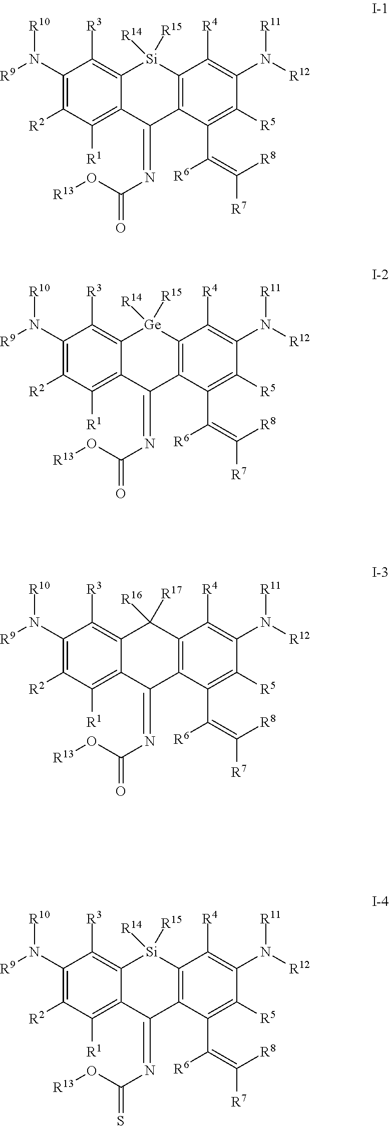

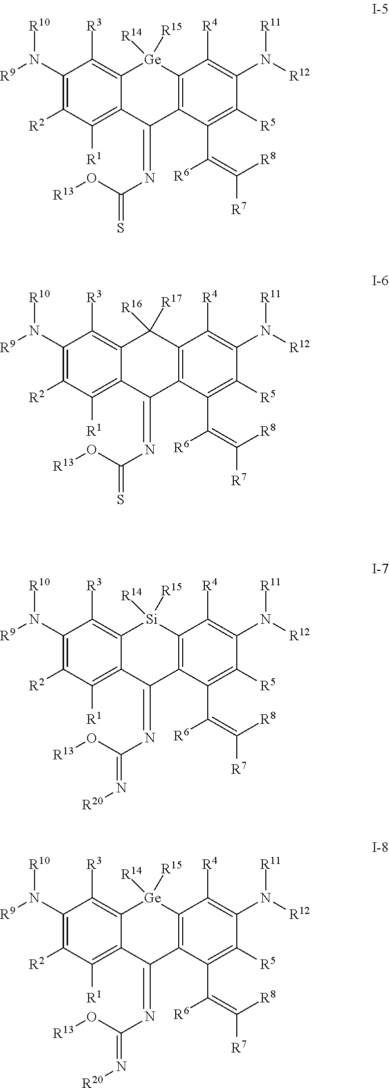

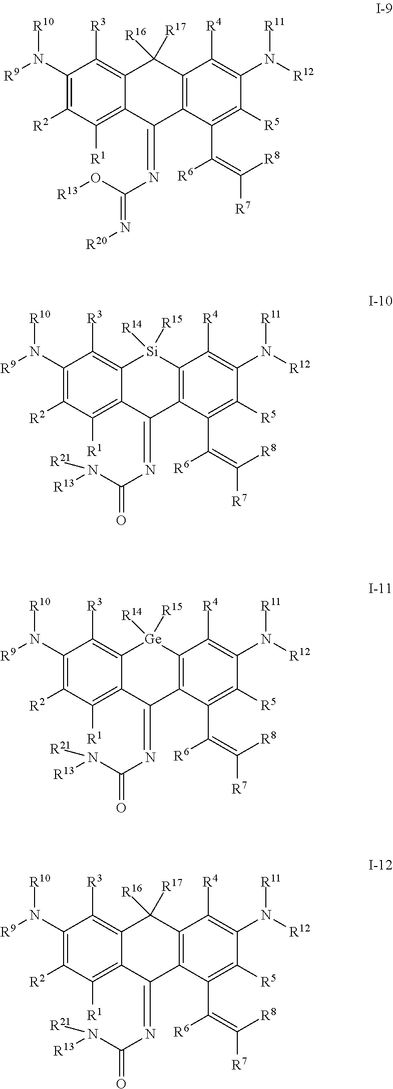

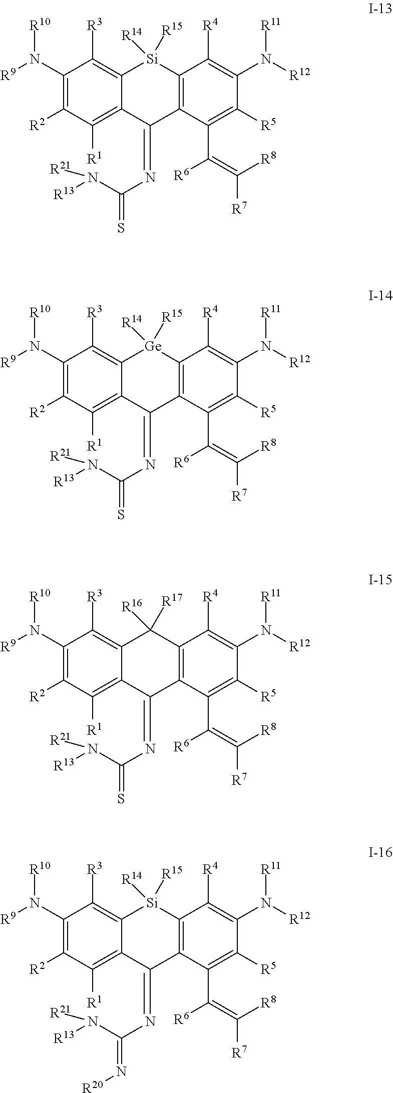

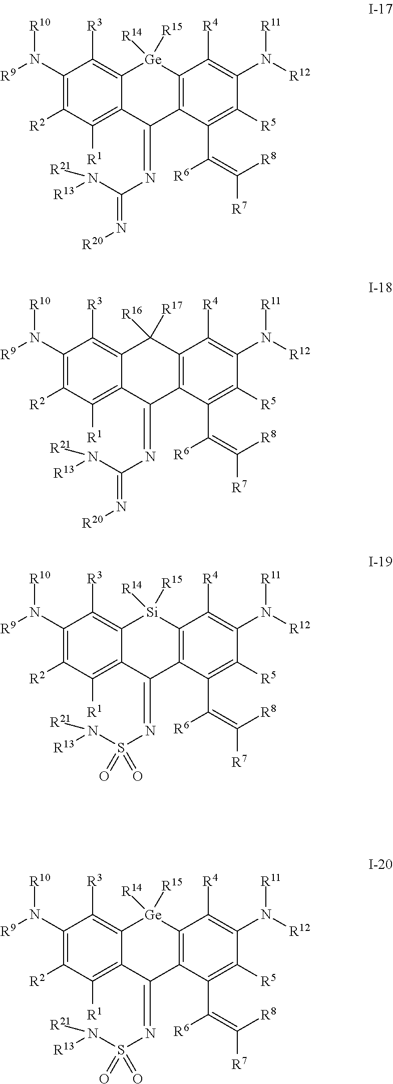

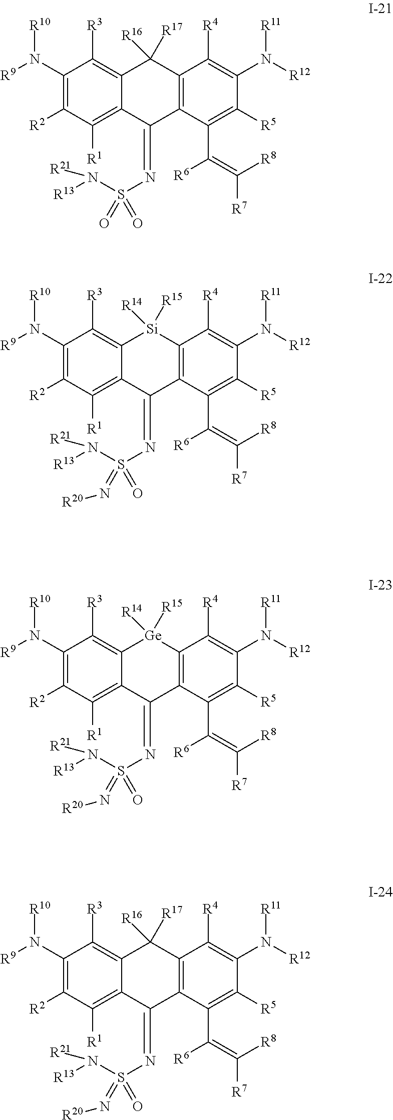

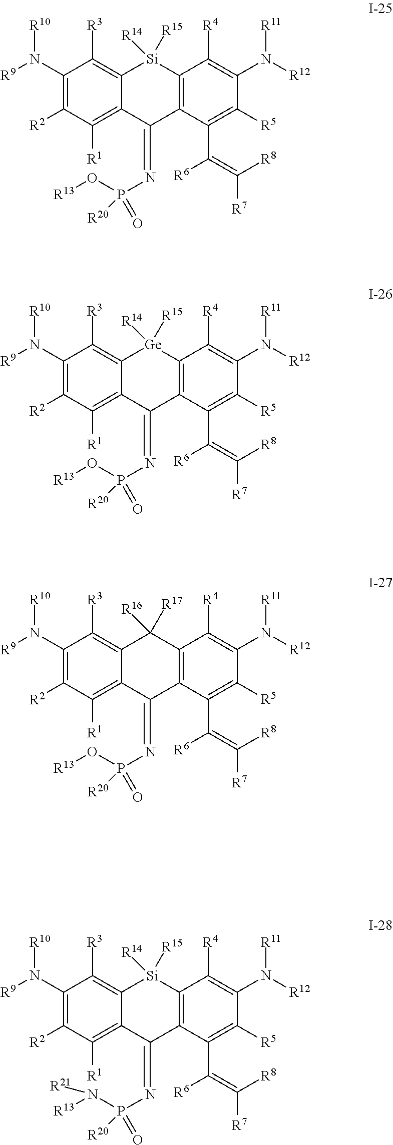

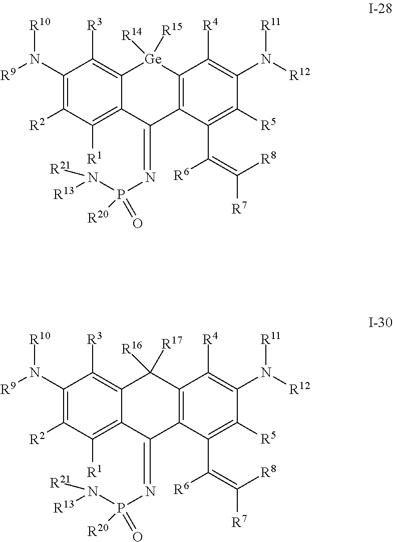

wherein any one of substituents R¹, R², R³, R⁴, R⁵, R⁶, R⁷, R⁸, R⁹, R¹⁰, R¹¹, R¹² or any one of the substituents R¹³, R¹⁴, R¹⁵, R¹⁶, R¹⁷, R¹⁸, R¹⁹, R²⁰, R²¹, if present, independently of any other is H or a moiety having a molecular weight between 15 and 1500 Da;
   particularly wherein:
   a) the substituents R⁹, R¹⁰, R¹¹, R¹² are selected from H and methyl, or any of the substituents —NR⁹R¹⁰ and —NR¹¹R¹² represents an azetidine ring, and
   b) one of substituents R¹, R², R³, R⁴, R⁵, R⁷, R⁸ or one of the R¹³, R¹⁴, R¹⁵, R¹⁶, R¹⁷, R¹⁸, R¹⁹, R²⁰, R²¹, if present, is H or a moiety M having a molecular weight between 15 and 1500 Da, and
   c) the other substituents R¹, R², R³, R⁴, R⁵ are selected from H and F, and
   d) the other substituents R⁶, R⁷, R¹ are selected from H and methyl, and
   e) the other substituents R¹⁴, R¹⁵, if present, are selected from methyl, ethyl, isopropyl or phenyl,
   f) the other substituents R¹⁶, R¹⁷ if present, are methyl,
   g) the other substituents R²⁰, R²¹ if present, are selected from H, OH, methoxy and methyl.

In another specific embodiment, the compound of general structural formula II, in particular a fluorescent dye, in particular when produced by irradiation with light (UV, visible or infrared) of any of the compounds of general formula I-1-I-30, has one of the structural formulas II-1-II-30:

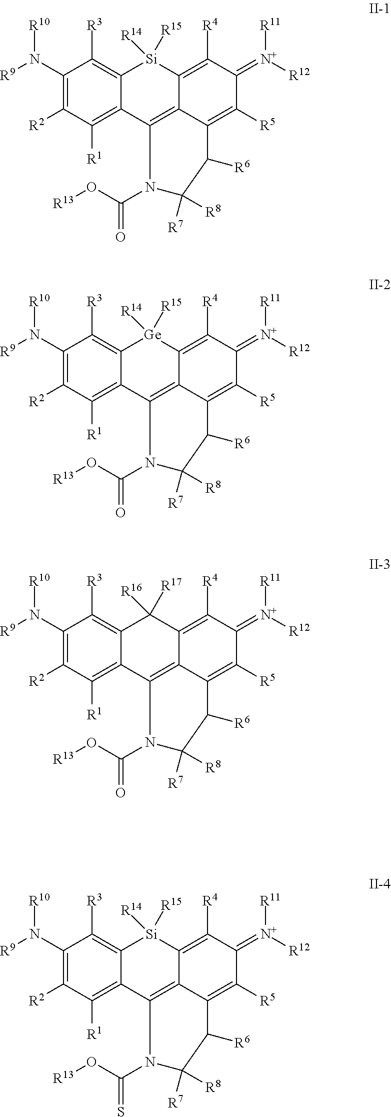

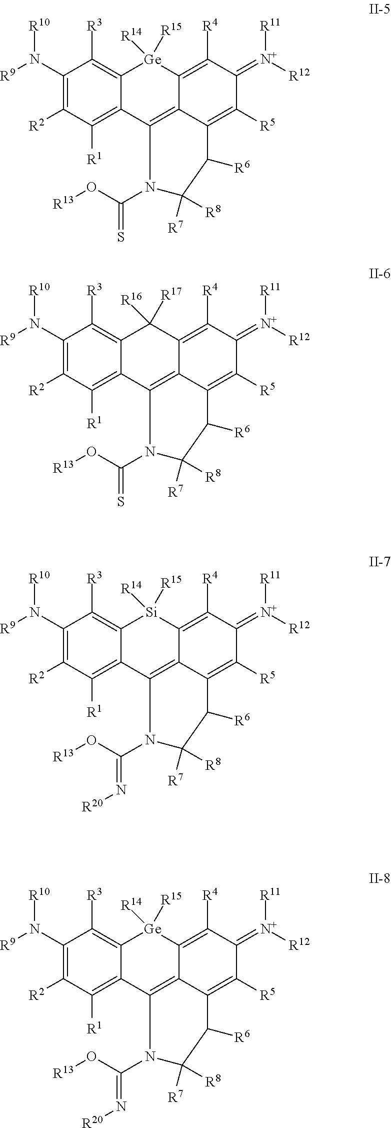

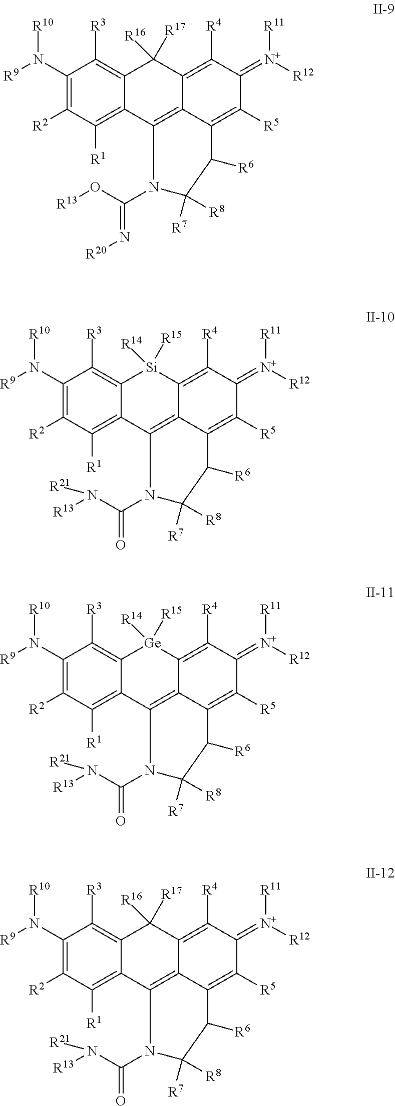

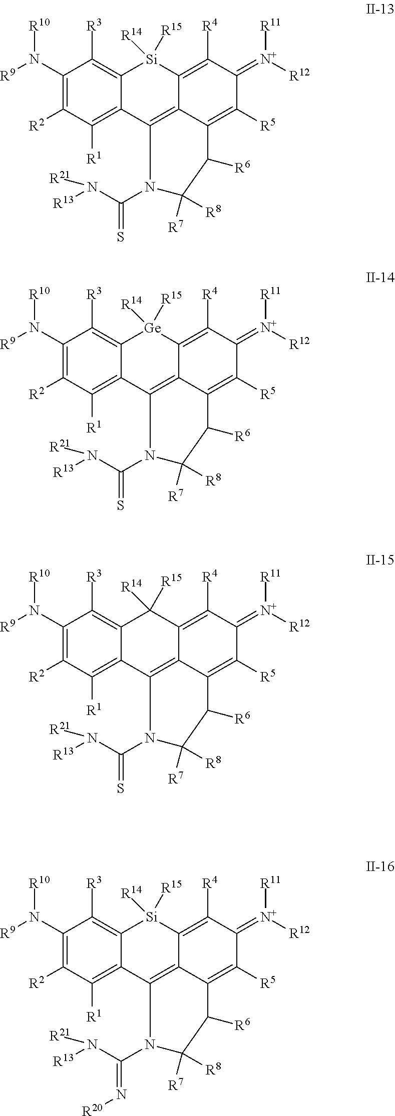

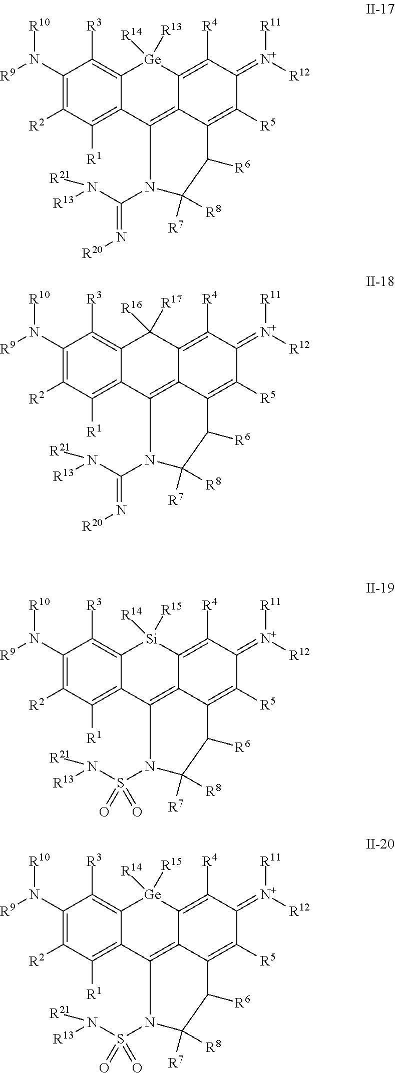

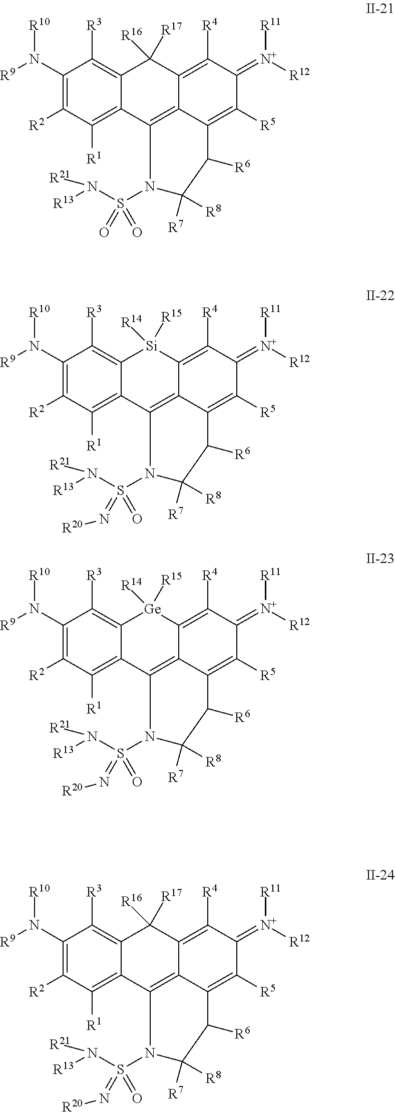

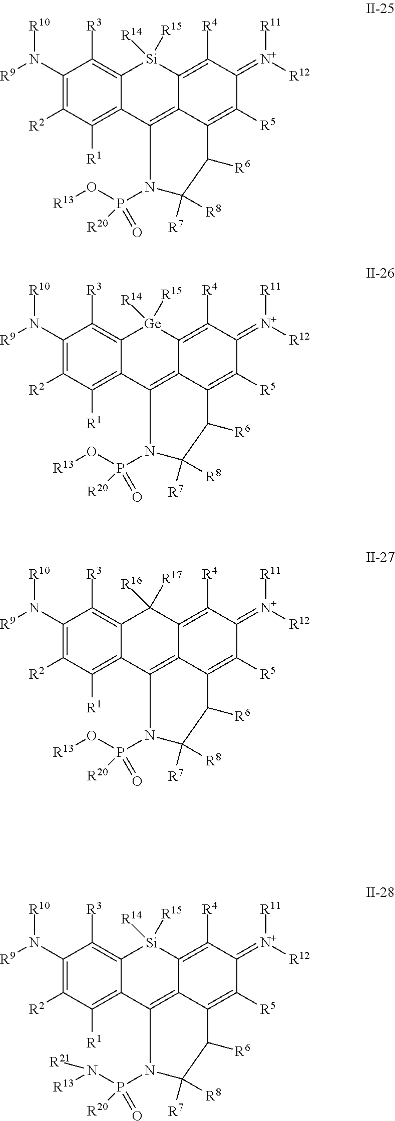

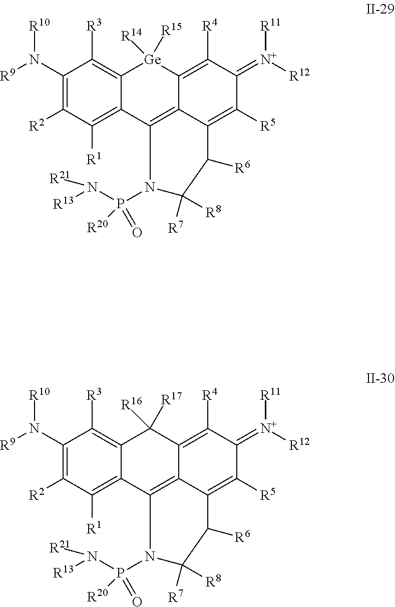

wherein any one of substituents R¹, R², R³, R⁴, R⁵, R⁶, R⁷, R⁸, R⁹, R¹⁰, R¹¹, R¹² or any one of the substituents R¹³, R¹⁴, R¹⁵, R¹⁶, R¹⁷, R¹⁸, R¹⁹, R²⁰, R²¹, if present, independently of any other is H or a moiety having a molecular weight between 15 and 1500 Da;
   particularly wherein:
   h) the substituents R⁹, R¹⁰, R¹¹, R¹² are selected from H and methyl, or any of the substituents —NR⁹R¹⁰ and —NR¹¹R¹² represents an azetidine ring, and
   i) one of substituents R¹, R², R³, R⁴, R⁵, R⁶, R⁷, R⁸ or one of the R¹³, R¹⁴, R¹⁵, R¹⁶, R¹⁷, R¹⁸, R¹⁹, R²⁰, R²¹, if present, is H or a moiety M having a molecular weight between 15 and 1500 Da, and
   j) the other substituents R¹, R², R³, R⁴, R⁵ are selected from H and F, and
   k) the other substituents R⁶, R⁷, R¹ are selected from H and methyl, and
   l) the other substituents R¹⁴, R¹⁵, if present, are selected from methyl, ethyl, isopropyl or phenyl,
   m) the other substituents R¹⁶, R¹⁷, if present, are methyl,
   n) the other substituents R²⁰, R²¹, if present, are selected from H, OH, methoxy and methyl.

In another specific embodiment, the said binding moiety M defined as above and having a molecular weight between 15 and 1500 Da is characterized by a general formula -L-MS, where -L- is a covalent bond or a linker consisting of 1 to 50 atoms having an atomic weight of 12 or higher (in addition to the number of hydrogen atoms required to satisfy the valence rules) covalently connecting the compound of structure I-1-I-30 or II-1-II-30 to the binding moiety Mₛ (which is defined identical to binding moiety M above). In a more specific embodiment, said moiety M having a molecular weight between 15 and 1500 Da is characterized by a general formula

-L^{A1}ₘ-L^{J1}_{m′}-L^{A2}ₙ-L^{J2}_{n′}- L^{A3}ₚ-L^{J3}_{p′}-L^{A4}_{q}-L^{A4}_{q′}-Mₛ, wherein
L^{A1}, L^{A2}, L^{A3} and L^{A4} independently of each other are selected from C₁ to C₁₂ unsubstituted or amino-, hydroxyl-, carboxyl- or fluoro substituted alkyl or cycloalkyl, (CH₂—CH₂—O)ᵣ with r being an integer from 1 to 20, alkylaryl, alkylaryl-alkyl, and unsubstituted or alkyl-, halogen-, amino-, alkylamino-, imido-, nitro-, hydroxyl-, oxyalkyl-, carbonyl-, carboxyl-, sulfonyl- and/or sulfoxyl substituted aryl or heteroaryl;
L^{J1}, L^{J2}, L^{J3} and L^{J4} independently of each other are selected from —NRC(═O)—, —C(═O)N(R)—, —NRC(═O)O—, —OC(═O)N(R)—, —C(R)═N—, —N═C(R)—, —C(═O)—, —OC(═O)—, —C(═O)O—, —N(R)—, —O—, —P(═O)(OR)—, —P(═O)(OR)O—, —OP(═O)(OR)—, —OP(═O)(OR)O—, —S—, —SO—, —SO₂—, —SO₂N(R)—, —N(R)SO₂N(R)—, —N(R)SO₂— with R selected from H and unsubstituted or amino-, hydroxyl-, carboxyl, sulfonate or fluoro substituted C₁ to C₆ alkyl, particularly when R is selected from H and methyl;
m, m′, n, n′, p, p′, q, q′ and s independently from each other are selected from 0 and 1, and the binding moiety Mₛ is defined identical to binding moiety M as above.

In a more specific embodiment, the compound of the present invention, in particular a photoactivatable fluorescent dye or fluorescent dye, has the general structure I-1-I-30 or II-1-II-30, and the said moiety is represented by one of the following structures:

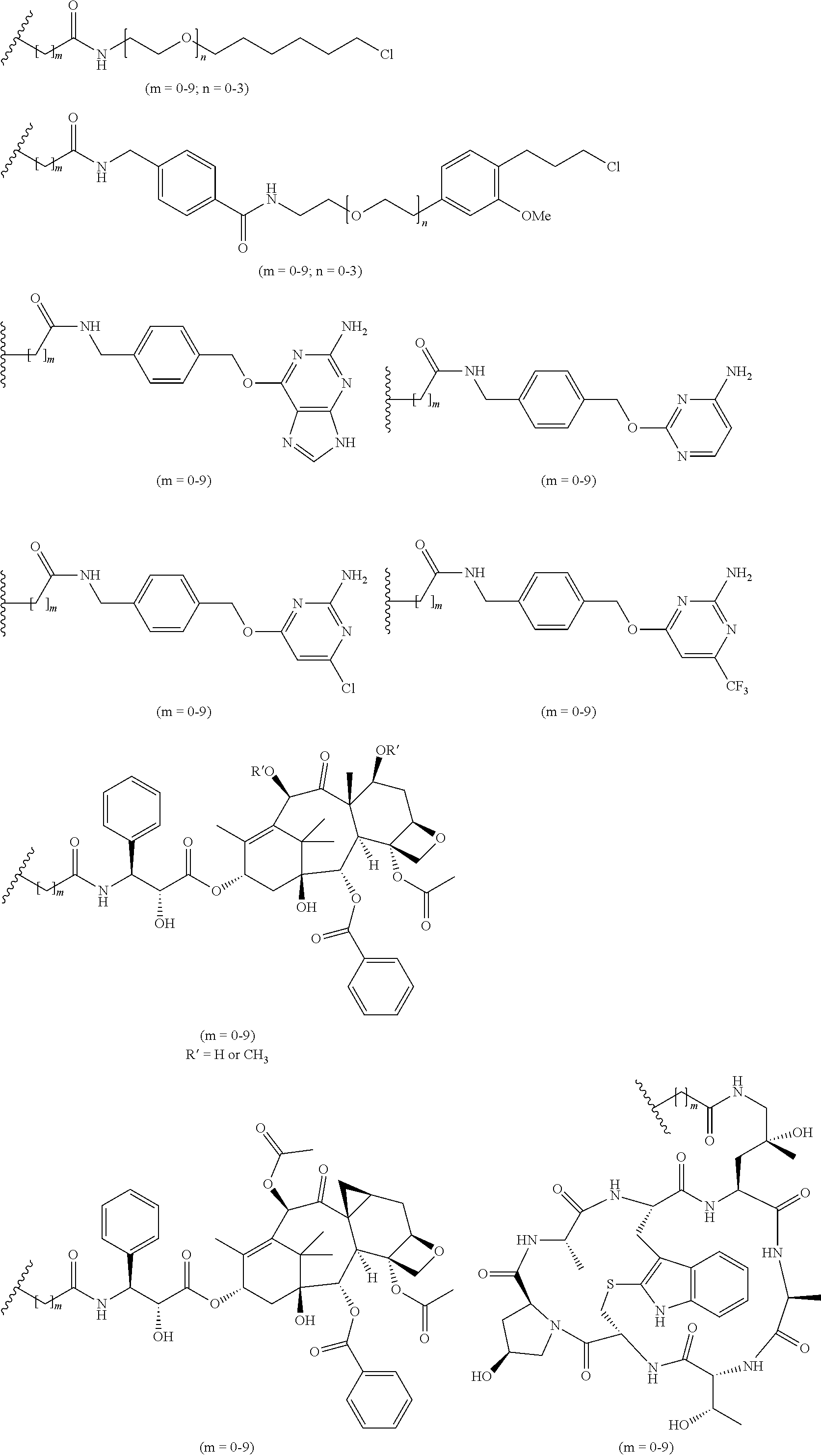

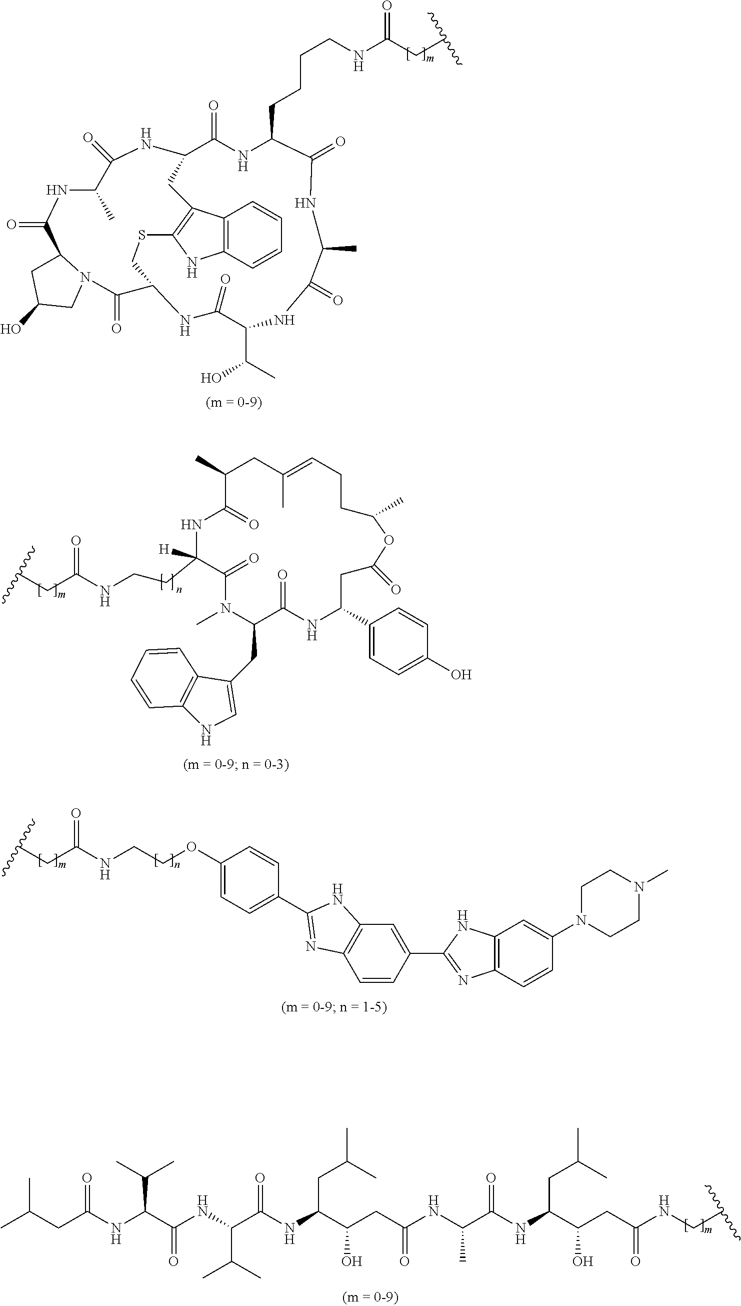

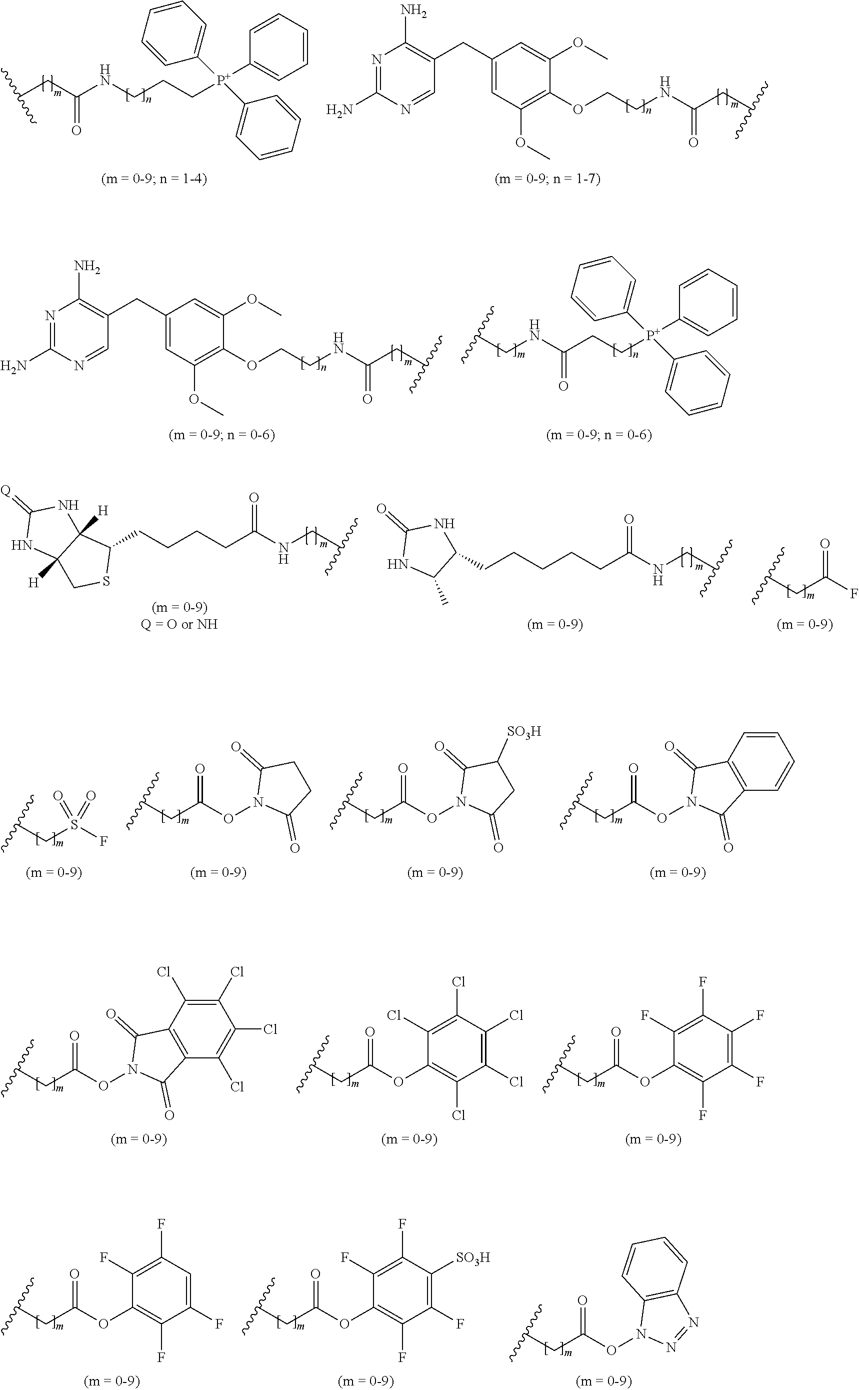

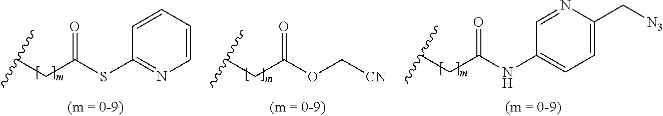

In another specific embodiment, the compound of the present invention, in particular a photoactivatable fluorescent dye or fluorescent dye, has the general structure I-1-I-30 or II-1-11-30, and:
a. R⁹ and R¹⁰, and/or R¹¹ and R¹², are independently selected from H, unsubstituted and amino-, hydroxy-, carboxy-, sulfonate- and/or fluoro-substituted C₁-C₆ alkyl, C₁-C₄ acyl, C₁-C₄ alkoxycarbonyl (including tert-butyloxycarbonyl or Boc group) and C₃-C₆ cycloalkyl, particularly when R⁹ and R¹⁰, and/or R¹¹ and R¹², are independently selected from H, methyl, ethyl, n-propyl, isopropyl, n-butyl, isobutyl, tert-butyl, allyl and CH₂CF₃; or
b. R⁹ together with R¹⁰, and/or R⁹ together with R¹⁰, are independently forming an unsubstituted or alkyl-, amino-, hydroxy-, carboxy-, sulfonate- and/or fluoro-substituted C₃-C₆ alkyl, particularly —(CH₂)₃—, —(CH₂)₄—, —(CH₂)₅—, —(CH₂)₂O(CH₂)₂—, —(CH₂)₂SO₂(CH₂)₂— or —(CH₂)₂NR²²(CH₂)₂— with R²² being selected from H and unsubstituted C₁ to C₄ alkyl (particularly methyl); or
c. R⁹ and/or R¹¹ are independently selected from H, unsubstituted and alkyl-substituted (particularly methyl-substituted), amino-, hydroxy-, carboxy-, sulfonate- and/or fluoro-substituted C₁-C₆ alkyl, C₁-C₄ acyl, C₁-C₄ alkoxycarbonyl (including tert-butyloxycarbonyl or Boc group) and C₃-C₆ cycloalkyl, and R¹⁰ together with R² or R³, and/or R¹² together with R⁴ or R⁵, is an alkyl or heteroalkyl bridge selected from —(CH₂)₂—, —(CH₂)₃—, —CH₂CH═CH— or —(CH₂)₄— or —CH₂—O—, —CH₂—NR—, —CH₂—S—, —CH₂—SO₂—, —(CH₂)₂₀—, —(CH₂)₂NR—, —(CH₂)₂S—, —(CH₂)₂SO₂—, —CH₂—O—CH₂—, —CH₂NR—, —CH₂S—CH₂—, —CH₂—SO₂—CH₂— (with R selected from H and unsubstituted or amino-, hydroxyl-, carboxyl, sulfonate or fluoro substituted C₁ to C₆ alkyl, particularly when R is selected from H and methyl) and a mono- or dimethyl substituted derivative of any one of the foregoing alkyl or heteroalkyl bridge moieties; or
d. R¹⁰ and/or R¹¹ are independently selected from H, unsubstituted and alkyl-substituted (particularly methyl-substituted), amino-, hydroxy-, carboxy-, sulfonate- and/or fluoro-substituted C₁-C₆ alkyl, C₁-C₄ acyl, C₁-C₄ alkoxycarbonyl (including tert-butyloxycarbonyl or Boc group) and C₃-C₆ cycloalkyl, and R⁹ together with R², and/or R¹² together with R⁵, form a fused annular structure according to any one of the following substructures:

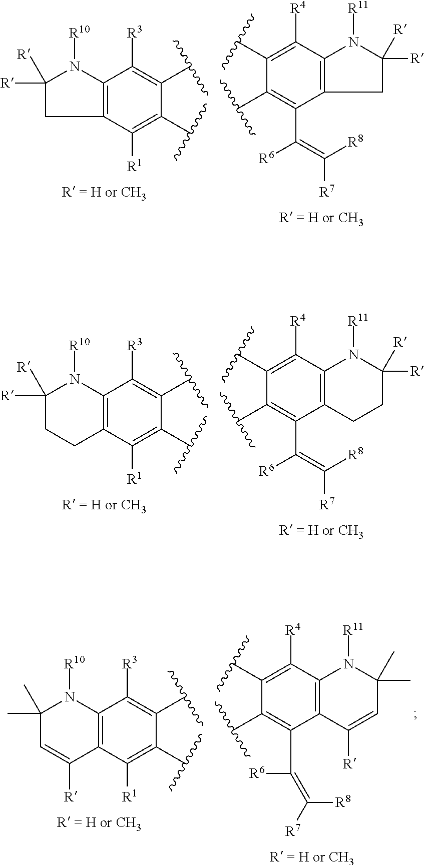

or
e. R⁹ and/or R¹² are independently selected from H, unsubstituted and alkyl-substituted (particularly methyl-substituted), amino-, hydroxy-, carboxy-, sulfonate- and/or fluoro-substituted C₁-C₆ alkyl, C₁-C₄ acyl, C₁-C₄ alkoxycarbonyl (including tert-butyloxycarbonyl or Boc group) and C₃-C₆ cycloalkyl, and R¹⁰ together with R³, and/or R¹¹ together with R⁴, form a fused annular structure according to any one of the following substructures:

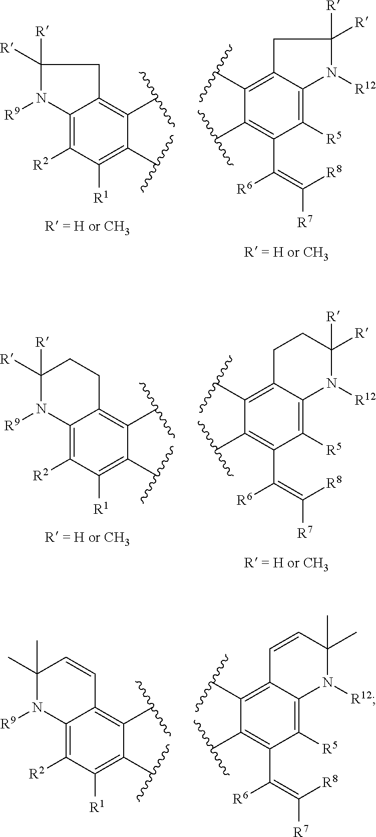

or
f. R⁹ together with R², and R¹⁰ together with R³, and/or R¹² together with R⁵, and R¹¹ together with R⁴, form a fused biannular structure according to any one of the following substructures:

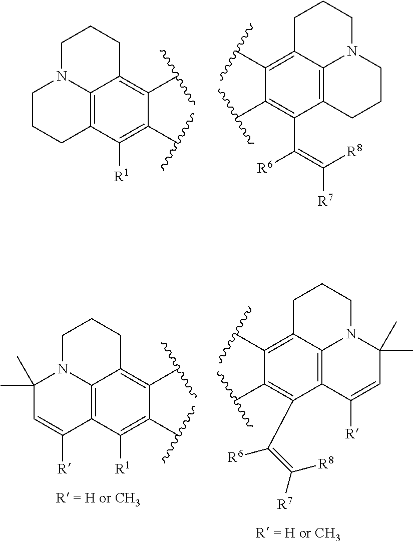

In another specific embodiment, the compound of the present invention, in particular a photoactivatable fluorescent dye or fluorescent dye, has the general structure I-1-I-30 or II-1-11-30, and R¹ is structurally identical to the substituent —CR⁶═CR⁷R⁸, in particular when the substituents R² and R⁵ are structurally identical, and/or the substituents —NR⁹R¹⁰ and —NR¹¹R¹² are structurally identical, and/or the substituents R³ and R⁴ are structurally identical.

In another more specific embodiment, the compound of the present invention, in particular a photoactivatable fluorescent dye or fluorescent dye, has the general structure I-1-I-30 or II-1-11-30, and:
R¹ is H, and/or
R², R³, R⁴ and R⁵ are independently selected from H, halogen, CN, and/or
R⁹, R¹⁰, R¹¹ and R¹² are individually unsubstituted or amino-, hydroxyl- or halogen-substituted C₁ to C₄ alkyl, or C₃ to C₆ cycloalkyl, or R⁹ together with R¹⁰ together with the N atom to which they are bound, and R¹¹ together with R¹² together with the N atom to which they are bound form an unsubstituted or methyl-, hydroxy-, methoxy-, or halogen-substituted aziridine, azetidine, pyrrolidine, piperidine, piperazine, morpholine, thiomorpholine-S,S-dioxide, and/or
R¹³, R¹⁴, R¹⁵ (if present) are selected from methyl, ethyl, isopropyl or phenyl,
R¹⁶, R¹⁷ (if present) are methyl,
one of the substituents R⁶, R⁷, R⁸ and R²⁰, R²¹ (if present) is selected from a) unsubstituted or amino-, hydroxyl-, carboxyl- and/or halogen-substituted C₂ to C₁₂ alkyl or C₃ to C₇ cycloalkyl; or b) -L^{A1}ₘ-L^{J1}_{m′}-L^{A2}ₙ-L^{J2}_{n′}-L^{A3}ₚ-L^{J3}_{p′}-L^{A4}_{q}-L^{J4}_{q′}-Mₛ, wherein L^{A1}, L^{A2}, L^{A3}, L^{A4}, L^{J1}, L^{J2}, L^{J3}, L^{J4} m, m′, n, n′, p, p′, q, q′, s and Mₛ have the definitions recited above, and
the other substituents R⁶, R⁷, R⁸ and R²⁰, R²¹ (if present) are selected from H or methyl.

In another more specific embodiment, the compound of the present invention, in particular a photoactivatable fluorescent dye or fluorescent dye, has the general structure I-1-I-30 or II-1-II-30, and the substituents —NR⁹R¹⁰ and/or —NR¹¹R¹² are independently represented by one of the following structures:

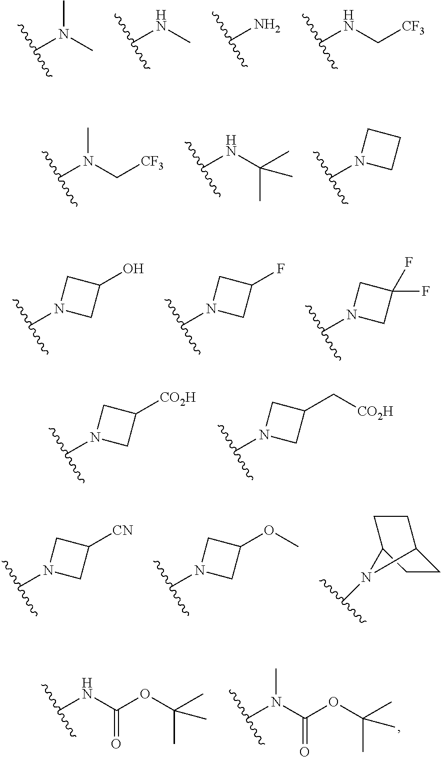

particularly when the substituents —NR⁹R¹⁰ and —NR¹¹R¹² are structurally identical.

In another more specific embodiment, the compound of the present invention, in particular a photoactivatable fluorescent dye or fluorescent dye, has the general structure I-1-I-30 or II-1-II-30, and the fragment —CR⁶═CR⁷R⁸ is represented by one of the following structures:

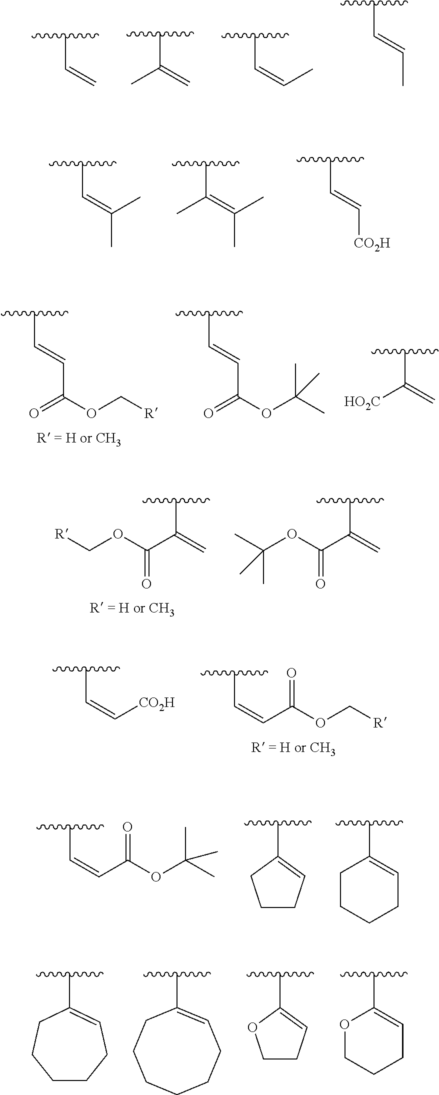

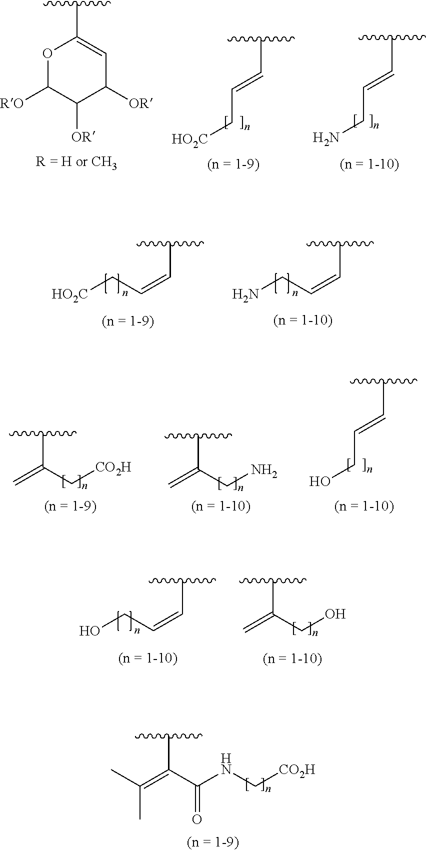

In another more specific embodiment, the compound of the present invention, in particular a photoactivatable fluorescent dye or fluorescent dye, has the general structure I-1-I-30 or II-1-II-30, and the group —Y—W—R¹³ is represented by one of the following structures:

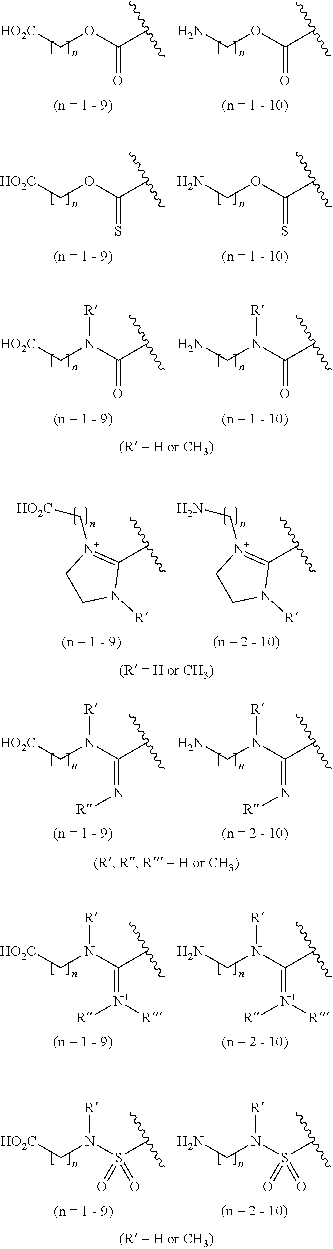

In another more specific embodiment, the compound of the present invention, in particular a photoactivatable fluorescent dye or fluorescent dye, has the general structure I-1-I-30 or II-1-II-30, and the group —X— is represented by one of the following structures:

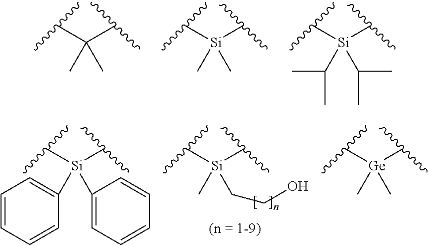

In another more specific embodiment, the compound of the present invention, in particular a photoactivatable fluorescent dye or fluorescent dye, having the general structure I-1-I-30 or II-1-II-30, is represented by one of the following structures:

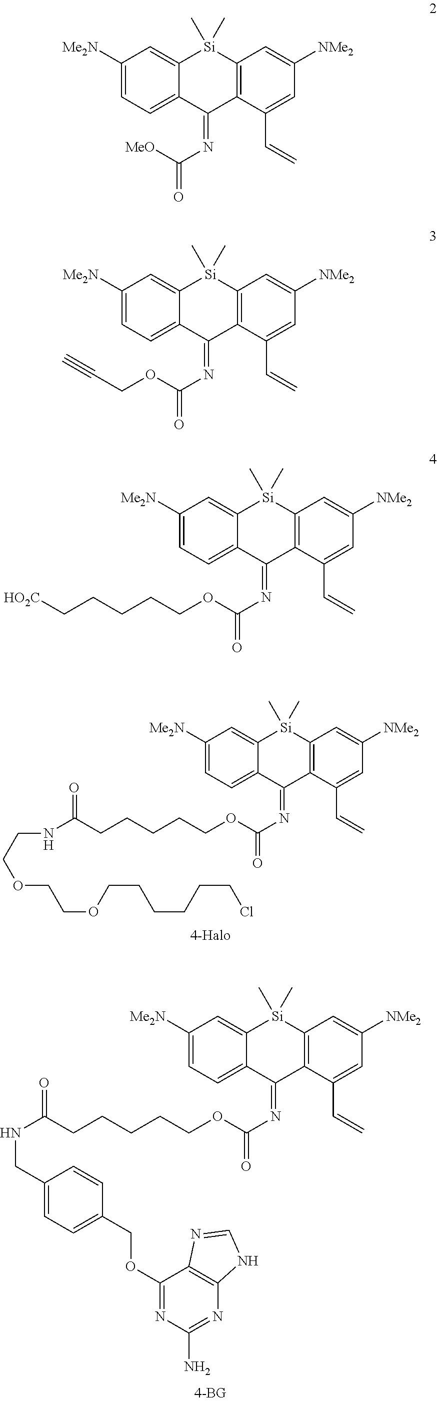 [SMILES: C=Cc1cc(N(C)C)cc2c1/C(=N/C(=O)OC)c1ccc(N(C)C)cc1[Si]2(C)C ; C#CCOC(=O)/N=C1\c2ccc(N(C)C)cc2[Si](C)(C)c2cc(N(C)C)cc(C=C)c21 ; C=Cc1cc(N(C)C)cc2c1/C(=N/C(=O)OCCCCCC(=O)O)c1ccc(N(C)C)cc1[Si]2(C)C ; C=Cc1cc(N(C)C)cc2c1/C(=N/C(=O)OCCCCCC(=O)NCCOCCOCCCCCCCl)c1ccc(N(C)C)cc1[Si]2(C)C ; C=Cc1cc(N(C)C)cc2c1/C(=N/C(=O)OCCCCCC(=O)NCc1ccc(COc3nc(N)nc4[nH]cnc34)cc1)c1ccc(N(C)C)cc1[Si]2(C)C]

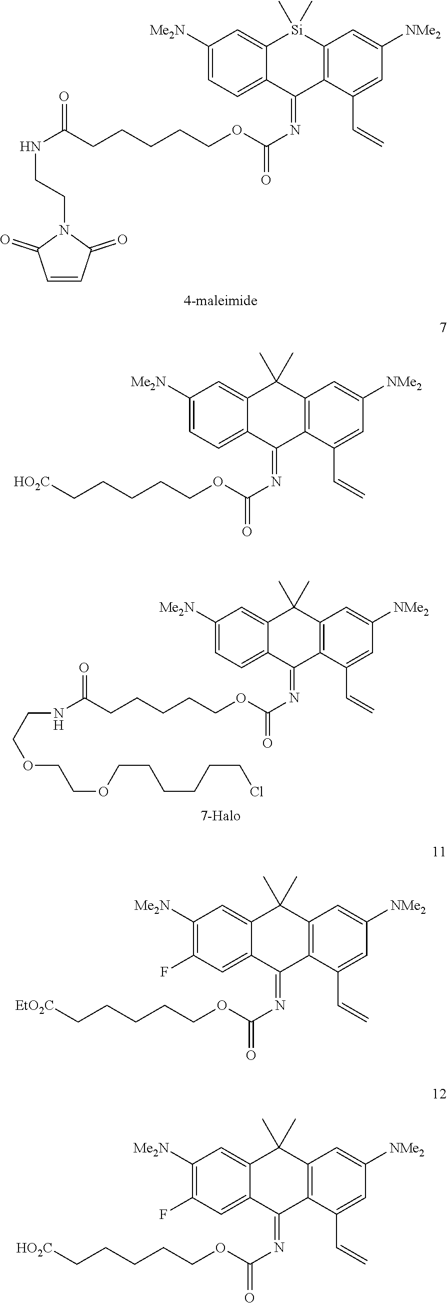 [SMILES: C=Cc1cc(N(C)C)cc2c1/C(=N/C(=O)OCCCCCC(=O)NCCN1C(=O)C=CC1=O)c1ccc(N(C)C)cc1[Si]2(C)C ; C=Cc1cc(N(C)C)cc2c1/C(=N/C(=O)OCCCCCC(=O)O)c1ccc(N(C)C)cc1C2(C)C ; C=Cc1cc(N(C)C)cc2c1/C(=N/C(=O)OCCCCCC(=O)NCCOCCOCCCCCCCl)c1ccc(N(C)C)cc1C2(C)C ; C=Cc1cc(N(C)C)cc2c1/C(=N/C(=O)OCCCCCC(=O)OCC)c1cc(F)c(N(C)C)cc1C2(C)C ; C=Cc1cc(N(C)C)cc2c1/C(=N/C(=O)OCCCCCC(=O)O)c1cc(F)c(N(C)C)cc1C2(C)C]

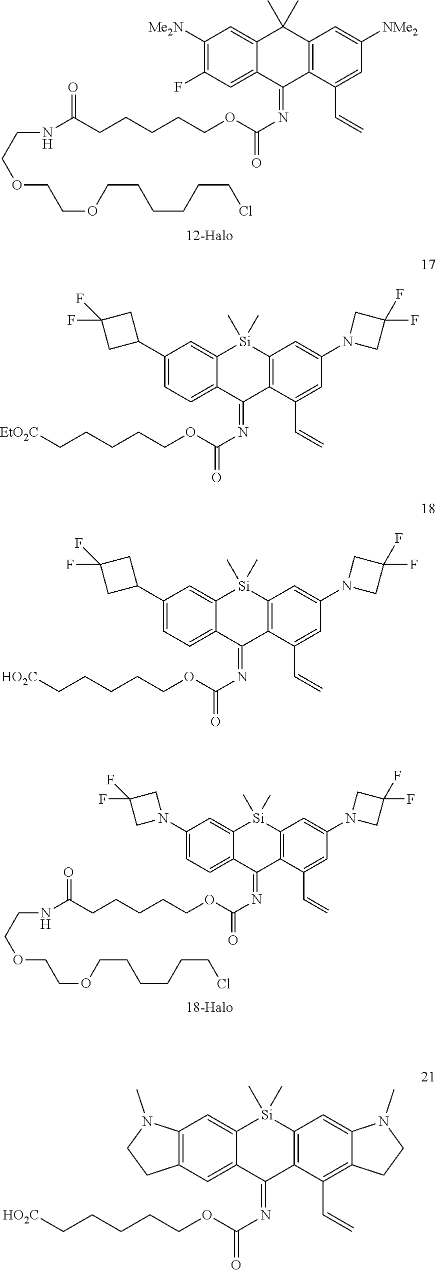 [SMILES: C=Cc1cc(N(C)C)cc2c1/C(=N/C(=O)OCCCCCC(=O)NCCOCCOCCCCCCCl)c1cc(F)c(N(C)C)cc1C2(C)C ; C=Cc1cc(N2CC(F)(F)C2)cc2c1/C(=N/C(=O)OCCCCCC(=O)OCC)c1ccc(C3CC(F)(F)C3)cc1[Si]2(C)C ; C=Cc1cc(N2CC(F)(F)C2)cc2c1/C(=N/C(=O)OCCCCCC(=O)O)c1ccc(C3CC(F)(F)C3)cc1[Si]2(C)C ; C=Cc1cc(N2CC(F)(F)C2)cc2c1/C(=N/C(=O)OCCCCCC(=O)NCCOCCOCCCCCCCl)c1ccc(N3CC(F)(F)C3)cc1[Si]2(C)C ; C=Cc1c2c(cc3c1/C(=N/C(=O)OCCCCCC(=O)O)c1cc4c(cc1[Si]3(C)C)N(C)CC4)N(C)CC2]

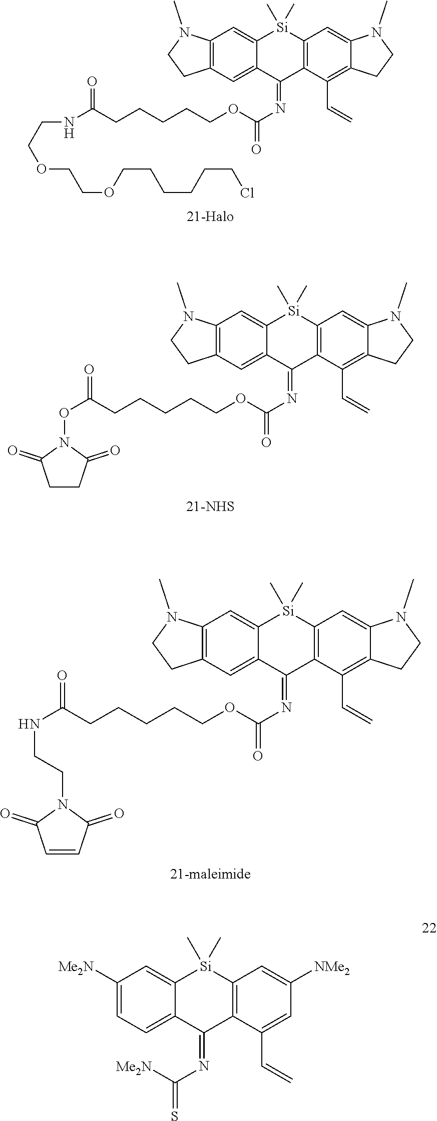 [SMILES: C=Cc1c2c(cc3c1/C(=N/C(=O)OCCCCCC(=O)NCCOCCOCCCCCCCl)c1cc4c(cc1[Si]3(C)C)N(C)CC4)N(C)CC2 ; C=Cc1c2c(cc3c1/C(=N/C(=O)OCCCCCC(=O)ON1C(=O)CCC1=O)c1cc4c(cc1[Si]3(C)C)N(C)CC4)N(C)CC2 ; C=Cc1c2c(cc3c1/C(=N/C(=O)OCCCCCC(=O)NCCN1C(=O)C=CC1=O)c1cc4c(cc1[Si]3(C)C)N(C)CC4)N(C)CC2 ; C=Cc1cc(N(C)C)cc2c1/C(=N/C(=S)N(C)C)c1ccc(N(C)C)cc1[Si]2(C)C]

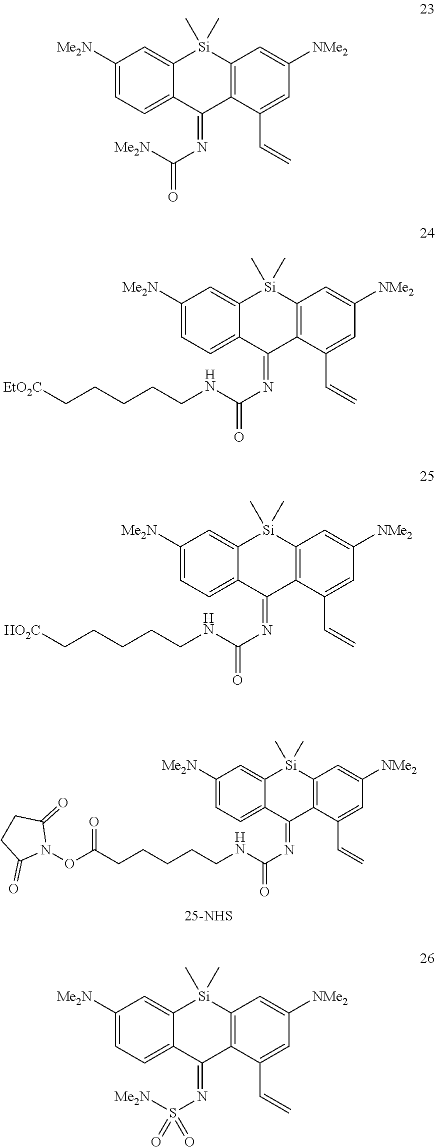 [SMILES: C=Cc1cc(N(C)C)cc2c1/C(=N/C(=O)N(C)C)c1ccc(N(C)C)cc1[Si]2(C)C ; C=Cc1cc(N(C)C)cc2c1/C(=N/C(=O)NCCCCCC(=O)OCC)c1ccc(N(C)C)cc1[Si]2(C)C ; C=Cc1cc(N(C)C)cc2c1/C(=N/C(=O)NCCCCCC(=O)O)c1ccc(N(C)C)cc1[Si]2(C)C ; C=Cc1cc(N(C)C)cc2c1/C(=N/C(=O)NCCCCCC(=O)ON1C(=O)CCC1=O)c1ccc(N(C)C)cc1[Si]2(C)C ; C=Cc1cc(N(C)C)cc2c1/C(=N/S(=O)(=O)N(C)C)c1ccc(N(C)C)cc1[Si]2(C)C]

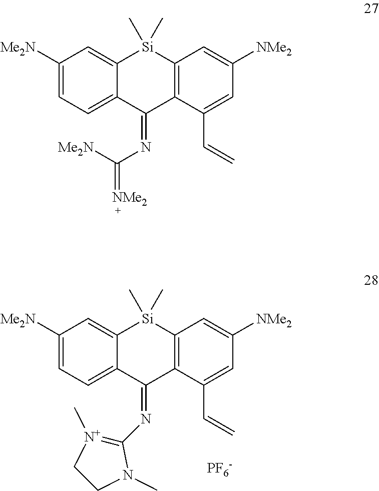

### General Characteristics of the Novel Compounds (Photoactivatable Fluorescent Dyes) of the Invention

The photoactivatable fluorescent dyes of the present invention are intended to be used in particular as photoactivatable fluorescent labels in super-resolution fluorescence microscopy methods in the context of fixed or living cells and extracellular matrix. General descriptions of various super-resolution imaging methods are presented in [Godin et al. Biophys J. 2014, 107, 1777-1784] and [Sahl, S. J.; Hell, S. W. High-Resolution 3D Light Microscopy with STED and RESOLFT. In: High Resolution Imaging in Microscopy and Ophthalmology: New Frontiers in Biomedical Optics; Bille, J. F., Ed.; Springer International Publishing, 2019; pp 3-32; DOI: 10.1007/978-3-030-16638-0_1], and representative applications of super-resolution microscopy in cell biology are presented in [Sahl et al. Nat. Rev. Mol. Cell Biol. 2017, 18, 685-701].

The requirements imposed by these methods and met by the photoactivatable fluorescent dyes of the present invention are as follows:
1) Intact cell membrane permeability for both the inactivated non-fluorescent form (corresponding to the general structure I) and the activated (fluorescent) form (corresponding to the general structure II) of the fluorescent label;
2) Reliable photoactivation kinetics of the compounds (photoactivatable fluorescent dyes) of general structure I, with relatively high photoactivation quantum yield which can be further tuned by variation of the substituents R¹, R², R³, R⁴, R⁵, X, Y, W and in particular R⁶, R⁷, R⁸, R⁹, R¹⁰, R¹¹ and R¹²;
3) Good solubility in aqueous media and low propensity of the labels and labeled antibodies, derived from the compounds of the general structures I and II, to aggregation and off-targeting in live and fixed cells or organisms; chemical stability of labeled antibodies, including single-domain antibodies;
4) Photostability of the photoactivated fluorescent dyes of the general structure II against ultraviolet (UV, >300 nm), visible and infrared (IR) light, which allows to achieve a high photon budget (emitted photon count per molecule before photobleaching), sufficient for any fluorescence microscopy technique, including superresolution techniques;
5) The mechanism of photoactivation of the dyes of the general structure I ensures a single well defined photochemical activation pathway and thus minimizes the possibility of formation of dark non-fluorescent side products (as in the case of diazoketone-caged rhodamines and rhodamine analogues) and the release of reactive or toxic byproducts arising from the cage groups (as in the case of various 2-nitrobenzyl- or 2-nitrobenzyloxycarbonyl-caged fluorescent dyes);
6) Compact structure and low molecular weight for many typical compounds of the general structure I ((MW<500 Da; see Examples below) and low number of functional groups, thus generally conforming to Lipinski's rule of five (≤5 hydrogen bond donors, ≤10 hydrogen bond acceptors, n-octanol/water partition coefficient log P≤5.6 [A. K. Ghose et al. J. Comb. Chem. 1999, 1(1), 55-68]).
7) Low chemical reactivity of the photoactivated (fluorescent) dyes, corresponding to the general structure II, ensuring the stability of the labels inside the living cells in the natural presence of oxidizing (molecular oxygen) and nucleophilic species (functional proteins and reduced glutathione), and in diverse imaging media compositions for fixed-cell imaging;
8) High chemical stability across a broad pH range of compounds of the general structures I and II; in addition, a reliable photoactivation mechanism operating across the biologically relevant pH range and in diverse solvents and media, such as in aqueous solvents, alcohols, and polymer films.

### Applications

As follows from the above-mentioned characteristics, the compounds (photoactivatable dyes or photoactivated dyes) of the present invention are suitable for various applications, in particular in the field of optical microscopy and bioimaging techniques.

The most basic aspect of the present invention relates to the use of a novel compound as defined above or of a conjugate or derivative comprising the same as photoactivatable fluorescent dyes.

In a more specific embodiment, these compounds, derivatives or conjugates may be used for staining a biological sample, in particular whole organisms, tissues, mammalian and non-mammalian cells including insect, plant, fungi, bacteria cells and viral particles.

In a more specific embodiment, these compounds, derivatives or conjugates may be used for tracking and monitoring dynamic processes in a sample or in an object or tracking and monitoring the behavior of single molecules within a sample or an object.

In another specific embodiment, these compounds, derivatives or conjugates may be used as components in inorganic, bio-inorganic, organic or macromolecular composites as materials for optical memories, data storage, photo-lithography, photo-activatable paints and inks.

In another specific embodiment, these compounds, derivatives or conjugates may be used as fluorescent tags, analytical reagents and labels in optical microscopy, imaging techniques, protein tracking, nucleic acid labeling, glycan analysis, flow cytometry or as a component of biosensors, or as analytical tools or reporters in microfluidic devices or nanofluidic circuitry.

In another more specific embodiment, these compounds, derivatives or conjugates as such or after photoactivation may be used as energy donors or acceptors (reporters) in applications based on fluorescence energy transfer (FRET) process or as energy acceptors (reporters) in applications based on bioluminescence resonance energy transfer (BRET) process.

In another specific embodiment, the optical microscopy and imaging methods may comprise stimulated emission depletion microscopy [STED] or any of its improved versions with reduced phototoxicity (e.g, FastRESCue STED), when additional color multiplexing is achieved by combining the compounds, derivatives or conjugates of the present invention together with any other STED-compatible fluorescent dyes, photoactivatable or not, in a single sample under study.

In another specific embodiment, the optical microscopy and imaging methods may comprise single molecule switching techniques (SMS: diffraction unlimited optical resolution achieved by recording the fluorescence signals of single molecules, reversibly or irreversibly switched between emitting and non-emitting states, such as single molecule localization microscopy [SMLM], photoactivation localization microscopy [PALM, PALMIRA, fPALM], stochastic optical reconstruction microscopy [STORM], minimal photon fluxes [MINFLUX] or their parallelized implementations, fluorescence correlation spectroscopy [FCS], fluorescence recovery after photobleaching [FRAP] and its derivations (such as iFRAP, FLIP, FLAP), and fluorescence lifetime imaging [FLIM].

In another specific embodiment, additional color multiplexing may be achieved by these compounds, derivatives or conjugates as such or after photoactivation together with any other fluorescent dyes in a single sample or object under study.

In another specific embodiment, the activation of spatiotemporal subpopulations of photoactivatable dyes of the present invention allows imaging with the photoactivated fluorophore molecules while protecting the remaining photoactivatable dyes from photobleaching.

The presently-disclosed subject matter further includes a method of using the compounds described herein. In some embodiments, the method comprises utilizing the photoactivated fluorescent labels of the present invention as a reporter for enzyme activity, as a fluorescent tag, as a photosensitizer, as a pH indicator, as a redox indicator, as an intracellular environment polarity indicator, as an optical sensor of transmembrane potential, as a sensor for a target substance (an analyte), as an agent for imaging experiments, and/or as an imaging agent for super-resolution microscopy.

The presently-disclosed method for detecting a target substance can further comprise a detecting step that includes detecting an emission light from the compound, the emission light indicating the presence of the target substance, or a ratiometric detection step which comprises detecting an emission light before and after photoactivating the dyes of the present invention within the sample.

In some embodiments the method for using the compounds comprises photoactivating a compound of the present invention by exposing the sample to a UV or blue light. As described herein, the photoactivating light source can produce an excitation wavelength from ultraviolet light to blue light in the visible range. In specific embodiments the excitation wavelength can be in a range of 200 nm to about 500 nm, or preferably in a range of about 350 nm to about 450 nm.

In some embodiments the method for using the compounds comprises photoactivating a compound of the present invention by exposing the sample to an orange, red or infrared (IR) light making use of multiphoton excitation conditions, either with a continuous wave or pulsed source. As described herein, the photoactivating light source can be an orange, red or IR laser of sufficiently high power. In specific embodiments the excitation wavelength can be in a range of 500 nm to about 1500 nm, or preferably in a range of about 700 nm to about 1100 nm.

In some embodiments the method for using the compounds further comprises exposing the photoactivated compound to an excitation light. As described herein, the excitation light can include any wavelength matching the absorption of the compound, from ultraviolet light to near infrared light, by either a one-photon or multi-photon process. In specific embodiments the absorption wavelength can be in a range of 200 nm to about 1200 nm, or preferably in a range of about 400 nm to about 820 nm.

In some embodiments the detecting step is performed by use of fluorescence spectroscopy or by the naked eye. In some embodiments the detecting step is performed with a microscope. In some embodiments the detecting step is performed with a fluorimeter or a microplate reader, or within a flow cell. In some embodiments the presence of a target substance can indicate the occurrence or absence of a particular biological function, as will be appreciated by those skilled in the art. In some embodiments the method is performed in a live cell, a tissue and/or a subject.

Some embodiments of detection methods comprise contacting the sample with two or more embodiments of compounds that are selective for different target substances. Methods for detecting two or more target substances with two or more of the presently-disclosed compounds are referred to herein as “multiplex” detection methods.

In some of the present multiplex methods, two or more distinct target structures or substances and/or two or more regions of one target structure or substance are detected using two or more probes, wherein each of the probes is labeled with a different embodiment of the present compounds. The presently-disclosed compounds can be used in multiplex detection methods for a variety of target substances, whereby the first compound can be selective for a first target substance, is excited with a first absorption wavelength and can be emitting a first emission light, and the second compound can be selective for a second target substance, is excited with a second absorption wavelength and can be emitting a second emission light, while both compounds are sharing the same photoactivation conditions (multiplexing by excitation or emission wavelengths). In other embodiments of the multiplex methods, the photoactivatable compounds of the present studies are employed together where the first compound is photoactivated with an activation wavelength and a minimum intensity of light that does not photoactivate the second compound. The second compound is photoactivated with either a second activation wavelength of light suitable for photoactivation (multiplexing by photoactivation wavelength) or a greater light intensity with the first activation wavelength (multiplexing by photoactivation kinetics). In other embodiments of the multiplex methods, the photoactivatable compounds of the present studies are employed together with the common fluorophores that do not require a photoactivating step to be used in fluorescence detection methods (multiplexing by photoactivation). In some embodiments the emission wavelengths of the first and second compounds are different from one another, and in other embodiments the excitation (absorption) wavelengths of the first and second compounds are different from one another (multiplexing by Stokes shift), providing an efficient means for detecting a plurality of different target substances in one setting.

As a non-limiting illustrative example, imaging in samples can be performed in cells transiently or endogenously expressing protein fusions with self-labeling enzymes (for example SNAP-tag or HaloTag proteins) labelled with the photoactivatable dyes of the present invention (e.g., 4-BG or 4-Halo) excitable with yellow, orange, or red light (e.g., 640 nm) upon photoactivation and emitting in one spectral detection channel (e.g., 660-710 nm). Another caging-group-free photoactivatable dye (such as PaX₅₆₀ [R. Lincoln et al. Nat. Chem. 2022, 14, 1013-1020; R. Lincoln et al. WO2023/284968A1]) that is excitable with blue or green light (e.g., 560 nm) and emitting in a different spectral detection channel (e.g., 570-620 nm) would be used for a different target structure. The two photoactivatable dyes can then be imaged in parallel or sequentially in PALM mode using appropriate laser for photoactivation (e.g., 560 nm for 4-Halo and 405 nm for PaX₅₆₀) and their respective excitation lasers and detection channels. This imaging routine allows the parallel or sequential two-color PALM imaging of two structures of interest on a commercial SMLM microscope (e.g. ONI Nanoimager, ONI Inc., San Diego, CA, USA; see FIG. 5).

As another non-limiting illustrative example, imaging in samples can be performed with one or more than one pair of primary and mutually orthogonal secondary nanobodies, labelled with photoactivatable dyes of the present invention (e.g., 4-Maleimide and 21-Maleimide), each of which is excitable with the same wavelength but emits in a different spectral detection channel. This imaging routine allows multiple photoactivatable dyes of the present invention to be used in combination for dual-color imaging based on spectral seperation on a commercial beam-scanning microscope (e.g. abberior MINFLUX, abberior Instruments GmbH, Göttingen, Germany), but can be adapted to suit any microscope equipped for spectral seperation or a custom-built nanoscopy setup (see FIG. 6).

### General Approach for Synthesizing the Novel Compounds, in Particular Photoactivatable Fluorescent Dyes, of the Invention

For the preparation of the novel compounds, the present inventors have identified the following synthetic sequences leading to the example compounds Ia-g of the present invention and starting (as in following illustrative and non-limiting examples) from the advanced intermediates of type A1-A5, described previously in the literature (A1 and A2: [R. Lincoln et al. Nat. Chem. 2022, 14, 1013-1020]; A3: [A. N. Butkevich et al. Angew. Chem. Int. Ed., 2016, 55(10), 3290-3294]; A4: [S. Shen et al. RSC Adv., 2017, 7(18), 10922-10927]; A5: [M. Remmel et al. Small Methods 2024, 2301497].

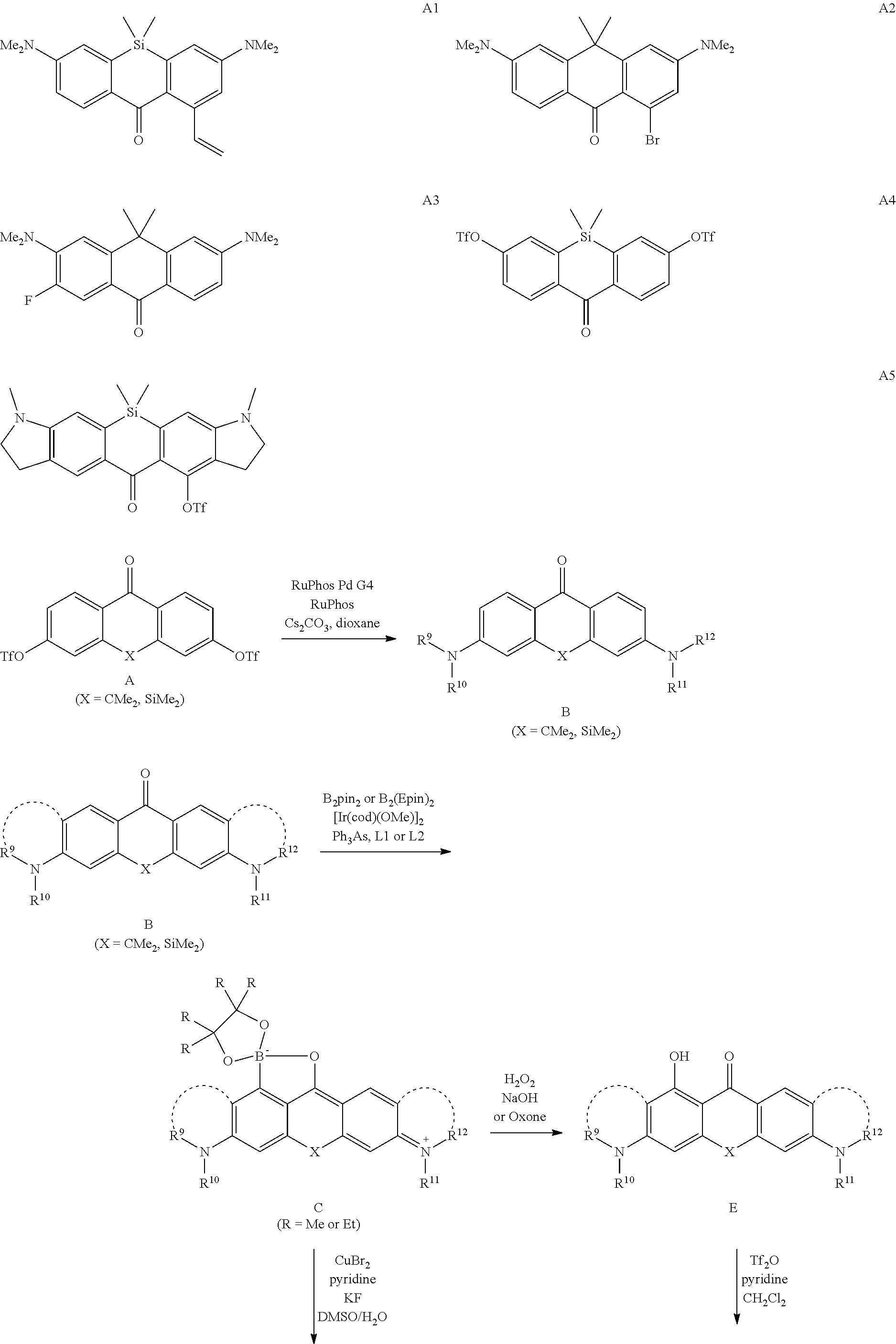

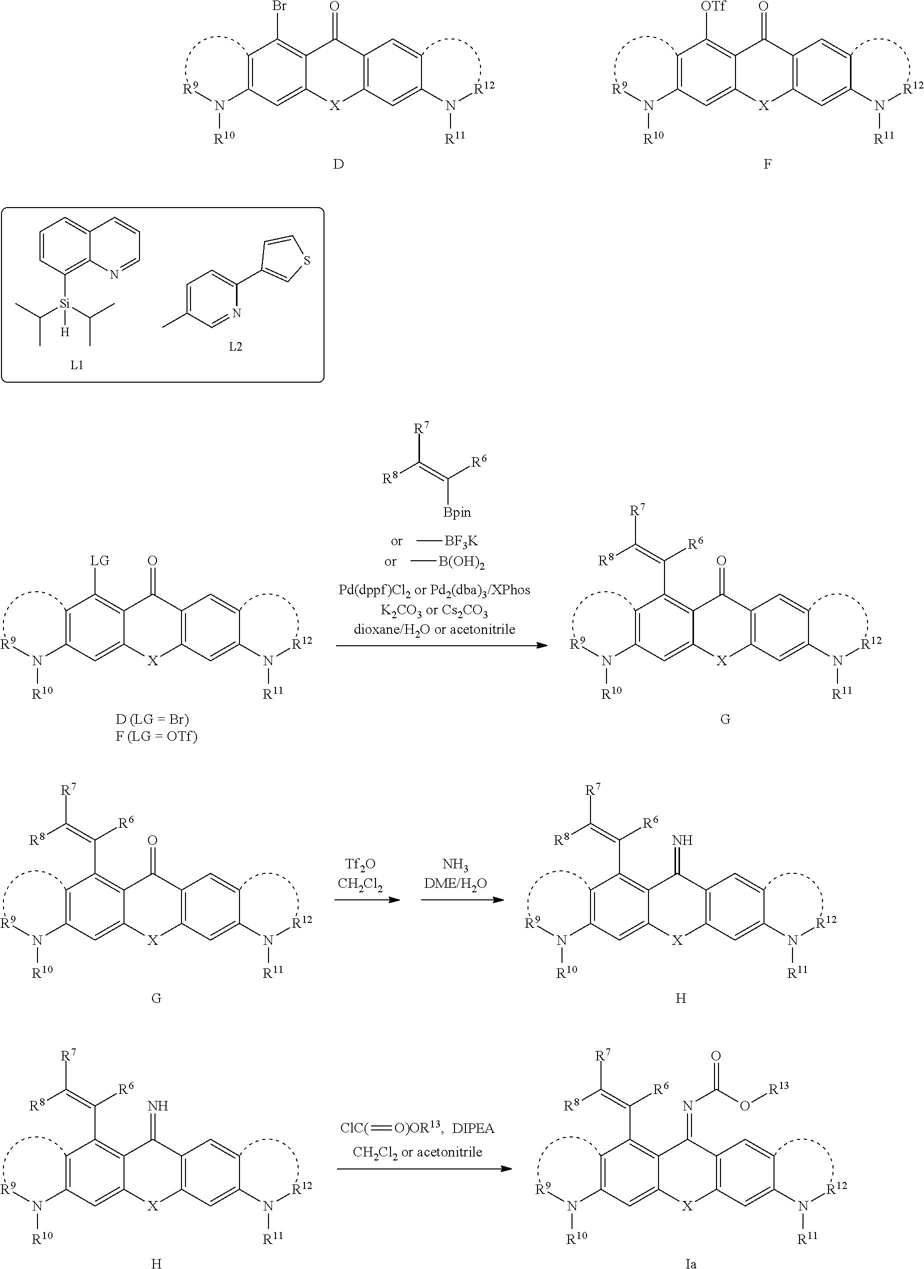

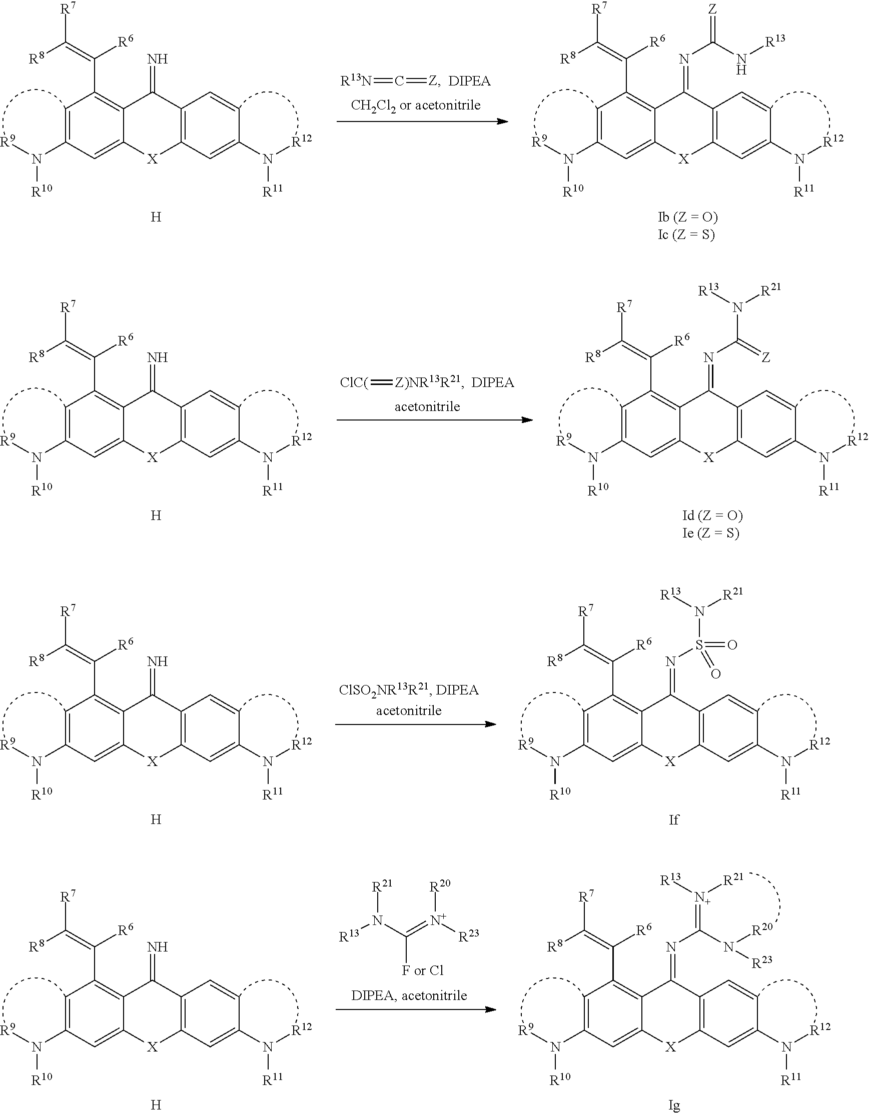

However, any suitable synthetic method can be used to synthesize compounds according to the present invention, with variations including the choice of reagents and catalysts, reaction conditions and the order of synthetic steps.

### BRIEF DESCRIPTION OF THE FIGURES

FIG. 1 shows absorption (A) and emission (B) changes during photo-induced activation of compound 4 with ultra-violet light (365 nm) in an aqueous buffered solution at pH 7 (phosphate buffer, 100 mM) and the change in absorption at the maximum (C); HPLC 2D-maps of absorption spectra vs. retention time for samples of the solution before (D) and after the photo-induced activation with 365 nm (E) or 405 nm (F) light; and chromatograms (G) of these samples at the wavelengths corresponding to the respective absorption maxima.

FIG. 2 shows photo-fatigue resistance of compound 4 and established commercial fluorophores to excitation light (640 nm) in an aqueous buffered solution at pH 7 (phosphate buffer, 100 mM). The measurement was performed as previously described in [R. Lincoln et al. Nat. Chem. 2022, 14, 1013-1020; R. Lincoln et al. WO2023/284968A1].

FIG. 3 shows live-cell confocal image of vimentin filaments labelled with compound 4-Halo in U2OS cells before (A) and after (B) photoactivation by irradiation with a 405 nm laser and the corresponding change in fluorescence intensity of the field of view upon photoactivation (C).

FIG. 4 shows single molecule localization microscopy super-resolution image of fixed U-2 OS cells stably expressing a vimentin-HaloTag construct labelled with 4-Halo.

FIG. 5 shows sequential two-color single molecule localization microscopy super-resolution image of fixed HeLa cells stably expressing a COX8A-SNAP-tag construct labelled with 4-BG (A) and co-labelled via indirect immunofluorescence with an anti-TOMM20 primary antibody and a secondary nanobody labelled with PaX₅₆₀-Maleimide (B).

FIG. 6 shows dual-color MINFLUX imaging based on spectral seperation. A) Normalized histograms of the detector channel ratio (DCR) value of all localizations after spectral classification (circles/crosses). B) Dual color MINFLUX image of mitochondria in fixed U-2 OS cells labeled by indirect immunofluorescence with a primary antibody against TOMM20 (circles) in combination with a secondary nanobody conjugated with 4-maleimide, and with a primary antibody against TIMM23 (crosses) in combination with a secondary nanobody conjugated with 21-maleimide.

The present invention is further illustrated by the following specific but non-limiting examples.

### EXAMPLE 1

### Synthesis of the Starting Materials, Photoactivatable Compounds and Photoactivatable Labels

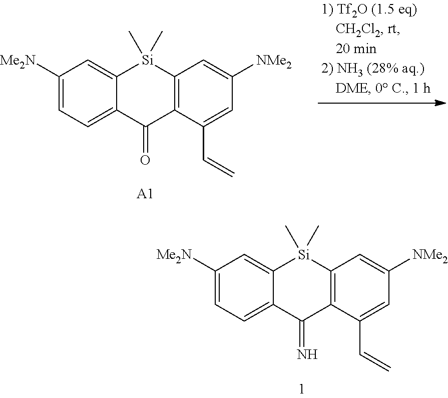

Compound 1. A solution of trifluoromethanesulfonic anhydride (Tf₂O, 1 M in CH₂Cl₂; 0.68 mL, ˜0.68 mmol, 1.5 equiv.) was added to the stirred solution of A1 (known compound: R. Lincoln et al. Nat. Chem. 2022, 14, 1013-1020) (160 mg, 0.46 mmol) in dry CH₂Cl₂ (7 mL) under argon, and the resulting dark blue solution was stirred at rt for 20 min. It was then transferred dropwise into the stirred mixture of aqueous ammonia (28% aq., 3.5 mL) and 1,2-dimethoxyethane (DME, 6 mL), cooled in ice-water bath. The reaction mixture was stirred at 0° C. for 1 h, diluted with brine (30 mL), the product was then extracted with CH₂Cl₂ (3×20 mL) and the combined extracts were dried over Na₂SO₄. The product was isolated by flash column chromatography (25 g Interchim SiHP 30 μm cartridge, gradient 0% to 100% A/B, A=CH₂Cl₂— ethanol-25% aq. NH₃ 80:20:2, B═CH₂Cl₂) and freeze-dried from 1,4-dioxane to yield 117 mg (73%) of 1 as brown-orange solid.

¹H NMR (400 MHz, CDCl₃): δ 7.94 (dd, J=8.2, 1.0 Hz, 1H), 7.05 (dd, J=17.3, 10.8 Hz, 1H), 6.87-6.79 (m, 4H), 5.70 (dd, J=17.3, 1.5 Hz, 1H), 5.32 (dd, J=10.8, 1.5 Hz, 1H), 3.05 (s, 6H), 3.02 (s, 6H), 0.45 (s, 6H).

¹³C NMR (101 MHz, CDCl₃): δ 173.1, 150.5, 149.9, 138.5, 138.2, 137.8, 136.5, 134.3, 131.7, 128.1, 115.5, 115.4, 114.7, 113.9, 112.9, 40.5, 40.4, −1.8.

HRMS (ESI) m/z: [M+H]⁺ Calcd for C₂₁H₂₇N₃Si 350.2047; Found 350.2042.

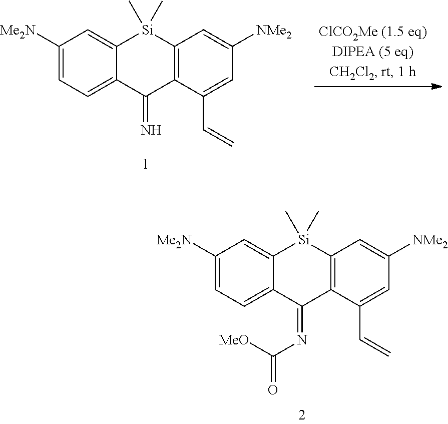 [SMILES: C=Cc1cc(N(C)C)cc2c1C(=N)c1ccc(N(C)C)cc1[Si]2(C)C ; C=Cc1cc(N(C)C)cc2c1/C(=N/C(=O)OC)c1ccc(N(C)C)cc1[Si]2(C)C]

Compound 2. Methyl chloroformate (12 μL, 0.15 mmol, 1.5 equiv) was added to the stirred solution of compound 1 (35 mg, 0.10 mmol) and N,N-diisopropylethylamine (DIPEA; 87 μL, 0.50 mmol, 5 equiv) in dry CH₂Cl₂ (1 mL), and the resulting solution was stirred at rt for 1 h. The mixture was evaporated on Celite, and the product was isolated by flash column chromatography (12 g Interchim SiHP 30 μm cartridge, gradient 5% to 60% EtOAc/hexane) and freeze-dried from 1,4-dioxane to yield 29 mg (71%) of 2 as bright yellow solid.

¹H NMR (400 MHz, CDCl₃): δ 7.67 (d, J=8.8 Hz, 1H), 7.33 (dd, J=17.3, 10.8 Hz, 1H), 6.87 (d, J=2.7 Hz, 1H), 6.84 (d, J=2.7 Hz, 1H), 6.83 (d, J=2.7 Hz, 1H), 6.69 (dd, J=8.8, 2.7 Hz, 1H), 5.66 (dd, J=17.3, 1.5 Hz, 1H), 5.26 (dd, J=10.8, 1.5 Hz, 1H), 3.68 (s, 3H), 3.04 (s, 6H), 3.02 (s, 6H), 0.48 (s, 6H).

¹³C NMR (101 MHz, CDCl₃): δ 169.1, 163.4, 150.4, 150.2, 138.4, 138.1, 137.9, 137.8, 132.3, 130.4, 128.0, 115.4, 114.9, 114.3, 112.8, 111.6, 53.0, 40.33, 40.25, −2.2.

HRMS (ESI) m/z: [M+H]⁺ Calcd for C₂₃H₂₉N₃O₂Si 408.2102; Found 408.2097.

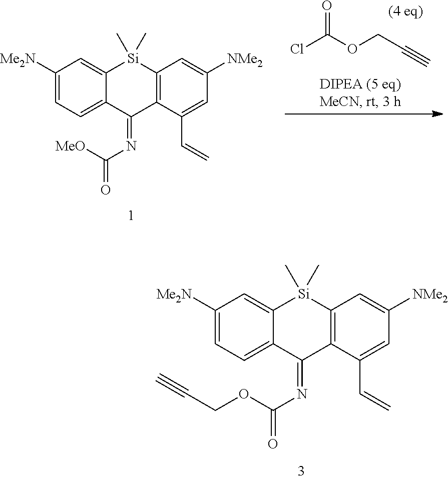

Compound 3. Propargyl chloroformate (28 μL, 0.286 mmol, 4 equiv) was added to the mixture of compound 1 (25 mg, 71.4 μmol) and N,N-diisopropylethylamine (DIPEA; 62 μL, 0.357 mmol, 5 equiv) in dry acetonitrile (0.5 mL), and the resulting solution was stirred at rt for 3 h. The solvents were evaporated, and the product was isolated by preparative HPLC (ThermoFisher Hypersil Gold C18 250×20 mm 5 m, solvent flow rate 18 mL/min, gradient 30% to 90% A:B, A-acetonitrile+0.1% (v/v) HCO₂H, B-water+0.1% (v/v) HCO₂H) and freeze-dried from dioxane to give 9.6 mg (31%) of 3 as brown solid.

¹H NMR (400 MHz, CDCl₃): δ 7.71 (d, J=8.7 Hz, 1H), 7.32 (dd, J=17.3, 10.8 Hz, 1H), 6.87 (d, J=2.7 Hz, 1H), 6.84 (d, J=2.8 Hz, 1H), 6.83 (d, J=2.7 Hz, 1H), 6.68 (dd, J=8.8, 2.8 Hz, 1H), 5.66 (dd, J=17.3, 1.5 Hz, 1H), 5.28 (dd, J=10.8, 1.5 Hz, 1H), 4.68 (d, J=2.4 Hz, 2H), 3.05 (s, 6H), 3.02 (s, 6H), 2.42 (t, J=2.4 Hz, 1H), 0.48 (s, 6H).

¹³C NMR (101 MHz, CDCl₃): δ 170.2, 161.8, 150.5, 150.3, 138.5, 138.4, 138.0, 137.8, 132.0, 130.1, 128.5, 115.3, 115.0, 114.4, 112.8, 111.6, 78.4, 74.6, 53.3, 40.32, 40.26, −2.2.

HRMS (ESI) m/z: [M+H]⁺ Calcd for C₂₅H₂₉N₃O₂Si: 432.2102, found: 432.2100.

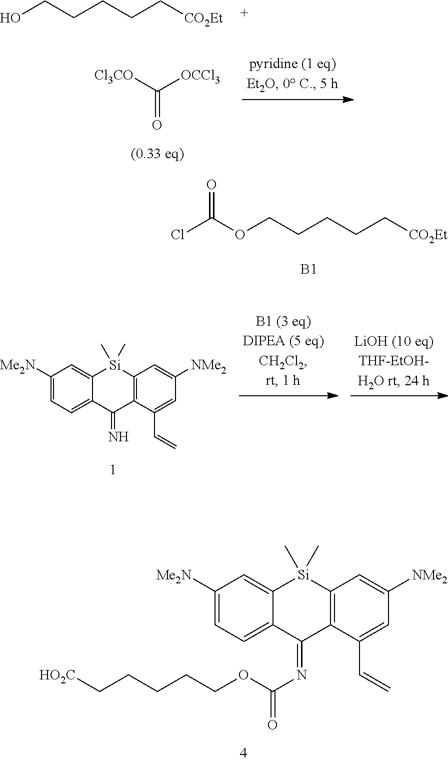

Compound 4. Chloroformate ester B1 was prepared according to the procedure from K. M. Anderson et al. Crystal Growth & Design 2006, 6(9), 2109-2113. Ethyl 6-hydroxyhexanoate (160 mg, 1 mmol) and pyridine (81 μL, 1 mmol, 1 equiv) were added to the stirred solution of triphosgene (99 mg, 0.33 mmol, 0.33 equiv) in dry diethyl ether (2 mL), cooled to 0° C. The reaction mixture was stirred at 0° C. for 5 h, the precipitate of pyridine hydrochloride was filtered off on a short plug of Celite, washed with dry diethyl ether (3 mL), the filtrate was evaporated and the residue was redissolved in dry CH₂Cl₂ (1 mL) and used directly in the next step.

The prepared solution of B1 in CH₂Cl₂ (0.3 mL, ˜0.3 mmol, 3 equiv) was added to the stirred solution of compound 1 (35 mg, 0.1 mmol) and DIPEA (87 μL, 0.5 mmol, 5 equiv) in dry CH₂Cl₂ (0.5 mL), and the resulting solution was stirred at rt for 1 h. The crude reaction mixture was evaporated, the residue was dissolved in the mixture of THF (2 mL) and ethanol (0.5 mL), and lithium hydroxide solution (21 mg of LiOH H₂O in 0.5 mL water, 0.5 mmol, 5 equiv) was added to the mixture, which was left stirring at rt for 24 h (the second portion of LiOH H₂O (21 mg, 0.5 mmol, 5 equiv) was added after 8 h). Acetic acid (100 μL) was then added, and the reaction mixture was evaporated to dryness. The product was isolated by preparative HPLC (ThermoFisher Hypersil Gold C18 250×21.2 mm 5 m, solvent flow rate 18 mL/min, gradient 40% to 100% A:B, A-acetonitrile+0.1% (v/v) HCO₂H, B-water+0.1% (v/v) HCO₂H) and freeze-dried from dioxane to give 47 mg (93% over 2 steps) of 4 as yellow solid.

¹H NMR (400 MHz, CDCl₃): δ 7.69 (d, J=8.7 Hz, 1H), 7.37 (dd, J=17.3, 10.8 Hz, 1H), 6.92 (br.s, 1H), 6.88 (br.s, 2H), 6.72 (br.s, 1H), 5.66 (dd, J=17.3, 1.5 Hz, 1H), 5.29 (dd, J=10.8, 1.5 Hz, 1H), 4.02 (t, J=6.2 Hz, 2H), 3.05 (s, 6H), 3.02 (s, 6H), 2.22 (t, J=7.5 Hz, 2H), 1.57-1.44 (m, 4H), 1.16-1.03 (m, 2H), 0.49 (s, 6H).

¹³C NMR (101 MHz, CDCl₃): δ 178.5, 168.8, 162.8, 150.0, 138.2, 137.9, 137.3, 128.1, 115.2, 112.8, 111.6, 65.4, 40.4, 33.7, 28.3, 25.2, 24.2, −2.5.

HRMS (ESI) m/z: [M+H]⁺ Calcd for C₂₈H₃₇N₃O₄Si: 508.2626, found: 508.2640.

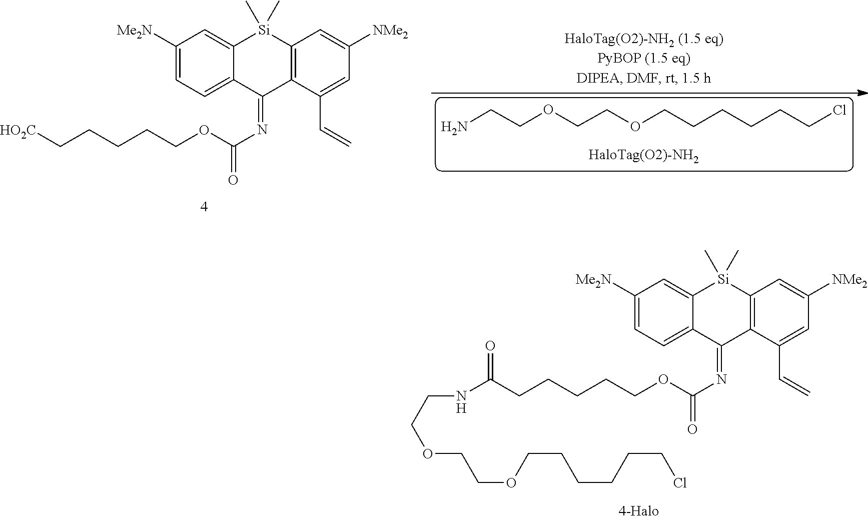 [SMILES: C=Cc1cc(N(C)C)cc2c1/C(=N/C(=O)OCCCCCC(=O)O)c1ccc(N(C)C)cc1[Si]2(C)C ; NCCOCCOCCCCCCCl ; C=Cc1cc(N(C)C)cc2c1/C(=N/C(=O)OCCCCCC(=O)NCCOCCOCCCCCCCl)c1ccc(N(C)C)cc1[Si]2(C)C]

Compound 4-Halo. PyBOP solution (benzotriazol-1-yloxy-tris(pyrrolidino)phosphonium hexafluorophosphate; 15.6 mg in 100 μL DMF, 30.0 μmol, 1.5 equiv) was added to the stirred solution of compound 4 (10 mg, 19.7 μmol) and HaloTag(O2) amine (7.7 mg, 30.0 μmol, 1.5 equiv) in DMF (200 μL) and DIPEA (70 μL), and the reaction mixture was stirred at rt for 1.5 h. The organic solvents were evaporated in vacuo, and the product was isolated by preparative HPLC (ThermoFisher Hypersil Gold C18 250×21.2 mm 5 m, solvent flow rate 18 mL/min, gradient 50% to 100% A:B, A-acetonitrile+0.1% (v/v) HCO₂H, B-water+0.1% (v/v) HCO₂H) to give 11 mg (78%) of 4-Halo as viscous yellow oil.

¹H NMR (400 MHz, CDCl₃): δ 7.66 (d, J=8.8 Hz, 1H), 7.36 (dd, J=17.3, 10.8 Hz, 1H), 6.89 (d, J=2.7 Hz, 1H), 6.84 (d, J=2.7 Hz, 1H), 6.83 (d, J=2.7 Hz, 1H), 6.68 (dd, J=8.8, 2.7 Hz, 1H), 5.97 (t, J=5.6 Hz, 1H), 5.65 (dd, J=17.3, 1.5 Hz, 1H), 5.26 (dd, J=10.8, 1.5 Hz, 1H), 4.02 (t, J=6.4 Hz, 2H), 3.63-3.50 (m, 8H), 3.48-3.41 (m, 4H), 3.04 (s, 6H), 3.01 (s, 6H), 2.11-2.04 (m, 2H), 1.77 (dq, J=8.0, 6.7 Hz, 2H), 1.60 (dq, J=8.0, 6.8 Hz, 2H), 1.56-1.32 (m, 8H), 1.21-1.10 (m, 2H), 0.48 (s, 6H).

¹³C NMR (101 MHz, CDCl₃): δ 173.0, 169.1, 163.0, 150.4, 150.2, 138.2, 137.9, 137.8, 137.6, 132.5, 130.7, 128.1, 115.4, 115.0, 114.3, 112.8, 111.5, 71.4, 70.4, 70.2, 70.1, 65.6, 45.2, 40.4, 40.3, 39.3, 36.7, 32.6, 29.6, 28.6, 26.8, 25.6, 25.54, 25.45, −2.3.

HRMS (ESI) m/z: [M+H]⁺ Calcd for C₃₈H₅₇ClN₄O₅Si: 713.3860, found: 713.3865.

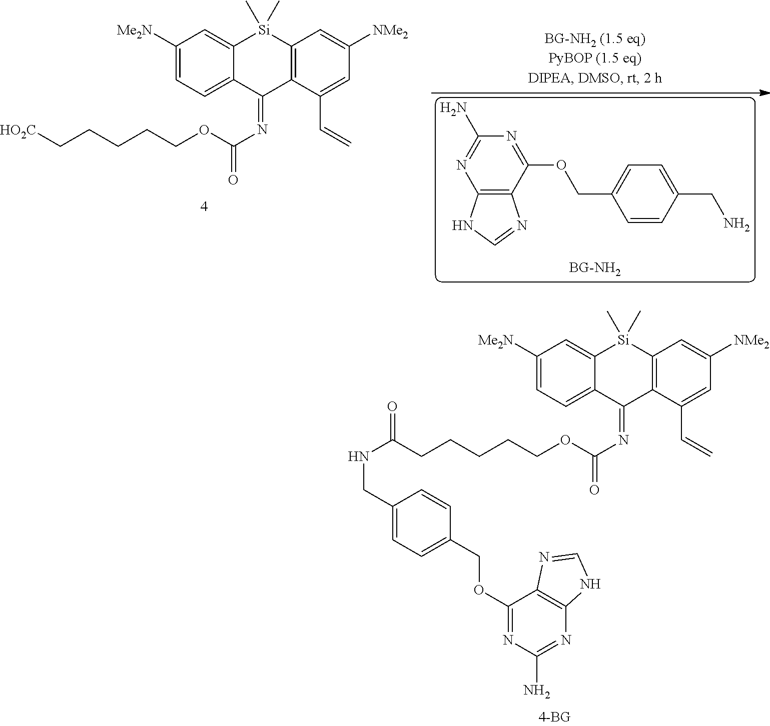 [SMILES: C=Cc1cc(N(C)C)cc2c1/C(=N/C(=O)OCCCCCC(=O)O)c1ccc(N(C)C)cc1[Si]2(C)C ; NCc1ccc(COc2nc(N)nc3[nH]cnc23)cc1 ; C=Cc1cc(N(C)C)cc2c1/C(=N/C(=O)OCCCCCC(=O)NCc1ccc(COc3nc(N)nc4[nH]cnc34)cc1)c1ccc(N(C)C)cc1[Si]2(C)C]

Compound 4-BG. PyBOP solution (benzotriazol-1-yloxy-tris(pyrrolidino)phosphonium hexafluorophosphate; 15.3 mg in 50 μL DMSO, 29.5 μmol, 1.5 equiv) was added to the stirred solution of 4 (10 mg, 19.7 μmol) and BG-NH₂ (8 mg, 29.5 μmol, 1.5 equiv) in DMSO (100 μL) and DIPEA (50 μL), and the reaction mixture was stirred at rt for 2 h. The volatiles were evaporated in vacuo, and the product was isolated by preparative HPLC (ThermoFisher Hypersil Gold C18 250×21.2 mm 5 m, solvent flow rate 18 mL/min, gradient 30% to 90% A:B, A-acetonitrile+0.1% (v/v) HCO₂H, B-water+0.1% (v/v) HCO₂H) to give 14 mg (94%) of 4-BG as greenish-yellow solid.

HRMS (ESI) m/z: [M+2H]²⁺ Calcd for C₄₁H₄₉N₉O₄Si: 380.6911, found: 380.6905.

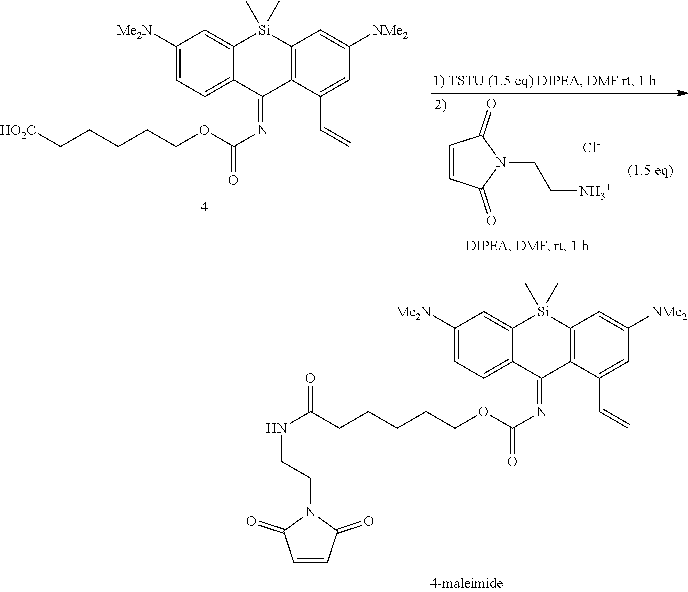 [SMILES: C=Cc1cc(N(C)C)cc2c1/C(=N/C(=O)OCCCCCC(=O)O)c1ccc(N(C)C)cc1[Si]2(C)C ; [NH3+]CCN1C(=O)C=CC1=O ; [Cl-] ; "(1.5 eq)" ; C=Cc1cc(N(C)C)cc2c1/C(=N/C(=O)OCCCCCC(=O)NCCN1C(=O)C=CC1=O)c1ccc(N(C)C)cc1[Si]2(C)C]

Compound 4-maleimide. TSTU solution (N,N,N′,N′-tetramethyl-O—(N-succinimidyl)uronium tetrafluoroborate; 9.0 mg in 50 μL DMF, 30 μmol, 1.5 equiv) was added to the stirred solution of 4 (10 mg, 19.7 μmol) in DMF (100 μL) and DIPEA (30 μL), and the reaction mixture was stirred at rt for 1 h. A solution of 1-(2-aminoethyl)maleimide hydrochloride (5.3 mg, 30 μmol, 1.5 equiv) was then added, followed by DIPEA (50 μL) and the reaction mixture was stirred for further 1 h. The organic solvents were evaporated in vacuo, and the product was isolated by preparative HPLC (ThermoFisher Hypersil Gold C18 250×21.2 mm 5 m, solvent flow rate 18 mL/min, gradient 30% to 100% A:B, A-acetonitrile+0.1% (v/v) HCO₂H, B-water+0.1% (v/v) HCO₂H) to give 8.5 mg (68%) of 4-maleimide as yellow solid.

HRMS (ESI) m/z: [M+H]⁺ Calcd for C₃₃H₄₃N₅O₅Si: 630.3106, found: 630.3104.

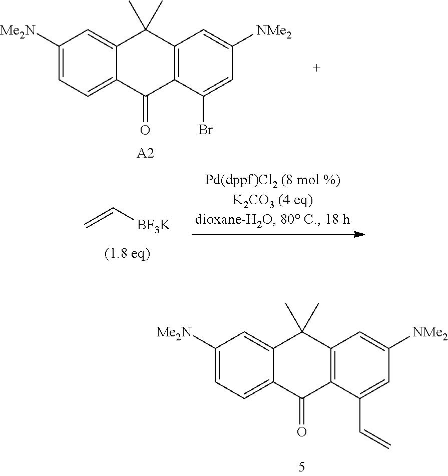

Compound 5. A mixture of A2 (known compound: R. Lincoln et al. Nat. Chem. 2022, 14, 1013-1020) (220 mg, 0.568 mmol), potassium vinyltrifluoroborate (229 mg, 1.70 mmol, 3 equiv), [1,1′-bis(diphenylphosphino)ferrocene]dichloropalladium(II) (33 mg, 45.4 μmol, 8 mol %) and potassium carbonate (312 mg, 2.27 mmol, 4 equiv) in 1,4-dioxane (5 mL) and water (1 mL) was stirred at 80° C. for 18 h. Upon cooling, the reaction mixture was diluted with brine (50 mL) and extracted with CH₂Cl₂ (3×20 mL). The combined extracts were dried over Na₂SO₄, and the product was isolated by flash column chromatography (12 g Interchim SiHP 30 μm cartridge, gradient 5% to 30% EtOAc/hexane+20% CH₂Cl₂ constant additive) and freeze-dried from 1,4-dioxane to yield 168 mg (89%) of 5 as yellow solid.

¹H NMR (400 MHz, CDCl₃): δ 8.20 (d, J=8.4, 1H), 7.90 (dd, J=17.2, 10.8, 1H), 6.79 (d, J=2.7 Hz, 1H), 6.77-6.72 (m, 2H), 6.70 (d, J=2.7, 1H), 5.44 (dd, J=17.2, 2.0 Hz, 1H), 5.27 (dd, J=10.8, 2.0 Hz, 1H), 3.11 (s, 6H), 3.09 (s, 6H), 1.72 (s, 6H).

¹³C NMR (101 MHz, CDCl₃): δ 182.9, 153.6, 153.0, 152.2, 151.3, 143.6, 141.8, 129.3, 121.5, 118.1, 113.2, 111.5, 111.1, 108.3, 107.3, 40.4, 40.3, 38.9, 34.3.

HRMS (ESI) m/z: [M+H]⁺ Calcd for C₂₂H₂₆N₂O: 335.2118, found: 335.2118.

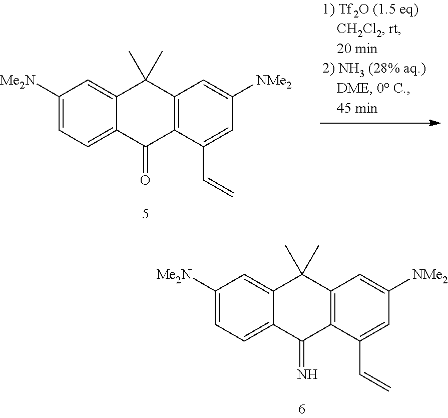

Compound 6. A solution of trifluoromethanesulfonic anhydride (Tf₂O, 1 M in CH₂Cl₂; 0.72 mL, ˜0.72 mmol, 1.5 equiv.) was added to the stirred solution of compound 5 (160 mg, 0.479 mmol) in dry CH₂Cl₂ (7 mL) under argon, and the resulting blue-violet solution was stirred at rt for 20 min. It was then transferred dropwise into the stirred mixture of aqueous ammonia (28% aq., 3.5 mL) and 1,2-dimethoxyethane (DME, 6 mL), cooled in ice-water bath. The reaction mixture was stirred at 0° C. for 45 min, diluted with brine (30 mL), the product was then extracted with CH₂Cl₂ (4×20 mL) and the combined extracts were dried over Na₂SO₄. The product was isolated by flash column chromatography (12 g Interchim SiHP 30 μm cartridge, gradient 0% to 100% A/B, A=CH₂Cl₂— ethanol-25% aq. NH₃ 80:20:2, B═CH₂Cl₂) and freeze-dried from 1,4-dioxane to yield 83 mg (52%) of 6 as brown-orange solid.

¹H NMR (400 MHz, CDCl₃): δ 8.9 (br.s, 1H), 7.96 (br. d, J=7.5 Hz, 1H), 7.26-7.14 (m, 1H), 6.86 (d, J=2.6 Hz, 1H), 6.82 (d, J=2.5 Hz, 1H), 6.75-6.68 (m, 2H), 5.70 (dd, J=17.3, 1.6 Hz, 1H), 5.35 (dd, J=10.8, 1.6 Hz, 1H), 3.06 (s, 6H), 3.04 (s, 6H), 1.65 (s, 6H).

¹³C NMR (101 MHz, CDCl₃): δ 167.7, 151.8, 150.9, 149.1, 147.7, 139.0, 138.8, 126.6, 124.4, 121.2, 115.6, 110.9, 110.8, 107.8, 107.1, 40.6, 40.5, 39.8, 32.0.

HRMS (ESI) m/z: [M+H]⁺ Calcd for C₂₂H₂₇N₃: 334.2278, found: 334.2277.

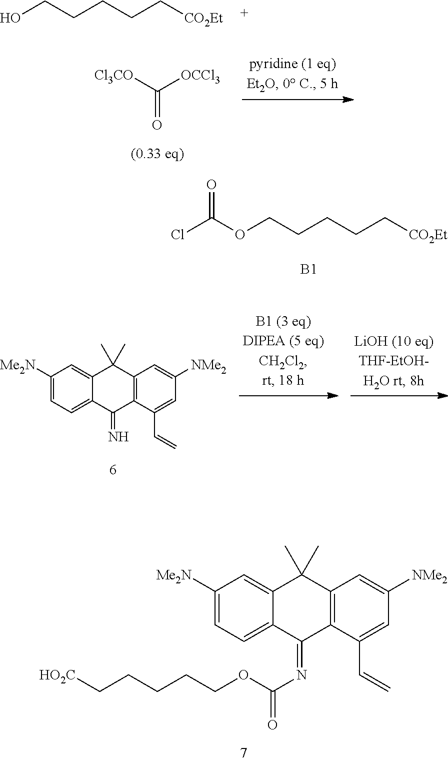

Compound 7. Chloroformate ester B1 was prepared according to the procedure from K. M. Anderson et al. Crystal Growth & Design 2006, 6(9), 2109-2113. Ethyl 6-hydroxyhexanoate (160 mg, 1 mmol) and pyridine (81 μL, 1 mmol, 1 equiv) were added to the stirred solution of triphosgene (99 mg, 0.33 mmol, 0.33 equiv) in dry diethyl ether (2 mL), cooled to 0° C. The reaction mixture was stirred at 0° C. for 5 h, the precipitate of pyridine hydrochloride was filtered off on a short plug of Celite, washed with dry diethyl ether (3 mL), the filtrate was evaporated and the residue was redissolved in dry CH₂Cl₂ (1 mL) and used directly in the next step.

The prepared solution of B1 in CH₂Cl₂ (0.36 mL, ˜0.36 mmol, 3 equiv) was added to the stirred solution of compound 6 (40 mg, 0.12 mmol) and DIPEA (104 μL, 0.6 mmol, 5 equiv) in dry CH₂Cl₂ (1.2 mL), and the resulting solution was stirred at rt for 18 h. The crude reaction mixture was evaporated, the residue was dissolved in the mixture of THF (2 mL) and ethanol (0.5 mL), and lithium hydroxide solution (50 mg of LiOH H₂O in 0.5 mL water, 1.2 mmol, 10 equiv) was added to the mixture, which was left stirring at rt for 8 h. Acetic acid (150 μL) was then added, and the reaction mixture was evaporated to dryness. The product was isolated by preparative HPLC (ThermoFisher Hypersil Gold C18 250×21.2 mm 5 m, solvent flow rate 18 mL/min, gradient 20% to 80% A:B, A-acetonitrile+0.1% (v/v) HCO₂H, B-water+0.1% (v/v) HCO₂H) and freeze-dried from dioxane to give 66 mg (95% over 2 steps) of 7 as green hygroscopic solid, containing ˜1 eq./eq. 1,4-dioxane.

¹H NMR (400 MHz, CDCl₃): δ 7.67 (d, J=8.8 Hz, 1H), 7.55 (dd, J=17.3, 10.8 Hz, 1H), 6.83 (d, J=2.5 Hz, 1H), 6.81 (d, J=2.5 Hz, 1H), 6.75 (d, J=2.5 Hz, 1H), 6.57 (dd, J=8.8, 2.5 Hz, 1H), 5.63 (dd, J=17.3, 1.6 Hz, 1H), 5.25 (dd, J=10.8, 1.6 Hz, 1H), 4.10 (t, J=6.6 Hz, 2H), 3.06 (s, 6H), 3.03 (s, 6H), 2.22 (t, J=7.5 Hz, 2H), 1.66 (s, 6H), 1.62-1.36 (m, 4H), 1.27-1.09 (m, 2H).

¹³C NMR (101 MHz, CDCl₃): δ 179.0, 163.7, 163.5, 151.7, 151.2, 150.0, 149.3, 139.1, 138.4, 127.7, 122.7, 120.8, 114.1, 109.9, 109.4, 107.1, 106.7, 65.5, 40.43, 40.37, 34.0, 31.5, 28.5, 25.5, 24.4.

HRMS (ESI) m/z: [M+H]⁺ Calcd for C₂₉H₃₇N₃O₄: 492.2857, found: 492.2859.

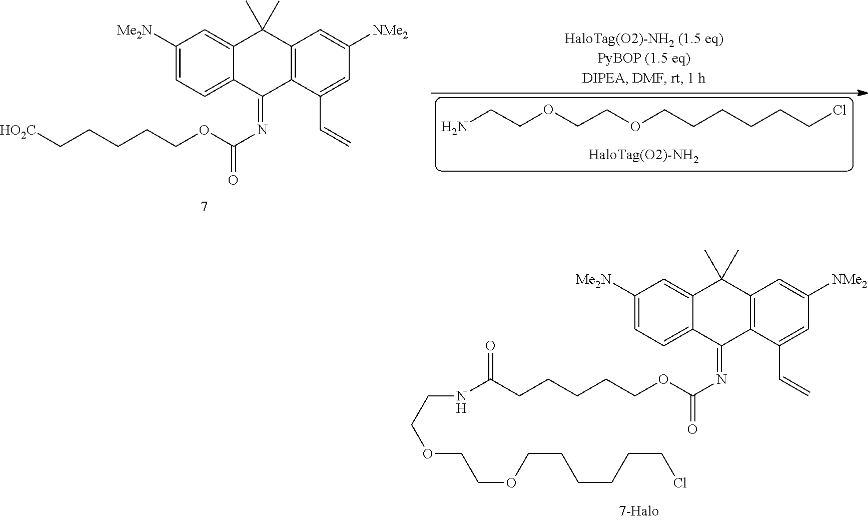 [SMILES: C=Cc1cc(N(C)C)cc2c1/C(=N/C(=O)OCCCCCC(=O)O)c1ccc(N(C)C)cc1C2(C)C ; NCCOCCOCCCCCCCl ; C=Cc1cc(N(C)C)cc2c1/C(=N/C(=O)OCCCCCC(=O)NCCOCCOCCCCCCCl)c1ccc(N(C)C)cc1C2(C)C]

Compound 7-Halo. PyBOP solution (benzotriazol-1-yloxy-tris(pyrrolidino)phosphonium hexafluorophosphate; 15.9 mg in 100 μL DMF, 30.5 μmol, 1.5 equiv) was added to the stirred solution of compound 7 (10 mg, 20.3 μmol) and HaloTag(O2) amine (hydrochloride salt; 7.9 mg, 30.5 μmol, 1.5 equiv) in DMF (200 μL) and DIPEA (80 μL), and the reaction mixture was stirred at rt for 1 h. The organic solvents were evaporated in vacuo, and the product was isolated by preparative HPLC (ThermoFisher Hypersil Gold C18 250×21.2 mm 5 m, solvent flow rate 18 mL/min, gradient 30% to 90% A:B, A-acetonitrile+0.1% (v/v) HCO₂H, B-water+0.1% (v/v) HCO₂H) and freeze-dried from dioxane to give 12.8 mg (90%) of 7-Halo as viscous blue oil.

HRMS (ESI) m/z: [M+H]⁺ Calcd for C₃₉H₅₇ClN₄O₅: 697.4090, found: 697.4088.

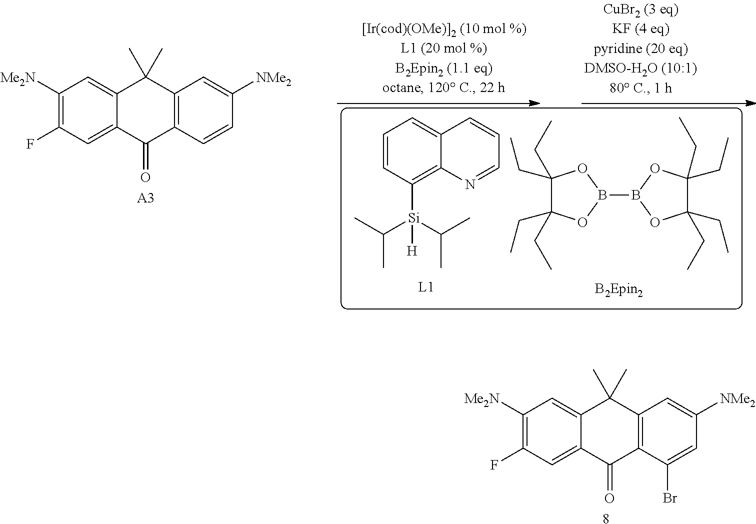

Compound 8. A mixture of A3 (known compound: A. N. Butkevich et al. Angew. Chem. Int. Ed., 2016, 55(10), 3290-3294) (167 mg, 0.51 mmol), (1,5-cyclooctadiene)(methoxy)iridium(I) dimer (34 mg, 0.051 mmol, 10 mol %), ligand L1 (known compound: B. Ghaffari et al. J. Am. Chem. Soc. 2014, 136, 14345-14348) (25 mg, 0.102 μmol, 20 mol %) and 4,4,4′,4′,5,5,5′,5′-octaethyl-2,2′-bi(1,3,2-dioxaborolane) (B₂(Epin)₂; 205 mg, 0.561 mmol, 1.1 equiv) in degassed octane (6 mL) was stirred at 120° C. for 22 h. The reaction mixture was diluted with CH₂Cl₂ and evaporated on silica, and the product (the major regioisomer of aryl boronate ester) was separated by flash column chromatography (40 g RediSep Rf cartridge, gradient 0% to 30% EtOAc/hexane+20% CH₂Cl₂ constant additive) to give 123 mg of yellow foam, which was used in the next step without further characterization.

Anhydrous copper(II) bromide (162 mg, 0.726 mmol, 3 equiv) and potassium fluoride (56 mg, 0.97 mmol, 4 equiv) were added to the boronate ester (123 mg, 0.242 mmol) followed by DMSO (2.5 mL), pyridine (0.39 mL, 4.84 mmol, 20 equiv) and water (0.25 mL), and the mixture was stirred at 80° C. for 1 h. The reaction mixture was diluted with sat. aq. Na₂SO₄ solution and extracted with CH₂Cl₂ (3×25 mL), the combined extracts were dried over Na₂SO₄. The filtrate was evaporated on silica and the mixture was separated by flash column chromatography (25 g Interchim SiHP 30 μm cartridge, gradient 0% to 30% EtOAc/hexane+20% CH₂Cl₂ constant additive) to yield 69 mg (33%) of 8 as yellow solid.

¹H NMR (400 MHz, CDCl₃): δ 7.89 (d, J=14.6 Hz, 1H), 7.01 (d, J=2.6 Hz, 1H), 6.85 (d, J=8.3 Hz, 1H), 6.76 (d, J=2.6 Hz, 1H), 3.09 (s, 6H), 3.02 (d, J=1.5 Hz, 6H), 1.68 (s, 6H).

¹⁹F NMR (376 MHz, CDCl₃): δ −125.06.

¹³C NMR (101 MHz, CDCl₃): δ 179.8 (d, J=1.9 Hz), 154.3, 153.1 (d, J=245.1 Hz), 152.2, 145.6 (d, J=2.7 Hz), 144.2 (d, J=8.9 Hz), 124.34, 124.28 (d, J=6.5 Hz), 118.2, 117.0 (d, J=1.3 Hz), 114.5 (d, J=22.4 Hz), 113.4 (d, J=3.6 Hz), 108.2, 42.5 (d, J=5.5 Hz), 40.1, 38.8, 34.2.

HRMS (ESI) m/z: [M+H]⁺ Calcd for C₂₀H₂₂BrFN₂O: 405.0972, found: 405.0972.

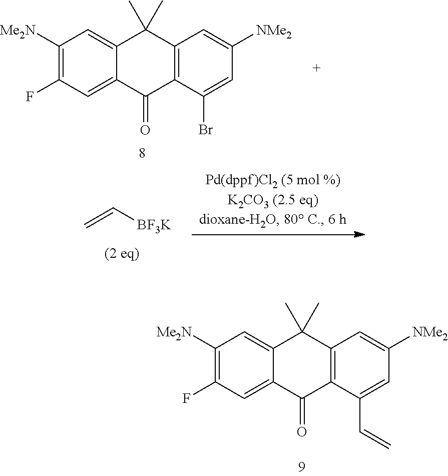

Compound 9. A mixture of compound 8 (88 mg, 0.217 mmol), potassium vinyltrifluoroborate (58 mg, 0.435 mmol, 2 equiv), [1,1′-bis(diphenylphosphino)ferrocene]dichloropalladium(II) (8.9 mg, 11.0 μmol, 5 mol %) and potassium carbonate (75 mg, 0.543 mmol, 2.5 equiv) in 1,5-dioxane (1.6 mL) and water (0.32 mL) was stirred at 80° C. for 6 h. Upon cooling, the reaction mixture was diluted with brine (30 mL) and extracted with CH₂Cl₂ (3×20 mL). The combined extracts were dried over Na₂SO₄, and the product was isolated by flash column chromatography (12 g Interchim SiHP 30 μm cartridge, gradient 0% to 30% EtOAc/hexane+20% CH₂Cl₂ constant additive) and freeze-dried from 1,4-dioxane to yield 59 mg (77%) of 9 as light-yellow solid.

¹H NMR (400 MHz, CDCl₃): δ 7.87 (d, J=14.7 Hz, 1H), 7.85 (dd, J=17.1, 10.8 Hz, 1H), 6.88 (d, J=8.3 Hz, 1H), 6.77 (d, J=2.7 Hz, 1H), 6.70 (dd, J=2.6, 0.7 Hz, 1H), 5.45 (dd, J=17.1, 1.9 Hz, 1H), 5.29 (dd, J=10.8, 1.9 Hz, 1H), 3.12 (s, 6H), 3.01 (d, J=1.3 Hz, 6H), 1.70 (s, 6H).

¹⁹F NMR (376 MHz, CDCl₃): δ −125.26.

¹³C NMR (101 MHz, CDCl₃): δ 182.0 (d, J=1.7 Hz), 153.7, 153.2 (d, J=244.8 Hz), 152.4, 146.4 (d, J=2.6 Hz), 144.0 (d, J=9.1 Hz), 143.9, 141.5, 124.9 (d, J=6.2 Hz), 117.5 (d, J=1.0 Hz), 114.1 (d, J=22.1 Hz), 113.8 (d, J=3.5 Hz), 113.7, 111.5, 108.2, 42.5 (d, J=5.3 Hz), 40.2, 38.6, 34.2.

HRMS (ESI) m/z: [M+H]⁺ Calcd for C₂₂H₂₅FN₂O: 353.2024, found: 353.2024.

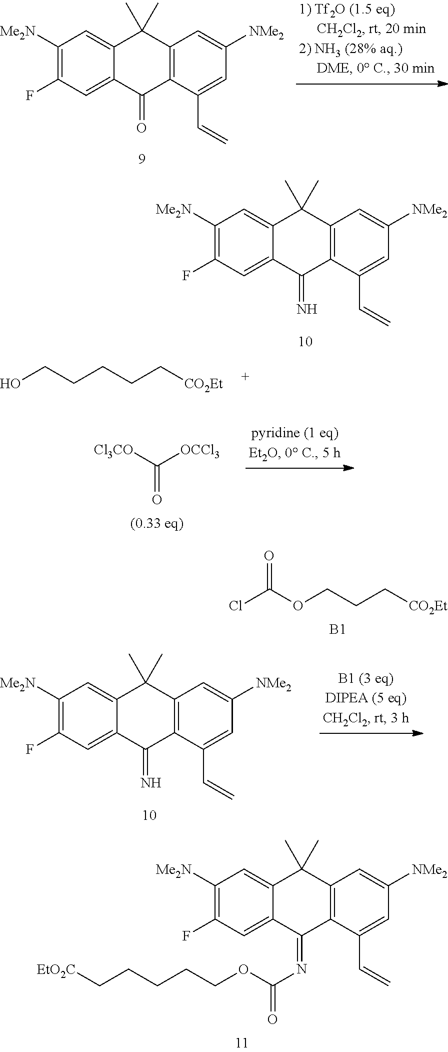

Compound 11. A solution of trifluoromethanesulfonic anhydride (Tf₂O, 1 M in CH₂Cl₂; 0.55 mL, ˜0.55 mmol, 1.5 equiv.) was added to the stirred solution of compound 9 (134 mg, 0.38 mmol) in dry CH₂Cl₂ (5 mL) under argon, and the resulting blue solution was stirred at rt for 20 min. It was then transferred dropwise into the stirred mixture of aqueous ammonia (28% aq., 3 mL) and 1,2-dimethoxyethane (DME, 5 mL), cooled in ice-water bath. The reaction mixture was stirred at 0° C. for 45 min, diluted with brine (50 mL), the product was then extracted with CH₂Cl₂ (3×20 mL) and the combined extracts were dried over Na₂SO₄. The product was isolated by flash column chromatography (12 g Interchim SiHP 30 μm cartridge, gradient 0% to 50% A/B, A=CH₂Cl₂— ethanol-25% aq. NH₃ 80:20:2, B═CH₂Cl₂) and freeze-dried from 1,4-dioxane to yield 71 mg (˜0.20 mmol) of crude imine 10 as viscous orange oil, which was used directly in the next step.

Chloroformate ester B1 was prepared according to the procedure from K. M. Anderson et al. Crystal Growth & Design 2006, 6(9), 2109-2113. Ethyl 6-hydroxyhexanoate (640 mg, 4 mmol) and pyridine (0.32 mL, 1 mmol, 1 equiv) were added to the stirred solution of triphosgene (396 mg, 0.33 mmol, 0.33 equiv) in dry diethyl ether (8 mL), cooled to 0° C. The reaction mixture was stirred at 0° C. for 5 h, the precipitate of pyridine hydrochloride was filtered off on a short plug of Celite, washed with dry diethyl ether (3 mL), the filtrate was evaporated, redissolved in dry hexane, microfiltered through a 0.22 μm PTFE membrane filter, evaporated to yellowish oil (561 mg, crude chloroformate ester containing alkyl chloride as an impurity), which was used directly in the next step.

The above prepared crude B1 (0.15 mL, ˜0.6 mmol, ˜3 equiv) was added to the stirred solution of 10 (71 mg, ˜0.2 mmol) and DIPEA (150 μL, 0.66 mmol, 4.3 equiv) in dry CH₂Cl₂ (0.5 mL), and the resulting solution was stirred at rt for 3 h. The crude reaction mixture was evaporated, the residue was redissolved in minimal volume of CH₂Cl₂, and the product was isolated by flash column chromatography (12 g Interchim SiHP 30 μm cartridge, gradient 10% to 60% EtOAc/hexane) to yield 47 mg (23%) of 11 as viscous green-brown oil.

¹H NMR (400 MHz, CD₃CN): δ 7.36 (dd, J=17.4, 10.9 Hz, 1H), 7.33 (d, J=14.5 Hz, 1H), 7.07 (d, J=8.9 Hz, 1H), 6.90 (d, J=2.5 Hz, 1H), 6.78 (d, J=2.5 Hz, 1H), 5.67 (dd, J=17.4, 1.5 Hz, 1H), 5.20 (dd, J=10.9, 1.5 Hz, 1H), 4.11-4.03 (m, 4H), 3.06 (s, 6H), 2.95 (d, J=1.4 Hz, 6H), 2.20 (t, J=7.5 Hz, 2H), 1.62 (s, 6H), 1.60-1.46 (m, 4H), 1.27-1.16 (m, 5H).

¹⁹F NMR (376 MHz, CD₃CN): δ −126.98.

¹³C NMR (101 MHz, CD₃CN): δ 174.1, 163.4, 162.5 (d, J=1.6 Hz), 152.9 (d, J=242.4 Hz), 152.6, 151.2, 145.7 (d, J=2.8 Hz), 143.0 (d, J=8.1 Hz), 139.8, 138.9, 125.9 (d, J=7.1 Hz), 119.9, 114.8, 114.3 (d, J=4.1 Hz), 114.1 (d, J=23.6 Hz), 109.8, 108.2, 66.6, 60.8, 42.6 (d, J=5.2 Hz), 40.9, 40.4, 34.7, 31.7, 29.2, 26.2, 25.3, 14.6.

HRMS (ESI) m/z: [M+H]⁺ Calcd for C₃₁H₄₀FN₃O₄: 538.3076, found: 538.3068.

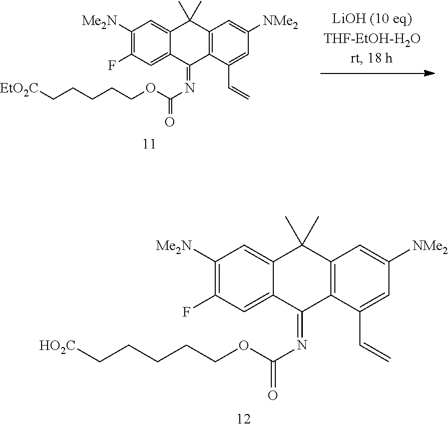 [SMILES: C=Cc1cc(N(C)C)cc2c1/C(=N/C(=O)OCCCCCC(=O)OCC)c1cc(F)c(N(C)C)cc1C2(C)C ; C=Cc1cc(N(C)C)cc2c1/C(=N/C(=O)OCCCCCC(=O)O)c1cc(F)c(N(C)C)cc1C2(C)C]

Compound 12. Compound 11 (47 mg, 87.4 μmol) was dissolved in the mixture of THF (2 mL) and ethanol (0.5 mL), and lithium hydroxide solution (37 mg of LiOH H₂O in 0.5 mL water, 0.874 mmol, ˜10 equiv) was added to the mixture, which was left stirring at rt overnight (18 h). Acetic acid (150 μL) was then added, and the reaction mixture was evaporated to dryness. The product was isolated by preparative HPLC (Interchim Uptisphere Strategy PhC4 250×21.2 mm 5 m, solvent flow rate 18 mL/min, gradient 30% to 80% A:B, A-acetonitrile+0.1% (v/v) HCO₂H, B-water+0.1% (v/v) HCO₂H) and freeze-dried from dioxane to give 39 mg (87% over 2 steps) of 12 as green lustrous solid.

¹H NMR (400 MHz, CDCl₃): δ 7.47 (d, J=14.0 Hz, 1H), 7.44 (dd, J=17.2, 10.8 Hz, 1H), 6.97 (d, J=8.6 Hz, 1H), 6.81 (d, J=2.5 Hz, 1H), 6.75 (d, J=2.5 Hz, 1H), 5.65 (dd, J=17.2, 1.6 Hz, 1H), 5.27 (dd, J=10.8, 1.6 Hz, 1H), 4.14 (t, J=6.4 Hz, 2H), 3.07 (s, 6H), 2.96 (d, J=1.2 Hz, 6H), 2.27 (t, J=7.5 Hz, 2H), 1.64 (s, 6H), 1.63-1.53 (m, 2H), 1.33-1.21 (m, 2H).

¹⁹F NMR (376 MHz, CDCl₃): δ −125.49.

¹³C NMR (101 MHz, CDCl₃): δ 178.4, 162.9, 152.5 (d, J=244.3 Hz), 151.5, 150.2, 144.5 (d, J=2.9 Hz), 141.9 (d, J=8.4 Hz), 139.4, 138.1, 126.1 (d, J=7.2 Hz), 119.9, 114.7, 113.9 (d, J=23.3 Hz), 112.9 (d, J=3.7 Hz), 109.3, 107.0, 42.5 (d, J=5.1 Hz), 40.4, 40.1, 33.9, 31.7, 28.5, 25.6, 24.5.

HRMS (ESI) m/z: [M+H]⁺ Calcd for C₂₉H₃₆FN₃O₄ 510.2763; Found 510.2774.

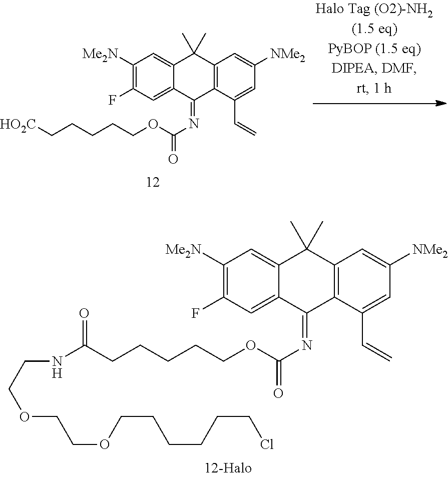 [SMILES: C=Cc1cc(N(C)C)cc2c1/C(=N/C(=O)OCCCCCC(=O)O)c1cc(F)c(N(C)C)cc1C2(C)C ; C=Cc1cc(N(C)C)cc2c1/C(=N/C(=O)OCCCCCC(=O)NCCOCCOCCCCCCCl)c1cc(F)c(N(C)C)cc1C2(C)C]

Compound 12-Halo. PyBOP solution (benzotriazol-1-yloxy-tris(pyrrolidino)phosphonium hexafluorophosphate; 15.3 mg in 100 μL DMF, 29.4 μmol, 1.5 equiv) was added to the stirred solution of compound 12 (10 mg, 19.6 μmol) and HaloTag(O2) amine (hydrochloride salt; 7.6 mg, 29.4 μmol, 1.5 equiv) in DMF (200 μL) and DIPEA (80 μL), and the reaction mixture was stirred at rt for 1 h. The organic solvents were evaporated in vacuo, and the product was isolated by preparative HPLC (ThermoFisher Hypersil Gold C18 250×21.2 mm 5 m, solvent flow rate 18 mL/min, gradient 50% to 100% A:B, A-acetonitrile+0.1% (v/v) HCO₂H, B-water+0.1% (v/v) HCO₂H) and freeze-dried from dioxane to give 12 mg (85%) of 12-Halo as viscous brown-yellow oil.

HRMS (ESI) m/z: [M+H]⁺ Calcd for C₃₉H₅₆ClFN₄O₅: 715.3996, found: 715.4001.

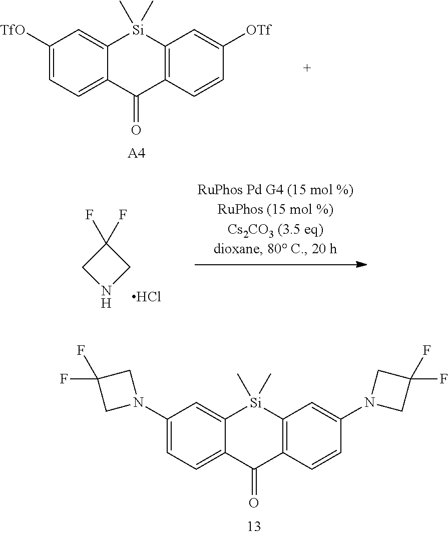

Compound 13. A mixture of A4 (known compound: S. Shen et al. RSC Adv., 2017, 7(18), 10922-10927) (150 mg, 0.28 mmol), 3,3-difluoroazetidine hydrochloride (110 mg, 0.84 mmol, 3 equiv), RuPhos Pd G4 precatalyst (35.7 mg, 42 μmol, 15 mol %), RuPhos ligand (20 mg, 42 μmol, 15 mol %) and cesium carbonate (320 mg, 0.98 mmol, 3.5 equiv) in 1,4-dioxane (1 mL) was stirred at 80° C. for 20 h. Upon cooling, the reaction mixture was diluted with brine (30 mL) and extracted with ethyl acetate (3×20 mL). The combined extracts were dried over Na₂SO₄, and the product was isolated by flash column chromatography (12 g Interchim SiHP 30 μm cartridge, gradient 10% to 50% EtOAc/hexane) and freeze-dried from 1,4-dioxane to yield 118 mg (99%) of 13 as yellowish solid.

¹H NMR (400 MHz, CDCl₃): δ 8.40 (d, J=8.7 Hz, 2H), 6.62 (dd, J=8.7, 2.6 Hz, 2H), 6.57 (d, J=2.5 Hz, 2H), 4.36 (t, J=11.7 Hz, 8H), 0.46 (s, 6H).

¹⁹F NMR (376 MHz, CDCl₃): δ −99.53.

¹³C NMR (101 MHz, CDCl₃): δ 185.4, 150.8, 150.8, 140.7, 132.1, 131.9, 115.8 (t, J=274.6 Hz), 114.7, 113.6, 63.2 (t, J=26.7 Hz), −1.1.

HRMS (ESI) m/z: [M+H]⁺ Calcd for C₂₁H₂₀F₄N₂OSi: 421.1354, found: 421.1341.

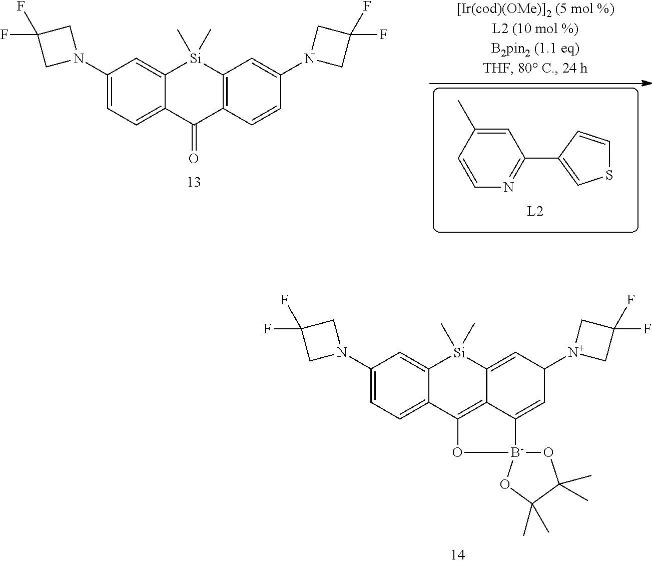 [SMILES: C[Si]1(C)c2cc(N3CC(F)(F)C3)ccc2C(=O)c2ccc(N3CC(F)(F)C3)cc21 ; Cc1ccnc(-c2ccsc2)c1 ; CC1(C)O[B-]2(OC3=C4C2=CC([NH+]2CC(F)(F)C2)C=C4[Si](C)(C)c2cc(N4CC(F)(F)C4)ccc23)OC1(C)C]

Compound 14. A mixture of compound 13 (111 mg, 0.264 mmol), (1,5-cyclooctadiene)(methoxy)iridium(I) dimer (8.8 mg, 13.2 μmol, 5 mol %), ligand L2 (known compound: M. E. Hoque et al. J. Am. Chem. Soc. 2021, 143, 5022-5037) (4.6 mg, 26.4 μmol, 10 mol %) and bis(pinacolato)diboron (74 mg, 0.29 mmol, 1.1 equiv) in degassed THF (2.5 mL) was stirred at 80° C. overnight. The reaction mixture was evaporated on Celite, and the product was isolated by flash column chromatography (12 g Interchim SiHP 30 μm cartridge, gradient 0% to 20% EtOAc/CH₂Cl₂) and freeze-dried from 1,4-dioxane to yield 108 mg (75%) of 14 as yellow solid.

¹H NMR (400 MHz, CDCl₃): δ 8.43 (dd, J=8.3, 0.8 Hz, 1H), 6.74 (d, J=2.3 Hz, 1H), 6.58-6.53 (m, 2H), 6.46 (d, J=2.3 Hz, 1H), 4.43 (t, J=11.6 Hz, 4H), 4.42 (t, J=11.7 Hz, 4H), 1.43 (s, 12H), 0.40 (s, 6H).

¹⁹F NMR (376 MHz, CDCl₃): δ −99.73, −99.87.

¹³C NMR (101 MHz, CDCl₃): δ 188.5, 152.0, 145.9, 139.7, 134.0, 133.7, 125.2, 115.8 (t, J=274.5 Hz), 115.5, 115.4 (t, J=274.5 Hz), 114.91, 114.86, 112.6, 62.9 (t, J=27.3 Hz), 25.6, −1.4.

HRMS (ESI) m/z: [M+H]⁺ Calcd for C₂₇H₃₁BF₄N₂O₃Si: 546.2242, found: 546.2243.

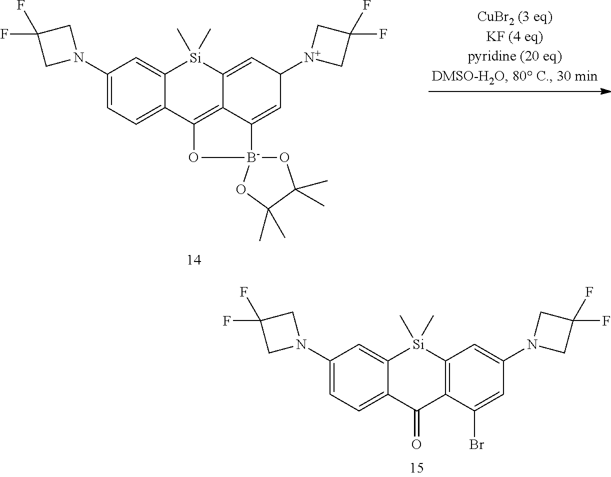 [SMILES: CC1(C)O[B-]2(OC3=C4C2=CC([NH+]2CC(F)(F)C2)C=C4[Si](C)(C)c2cc(N4CC(F)(F)C4)ccc23)OC1(C)C ; C[Si]1(C)c2cc(N3CC(F)(F)C3)ccc2C(=O)c2c(Br)cc(N3CC(F)(F)C3)cc21]

Compound 15. Copper(II) bromide (132 mg, 0.593 mmol, 3 equiv) and potassium fluoride (46 mg, 0.792 mmol, 4 equiv) were added to a stirred solution of compound 14 (108 mg, 0.198 mmol) in DMSO (1.5 mL), followed by addition of pyridine (320 μL, 3.96 mmol, 20 equiv) and water (150 μL), and the reaction mixture was stirred at 80° C. for 30 min. On cooling, it was diluted with water (30 mL) and extracted with ethyl acetate (3×20 mL). The combined extracts were dried over Na₂SO₄, the product was isolated by flash column chromatography (12 g Interchim SiHP 30 μm cartridge, gradient 10% to 50% EtOAc/hexane) and freeze-dried from 1,4-dioxane to yield 104 mg (quant.) of 15 as light-yellow solid, containing −25 mol % dioxane.

¹H NMR (400 MHz, CDCl₃): δ 8.17 (d, J=8.6 Hz, 1H), 6.85 (d, J=2.4 Hz, 1H), 6.61 (dd, J=8.7, 2.6 Hz, 1H), 6.53 (d, J=2.5 Hz, 2H), 4.35 (t, J=11.6 Hz, 4H), 4.34 (t, J=11.7 Hz, 4H), 0.46 (s, 6H).

¹⁹F NMR (376 MHz, CDCl₃): δ −99.49, −99.51.

¹³C NMR (101 MHz, CDCl₃): δ 186.8, 150.5, 150.0, 142.5, 138.4, 134.6, 131.4, 130.7, 125.0, 120.3, 115.8 (t, J=274.5 Hz), 115.5 (t, J=274.7 Hz), 114.3, 114.0, 113.8, 63.2 (t, J=26.8 Hz), −1.3.

HRMS (ESI) m/z: [M+H]⁺ Calcd for C₂₁H₁₉BrF₄N₂OSi: 499.0459, found: 499.0453.

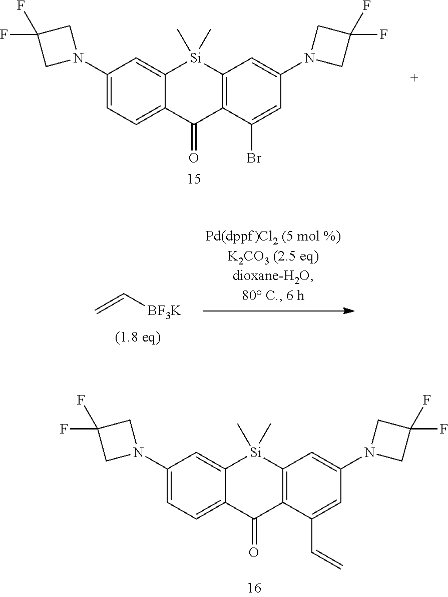

Compound 16. A mixture of compound 15 (104 mg, 0.208 mmol), potassium vinyltrifluoroborate (50 mg, 0.375 mmol, 1.8 equiv), [1,1′-bis(diphenylphosphino)ferrocene]dichloropalladium(II) (8.5 mg, 10.0 μmol, 5 mol %) and potassium carbonate (72 mg, 0.52 mmol, 2.5 equiv) in 1,5-dioxane (1 mL) and water (0.3 mL) was stirred at 80° C. for 6 h. Upon cooling, the reaction mixture was diluted with brine (30 mL) and extracted with ethyl acetate (3×20 mL). The combined extracts were dried over Na₂SO₄, and the product was isolated by flash column chromatography (12 g Interchim SiHP 30 μm cartridge, gradient 5% to 50% EtOAc/hexane) and freeze-dried from 1,4-dioxane to yield 79 mg (89%) of 16 as light-yellow solid.

¹H NMR (400 MHz, CDCl₃): δ 8.22 (d, J=8.7 Hz, 1H), 7.47 (dd, J=17.3, 10.8 Hz, 1H), 6.61 (dd, J=8.7, 2.6 Hz, 1H), 6.58 (d, J=2.7 Hz, 1H), 6.55 (d, J=2.2 Hz, 1H), 5.46 (dd, J=17.2, 1.6 Hz, 1H), 5.28 (dd, J=10.8, 1.6 Hz, 1H), 4.37 (t, J=11.6 Hz, 4H), 4.34 (t, J=11.6 Hz, 4H), 0.46 (s, 6H).

¹⁹F NMR (376 MHz, CDCl₃): δ −99.50, −99.51.

¹³C NMR (101 MHz, CDCl₃): 188.2, 150.5 (t, J=3.0 Hz), 150.1 (t, J=3.0 Hz), 144.1, 141.4, 140.5, 139.2, 134.6, 131.4, 130.9, 115.82 (t, J=274.5 Hz), 115.78 (t, J=274.5 Hz), 114.7, 114.2, 114.0, 113.8, 113.7, 63.2 (t, J=26.2 Hz), −1.1.

HRMS (ESI) m/z: [M+H]⁺ Calcd for C₂₃H₂₂F₄N₂OSi: 447.1510, found: 447.1510.

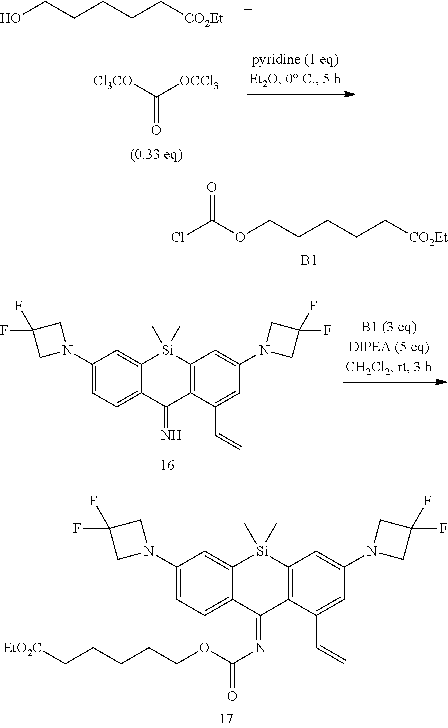

Compound 17. Chloroformate ester B1 was prepared according to the procedure from K. M. Anderson et al. Crystal Growth & Design 2006, 6(9), 2109-2113. Ethyl 6-hydroxyhexanoate (160 mg, 1 mmol) and pyridine (81 μL, 1 mmol, 1 equiv) were added to the stirred solution of triphosgene (99 mg, 0.33 mmol, 0.33 equiv) in dry diethyl ether (2 mL), cooled to 0° C. The reaction mixture was stirred at 0° C. for 5 h, the precipitate of pyridine hydrochloride was filtered off on a short plug of Celite, washed with dry diethyl ether (3 mL), the filtrate was evaporated and the residue was redissolved in dry CH₂Cl₂ (1 mL) and used directly in the next step.

The above prepared crude B1 (0.1 mL, ˜0.4 mmol, ˜3 equiv) dissolved in dry CH₂Cl₂ (0.5 mL) was added to the stirred solution of 16 (54 mg, 0.121 mmol) and DIPEA (105 μL, 0.605 mmol, 5 equiv) in dry CH₂Cl₂ (0.6 mL), and the resulting solution was stirred at rt for 3 h. The crude reaction mixture was evaporated, the residue was redissolved in minimal volume of CH₂Cl₂, and the product was isolated by flash column chromatography (12 g Interchim SiHP 30 μm cartridge, gradient 0% to 50% EtOAc/hexane) to yield 93 mg of crude 17 as viscous yellow solid which was used directly in the hydrolysis step.

HRMS (ESI) m/z: [M+H]⁺ Calcd for C₃₂H₃₇F₄N₃O₄Si: 632.2562, found: 632.2564.

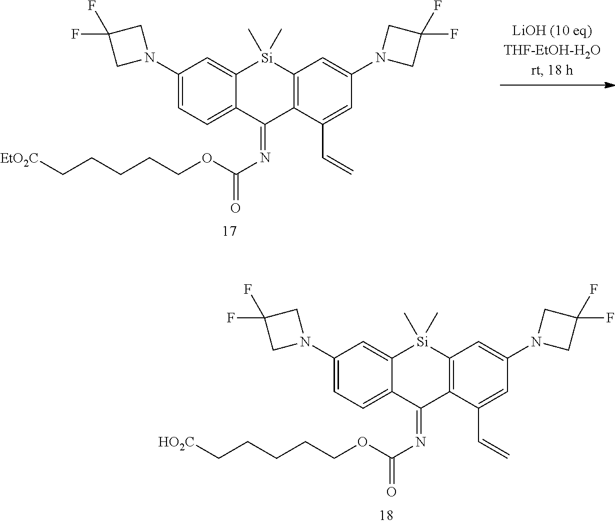 [SMILES: C=Cc1cc(N2CC(F)(F)C2)cc2c1/C(=N/C(=O)OCCCCCC(=O)OCC)c1ccc(N3CC(F)(F)C3)cc1[Si]2(C)C ; C=Cc1cc(N2CC(F)(F)C2)cc2c1/C(=N/C(=O)OCCCCCC(=O)O)c1ccc(N3CC(F)(F)C3)cc1[Si]2(C)C]

Compound 18. The entire amount of crude 17 was dissolved in the mixture of THF (3 mL) and ethanol (0.75 mL), and lithium hydroxide solution (51 mg of LiOH H₂O in 0.75 mL water, 1.21 mmol, ˜10 equiv) was added to the mixture, which was left stirring at rt overnight (18 h). Acetic acid (200 μL) was then added, and the reaction mixture was evaporated to dryness. The product was isolated by preparative HPLC (Interchim Uptisphere Strategy C18HQ 250×30 mm 10 m, solvent flow rate 32 mL/min, gradient 50% to 100% A:B, A-acetonitrile+0.1% (v/v) HCO₂H, B-water+0.1% (v/v) HCO₂H) and freeze-dried from dioxane to give 65 mg (89% over 2 steps) of 18 as viscous yellow solid.

¹H NMR (400 MHz, CDCl₃): δ 7.66 (d, J=8.5 Hz, 1H), 7.33 (dd, J=17.3, 10.9 Hz, 1H), 6.67 (d, J=2.4 Hz, 1H), 6.62 (d, J=2.5 Hz, 1H), 6.58 (d, J=2.5 Hz, 1H), 6.48 (dd, J=8.4, 2.6 Hz, 1H), 5.66 (dd, J=17.3, 1.3 Hz, 1H), 5.33 (dd, J=10.9, 1.2 Hz, 1H), 4.30 (t, J=11.8 Hz, 4H), 4.28 (t, J=11.7 Hz, 4H), 4.02 (t, J=6.3 Hz, 2H), 2.25 (t, J=7.6 Hz, 2H), 1.56-1.45 (m, 4H), 1.17-1.06 (m, 2H), 0.48 (s, 6H).

¹⁹F NMR (376 MHz, CDCl₃): δ −99.43.

¹³C NMR (101 MHz, CDCl₃): δ 178.6, 168.7, 162.6, 149.5 (t, J=2.8 Hz), 149.4 (t, J=2.7 Hz), 138.5, 138.1, 137.9, 136.3, 134.9, 133.0, 128.0, 115.9 (t, J=274.7 Hz), 115.8 (t, J=274.7 Hz), 115.6, 115.3, 115.2, 113.0, 111.4, 65.8, 63.4 (t, J=26.2 Hz), 63.3 (t, J=26.3 Hz), 33.8, 28.5, 25.3, 24.4, −2.7.

HRMS (ESI) m/z: [M+H]⁺ Calcd for C₃₀H₃₃F₄N₃O₄Si: 604.2249, found: 604.2247.

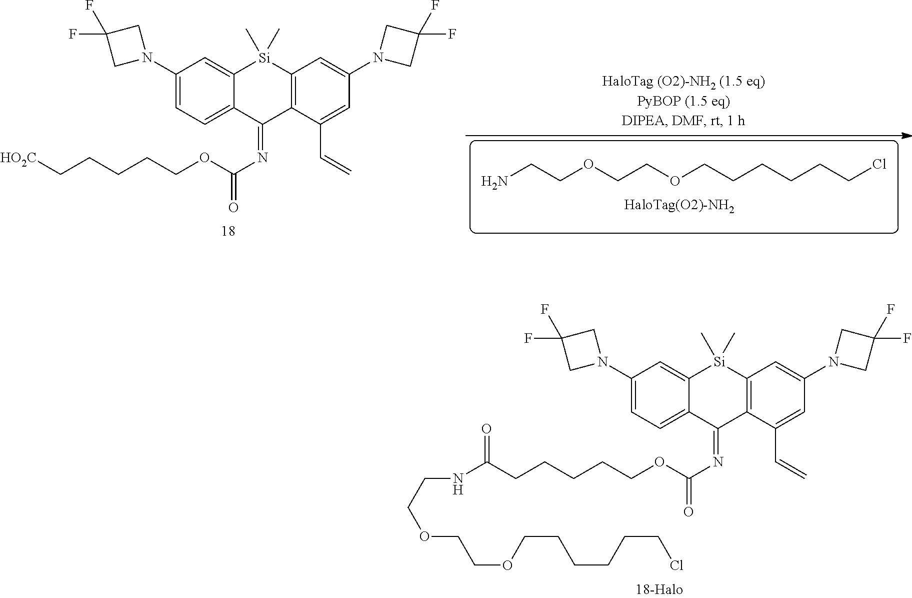 [SMILES: C=Cc1cc(N2CC(F)(F)C2)cc2c1/C(=N/C(=O)OCCCCCC(=O)O)c1ccc(N3CC(F)(F)C3)cc1[Si]2(C)C ; NCCOCCOCCCCCCCl ; C=Cc1cc(N2CC(F)(F)C2)cc2c1/C(=N/C(=O)OCCCCCC(=O)NCCOCCOCCCCCCCl)c1ccc(N3CC(F)(F)C3)cc1[Si]2(C)C]

Compound 18-Halo. PyBOP solution (benzotriazol-1-yloxy-tris(pyrrolidino)phosphonium hexafluorophosphate; 15.5 mg in 100 μL DMF, 29.8 μmol, 1.5 equiv) was added to the stirred solution of 18 (12 mg, 19.9 μmol) and HaloTag(O2) amine (hydrochloride salt; 7.7 mg, 29.8 μmol, 1.5 equiv) in DMF (200 μL) and DIPEA (80 μL), and the reaction mixture was stirred at rt for 1 h. The organic solvents were evaporated in vacuo, and the product was isolated by preparative HPLC (ThermoFisher Hypersil Gold C18 250×21.2 mm 5 m, solvent flow rate 18 mL/min, gradient 50% to 100% A:B, A-acetonitrile+0.1% (v/v) HCO₂H, B-water+0.1% (v/v) HCO₂H) and freeze-dried from dioxane to give 14 mg (87%) of 18-Halo as viscous yellow oil.

HRMS (ESI) m/z: [M+H]⁺ Calcd for C₄₀H₅₃ClF₄N₄O₅Si: 809.3483, found: 809.3491.

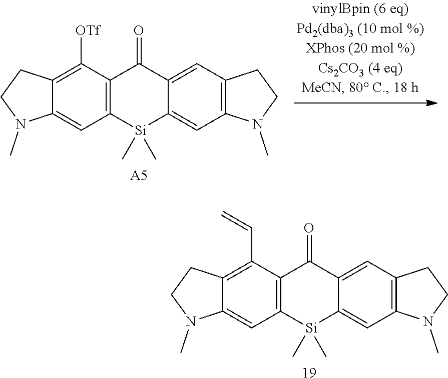

Compound 19. In a 25 mL round-bottom flask, a mixture of A5 (known compound: M. Remmel et al. Small Methods 2024, 2301497) (181 mg, 0.36 mmol), vinylboronic acid pinacol ester (336 mg, 2.18 mmol, 6 equiv), tris(dibenzylideneacetone)dipalladium(0) (33 mg, 36 μmol, 10 mol %), XPhos (35 mg, 72 μmol, 20 mol %) and cesium carbonate (474 mg, 1.44 mmol, 4 equiv) in degassed dry acetonitrile (6 mL) was stirred at 80° C. overnight (18 h). On cooling, the reaction mixture was diluted with CH₂Cl₂ and filtered through a plug of Celite, washing with CH₂Cl₂ (100 mL). The filtrate was washed with brine, dried over Na₂SO₄ and the product was isolated by flash column chromatography (25 g Interchim SiHP 30 μm cartridge, gradient 5% to 60% EtOAc/hexane) and freeze-dried from 1,4-dioxane to yield 92 mg (67%) of 19 as yellow solid.

¹H NMR (400 MHz, CDCl₃): δ 8.04 (t, J=1.2 Hz, 2H), 7.21 (dd, J=17.8, 11.3 Hz, 1H), 6.48 (d, J=2.1 Hz, 2H), 5.38 (dd, J=11.3, 1.9 Hz, 1H), 5.15 (dd, J=17.8, 1.9 Hz, 1H), 3.46-3.38 (m, 4H), 3.14-3.06 (m, 2H), 3.01 (td, J=8.4, 1.2 Hz, 2H), 2.878 (s, 3H), 2.876 (s, 3H), 0.44 (s, 6H).

¹³C NMR (101 MHz, CDCl₃): δ 188.0, 154.6, 154.5, 141.1, 138.9, 138.8, 138.4, 134.1, 132.3, 131.3, 131.0, 126.0, 113.9, 107.8, 107.6, 55.3, 55.1, 35.0, 34.9, 29.2, 28.3, −1.0.

HRMS (ESI) m/z: [M+H]⁺ Calcd for C₂₃H₂₆N₂OSi: 375.1887, found: 375.1882.

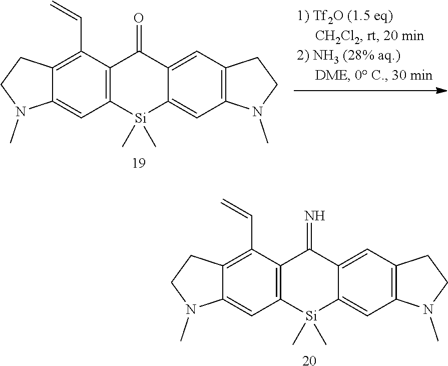

Compound 20. A solution of trifluoromethanesulfonic anhydride (Tf₂O, 1 M in CH₂Cl₂; 0.37 mL, ˜0.37 mmol, 1.5 equiv.) was added under argon atmosphere to the stirred solution of compound 19 (92 mg, 0.25 mmol) in dry CH₂Cl₂ (3 mL), cooled in ice-water bath, and the resulting dark blue solution was stirred at 0° C. for 20 min. It was then transferred dropwise into the stirred mixture of aqueous ammonia (28% aq., 2.5 mL) and 1,2-dimethoxyethane (DME, 5 mL), cooled in ice-water bath. The reaction mixture was stirred at 0° C. for 30 min, diluted with brine (230 mL), the product was then extracted with CH₂Cl₂ (3×20 mL) and the combined extracts were dried over Na₂SO₄. The product was isolated by flash column chromatography (12 g Interchim SiHP 30 μm cartridge, gradient 0% to 100% A/B, A=CH₂Cl₂— ethanol-25% aq. NH₃ 80:20:2, B═CH₂Cl₂) and freeze-dried from 1,4-dioxane to yield 19 mg (21%) of 20 as brown-orange solid.

¹H NMR (400 MHz, CDCl₃): δ 7.78 (s, 1H), 6.80 (dd, J=17.9, 11.5 Hz, 1H), 6.54 (d, J=6.5 Hz, 2H), 5.52 (dd, J=11.5, 1.6 Hz, 1H), 5.45 (dd, J=17.9, 1.6 Hz, 1H), 3.40-3.32 (m, 4H), 3.07 (t, J=8.2 Hz, 2H), 3.00 (t, J=8.5 Hz, 1H), 2.83 (s, 6H), 0.43 (s, 6H).

¹³C NMR (101 MHz, CDCl₃): δ 173.8, 153.8, 153.4, 137.1, 136.0, 135.6, 133.4, 132.5, 131.2, 123.6, 118.9, 108.73, 108.67, 55.8, 55.7, 35.7, 29.8, 29.3, 28.6, −1.8.

HRMS (ESI) m/z: [M+H]⁺ Calcd for C₂₃H₂₇N₃Si: 374.2047, found: 374.2062.

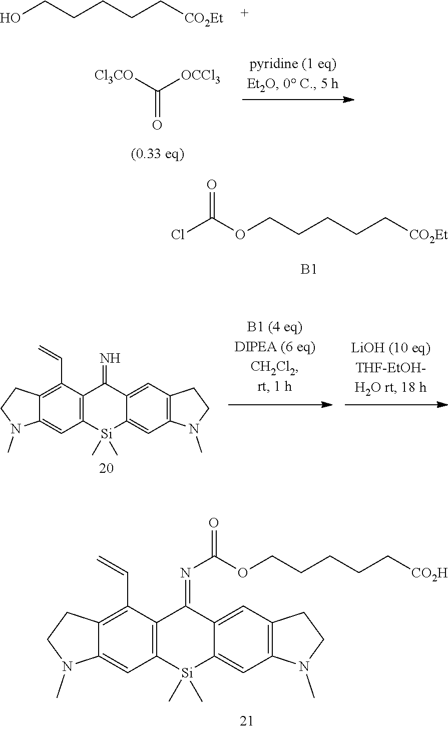

Compound 21. Chloroformate ester B1 was prepared according to the procedure from K. M. Anderson et al. Crystal Growth & Design 2006, 6(9), 2109-2113. Ethyl 6-hydroxyhexanoate (160 mg, 1 mmol) and pyridine (81 μL, 1 mmol, 1 equiv) were added to the stirred solution of triphosgene (99 mg, 0.33 mmol, 0.33 equiv) in dry diethyl ether (2 mL), cooled to 0° C. The reaction mixture was stirred at 0° C. for 5 h, the precipitate of pyridine hydrochloride was filtered off on a short plug of Celite, washed with dry diethyl ether (3 mL), the filtrate was evaporated and the residue was redissolved in dry CH₂Cl₂ (1 mL) and used directly in the next step.

The prepared solution of B1 in CH₂Cl₂ (0.2 mL, ˜0.2 mmol, ˜4 equiv) was added to the stirred solution of compound 20 (19 mg, 50.8 μmol) and DIPEA (50 μL, 0.29 mmol, ˜6 equiv) in dry CH₂Cl₂ (0.5 mL), and the resulting solution was stirred at rt for 1 h. The crude reaction mixture was evaporated, the residue was dissolved in the mixture of THF (1 mL) and ethanol (0.25 mL), and lithium hydroxide solution (21 mg of LiOH H₂O in 0.25 mL water, 0.5 mmol, 10 equiv) was added to the mixture, which was left stirring at rt for 18 h. Acetic acid (100 μL) was then added, and the reaction mixture was evaporated to dryness. The product was isolated by preparative HPLC (ThermoFisher Hypersil Gold C18 250×21.2 mm 5 m, solvent flow rate 18 mL/min, gradient 30% to 80% A:B, A-acetonitrile+0.1% (v/v) HCO₂H, B-water+0.1% (v/v) HCO₂H) and freeze-dried from dioxane to give 14 mg (52% over 2 steps) of 21 as brown solid.

¹H NMR (400 MHz, CDCl₃): δ 7.55 (s, 1H), 7.05 (dd, J=17.8, 11.5 Hz, 1H), 6.62 (s, 1H), 6.57 (s, 1H), 5.47 (dd, J=11.5, 1.6 Hz, 1H), 5.34 (dd, J=17.8, 1.6 Hz, 1H), 4.00 (t, J=6.1 Hz, 2H), 3.47-3.34 (m, 4H), 3.06 (t, J=8.1 Hz, 2H), 2.99 (t, J=8.2 Hz, 2H), 2.85 (s, 6H), 2.26 (t, J=7.4 Hz, 2H), 1.56-1.44 (m, 4H), 1.16-1.05 (m, 2H).

¹³C NMR (101 MHz, CDCl₃): 135.3, 123.7, 118.0, 110.0, 109.1, 65.5, 55.5, 35.5, 33.9, 29.0, 28.2, 28.1, 25.2, 24.5, −2.4 (indirect detection from a gHSQC experiment, only H-coupled carbons are resolved).

HRMS (ESI) m/z: [M+H]⁺ Calcd for C₃₀H₃₇N₃O₄Si: 532.2626, found: 532.2647.

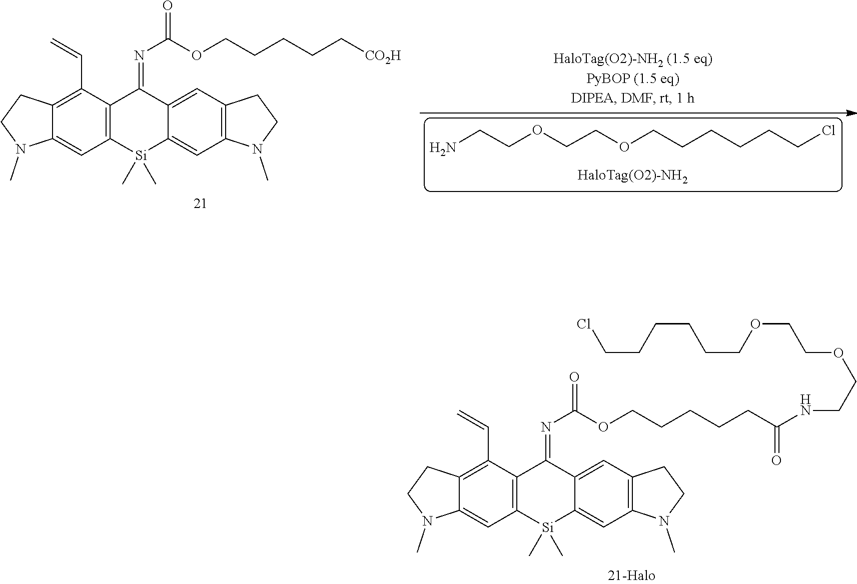 [SMILES: C=Cc1c2c(cc3c1/C(=N/C(=O)OCCCCCC(=O)O)c1cc4c(cc1[Si]3(C)C)N(C)CC4)N(C)CC2 ; NCCOCCOCCCCCCCl ; C=Cc1c2c(cc3c1/C(=N/C(=O)OCCCCCC(=O)NCCOCCOCCCCCCCl)c1cc4c(cc1[Si]3(C)C)N(C)CC4)N(C)CC2]

Compound 21-Halo. PyBOP solution (benzotriazol-1-yloxy-tris(pyrrolidino)phosphonium hexafluorophosphate; 10.4 mg in 100 μL DMF, 20.0 μmol, 1.5 equiv) was added to the stirred solution of compound 21 (7 mg, 13.2 μmol) and HaloTag(O2) amine hydrochloride (5.2 mg, 20.0 μmol, 1.5 equiv) in DMF (150 μL) and DIPEA (50 μL), and the reaction mixture was stirred at rt for 1.5 h. The organic solvents were evaporated in vacuo, and the product was isolated by preparative HPLC (ThermoFisher Hypersil Gold C18 250×21.2 mm 5 m, solvent flow rate 18 mL/min, gradient 30% to 90% A:B, A-acetonitrile+0.1% (v/v) HCO₂H, B-water+0.1% (v/v) HCO₂H) to give 8.3 mg (86%) of 21-Halo as viscous brown-yellow oil.

¹H NMR (400 MHz, CDCl₃): δ 7.61 (br.s, 1H), 7.05 (dd, J=17.8, 11.5 Hz, 1H), 6.62 (s, 1H), 6.59 (s, 1H), 6.26 (br.s, 1H), 5.47 (dd, J=11.5, 1.5 Hz, 1H), 5.34 (dd, J=17.8, 1.5 Hz, 1H), 4.01 (t, J=6.3 Hz, 2H), 3.65-3.50 (m, 8H), 3.50-3.34 (m, 8H), 3.07 (t, J=8.1 Hz, 2H), 3.00 (t, J=8.2 Hz, 2H), 2.87 (s, 6H), 2.10 (t, J=7.7 Hz, 2H), 1.82-1.71 (m, 2H), 1.66-1.32 (m, 10H), 1.22-1.08 (m, 2H), 0.47 (s, 6H).

¹³C NMR (101 MHz, CDCl₃): δ 135.2, 118.1, 109.9, 109.4, 71.4, 70.3, 70.1, 65.7, 55.6, 45.1, 39.3, 36.6, 35.6, 32.7, 29.6, 29.1, 28.5, 28.3, 26.7, 25.6, 25.4, −2.3 (indirect detection from a gHSQC experiment, only H-coupled carbons are resolved).

HRMS (ESI) m/z: [M+H]⁺ Calcd for C₄₀H₅₇ClN₄O₅Si: 737.3860, found: 737.3844.

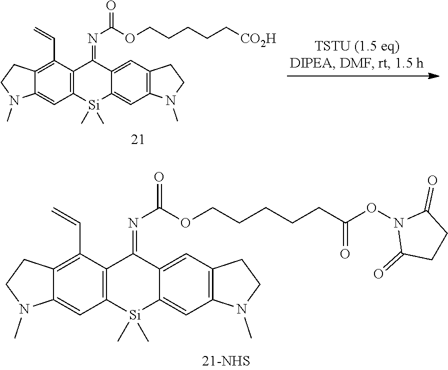 [SMILES: C=Cc1c2c(cc3c1/C(=N/C(=O)OCCCCCC(=O)O)c1cc4c(cc1[Si]3(C)C)N(C)CC4)N(C)CC2 ; C=Cc1c2c(cc3c1/C(=N/C(=O)OCCCCCC(=O)ON1C(=O)CCC1=O)c1cc4c(cc1[Si]3(C)C)N(C)CC4)N(C)CC2]

Compound 21-NHS. TSTU solution (N,N,N′,N′-tetramethyl-O—(N-succinimidyl)uronium tetrafluoroborate; 5.2 mg in 50 μL DMF, 17.2 μmol, 1.5 equiv) was added to the stirred solution of compound 21 (6.1 mg, 11.5 μmol) in DMF (150 μL) and DIPEA (50 μL), and the reaction mixture was stirred at rt for 1.5 h. The organic solvents were evaporated in vacuo, and the product was isolated by flash column chromatography (12 g Interchim SiHP 30 μm cartridge, gradient 30% to 100% EtOAc/hexane) and freeze-dried from 1,4-dioxane to yield 6.4 mg (89%) of 21-NHS as yellow solid.

HRMS (ESI) m/z: [M+H]⁺ Calcd for C₃₄H₄₀N₄O₆Si: 629.2790, found: 629.2782.

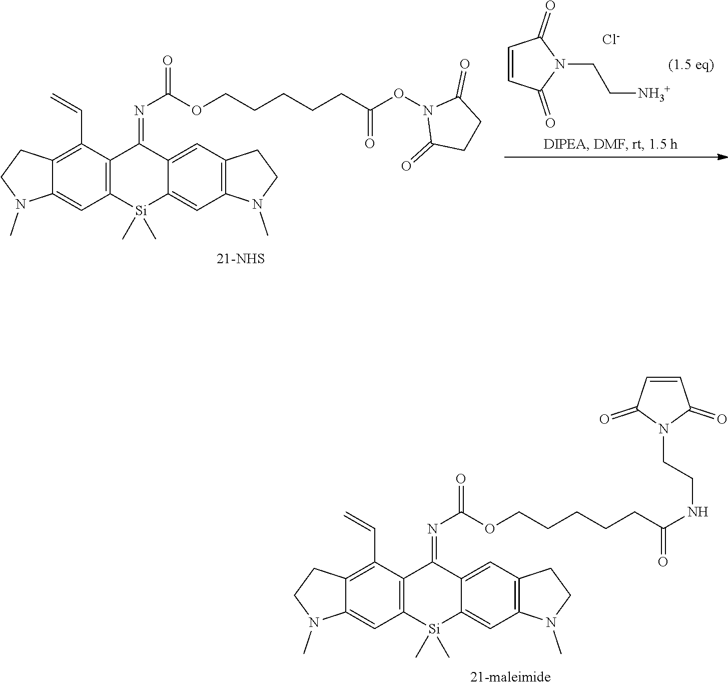 [SMILES: C=Cc1c2c(cc3c1/C(=N/C(=O)OCCCCCC(=O)ON1C(=O)CCC1=O)c1cc4c(cc1[Si]3(C)C)N(C)CC4)N(C)CC2 ; [NH3+]CCN1C(=O)C=CC1=O ; [Cl-] ; C=Cc1c2c(cc3c1/C(=N/C(=O)OCCCCCC(=O)NCCN1C(=O)C=CC1=O)c1cc4c(cc1[Si]3(C)C)N(C)CC4)N(C)CC2]

Compound 21-maleimide. A solution of compound 21-NHS (5.7 mg, 9.1 μmol), 1-(2-aminoethyl)maleimide hydrochloride (2.4 mg, 13.6 μmol, 1.5 equiv) in DMF (200 μL) and DIPEA (50 μL) was stirred at rt for 1.5 h. The organic solvents were evaporated in vacuo, and the product was isolated by preparative HPLC (ThermoFisher Hypersil Gold C18 250×21.2 mm m, solvent flow rate 18 mL/min, gradient 30% to 80% A:B, A-acetonitrile+0.1% (v/v) HCO₂H, B-water+0.1% (v/v) HCO₂H) to give 2.1 mg (35%) of 21-maleimide as yellow solid.

HRMS (ESI) m/z: [M+H]⁺ Calcd for C₃₆H₄₃N₅O₅Si: 654.3106, found: 654.3101.

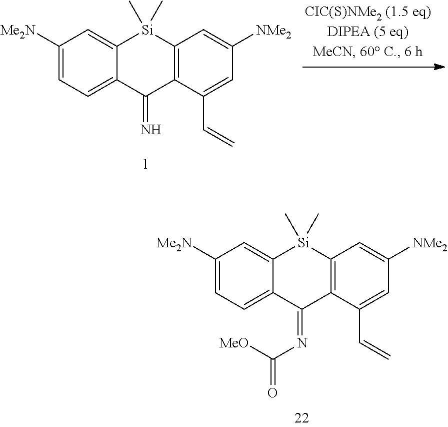 [SMILES: C=Cc1cc(N(C)C)cc2c1C(=N)c1ccc(N(C)C)cc1[Si]2(C)C ; C=Cc1cc(N(C)C)cc2c1/C(=N/C(=O)OC)c1ccc(N(C)C)cc1[Si]2(C)C]

Compound 22. Dimethylthiocarbamoyl chloride (16 mg in 0.5 mL dry acetonitrile, 0.128 mmol, 1.5 equiv) was added to the mixture of compound 1 (30 mg, 85.7 μmol) and N,N-diisopropylethylamine (DIPEA; 74 μL, 0.429 mmol, 5 equiv), and the resulting solution was stirred at 60° C. for 6 h. The solvents were evaporated, and the product was isolated by preparative HPLC (ThermoFisher Hypersil Gold C18 250×20 mm 5 m, solvent flow rate 18 mL/min, gradient 30% to 90% A:B, A-acetonitrile+0.1% (v/v) HCO₂H, B-water+0.1% (v/v) HCO₂H) and freeze-dried from dioxane to give 5 mg (13%) of 22 as brown-orange solid.

¹H NMR (400 MHz, CDCl₃): δ 8.10 (d, J=8.8 Hz, 1H), 7.53 (dd, J=17.3, 10.9 Hz, 1H), 7.03-6.71 (m, 5H), 5.60 (dd, J=17.3, 1.4 Hz, 1H), 5.30 (dd, J=10.9, 1.4 Hz, 1H), 3.40 (s, 3H), 3.06 (s, 6H), 3.04 (s, 6H), 3.01 (s, 3H), 0.50 (s, 6H).

¹³C NMR (101 MHz, CDCl₃) δ 138.7, 129.1, 116.4, 115.9, 113.7, 113.2, 41.9, 40.5, 40.1, −1.8 (indirect detection from a gHSQC experiment, only H-coupled carbons are resolved).

HRMS (ESI) m/z: [M+H]⁺ Calcd for C₂₄H₃₂N₄SSi: 437.2190, found: 437.2199.

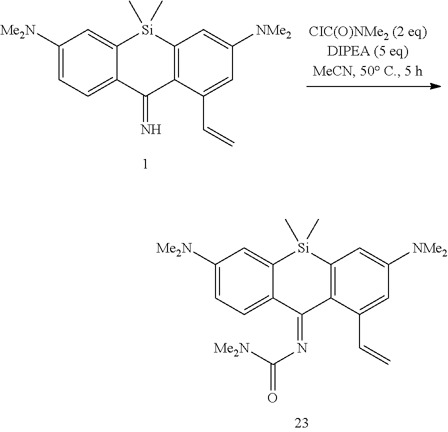 [SMILES: C=Cc1cc(N(C)C)cc2c1C(=N)c1ccc(N(C)C)cc1[Si]2(C)C ; C=Cc1cc(N(C)C)cc2c1/C(=N/C(=O)N(C)C)c1ccc(N(C)C)cc1[Si]2(C)C]

Compound 23. Dimethylcarbamoyl chloride (16 μL, 0.171 mmol, 2 equiv) was added to the mixture of compound 1 (30 mg, 85.7 μmol) and N,N-diisopropylethylamine (DIPEA; 74 μL, 0.429 mmol, 5 equiv) in dry acetonitrile (0.5 mL), and the resulting solution was stirred at 50° C. for 5 h. The solvents were evaporated, and the product was isolated by preparative HPLC (ThermoFisher Hypersil Gold C18 250×20 mm 5 m, solvent flow rate 18 mL/min, gradient 30% to 80% A:B, A-acetonitrile+0.1% (v/v) HCO₂H, B-water+0.1% (v/v) HCO₂H) and freeze-dried from dioxane to give 26 mg (72%) of 23 as light brown solid.

¹H NMR (400 MHz, CDCl₃): δ 7.81 (d, J=8.8 Hz, 1H), 7.44 (dd, J=17.3, 10.8 Hz, 1H), 6.91 (d, J=2.8 Hz, 1H), 6.84 (d, J=2.8 Hz, 1H), 6.82 (d, J=2.8 Hz, 1H), 6.69 (dd, J=8.8, 2.8 Hz, 1H), 5.63 (dd, J=17.3, 1.5 Hz, 1H), 5.26 (dd, J=10.8, 1.5 Hz, 1H), 3.04 (s, 6H), 3.01 (s, 6H), 2.91 (s, 3H), 2.72 (s, 3H), 0.47 (s, 6H).

¹³C NMR (101 MHz, CDCl₃): δ 166.1, 164.5, 150.1, 150.0, 138.4, 138.3, 137.9, 137.2, 132.5, 131.5, 128.7, 115.3, 115.1, 113.6, 112.9, 112.1, 40.4, 40.2, 37.1, 35.7, −1.7.

HRMS (ESI) m/z: [M+H]⁺ Calcd for C₂₄H₃₂N₄OSi 421.2418; Found 421.2428.

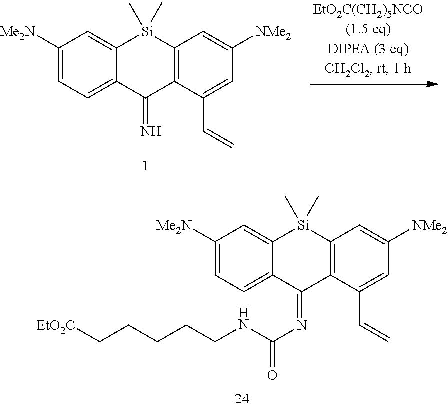 [SMILES: C=Cc1cc(N(C)C)cc2c1C(=N)c1ccc(N(C)C)cc1[Si]2(C)C ; C=Cc1cc(N(C)C)cc2c1/C(=N/C(=O)NCCCCCC(=O)OCC)c1ccc(N(C)C)cc1[Si]2(C)C]

Compound 24. Ethyl 6-isocyanatohexanoate (36 μL, 0.19 mmol, 1.5 equiv) was added to the stirred mixture of compound 1 (45 mg, 0.13 mmol) and DIPEA (68 μL, 0.39 mmol, 3 equiv) in dry CH₂Cl₂ (0.9 mL), and the resulting solution was stirred at rt for 1 h. The crude reaction mixture was evaporated on Celite, the product was isolated by flash column chromatography (12 g Interchim SiHP 30 μm cartridge, gradient 0% to 50% EtOAc/CH₂Cl₂) and freeze-dried from 1,4-dioxane to yield 52 mg (76%) of 24 as light tan solid.

¹H NMR (400 MHz, CD₃CN): 7.68 (d, J=8.8 Hz, 1H), 7.44-7.30 (m, 1H), 6.95-6.90 (m, 3H), 6.70 (dd, J=8.8, 2.8 Hz, 1H), 5.65 (dd, J=17.4, 1.5 Hz, 1H), 5.61 (t, J=5.2 Hz, 1H), 5.17 (dd, J=11.0, 1.5 Hz, 1H), 4.06 (q, J=7.1 Hz, 2H), 3.06 (q, J=6.5 Hz, 2H), 3.02 (s, 6H), 2.98 (s, 6H), 2.19 (t, J=7.6 Hz, 2H), 1.48 (p, J=7.6 Hz, 2H), 1.43-1.34 (m, 2H), 1.20 (t, J=7.1 Hz, 3H), 1.16-1.07 (m, 2H), 0.46 (s, 6H).

¹³C NMR (101 MHz, CD₃CN): δ 174.3, 164.8, 151.2, 151.0, 138.9, 138.4, 138.3, 132.3, 129.1, 116.5, 116.0, 113.7, 113.1, 111.8, 60.8, 40.5, 40.4, 40.3, 34.7, 30.1, 26.9, 25.5, 14.6, −2.3.

HRMS (ESI) m/z: [M+H]⁺ Calcd for C₃₀H₄₂N₄O₃Si: 535.3099, found: 535.3092.

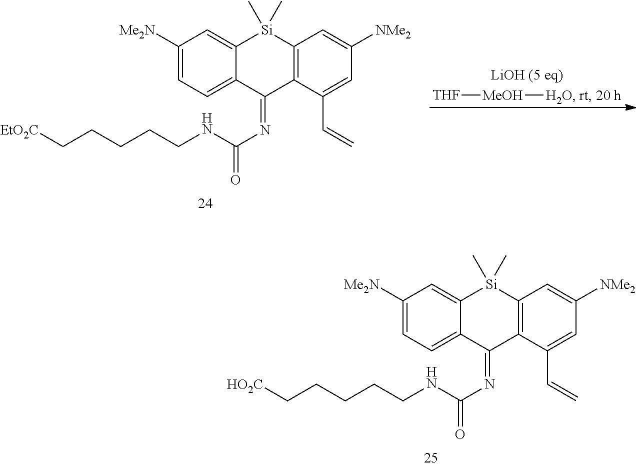

Compound 25. Lithium hydroxide solution (12 mg of LiOH H₂O in 0.5 mL water, 0.28 mmol, 5 equiv) was added to the stirred solution of compound 24 (30 mg, 56 μmol) in THE (2 mL) and methanol (0.5 mL), and the reaction mixture was left stirring overnight (20 h). The organic solvents were evaporated, and the product was isolated by preparative HPLC (Interchim Uptisphere Strategy PhC4 250×21.2 mm 5 m, solvent flow rate 18 mL/min, gradient 30% to 70% A:B, A-acetonitrile+0.1% (v/v) HCO₂H, B-water+0.1% (v/v) HCO₂H) and freeze-dried from dioxane to give 26 mg (91%) of 25 as brown-yellow solid.

¹H NMR (400 MHz, DMSO-d₆): δ 12.0 (br.s, 1H), 7.66 (d, J=8.8 Hz, 1H), 7.49-7.34 (m, 1H), 7.09 (t, J=5.8 Hz, 1H), 6.93-6.85 (m, 3H), 6.67 (dd, J=8.8, 2.8 Hz, 1H), 5.66 (dd, J=17.3, 1.5 Hz, 1H), 5.16 (dd, J=10.8, 1.5 Hz, 1H), 3.00 (s, 6H), 2.95 (s, 6H), 2.14 (t, J=7.4 Hz, 2H), 1.49-1.30 (m, 4H), 1.18-1.07 (m, 2H), 0.45 (s, 6H).

¹³C NMR (101 MHz, DMSO-d₆): δ 174.5, 163.4, 149.8, 149.5, 137.7, 137.5, 137.1, 136.6, 131.4, 128.0, 115.4, 114.9, 113.3, 112.0, 110.3, 33.7, 29.2, 26.0, 24.4, −2.4.

HRMS (ESI) m/z: [M+H]⁺ Calcd for C₂₈H₃₈N₄O₃Si 507.2786; Found 507.2778.

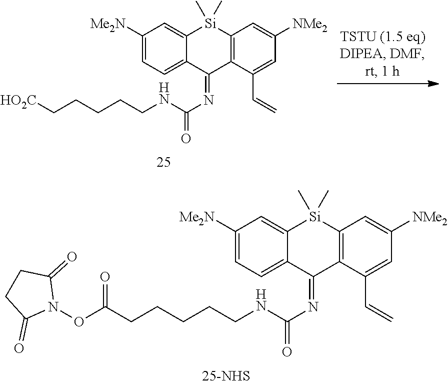 [SMILES: C=Cc1cc(N(C)C)cc2c1/C(=N/C(=O)NCCCCCC(=O)O)c1ccc(N(C)C)cc1[Si]2(C)C ; C=Cc1cc(N(C)C)cc2c1/C(=N/C(=O)NCCCCCC(=O)ON1C(=O)CCC1=O)c1ccc(N(C)C)cc1[Si]2(C)C]

Compound 25-NHS. TSTU solution (N,N,N′,N′-tetramethyl-O—(N-succinimidyl)uronium tetrafluoroborate; 8.4 mg in 100 μL DMF, 28 μmol, 1.5 equiv) was added to the stirred solution of compound 25 (10 mg, 18.7 μmol) in DMF (100 μL) and DIPEA (50 μL), and the reaction mixture was stirred at rt for 1 h. The organic solvents were evaporated in vacuo, and the product was isolated by flash column chromatography (12 g Interchim SiHP 30 μm cartridge, gradient 5% to 70% EtOAc/CH₂Cl₂) and freeze-dried from 1,4-dioxane to yield 11 mg (97%) of 25-NHS as yellow solid.

¹H NMR (400 MHz, CD₃CN): δ 7.69 (d, J=8.8 Hz, 1H), 7.35 (dd, J=17.3, 10.7 Hz, 1H), 6.96-6.90 (m, 3H), 6.71 (dd, J=8.8, 2.8 Hz, 1H), 5.65 (dd, J=17.3, 1.5 Hz, 1H), 5.61 (t, J=5.6 Hz, 1H), 5.18 (dd, J=10.7, 1.5 Hz, 1H), 3.08 (q, J=6.5 Hz, 2H), 3.02 (s, 6H), 2.99 (s, 6H), 2.76 (s, 4H), 2.53 (t, J=7.5 Hz, 2H), 1.61 (p, J=7.6 Hz, 2H), 1.41 (dt, J=14.6, 6.8 Hz, 2H), 1.23-1.14 (m, 2H), 0.46 (s, 6H).

¹³C NMR (101 MHz, CD₃CN): δ 139.0, 129.3, 116.6, 116.1, 114.0, 113.2, 112.0, 40.48, 40.44, 40.40, 31.4, 30.1, 26.6, 26.4, 25.2, −2.1 (indirect detection from a gHSQC experiment, only H-coupled carbons are resolved).

HRMS (ESI) m/z: [M+H]⁺ Calcd for C₃₂H₄₁N₅O₅Si 604.2950; Found 604.2942.

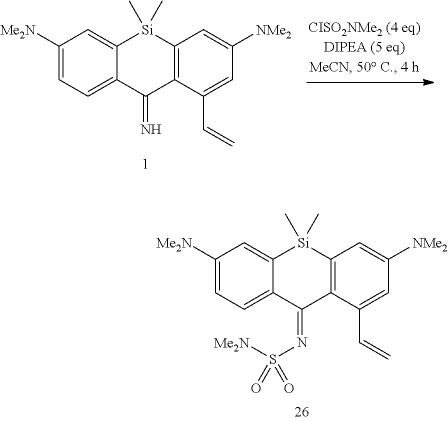 [SMILES: C=Cc1cc(N(C)C)cc2c1C(=N)c1ccc(N(C)C)cc1[Si]2(C)C ; C=Cc1cc(N(C)C)cc2c1/C(=N/S(=O)(=O)N(C)C)c1ccc(N(C)C)cc1[Si]2(C)C]

Compound 26. N,N-Dimethylsulfamoyl chloride (31 μL, 0.286 mmol, 4 equiv) was added to the mixture of compound 1 (25 mg, 71.4 μmol) and N,N-diisopropylethylamine (DIPEA; 62 μL, 0.357 mmol, 5 equiv) in dry acetonitrile (0.4 mL), and the resulting solution was stirred at 50° C. for 4 h. The solvents were evaporated, and the product was isolated by preparative HPLC (ThermoFisher Hypersil Gold C18 250×20 mm 5 m, solvent flow rate 18 mL/min, gradient 30% to 90% A:B, A-acetonitrile+0.1% (v/v) HCO₂H, B-water+0.1% (v/v) HCO₂H) and freeze-dried from dioxane to give 6 mg (18%) of 26 as orange-yellow solid.

¹H NMR (400 MHz, CDCl₃): δ 8.02 (d, J=8.8 Hz, 1H), 7.36 (dd, J=17.2, 10.8 Hz, 1H), 6.86 (d, J=2.7 Hz, 1H), 6.82 (app. t, J=2.5 Hz, 2H), 6.74 (dd, J=8.8, 2.8 Hz, 1H), 5.58 (dd, J=17.2, 1.5 Hz, 1H), 5.22 (dd, J=10.8, 1.5 Hz, 1H), 3.06 (s, 6H), 3.04 (s, 6H), 2.72 (s, 6H), 0.48 (s, 6H).

¹³C NMR (101 MHz, CDCl₃): δ 176.6, 150.8, 150.2, 139.1, 138.9, 138.4, 137.9, 131.9, 131.5, 130.7, 114.8, 114.5, 113.6, 111.8, 111.6, 40.3, 40.1, 38.8, −2.6.

HRMS (ESI) m/z: [M+H]⁺ Calcd for C₂₃H₃₂N₄O₂SSi 457.2088; Found 457.2097.

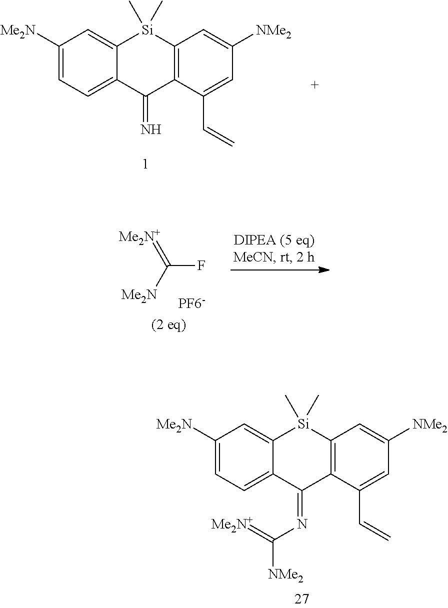

Compound 27. Fluoro-N,N,N′,N′-tetramethylformamidinium hexafluorophosphate (TFFH; 38 mg, 0.143 mmol, 2 equiv) was added to the mixture of 1 (25 mg, 71.4 μmol) and N,N-diisopropylethylamine (DIPEA; 62 μL, 0.357 mmol, 5 equiv) in dry acetonitrile (0.4 mL), and the resulting solution was stirred at rt for 2 h. The solvents were evaporated, and the product was isolated by preparative HPLC (ThermoFisher Hypersil Gold C18 250×20 mm 5 μm, solvent flow rate 18 mL/min, gradient 30% to 90% A:B, A-acetonitrile+0.1% (v/v) HCO₂H, B-water+0.1% (v/v) HCO₂H) and freeze-dried from aq. dioxane to give 27 mg (64%) of 27 as orange solid.

¹H NMR (400 MHz, CDCl₃+10% (v/v) DMSO-d₆): δ 7.28 (dd, J=17.3, 10.8 Hz, 1H), 7.22 (d, J=9.0 Hz, 1H), 6.96 (dd, J=9.0, 2.8 Hz, 1H), 6.86 (d, J=2.8 Hz, 1H), 6.82 (d, J=2.8 Hz, 1H), 6.79 (d, J=2.8 Hz, 1H), 5.51 (dd, J=17.3, 1.3 Hz, 1H), 5.21 (dd, J=10.8, 1.3 Hz, 1H), 3.15 (s, 6H), 3.13 (s, 6H), 2.95 (s, 12H), 0.49 (s, 6H).

¹³C NMR (101 MHz, CDCl₃+10% (v/v) DMSO-d₆): δ 176.1, 166.6, 151.6, 151.0, 142.6, 140.3, 140.2, 139.1, 129.7, 127.6, 127.0, 115.8, 115.0, 113.9, 113.71, 113.68, 41.0, 39.9, 39.8, −1.0.

¹⁹F NMR (376 MHz, CDCl₃) δ −73.1 (d, J=712.0 Hz, PF₆⁻).

HRMS (ESI) m/z: [M]⁺ Calcd for C₂₆H₃₈N₅Si 448.2891; Found 448.2886.

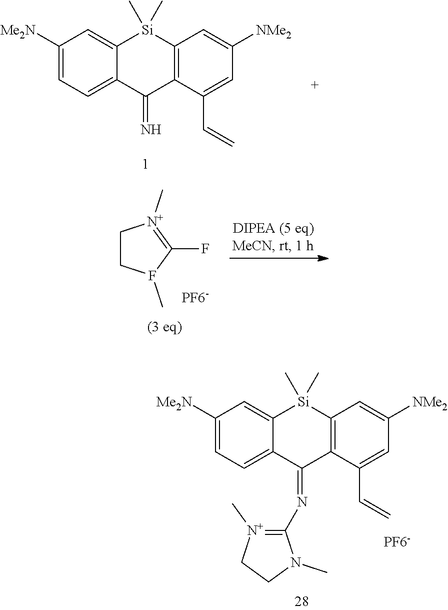

Compound 28. 2-Fluoro-1,3-dimethylimidazolidinium hexafluorophosphate (68 mg, 0.258 mmol, 3 equiv) was added to the mixture of compound 1 (35 mg, 85.7 μmol) and N,N-diisopropylethylamine (DIPEA; 74 μL, 0.429 mmol, 5 equiv) in dry acetonitrile (0.5 mL), and the resulting solution was stirred at rt for 1 h. The solvents were evaporated, and the product was isolated by preparative HPLC (ThermoFisher Hypersil Gold C18 250×20 mm 5 m, solvent flow rate 18 mL/min, gradient 30% to 80% A:B, A-acetonitrile+0.1% (v/v) HCO₂H, B-water+0.1% (v/v) HCO₂H) and freeze-dried from aq. dioxane to give 35 mg (69%) of 28 as orange solid.

¹H NMR (400 MHz, CDCl₃) δ 7.55 (d, J=9.0 Hz, 1H), 6.99 (dd, J=17.4, 10.8 Hz, 1H), 6.92 (dd, J=9.0, 2.8 Hz, 1H), 6.84-6.78 (m, 3H), 5.65 (dd, J=17.4, 1.1 Hz, 1H), 5.24 (dd, J=10.8, 1.1 Hz, 1H), 3.86-3.79 (m, 2H), 3.77-3.67 (m, 2H), 3.14 (s, 6H), 3.12 (s, 6H), 2.72 (s, 6H), 0.47 (s, 6H).

¹³C NMR (101 MHz, CDCl₃): δ 175.5, 162.5, 151.8, 151.2, 141.1, 139.9, 138.8, 138.7, 130.0, 128.9, 126.9, 115.3, 115.2, 115.0, 113.8, 113.4, 48.4, 40.1, 32.9, −1.4.

¹⁹F NMR (376 MHz, CDCl₃) δ −73.4 (d, J=712.4 Hz, PF₆⁻).

HRMS (ESI) m/z: [M]⁺ Calcd for C₂₆H₃₆N₅Si 446.2734; Found 446.2726.

### EXAMPLE 2

### Characterisation of Exemplary Compounds of the Present Invention

### General Materials and Methods

All chemical reagents (TCI, Sigma-Aldrich, Alfa Aesar) and dry solvents for synthesis (over molecular sieves, AcroSeal package, Acros Organics) were purchased from reputable suppliers and were used as received without further purification. The products were lyophilized from a suitable solvent system using Alpha 2-4 LDplus freeze-dryer (Martin Christ Gefriertrocknungsanlagen GmbH).

### Thin Layer Chromatography

Normal phase TLC was performed on silica gel 60 F₂₅₄ (Merck Millipore, Germany). For TLC on reversed phase silica gel 60 RP-18 F₂₅₄s (Merck Millipore) was used. Compounds were detected by exposing TLC plates to UV-light (254 or 366 nm) or heating with vanillin stain (6 g vanillin and 1.5 mL conc. H₂SO₄ in 100 mL ethanol), unless indicated otherwise.

### Flash Chromatography

Preparative flash chromatography was performed with an automated Isolera One system with Spektra package (Biotage AG) using commercially available cartridges of suitable size as indicated (RediSep Rf series from Teledyne ISCO, Puriflash Silica HP 30 μm series from Interchim).

Nuclear Magnetic Resonance (NMR) NMR spectra (¹H, ¹³C{¹H}, ¹⁹F) were recorded on a Bruker DPX 400 spectrometer. All spectra are referenced to tetramethylsilane as an internal standard (δ=0.00 ppm). Multiplicities of the signals are described as follows: s=singlet, d=doublet, t=triplet, q=quartet, m=multiplet or overlap of non-equivalent resonances; br=broad signal. Coupling constants ⁿJ_{X-Y} are given in Hz, where n is the number of bonds between the coupled nuclei X and Y (J_{H—H} are always listed as i without indices).

### Mass-Spectrometry (MS)

Low resolution mass spectra (100-1500 m/z) with electro-spray ionization (ESI) were obtained on a Shimadzu LC-MS system described below. High resolution mass spectra (HRMS) were obtained on a maXis II ETD (Bruker) with electrospray ionization (ESI) at the Mass Spectrometry Core facility of the Max-Planck Institute for Medical Research (Heidelberg, Germany).

### High-Performance Liquid Chromatography (HPLC)

Analytical liquid chromatography-mass spectrometry was performed on an LC-MS system (Shimadzu): 2× LC-20AD HPLC pumps with DGU-20A3R solvent degassing unit, SIL-20ACHT autosampler, CTO-20AC column oven, SPD-M30A diode array detector and CBM-20A communication bus module, integrated with CAMAG TLC-MS interface 2 and LCMS-2020 spectrometer with electrospray ionization (ESI, 100-1500 m/z). Analytical column: Hypersil GOLD 50×2.1 mm 1.9 μm, standard conditions: sample volume 1-2 μL, solvent flow rate 0.5 mL/min, column temperature 30° C. General method: isocratic 95:5 A:B over 2 min, then gradient 95:5→0:100 A:B over 5 min, then isocratic 0:100 A:B over 2 min; solvent A=water+0.1% v/v HCO₂H, solvent B=acetonitrile+0.1% v/v HCO₂H.

Preparative high-performance liquid chromatography was performed on a Buchi Reveleris Prep system using the suitable preparative columns and conditions as indicated for individual preparations. Method scouting was performed on a HPLC system (Shimadzu): 2×LC-20AD HPLC pumps with DGU-20A3R solvent degassing unit, CTO-20AC column oven equipped with a manual injector with a 20 μL sample loop, SPD-M20A diode array detector, RF-20A fluorescence detector and CBM-20A communication bus module; or on a Dionex Ultimate 3000 UPLC system: LPG-3400SD pump, WPS-3000SL autosampler, TCC-3000SD column compartment with 2×7-port 6-position valves and DAD-3000RS diode array detector. The test runs were performed on analytical columns with matching phases (HPLC: Interchim 250×4.6 mm 10 μm C18HQ, Interchim 250×4.6 mm 5 μm PhC4, solvent flow rate 1.2 mL/min; UPLC: Interchim C18HQ or PhC4 75×2.1 mm 2.2 μm, ThermoFisher Hypersil GOLD 100×2.1 mm 1.9 am, solvent flow rate 0.5 mL/min).

### Confocal and STED (Stimulated Emission Depletion) Microscopy

Confocal and STED images were acquired using two Abberior Expert Line (Abberior Instruments GmbH, Göttingen, Germany) fluorescence microscopes built on a motorized inverted microscope IX83 (Olympus, Tokyo, Japan). Microscope 1 is equipped with pulsed STED lasers at 595 nm and 775 nm shaped by Spatial Light Modulators (SLMs), and with 355 nm, 405 nm, 485 nm, 561 nm, and 640 nm excitation lasers, and a 100×/1.40 oil immersion objective lens (Olympus). Microscope 2 is equipped with pulsed STED lasers at 655 nm and 775 nm, and with 520 nm, 561 nm, 640 nm, and multiphoton (Chameleon Vision II, Coherent, Santa Clara, USA) excitation lasers, and a 60×/1.42 oil immersion objective lens (Olympus). The multiphoton laser is tuneable in the 680 nm-1080 nm range. Spectral detection is performed in both cases with avalanche photodiodes at spectral windows adjusted for each particular fluorophore.

Imaging and image processing was done with ImSpector software (v. 16.3.13367; Abberior Instruments GmbH, Göttingen, Germany), and all images are displayed as raw data unless otherwise noted.

### Superresolution Single Molecule Localization Microscopy (SMLM)

SMLM/PALM images were acquired using an ONI Nanoimager V3 (Oxford Nanoimaging, Oxford, UK). The 405 nm activation laser was applied as CW illumination. All images were analyzed and processed using the ThunderSTORM plugin [M. Ovesný et al. Bioinformatics, 2014, 30(16), 2389-2390] on Image J (version 1.52p) or using the ONI Nanoimager™ Software, Development build: Apr. 9 2023 22:54:56 Version: 1.19.7.20230409223555-28f00b5.

### MINFLUX Imaging

For MINFLUX imaging an Abberior 3D MINFLUX microscope (Abberior Instruments GmbH, Göttingen, Germany) was used. Details of the instrument are described in [Schmidt et al. Nat. Comm., 2021, 12, 1478]. The microscope, built on an Olympus IX83 body with a 60×UPLXAPO60XO oil objective, was equipped with a 640 nm excitation laser, a 405 nm activation laser, 488 nm and 560 nm confocal lasers, a 980 nm stabilization laser and an xyz piezo stage (Piezoconcept) for active sample stabilization.

For acquisition the pinhole was set to 0.83 AU and signal was detected on APDs in the spectral window of Cy5 (650-720 nm). The excitation power was set to initially 33 μW in the sample position for 2D imaging and to 56 μW for 3D imaging. The activation 405 nm laser was attenuated with an additional ND2 filter. Activation was switched on and the power was gradually increased up to 1.1 μW, sustaining the frequency of detected events, until the events became sparse in time and the imaging was stopped.

MINFLUX imaging was performed with modified imaging sequences based on the standard imaging sequences provided by the manufacturer. Images were post-processed and analyzed with a custom-built MATLAB (2022a, MathWorks) routine according to [Remmel et al. Small Methods. 2024, 8, 2301497].

### EXAMPLE 3

### Photolysis of the Exemplary Novel Compounds of the Invention and Chemometric Analysis of the Photoactivation and Photobleaching Reaction Kinetics

Solutions in phosphate buffer (100 mM, pH=7.0, 5.0 μM dye) were irradiated in a previously described home-built setup [K. Uno et al. Adv. Opt. Mater. 2019, 7, 1801746] with a 405 nm LED source (M405L3, Thorlabs Inc.) in combination with a 10 nm bandpass filter (FB405-10, Thorlabs Inc.). During the irradiation, samples were maintained at 20° C. and continuously stirred. The absorption and emission of irradiated solutions was monitored at desired irradiation intervals. For such purpose, excitation was performed with an LED emitting at a wavelength suitable for each compound (e.g. 625 nm). Photobleaching reactions were performed in the same setup using a 625 nm LED source (M625L4, Thorlabs Inc.). Photobleaching quantum yields were calculated as previously described in [R. Lincoln et al. Nat. Chem. 2022, 14, 1013-1020; R. Lincoln et al. WO2023/284968A1].

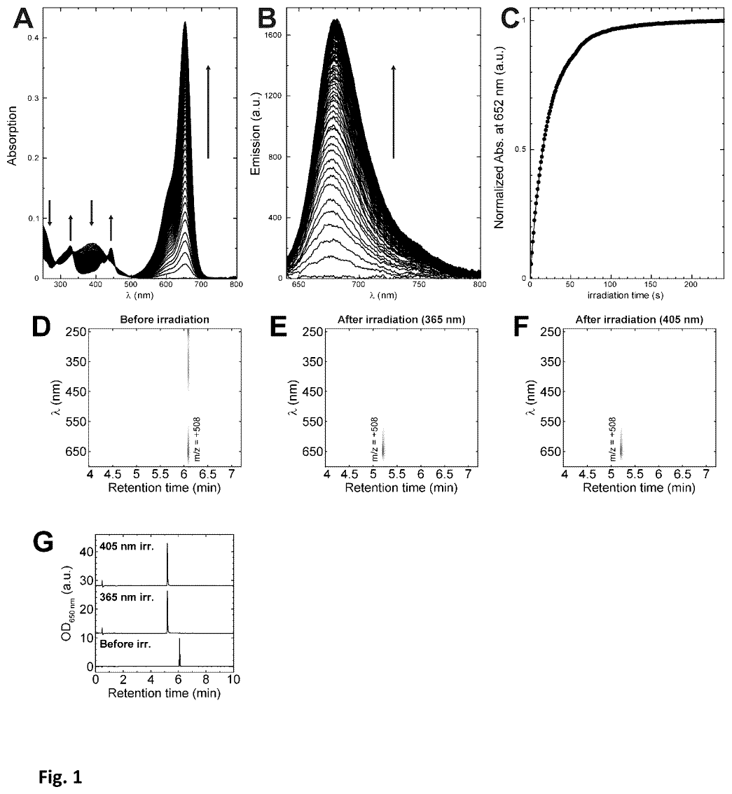

FIG. 1 shows absorption (A) and emission (B) changes during photo-induced activation of compound 4 with ultra-violet light (365 nm) in an aqueous buffered solution at pH 7 (phosphate buffer, 100 mM) and the change in absorption at the maximum (C); HPLC 2D-maps of absorption spectra vs. retention time for samples of the solution before (D) and after the photo-induced activation with 365 nm (E) or 405 nm (F) light; and chromatograms (G) of these samples at the wavelengths corresponding to the respective absorption maxima.

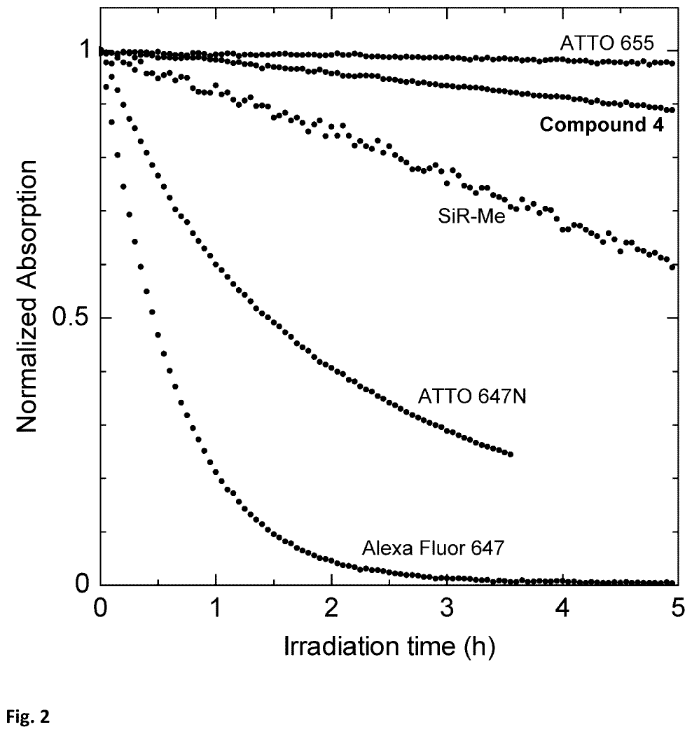

FIG. 2 shows photo-fatigue resistance of compound 4 and established commercial fluorophores to excitation light (640 nm) in an aqueous buffered solution at pH 7 (phosphate buffer, 100 mM). The measurement was performed as previously described in [R. Lincoln et al. Nat. Chem. 2022, 14, 1013-1020; R. Lincoln et al. WO2023/284968A1].

### EXAMPLE 4

### Live and Fixed Cell Optical Microscopy of Cells Using Exemplary Novel Dyes of the Invention with Self-Labelling Enzymes

The entire sample preparation procedure was conducted under red light (generic 12 V red LED strips, IP65 waterproof, 620-640 nm). Stocks solutions of SNAP-tag ligand (4-BG) or HaloTag ligand derivatives of the compounds (4-Halo, 21-Halo) were prepared in DMSO (500 μM-5 mM). U-2 OS cells that stably expressed Vimentin-HaloTag [Ratz et al. Sci. Rep. 2015, 5, 9592; Butkevich et al. ACS Chem. Biol. 2018, 13(2), 475-480] or HeLa cells that stably expressed COX8A-SNAP-tag8 [Stephan et al. Sci. Rep. 2019, 9, 12419] were grown for 12-72 h on glass coverslips. Cells were incubated in the dark for 30 min to overnight (depending on the dye and experiment) with the respective fluorescent ligands diluted from DMSO stock solutions with culture medium (without phenol red) to a final concentration of 500 nm-1 μM. After labeling with dyes, the samples were protected from the ambient light. Cells were washed twice with cell culture medium for ca. 15-30 minutes; then the medium was changed for fresh media for live-cell imaging or fixed as described below.

For live-cell imaging cells were mounted in a live-cell chamber (CM-B18-1, Live Cell Instrument Co.) with Fluorobrite (A1896701, Gibco) supplemented with 10% (v/v) FBS (10500064, ThermoFisher), 2% (v/v) GlutaMAX (35050061, Gibco) and 1% (v/v) penicillin/streptomycin.

PFA fixation for preservation of vimentin filaments was performed with a 4% formaldehyde solution in PBS (pH 7.4) at room temperature for 25 min, rinsed with a quenching solution (QS, 0.1 M NH₄Cl and 0.1 M glycine in PBS) and then incubated with QS for 10 min at room temperature then washed with PBS.

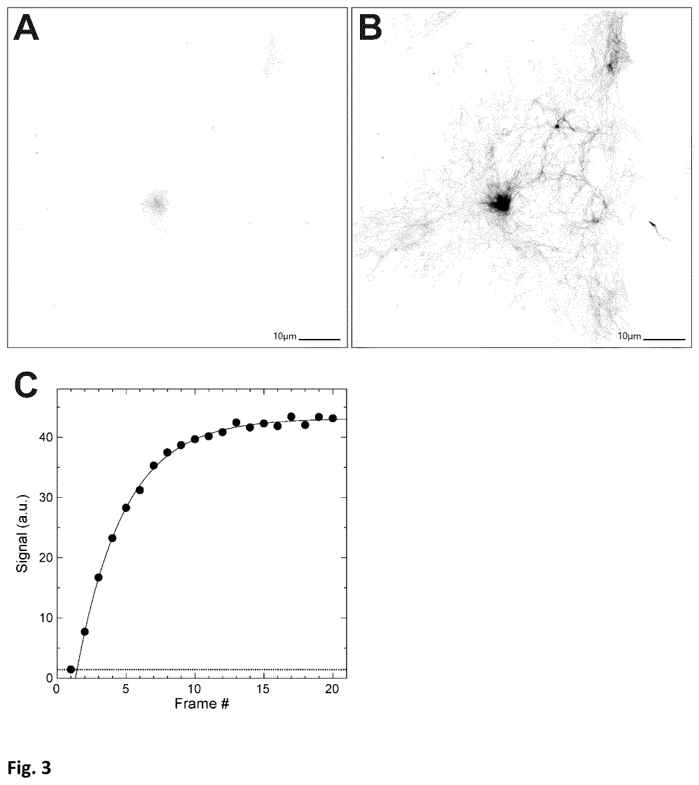

FIG. 3 shows live-cell confocal image of vimentin filaments labelled with compound 4-Halo in U2OS cells before (A) and after (B) photoactivation by irradiation with a 405 nm laser and the corresponding change in fluorescence intensity of the field of view upon photoactivation (C).

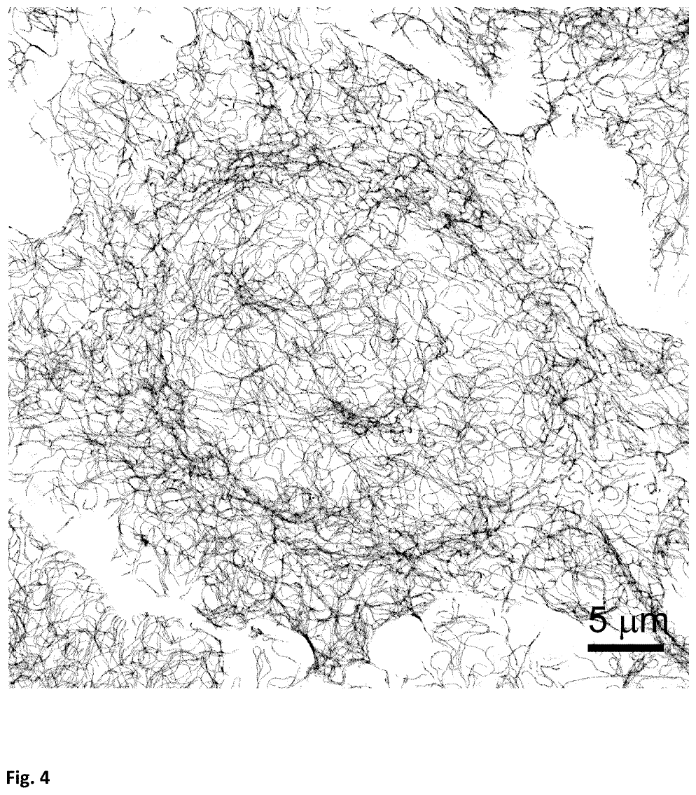

FIG. 4 shows single molecule localization microscopy super-resolution image of fixed U-2 OS cells stably expressing a vimentin-HaloTag construct labelled with 4-Halo.

### EXAMPLE 5

### Multiplexing of Two Photoactivatable Dyes in Single Molecule Localization Microscopy by Selective Photoactivation

HeLa cells that stably expressed COX8A-SNAP were labelled with 4-BG as described in Example 4 above. For preservation of mitochondria cristae, cells were fixed with warm 8% formaldehyde solution in PBS (pH 7.4) at 37 degrees for 7 minutes, and permeabilized with 0.5% Triton X-100 in PBS at room temperature for 10 minutes. To reduce unspecific binding, blocking buffer (5% BSA in PBS) was added and incubated for 10 minutes at room temperature, then washed with PBS. The coverslips were overlaid with the primary antibody for TOMM20 (from rabbit) in blocking buffer and incubated in a humid chamber for 1 h at room temperature and then washed with blocking buffer (3×5 min). The coverslips were then incubated with the secondary anti-rabbit nanobody labelled with PaX₅₆₀-Maleimide [R. Lincoln et al. Nat. Chem. 2022, 14, 1013-1020, R. Lincoln et al. WO2023/284968A1] in blocking buffer in a humid chamber for 1 h at room temperature, and then washed with blocking buffer (3×5 min), and with PBS (3×5 min).

As it was determined that 560 nm excitation was sufficient to photoactivate compound 4 (but not PaX₅₆₀), sequential imaging independently selects the two fluorophores. First, compound 4 was imaged with 640 nm excitation (270 mW, detection range 662-710 nm) using the 560 nm laser as the photoactivation laser (<0.1 mW to 3 mW). Upon depleting the localizations of 4, PaX₅₆₀ is imaged using the 560 nm laser for excitation (180 mW, detection range 570-620 nm) and a 405 nm laser for photoactivation (<0.1 mW).

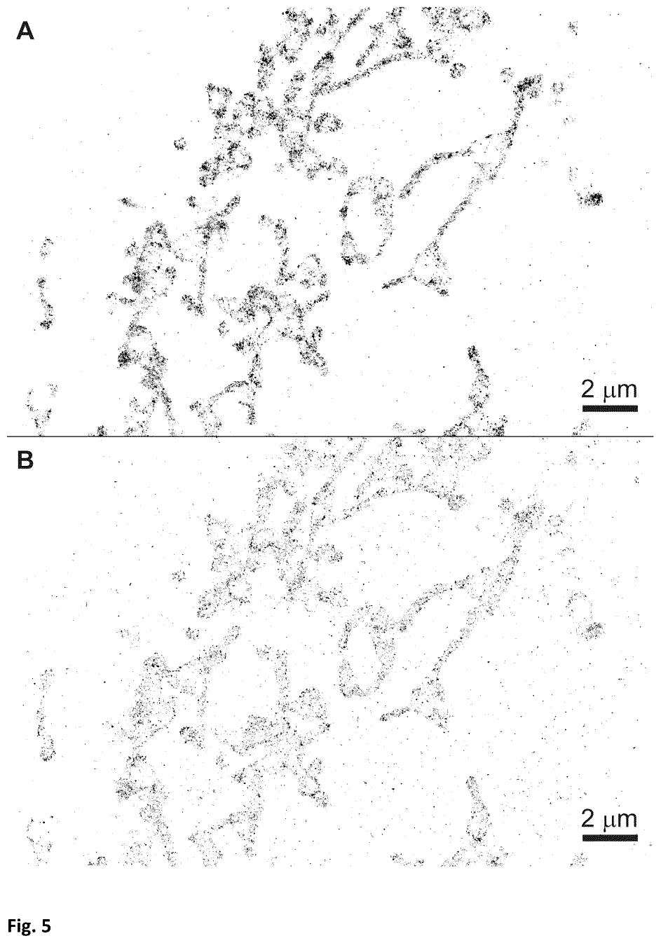

FIG. 5 shows sequential two-color single molecule localization microscopy super-resolution image of fixed HeLa cells stably expressing a COX8A-SNAP-tag construct labelled with 4-BG (A) and co-labelled via indirect immunofluorescence with an anti-TOMM20 primary antibody and a secondary nanobody labelled with PaX₅₆₀-Maleimide (B).

### EXAMPLE 6

### Two-Color MINFLUX Imaging of Photoactivatable Dyes by Spectral Classification

U-2 OS cells were seeded as described in Example 4 above. Fixation was performed with a 4% formaldehyde solution containing 0.2% glutaraldehyde in PBS (pH 7.4) at 37 degrees for 10 min. Samples were incubated with a quenching solution (0.1% sodium borohydride in PBS) for 7 min at room temperature then washed twice with PBS. To permeabilize and reduce unspecific binding, a blocking buffer (5% BSA in PBS with 0.1% Triton X-100) was added and incubated for 30 minutes at room temperature.

The coverslips were overlaid with the primary antibodies for TOMM20 (from rabbit) and TIMM23 (from mouse) in blocking buffer and incubated in a humid chamber for 1 h at room temperature and then washed with PBS (3×5 min). The coverslips were then incubated with the secondary nanobodies labelled with 4-Maleimide (anti-rabbit) and 21-Maleimide (anti-mouse) in blocking buffer, in a humid chamber for 1 h at room temperature, and then washed with PBS (3×5 min). Samples were post-fixed with a 4% PFA solution for 10 min at room temperature, then washed with PBS (3×5 min).

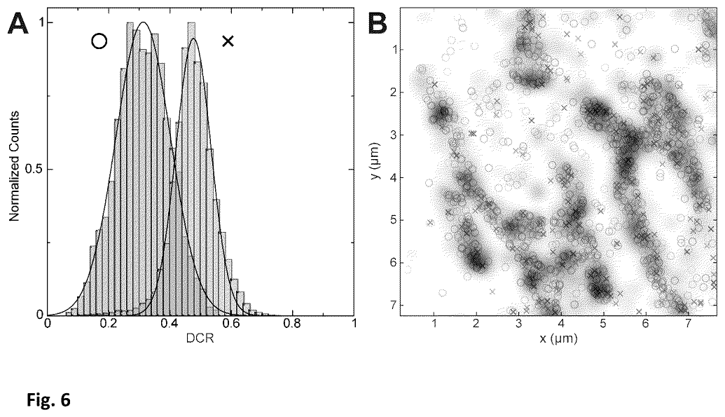

FIG. 6 shows dual-color MINFLUX imaging based on spectral seperation. A) Normalized histograms of the detector channel ratio (DCR) value of all localizations after spectral classification (circles/crosses). B) Dual color MINFLUX image of mitochondria in fixed U-2 OS cells labeled by indirect immunofluorescence with a primary antibody against TOMM20 (circles) in combination with a secondary nanobody conjugated with 4-maleimide, and with a primary antibody against TIMM23 (crosses) in combination with a secondary nanobody conjugated with 21-maleimide.

### ADDITIONAL NUMBERED EMBODIMENTS OF THE INVENTION

1. A compound having the structural formula I:

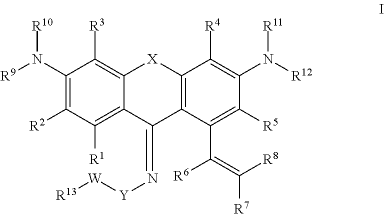

wherein:
R¹, R², R³, R⁴, R⁵, R⁶, R⁷ and R¹, independently of each other are selected from H, halogen, SO₃H, CO₂H, CN, NO₂, CO₂R, SO₂R (with R in CO₂R or SO₂R being selected from C₁ to C₄ unsubstituted alkyl), and an unsubstituted or substituted, in particular a halogen-, amino-, hydroxyl-, SO₃H— and/or carboxyl-substituted C₁-C₂₀ alkyl, C₃-C₈ cycloalkyl, C₁-C₂₀ alkoxy, C₂-C₂₀ alkylene, C₂-C₂₀ alkylyne, C₇-C₂₀ alkylaryl, phenyl and 5- or 6-membered ring heteroaryl, or a combination thereof;
   and where the substituents R⁶ and R⁷, taken together with the atoms to which they are bound, may form a 5-8 membered ring structure; and/or where the substituents R⁷ and R⁸, taken together with the atoms to which they are bound, may form a 5-8 membered ring structure;
R⁹, R¹⁰, R¹¹, R¹² are:
   a. independently selected from H, unsubstituted and substituted C₁-C₈ alkyl, C₃-C₈ cycloalkyl, C₁-C₈ acyl, C₁-C₈ alkoxycarbonyl, and C₇-C₁₂ alkylaryl, and unsubstituted phenyl or phenyl substituted by unsubstituted alkyl, halogen, alkoxy, NO₂, CO₂H, CO₂R and/or CONR₂ (with each R in CO₂R or CONR₂ being selected independently from C₁ to C₄ unsubstituted alkyl); or
   b. R⁹ together with R¹⁰ and a nitrogen atom to which they are bound, and/or R¹¹ together with R¹² and a nitrogen atom to which they are bound form a 3-7 membered ring structure; or
   c. R⁹ and/or R¹¹ are independently selected from H and unsubstituted and substituted C₁-C₈ alkyl, C₃-C₈ cycloalkyl, and C₇-C₁₂ alkylaryl; and R¹⁰ together with R² or R³ and the atoms to which they are bound form a 5-7 membered ring structure, and/or R¹² together with R⁴ or R⁵ and the atoms to which they are bound form a 5-7 membered ring structure;
   d. R⁹ together with R² and the atoms to which they are bound form a 5-7 membered ring structure, and/or R¹⁰ together with R³ and the atoms to which they are bound form a 5-7 membered ring structure, and/or R¹¹ together with R⁴ and the atoms to which they are bound form a 5-7 membered ring structure, and/or R¹² together with R⁵ and the atoms to which they are bound form a 5-7 membered ring structure;
X is independently selected from:
   a. SiR¹⁴R¹⁵ or GeR¹⁴R¹⁵ group, where R¹⁴ and R¹⁵ are each independently selected from unsubstituted and substituted C₁-C₁₂ alkyl, C₃-C₈ cycloalkyl, C₁-C₂₀ alkoxy, C₂-C₂₀ alkylene, C₂-C₂₀ alkylyne and C₇-C₂₀ alkylaryl, phenyl and 5- or 6-membered ring heteroaryl, or a combination thereof, or where both substituents R¹⁴ and R¹⁵, taken together with the Si or Ge to which they are attached, form a 4-7 membered ring structure;
   b. CR¹⁶R¹⁷ group, where R¹⁶ and R¹⁷ are each independently selected from H, F, CF₃, CN, OR¹⁸, COR¹⁸, CO₂R¹⁸, SO₂R¹⁸, CONR¹⁸R¹⁹ (where R¹⁸ and R¹⁹ in COR¹⁸, CO₂R¹⁸, SO₂R¹⁸, and CONR¹⁸R¹⁹ are each independently selected from unsubstituted and substituted C₁-C₁₂ alkyl, C₃-C₈ cycloalkyl, C₁-C₂₀ alkoxy, C₂-C₂₀ alkylene, C₂-C₂₀ alkylyne and C₇-C₂₀ alkylaryl, phenyl and 5- or 6-membered ring heteroaryl, or a combination thereof), unsubstituted and substituted C₁-C₁₂ alkyl, C₃-C₈ cycloalkyl, C₁-C₂₀ alkoxy, C₂-C₂₀ alkylene, C₂-C₂₀ alkylyne and C₇-C₂₀ alkylaryl, phenyl and 5- or 6-membered ring heteroaryl, or a combination thereof,
      or where both substituents R¹⁶ and R¹⁷, taken together with the C atom to which they are attached, form a 4-7 membered ring structure;
Y is independently selected from:
   a. C═O (carbonyl), C═S (thiocarbonyl) or C═NR²⁰ (iminocarbonyl) group, where R²⁰ is selected from H, unsubstituted and substituted C₁-C₁₂ alkyl, C₃-C₈ cycloalkyl, C₁-C₂₀ alkoxy, C₂-C₂₀ acyl, C₂-C₂₀ alkylsulfonyl, C₂-C₂₀ alkylene, C₂-C₂₀ alkylyne and C₇-C₂₀ alkylaryl, phenyl and 5- or 6-membered ring heteroaryl, or a combination thereof;
   b. SO₂ (sulfone) or S(═O)(═NR²⁰) (sulfoximine) group, where R²⁰ is selected from H, unsubstituted and substituted C₁-C₁₂ alkyl, C₃-C₈ cycloalkyl, C₁-C₂₀ alkoxy, C₂-C₂₀ acyl, C₂-C₂₀ alkylsulfonyl, C₂-C₂₀ alkylene, C₂-C₂₀ alkylyne and C₇-C₂₀ alkylaryl, phenyl and 5- or 6-membered ring heteroaryl, or a combination thereof;
   c. P(═O)(—OH), P(═O)(—OR²⁰) or P(═O)(—R²⁰), where R²⁰ is selected from H, unsubstituted and substituted C₁-C₁₂ alkyl, C₃-C₈ cycloalkyl, C₁-C₂₀ alkoxy, C₂-C₂₀ acyl, C₂-C₂₀ alkylsulfonyl, C₂-C₂₀ alkylene, C₂-C₂₀ alkylyne and C₇-C₂₀ alkylaryl, phenyl and 5- or 6-membered ring heteroaryl, or a combination thereof;
W is independently selected from O, S or NR²¹, where R²¹ is selected from H, unsubstituted and substituted C₁-C₁₂ alkyl, C₃-C₈ cycloalkyl, C₁-C₂₀ alkoxy, C₂-C₂₀ acyl, C₂-C₂₀ alkylsulfonyl, C₂-C₂₀ alkylene, C₂-C₂₀ alkylyne and C₇-C₂₀ alkylaryl, phenyl and 5- or 6-membered ring heteroaryl, or a combination thereof;
R¹³ is selected from H, unsubstituted and substituted C₁-C₁₂ alkyl, C₃-C₈ cycloalkyl, C₁-C₂₀ alkoxy, C₂-C₂₀ acyl, C₂-C₂₀ alkylsulfonyl, C₂-C₂₀ alkylene, C₂-C₂₀ alkylyne and C₇-C₂₀ alkylaryl, phenyl and 5- or 6-membered ring heteroaryl, or a combination thereof, or where the substituents R¹³ and R²⁰ taken together form a 5-8 membered ring structure.
   2. A compound, which has the structural formula II and is obtainable by irradiation with ultraviolet, visible or infrared light through a one-photon absorption process or a multiphoton absorption process from any of the compounds of general formula I of embodiment 1:

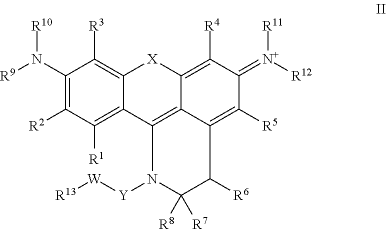

where R¹, R², R³, R⁴, R⁵, R⁶, R⁷, R⁸, R⁹, R¹⁰, R^{D}, R¹², R¹³, X, Y and W are defined as in embodiment 1.
   3. The compound according to embodiment 1 or 2, wherein the compound is covalently linked, particularly through any one of substituents R¹, R², R³, R⁴, R⁵, R⁶, R⁷, R⁸, R⁹, R¹⁰, R^{D}, R¹² and R¹³ or through any of the groups X, Y, W to a binding moiety M selected from:
a. a moiety selectively attachable by covalent bond to a protein or nucleic acid, particularly a moiety able to form an ester bond, a thioester bond, an ether bond, an amide or thioamide bond, a sulfide or disulfide bond, a carbon-carbon bond, a carbon-nitrogen bond such as a Schiff base, or a moiety able to react in a click-chemistry reaction with a corresponding functional group of a protein or nucleic acid,
more particularly a moiety selected from —COCH═CH₂, —SO₂CH═CH₂, —COCH₂I, —COC—CH, —N═C═S, —CO—NHS or another active ester, biotin, an azide or a tetrazine, a diazoalkane or diazoketone, a diazirine, an alkyne, a strained alkyne such as bicyclo[6.1.0]nonyne or cyclooctyne, a strained alkene such as trans-cyclooctene or norbornene, a maleimide; or from
b. a substrate of a haloalkane transferase, particularly a 1-chlorohexyl or a (3-chloropropyl)aryl moiety as exemplarily shown below:

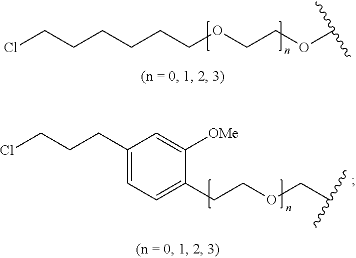

c. a substrate of O⁶-alkylguanine-DNA-alkyltransferase, particularly a (substituted) O⁶-benzylguanine, O²-benzylcytosine or 4-benzyloxy-6-halo- or 4-benzyloxy-6-pseudohalo-pyrimidine-2-amine moiety (where halo group is preferably chloro, and pseudohalo group is selected preferably, but without limitation, from CN and CF₃) as exemplarily shown below:

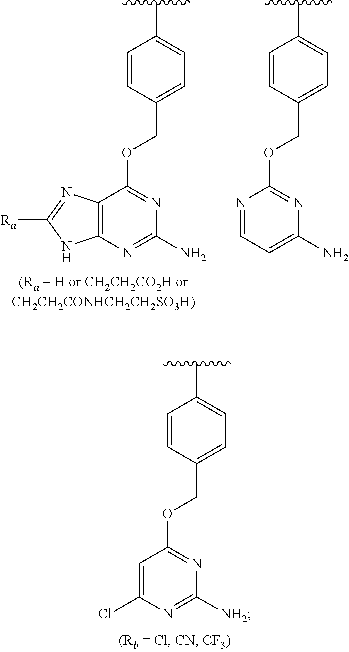

or from
d. a substrate of dihydrofolate reductase, particularly a 4-demethyltrimethoprim moiety as exemplarily shown below:

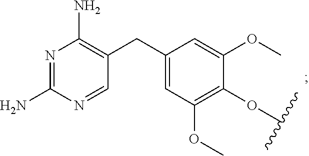 [SMILES: *Oc1c(OC)cc(Cc2cnc(N)nc2N)cc1OC]

or from
e. a moiety capable of selectively interacting non-covalently with a biomolecule, particularly a protein or nucleic acid, wherein said moiety and said biomolecule form a complex having a dissociation constant k_{D} of 10⁻⁶ mol/L or less,
more particularly, M is selected from de-N-Boc-docetaxel, de-N-Boc-cabazitaxel, de-N-Boc-larotaxel or another taxol derivative, a phalloidin derivative, a jasplakinolide derivative, a bis-benzimide DNA stain, pepstatin A or triphenylphosphonium, e.g. as shown below:

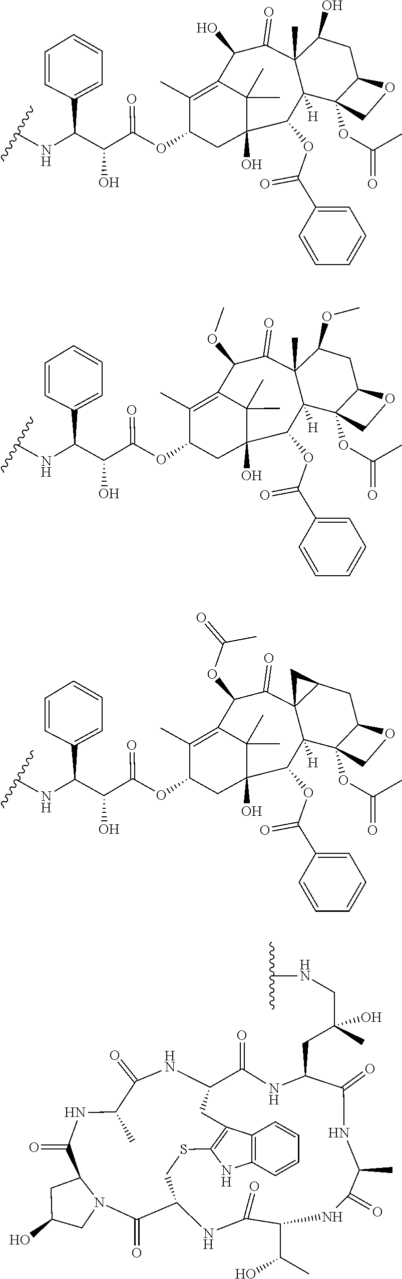

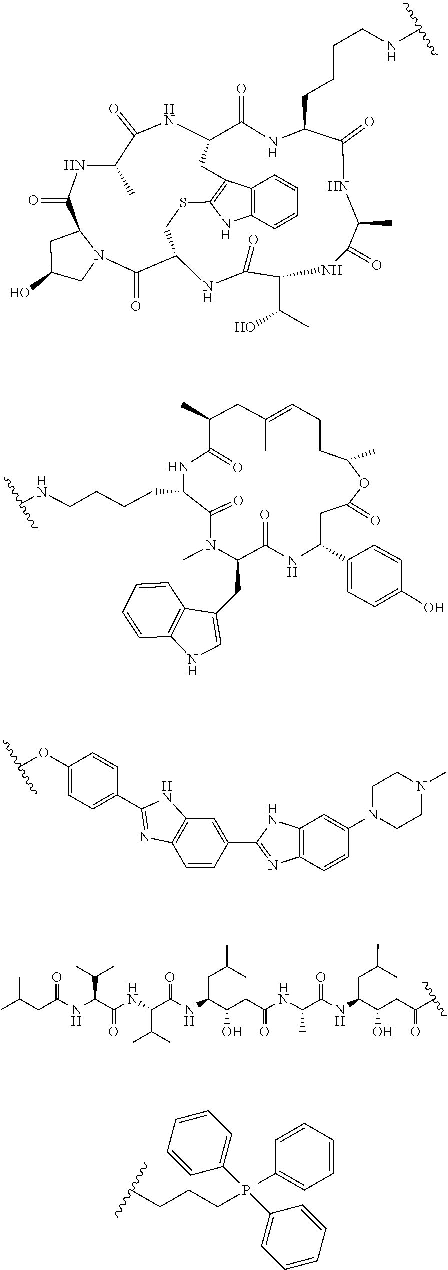

f. or wherein M is an oligonucleotide having a sequence length between 10 and 40 nucleotides;
g. or wherein M is a lipid, particularly a sphingosine derivative such as a ceramide, or a phospholipid such as dioleoylphosphatidylethanolamine (DOPE) or dipalmitoylphosphatidylethanolamine (DPPE), or a fatty acid.
   4. The compound according to embodiments 1-3, having one of the structural formulas I-1-I-30 or II-1-II-30:

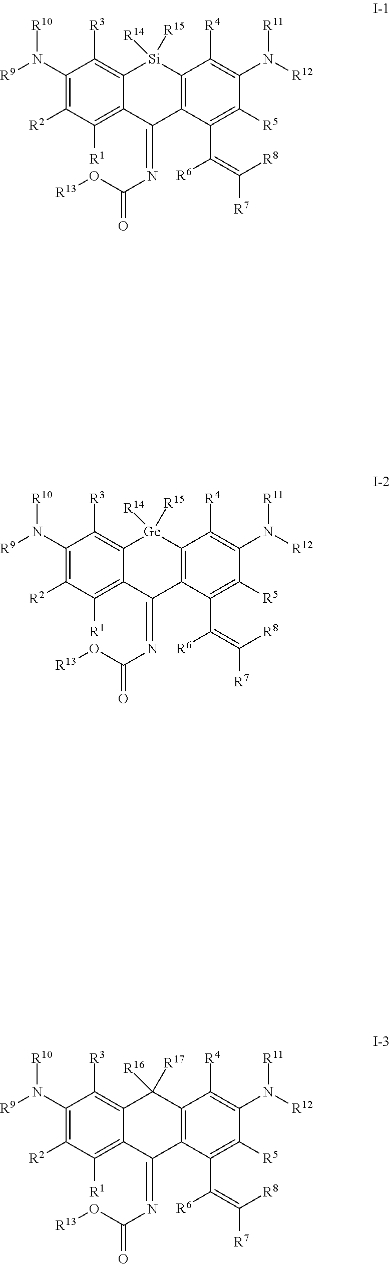

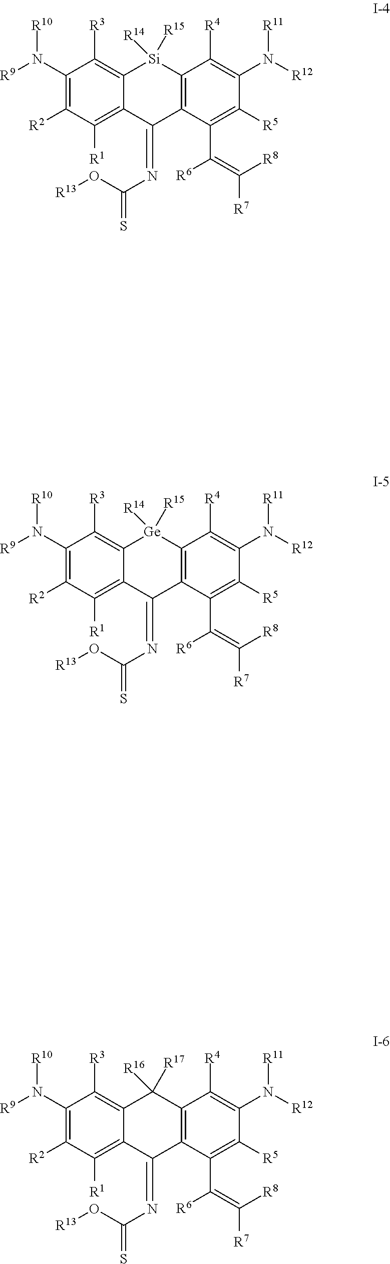

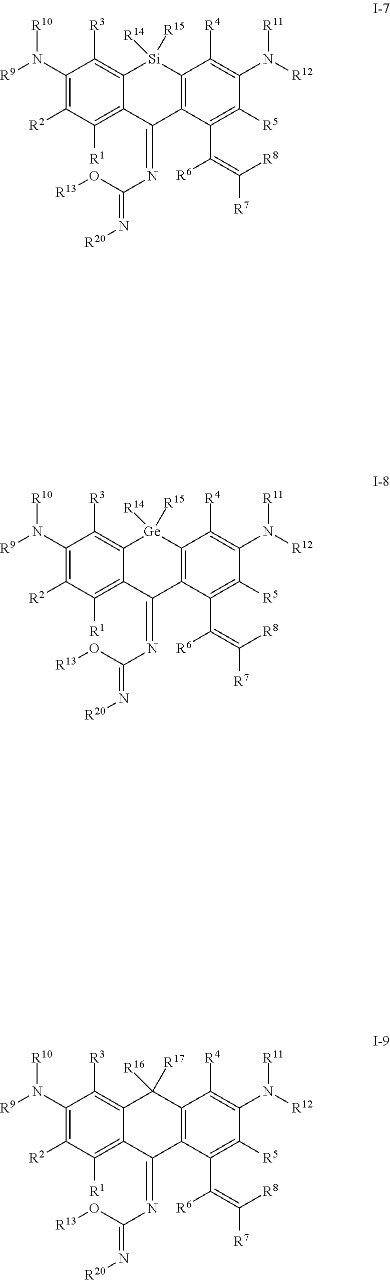

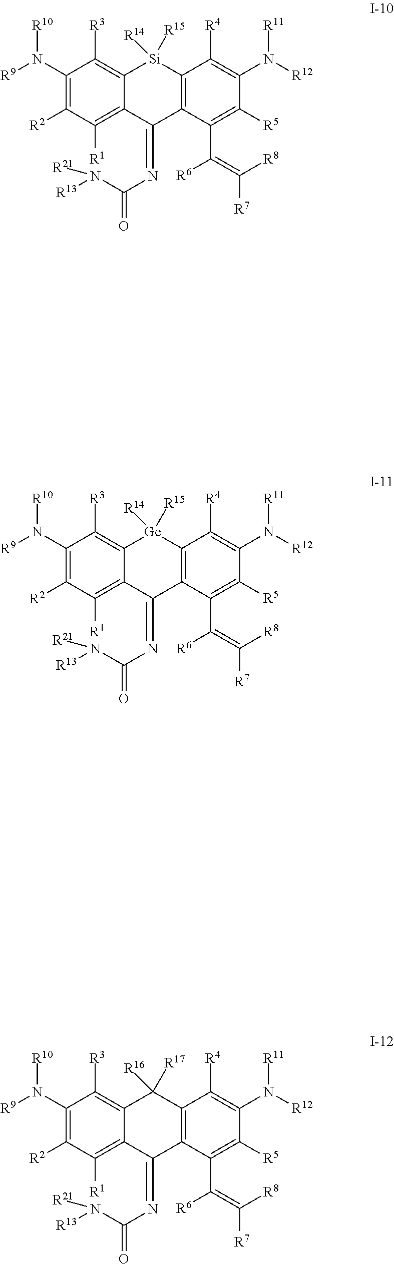

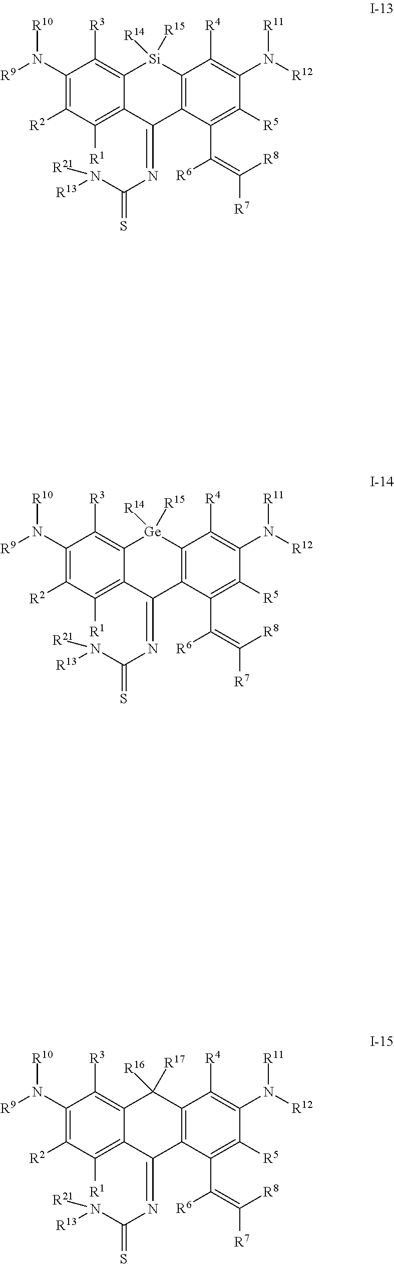

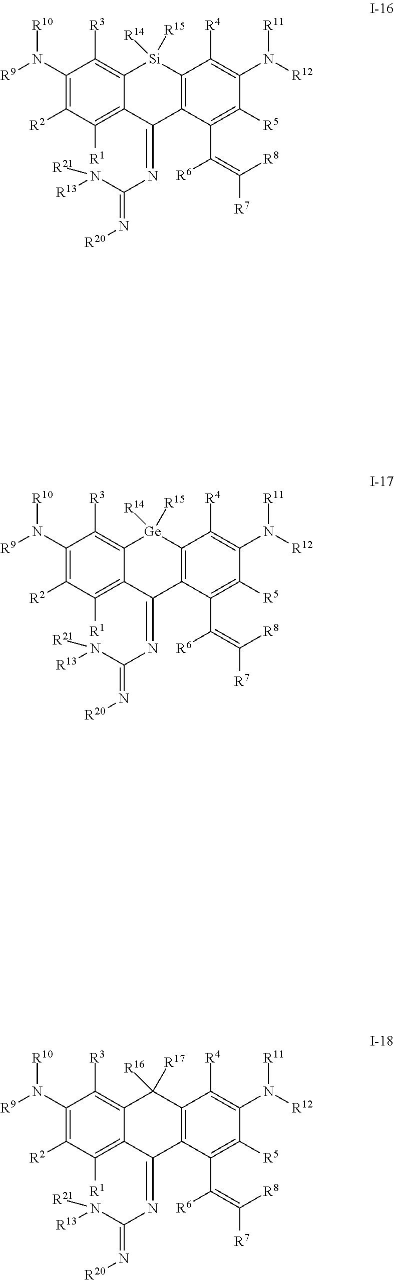

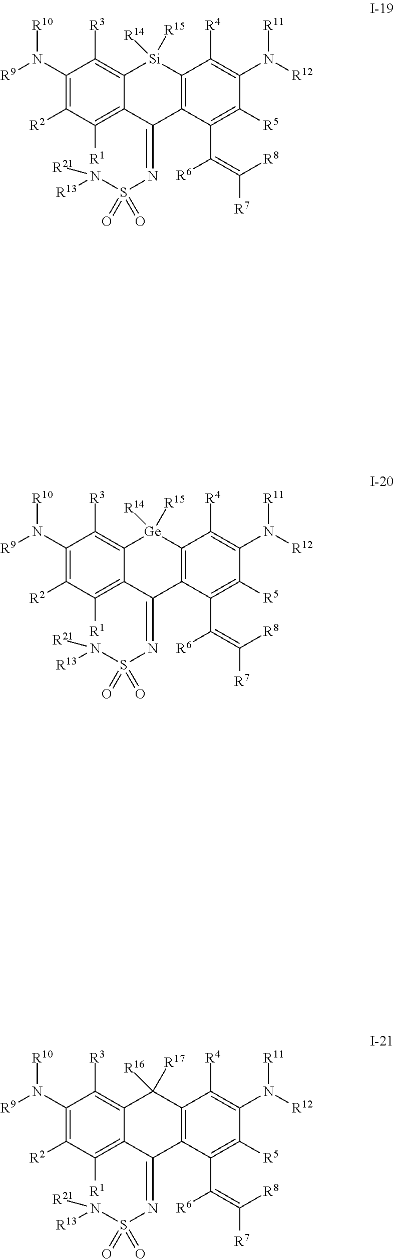

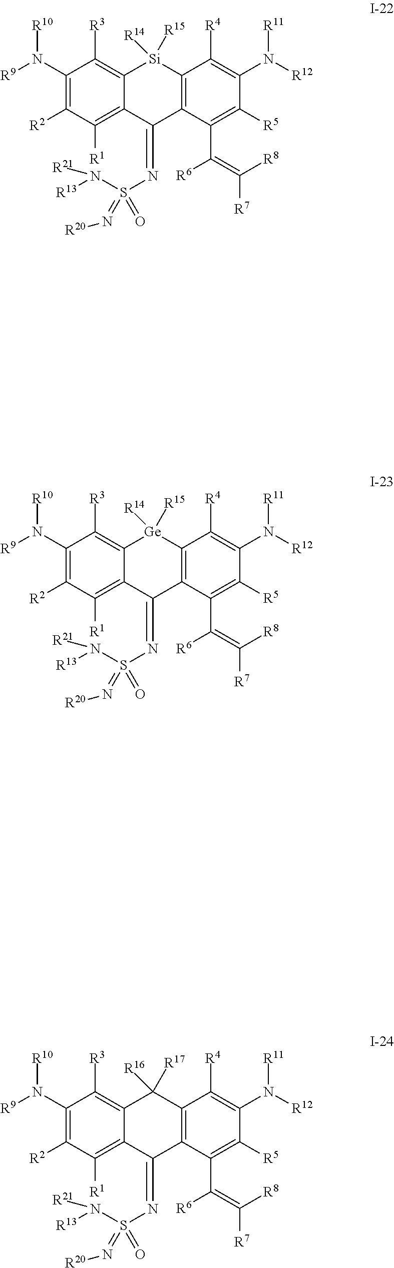

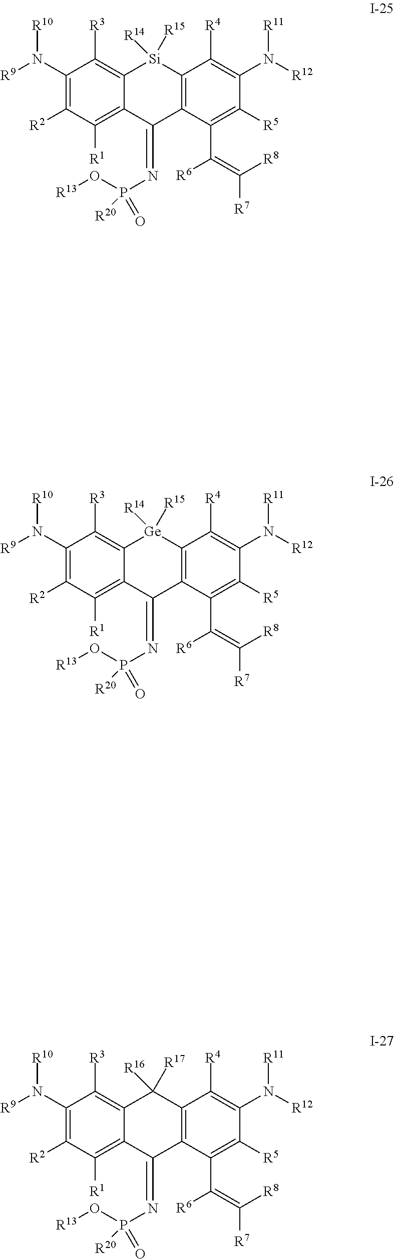

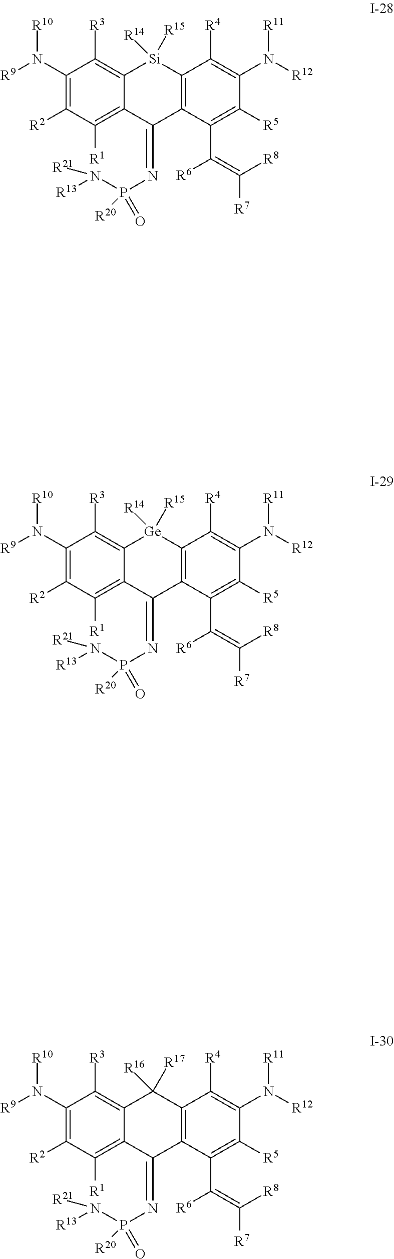

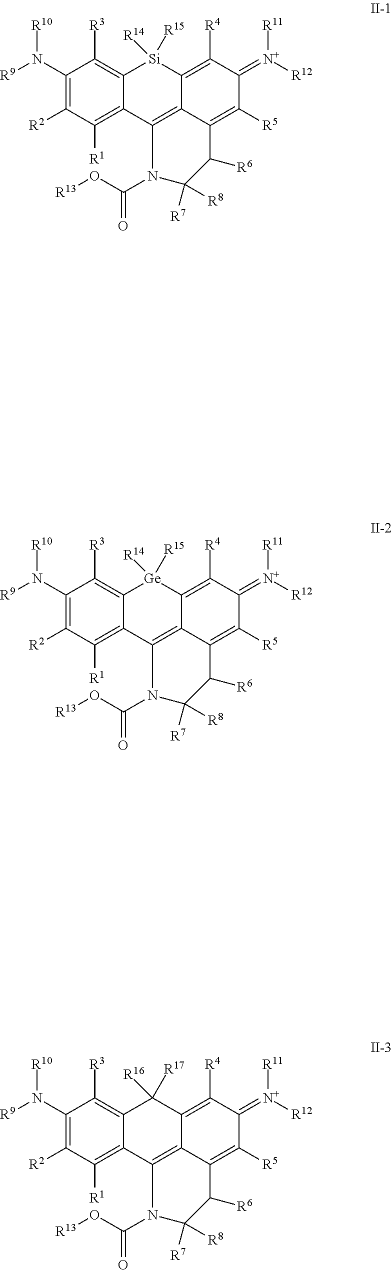

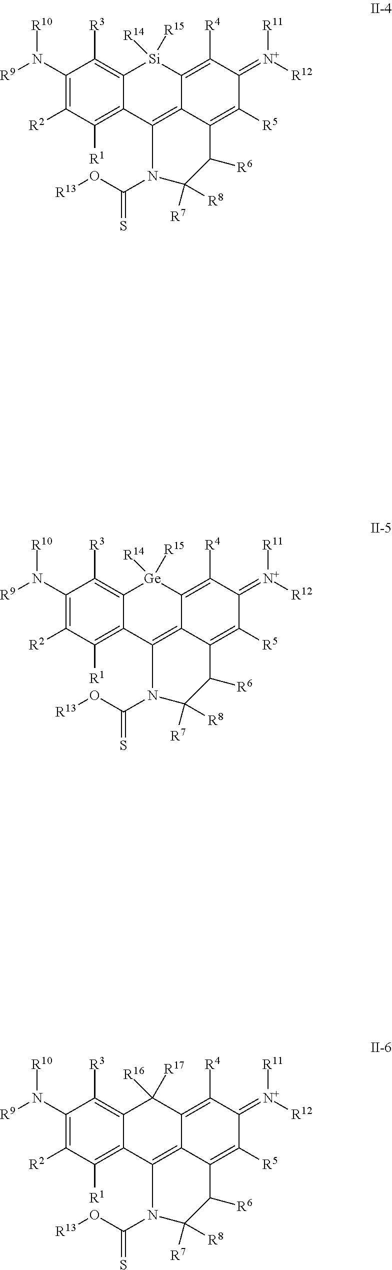

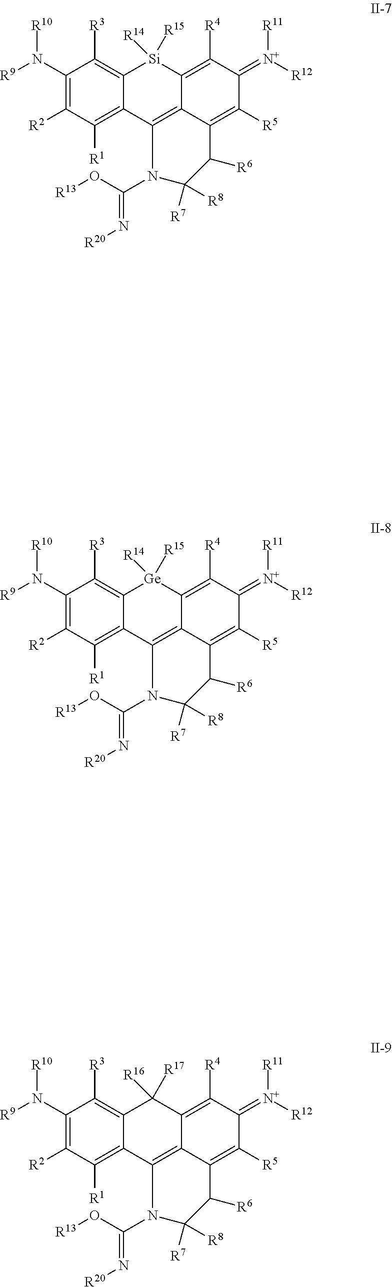

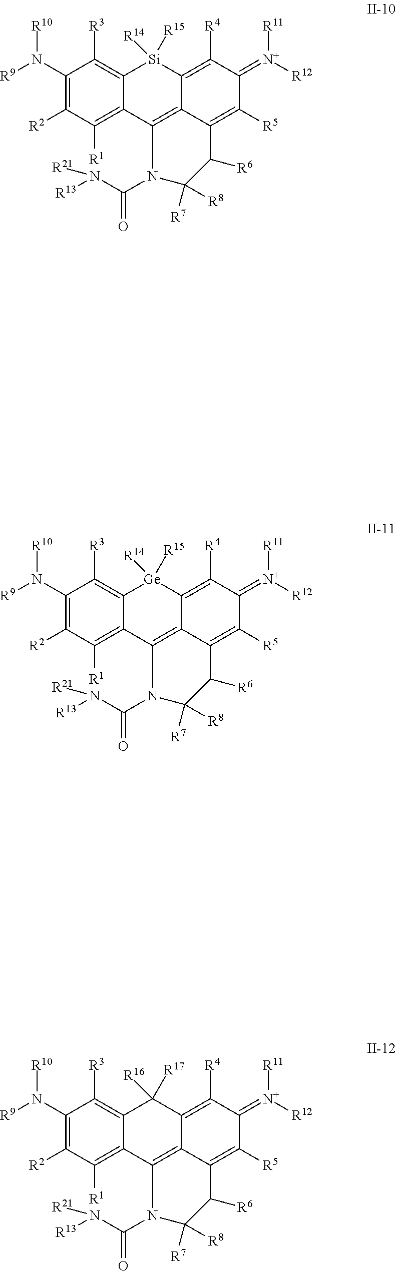

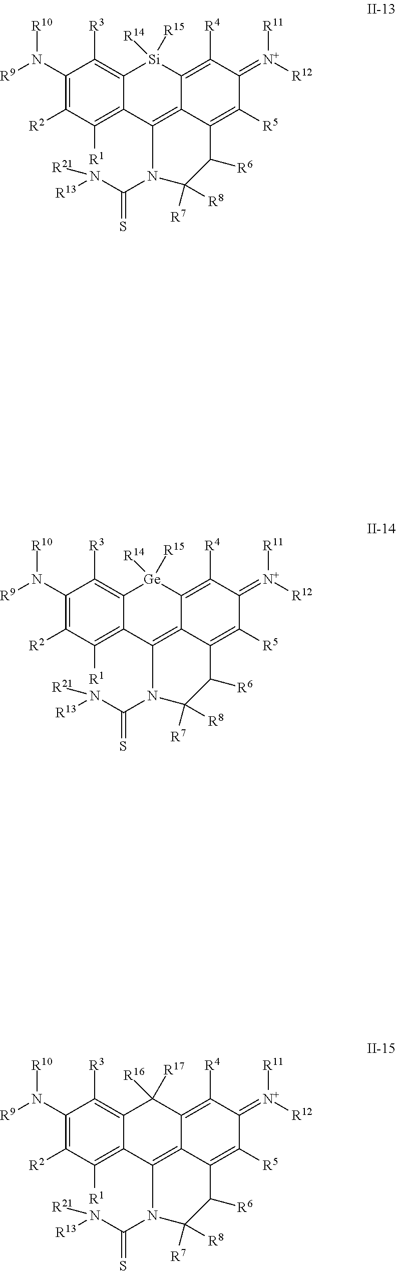

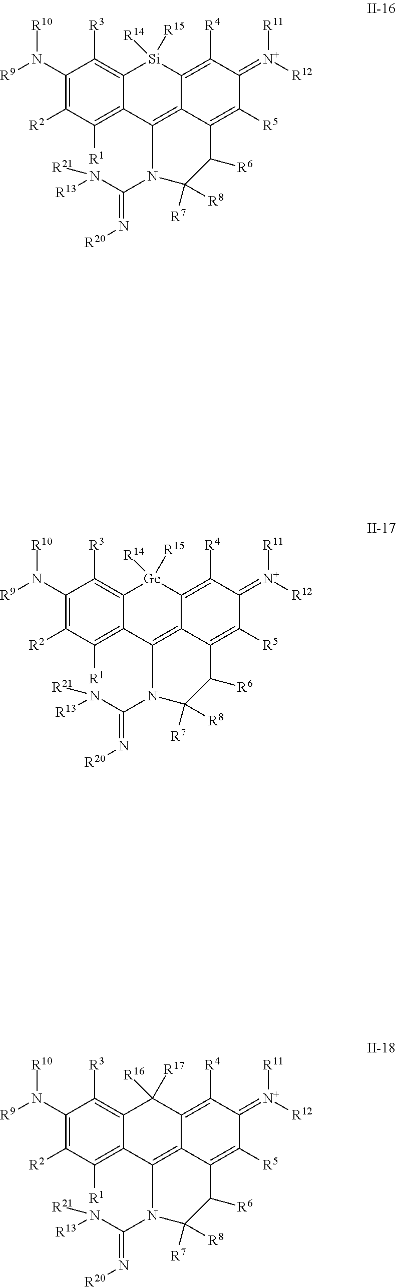

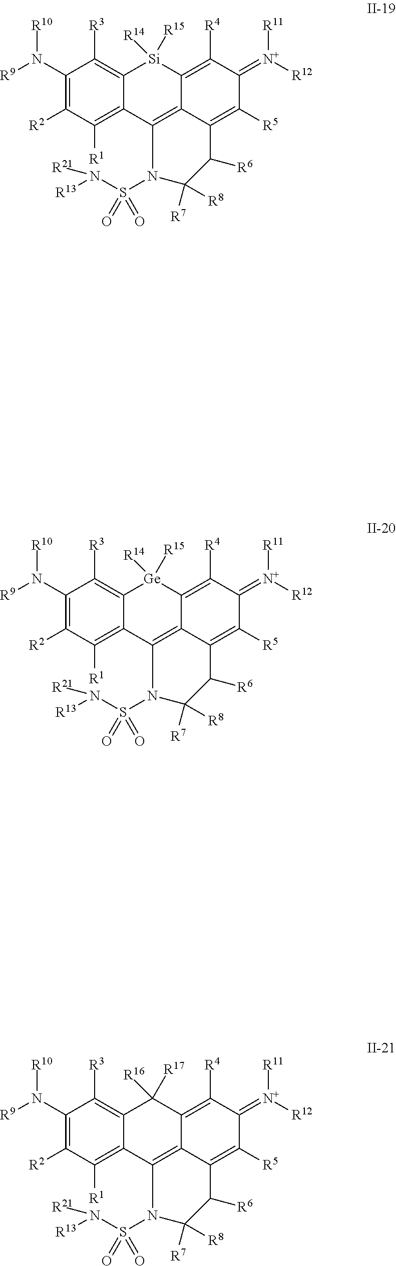

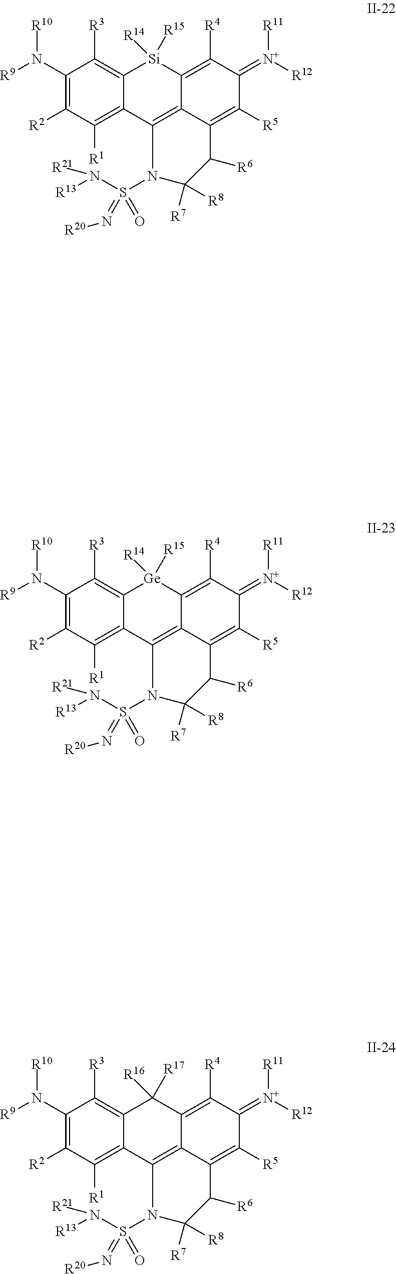

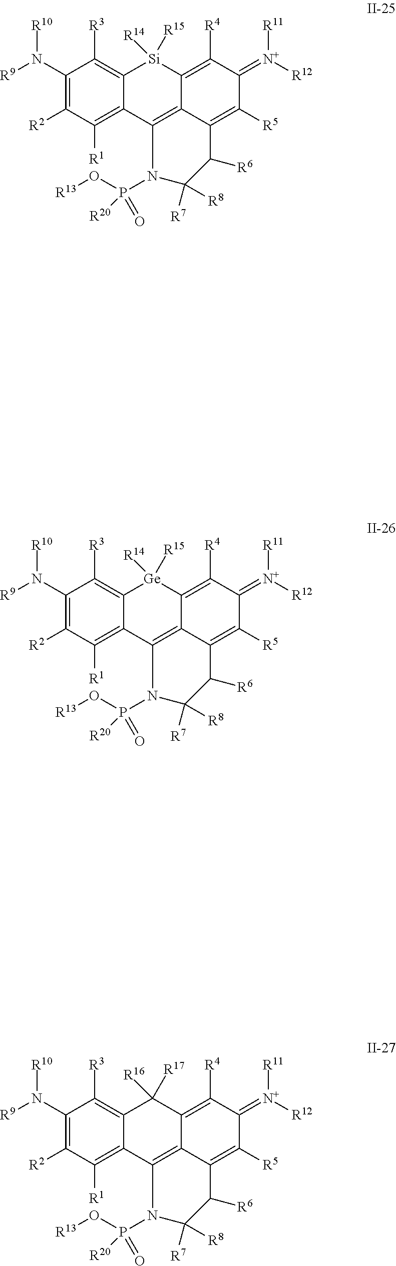

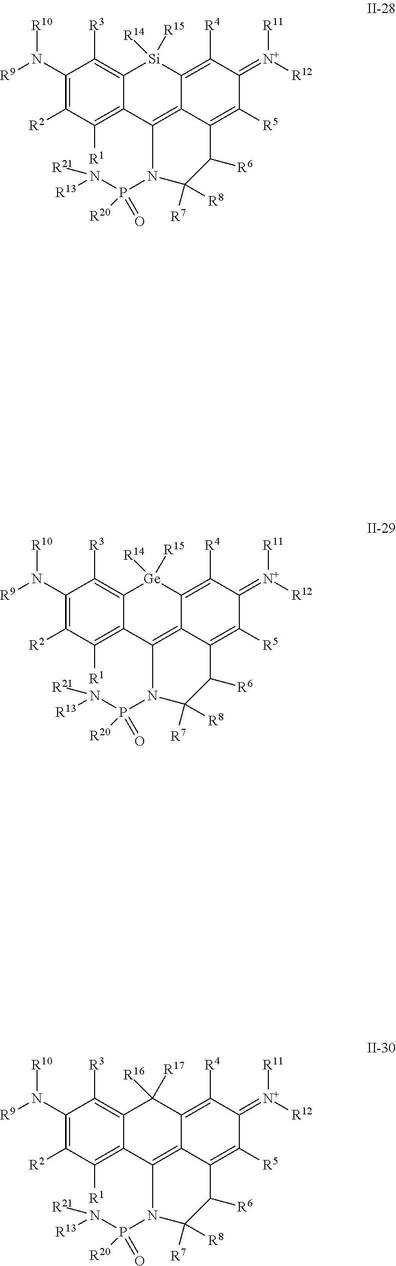

wherein any one of substituents R¹, R², R³, R⁴, R⁵, R⁶, R⁷, R⁸, R⁹, R¹⁰, R¹¹, R¹² or any one of the substituents R¹³, R¹⁴, R¹⁵, R¹⁶, R¹⁷, R¹⁸, R¹⁹, R²⁰, R²¹, if present, independently of any other is H or a moiety having a molecular weight between 15 and 1500 Da;
   particularly wherein:
   a) the substituents R⁹, R¹⁰, R^{D}, R¹² are selected from H and methyl, or any of the substituents —NR⁹R¹⁰ and —NR¹¹R¹² represents an azetidine ring, and
   b) one of substituents R¹, R², R³, R⁴, R⁵, R⁶, R⁷, R⁸ or one of the R¹³, R¹⁴, R¹⁵, R¹⁶, R¹⁷, R¹⁸, R¹⁹, R²⁰, R²¹, if present, is H or a moiety M having a molecular weight between 15 and 1500 Da, and
   c) the other substituents R¹, R², R³, R⁴, R⁵ are selected from H and F, and
   d) the other substituents R⁶, R⁷, R⁸ are selected from H and methyl, and
   e) the other substituents R¹⁴, R¹⁵, if present, are selected from methyl, ethyl, isopropyl or phenyl,
   f) the other substituents R¹⁶, R¹⁷, if present, are methyl,
   g) the other substituents R²⁰, R²¹, if present, are selected from H, OH, methoxy and methyl.
      5. The compound according to embodiment 4, wherein said binding moiety M defined as in embodiment 3 and having a molecular weight between 15 and 1500 Da is characterized by a general formula -L-Mₛ, where -L- is a covalent bond or a linker consisting of 1 to 50 atoms having an atomic weight of 12 or higher (in addition to the number of hydrogen atoms required to satisfy the valence rules) covalently connecting the compound of structure I-1-I-30 or II-1-II-30 to the binding moiety Mₛ (which is defined identical to binding moiety M in embodiment 3),
particularly wherein said moiety M having a molecular weight between 15 and 1500 Da is characterized by a general formula

-L^{A1}ₘ-L^{J1}_{m′}-L^{A2}ₙ-L^{J2}_{n′}-L^{A3}ₚ-L^{J3}_{p′}-L^{A4}_{q}-L^{J4}_{q′}-Mₛ, wherein
L^{A1}, L^{A2}, L^{A3} and L^{A4} independently of each other are selected from C₁ to C₁₂ unsubstituted or amino-, hydroxyl-, carboxyl- or fluoro substituted alkyl or cycloalkyl, (CH₂—CH₂-0)ᵣ with r being an integer from 1 to 20, alkylaryl, alkylaryl-alkyl, and unsubstituted or alkyl-, halogen-, amino-, alkylamino-, imido-, nitro-, hydroxyl-, oxyalkyl-, carbonyl-, carboxyl-, sulfonyl- and/or sulfoxyl substituted aryl or heteroaryl;
L^{J1}, L^{J2}, L and L^{J4} independently of each other are selected from —NRC(═O)—, —C(═O)N(R)—, —NRC(═O)O—, —OC(═O)N(R)—, —C(R)═N—, —N═C(R)—, —C(═O)—, —OC(═O)—,
—C(═O)O—, —N(R)—, —O—, —P(═O)(OR)—, —P(═O)(OR)O—, —OP(═O)(OR)—, —OP(═O)(OR)O—, —S—, —SO—, —SO₂—, —SO₂N(R)—, —N(R)SO₂N(R)—, —N(R)SO₂— with R selected from H and unsubstituted or amino-, hydroxyl-, carboxyl, sulfonate or fluoro substituted C₁ to C₆ alkyl, particularly when R is selected from H and methyl;
m, m′, n, n′, p, p′, q, q′ and s independently from each other are selected from 0 and 1, and
Mₛ is defined identical to binding moiety M in embodiment 3.
   6. The compound according to embodiment 5, wherein said moiety M having a molecular weight between 15 and 1500 Da is represented by one of the following structures:

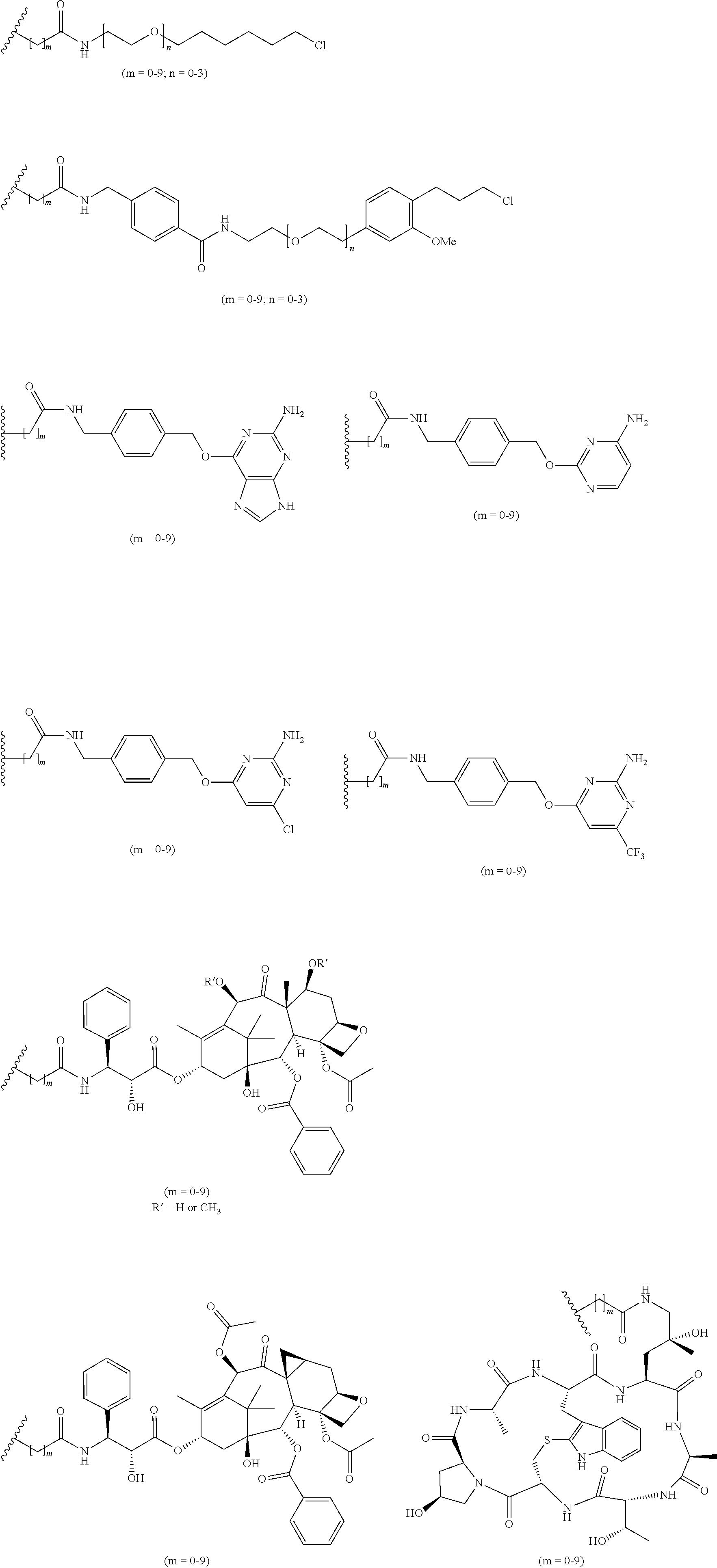

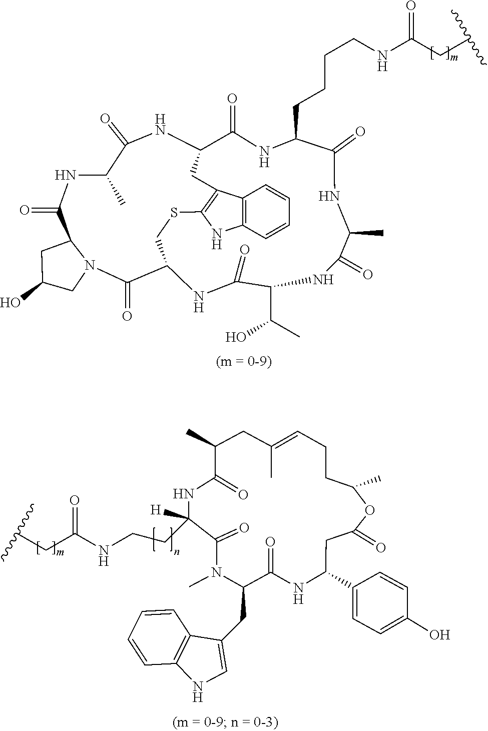

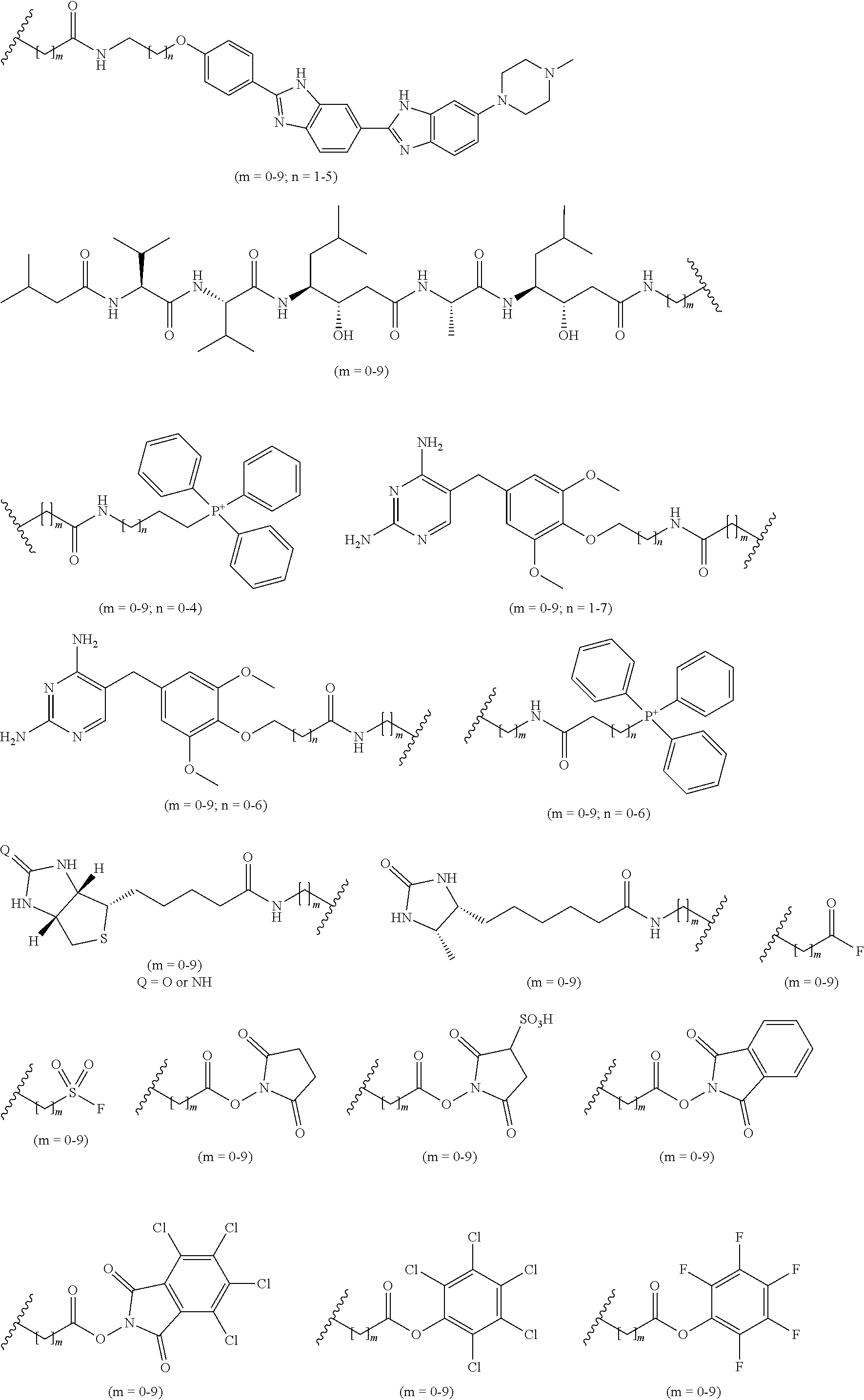

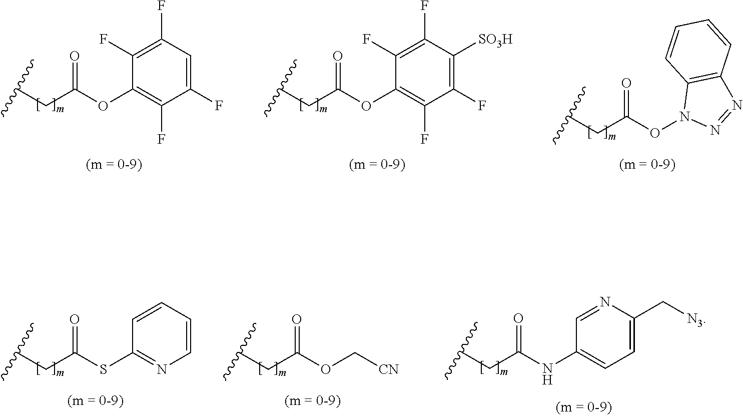

7. The compound according to any one of the preceding embodiments, wherein
a. R⁹ and R¹⁰, and/or R¹¹ and R¹², are independently selected from H, unsubstituted and amino-, hydroxy-, carboxy-, sulfonate- and/or fluoro-substituted C₁-C₆ alkyl, C₁-C₄ acyl, C₁-C₄ alkoxycarbonyl, including tert-butyloxycarbonyl or Boc group, and C₃-C₆ cycloalkyl,
particularly R⁹ and R¹⁰, and/or R¹¹ and R¹², are independently selected from H, methyl, ethyl, n-propyl, isopropyl, n-butyl, isobutyl, tert-butyl, allyl and CH₂CF₃,
b. R⁹ together with R¹⁰, and/or R⁹ together with R¹⁰, are independently forming an unsubstituted or alkyl-, amino-, hydroxy-, carboxy-, sulfonate- and/or fluoro-substituted C₃-C₆ alkyl, particularly —(CH₂)₃—, —(CH₂)₄—, —(CH₂)₅—, —(CH₂)₂O(CH₂)₂—, —(CH₂)₂SO₂(CH₂)₂— or —(CH₂)₂NR²²(CH₂)₂— with R²² being selected from H and unsubstituted C₁ to C₄ alkyl, particularly methyl;
c. R⁹ and/or R¹¹ are independently selected from H, unsubstituted and alkyl-substituted, particularly methyl-substituted, amino-, hydroxy-, carboxy-, sulfonate- and/or fluoro-substituted C₁-C₆ alkyl, C₁-C₄ acyl, C₁-C₄ alkoxycarbonyl, including tert-butyloxycarbonyl or Boc group, and C₃-C₆ cycloalkyl, and R¹⁰ together with R² or R³, and/or R¹² together with R⁴ or R⁵, is an alkyl or heteroalkyl bridge selected from —(CH₂)₂—, —(CH₂)₃—, —CH₂CH═CH— or —(CH₂)₄— or —CH₂—O—, —CH₂—NR—, —CH₂—S—, —CH₂—SO₂—, —(CH₂)₂₀—, —(CH₂)₂NR—, —(CH₂)₂S—, —(CH₂)₂SO₂—, —CH₂—O—CH₂—, —CH₂NR—, —CH₂S—CH₂—, —CH₂—SO₂—CH₂—, — with R selected from H and unsubstituted or amino-, hydroxyl-, carboxyl, sulfonate- or fluoro-substituted C₁ to C₆ alkyl, particularly when R is selected from H and methyl-, and a mono- or dimethyl-substituted derivative of any one of the foregoing alkyl or heteroalkyl bridge moieties;
d. R¹⁰ and/or R¹¹ are independently selected from H, unsubstituted and alkyl-, substituted, particularly methyl-substituted-, amino-, hydroxy-, carboxy-, sulfonate- and/or fluoro-substituted C₁-C₆ alkyl, C₁-C₄ acyl, C₁-C₄ alkoxycarbonyl, including tert-butyloxycarbonyl or Boc group, and C₃-C₆ cycloalkyl, and R⁹ together with R², and/or R¹² together with R⁵, form a fused annular structure according to any one of the following substructures:

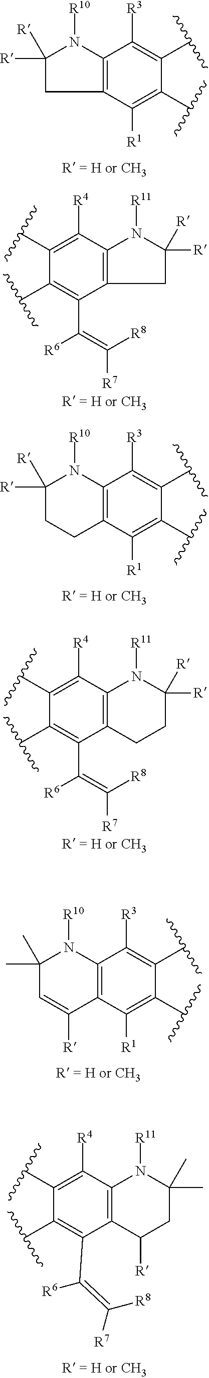

e. R⁹ and/or R¹² are independently selected from H, unsubstituted and alkyl-substituted, particularly methyl-substituted, amino-, hydroxy-, carboxy-, sulfonate- and/or fluoro-substituted C₁-C₆ alkyl, C₁-C₄ acyl, C₁-C₄ alkoxycarbonyl, including tert-butyloxycarbonyl or Boc group, and C₃-C₆ cycloalkyl, and R¹⁰ together with R³, and/or R¹¹ together with R⁴, form a fused annular structure according to any one of the following substructures:

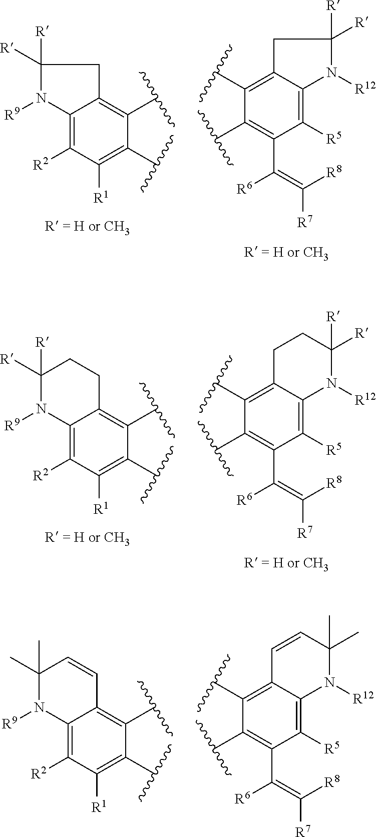

f. R⁹ together with R², and R¹⁰ together with R³, and/or R¹² together with R⁵, and R¹¹ together with R⁴, form a fused biannular structure according to any one of the following substructures:

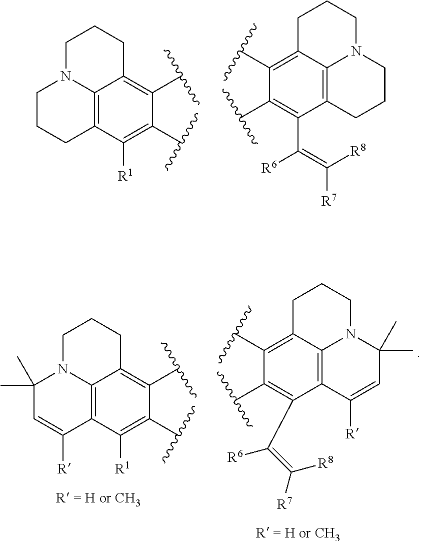

8. The compound according to any of the preceding embodiments, wherein R¹ is structurally identical to the substituent —CR⁶═CR⁷R⁸, in particular when the substituents R² and R⁵ are structurally identical, and/or the substituents —NR⁹R¹⁰ and —NR¹¹R¹² are structurally identical, and/or the substituents R³ and R⁴ are structurally identical.
9. The compound according to any of the preceding embodiments, wherein:
R¹ is H, and/or
R², R³, R⁴ and R⁵ are independently selected from H, halogen, CN, and/or
R⁹, R¹⁰, R¹¹ and R¹² are individually unsubstituted or amino-, hydroxyl- or halogen-substituted C₁ to C₄ alkyl, or C₃ to C₆ cycloalkyl, or R⁹ together with R¹⁰ together with the N atom to which they are bound, and R¹¹ together with R¹² together with the N atom to which they are bound form an unsubstituted or methyl-, hydroxy-, methoxy-, or halogen-substituted aziridine, azetidine, pyrrolidine, piperidine, piperazine, morpholine, thiomorpholine-S,S-dioxide, and/or
R¹³, R¹⁴, R¹⁵, if present, are selected from methyl, ethyl, isopropyl or phenyl,
R¹⁶, R¹⁷, if present, are methyl,
one of the substituents R⁶, R⁷, R⁸ and R²⁰, R²¹, if present, is selected from a) unsubstituted or amino-, hydroxyl-, carboxyl- and/or halogen-substituted C₂ to C₁₂ alkyl or C₃ to C₇ cycloalkyl; or b) -L^{A1}ₘ-L^{J1}_{m′}-L^{A2}ₙ-L^{J2}_{n′}-L^{A3}ₚ-L^{J3}_{p′}-L^{A4}_{q}-L^{J4}_{q′}-Mₛ, wherein L^{A1}, L^{A2}, L^{A3}, L^{A4}, L^{J1}, L^{J2}, L^{J3}, L^{J4} m, m′, n, n′, p, p′, q, q′, s and Mₛ have the definitions recited above in embodiment 5, and
the other substituents R⁶, R⁷, R⁸ and R²⁰, R²¹, if present, are selected from H or methyl.
   10. The compound according to any one of the preceding embodiments, wherein the substituents —NR⁹R¹⁰ and/or —NR¹¹R¹² are independently represented by one of the following structures, particularly when the substituents —NR⁹R¹⁰ and —NR¹¹R¹² are structurally identical:

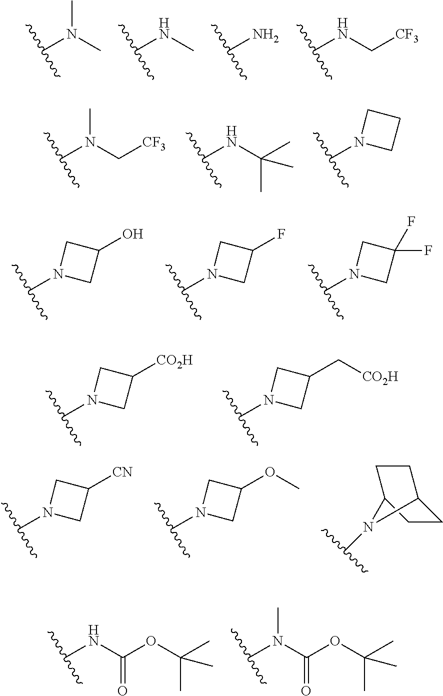

11. The compound according to any one of the preceding embodiments, wherein the fragment
—CR⁶═CR⁷R⁸ is represented by one of the following structures:

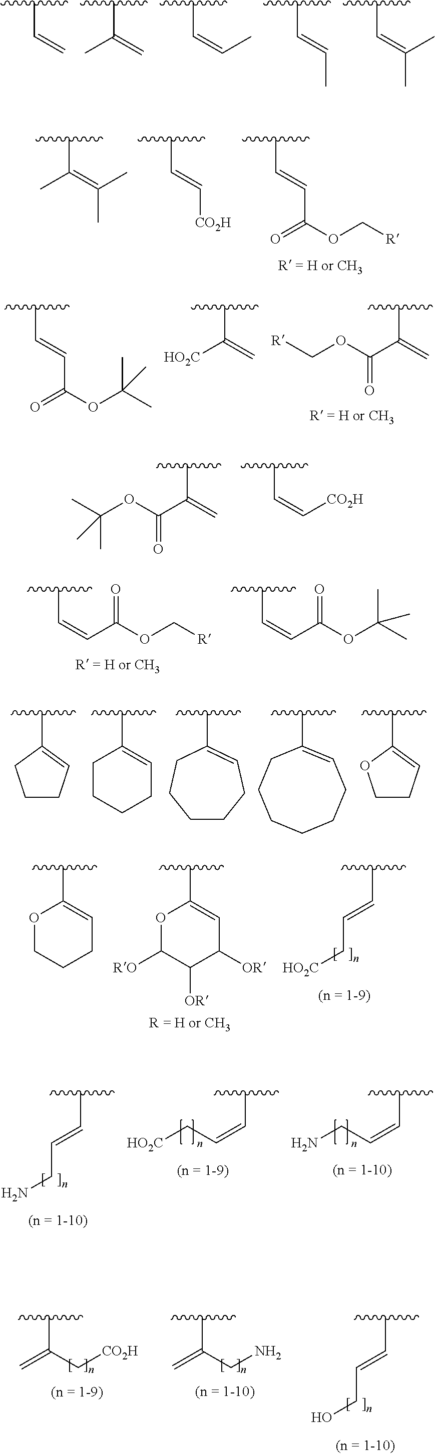

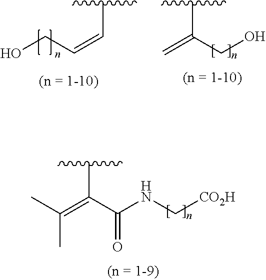

12. The compound according to any one of the preceding embodiments, wherein the group —Y—W—R¹³ is represented by one of the following structures:

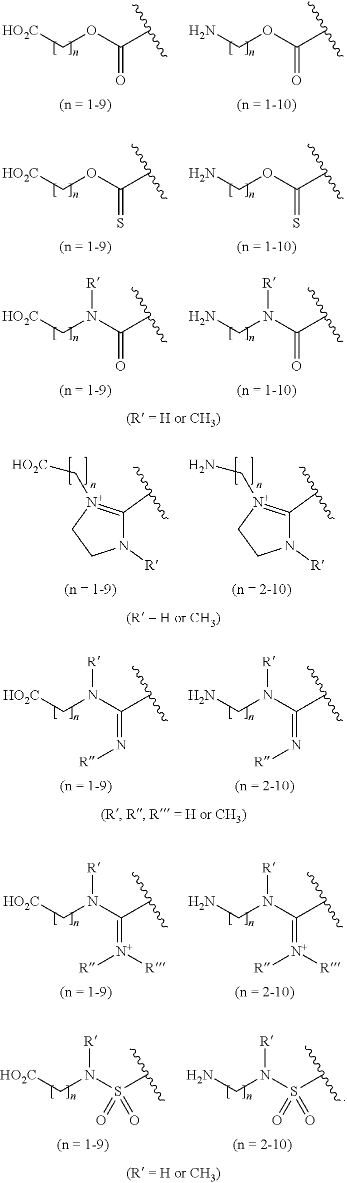

13. The compound according to any one of the preceding embodiments, wherein the group —X— is represented by one of the following structures:

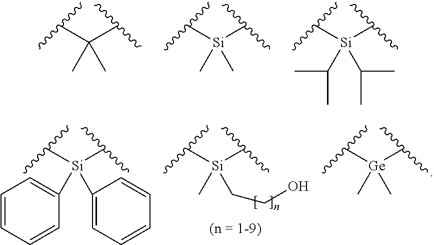

14. The compound according to any one of embodiments 1-4 which is selected from the group of compounds below:

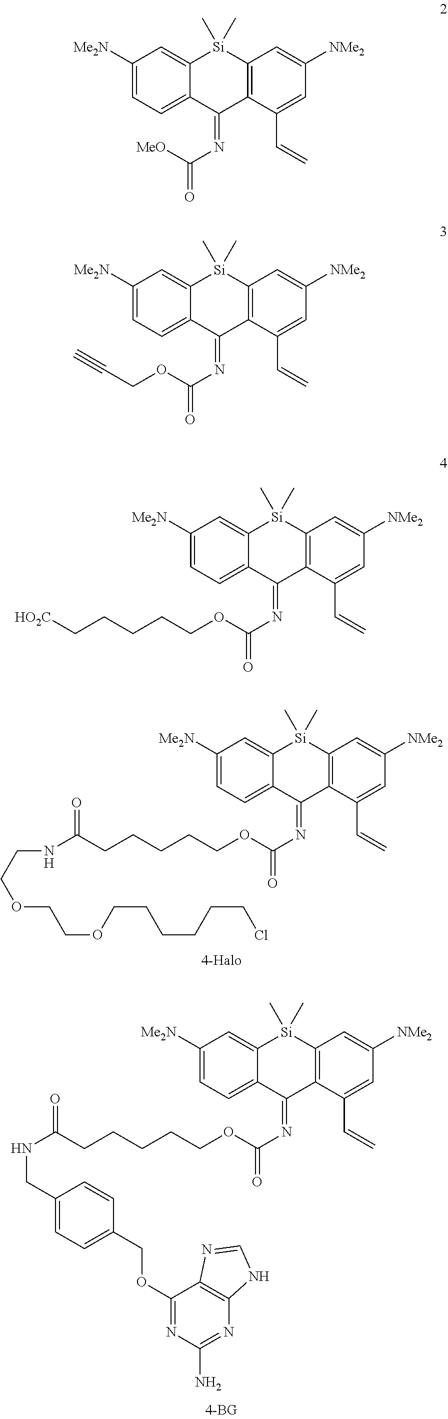

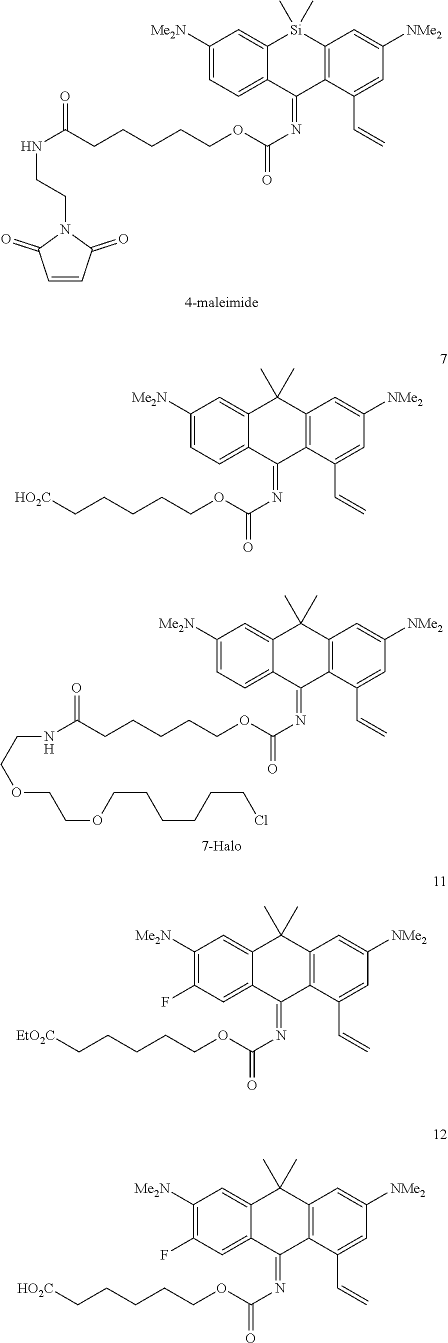 [SMILES: C=Cc1cc(N(C)C)cc2c1/C(=N/C(=O)OCCCCCC(=O)NCCN1C(=O)C=CC1=O)c1ccc(N(C)C)cc1[Si]2(C)C ; C=Cc1cc(N(C)C)cc2c1/C(=N/C(=O)OCCCCCC(=O)O)c1ccc(N(C)C)cc1C2(C)C ; C=Cc1cc(N(C)C)cc2c1/C(=N/C(=O)OCCCCCC(=O)NCCOCCOCCCCCCCl)c1ccc(N(C)C)cc1C2(C)C ; C=Cc1cc(N(C)C)cc2c1/C(=N/C(=O)OCCCCCC(=O)OCC)c1cc(F)c(N(C)C)cc1C2(C)C ; C=Cc1cc(N(C)C)cc2c1/C(=N/C(=O)OCCCCCC(=O)O)c1cc(F)c(N(C)C)cc1C2(C)C]

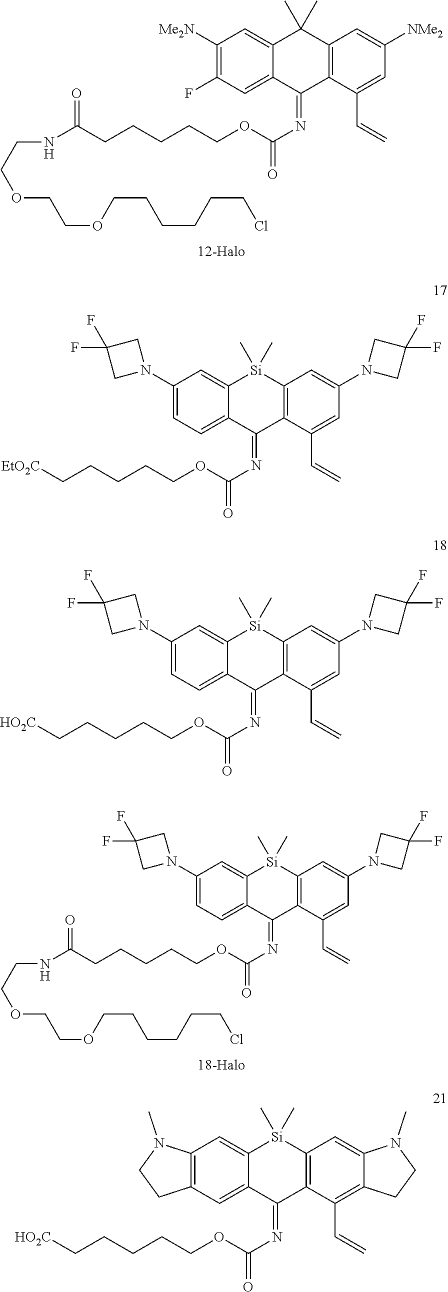 [SMILES: C=Cc1cc(N(C)C)cc2c1/C(=N/C(=O)OCCCCCC(=O)NCCOCCOCCCCCCCl)c1cc(F)c(N(C)C)cc1C2(C)C ; C=Cc1cc(N2CC(F)(F)C2)cc2c1/C(=N/C(=O)OCCCCCC(=O)OCC)c1ccc(N3CC(F)(F)C3)cc1[Si]2(C)C ; C=Cc1cc(N2CC(F)(F)C2)cc2c1/C(=N/C(=O)OCCCCCC(=O)O)c1ccc(N3CC(F)(F)C3)cc1[Si]2(C)C ; C=Cc1cc(N2CC(F)(F)C2)cc2c1/C(=N/C(=O)OCCCCCC(=O)NCCOCCOCCCCCCCl)c1ccc(N3CC(F)(F)C3)cc1[Si]2(C)C ; C=Cc1c2c(cc3c1/C(=N/C(=O)OCCCCCC(=O)O)c1cc4c(cc1[Si]3(C)C)N(C)CC4)N(C)CC2]

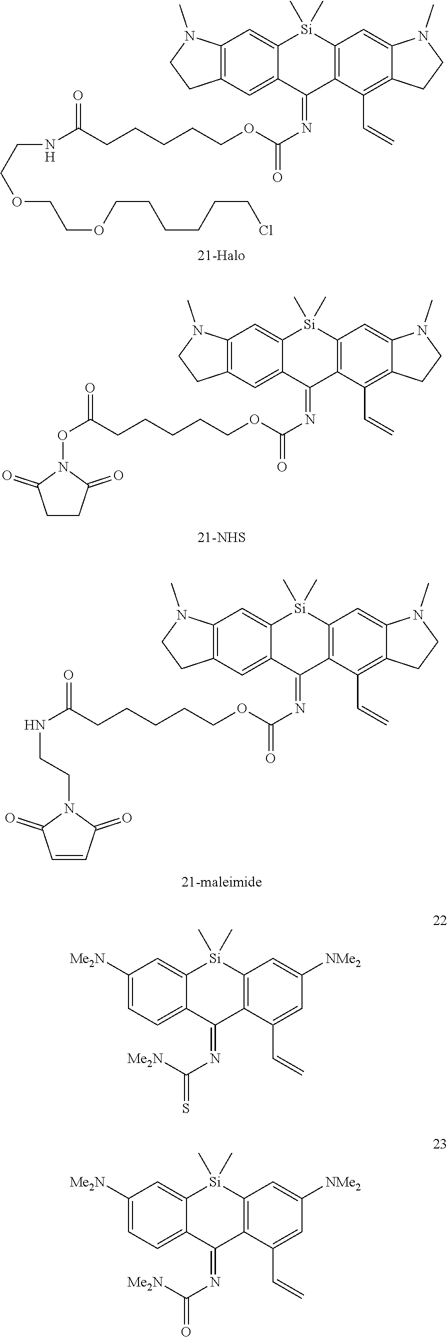 [SMILES: C=Cc1c2c(cc3c1/C(=N/C(=O)OCCCCCC(=O)NCCOCCOCCCCCCCl)c1cc4c(cc1[Si]3(C)C)N(C)CC4)N(C)CC2 ; C=Cc1c2c(cc3c1/C(=N/C(=O)OCCCCCC(=O)ON1C(=O)CCC1=O)c1cc4c(cc1[Si]3(C)C)N(C)CC4)N(C)CC2 ; C=Cc1c2c(cc3c1/C(=N/C(=O)OCCCCCC(=O)NCCN1C(=O)C=CC1=O)c1cc4c(cc1[Si]3(C)C)N(C)CC4)N(C)CC2 ; C=Cc1cc(N(C)C)cc2c1/C(=N/C(=S)N(C)C)c1ccc(N(C)C)cc1[Si]2(C)C ; C=Cc1cc(N(C)C)cc2c1/C(=N/C(=O)N(C)C)c1ccc(N(C)C)cc1[Si]2(C)C]

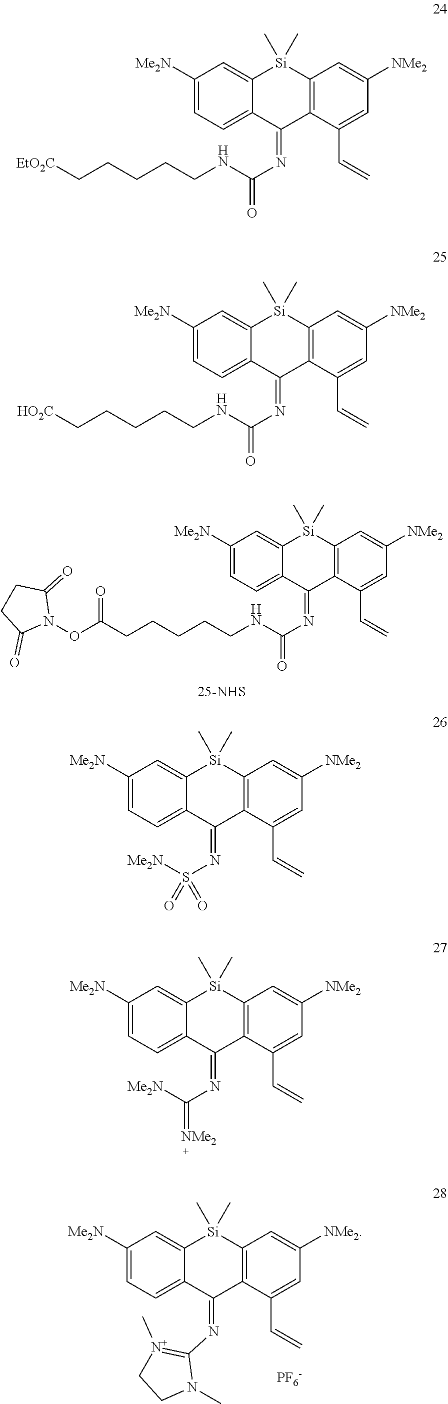

What is claimed is:

1. A compound having the structural formula I: 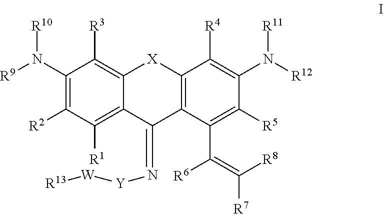
wherein:
R¹, R², R³, R⁴, R⁵, R⁶, R⁷ and R⁸, independently of each other are selected from H, halogen, SO₃H, CO₂H, CN, NO₂, CO₂R, SO₂R (with R in CO₂R or SO₂R being selected from C₁ to C₄ unsubstituted alkyl), and an unsubstituted or substituted, in particular a halogen-, amino-, hydroxyl-, SO₃H— and/or carboxyl-substituted C₁-C₂₀ alkyl, C₃-C₈ cycloalkyl, C₁-C₂₀ alkoxy, C₂-C₂₀ alkylene, C₂-C₂₀ alkylyne, C₇-C₂₀ alkylaryl, phenyl and 5- or 6-membered ring heteroaryl, or a combination thereof;
and where the substituents R⁶ and R⁷, taken together with the atoms to which they are bound, may form a 5-8 membered ring structure; and/or where the substituents R⁷ and R⁸, taken together with the atoms to which they are bound, may form a 5-8 membered ring structure;
R⁹, R¹⁰, R¹¹, R¹² are:
a. independently selected from H, unsubstituted and substituted C₁-C₈ alkyl, C₃-C₈ cycloalkyl, C₁-C₈ acyl, C₁-C₈ alkoxycarbonyl, and C₇-C₁₂ alkylaryl, and unsubstituted phenyl or phenyl substituted by unsubstituted alkyl, halogen, alkoxy, NO₂, CO₂H, CO₂R and/or CONR₂ (with each R in CO₂R or CONR₂ being selected independently from C₁ to C₄ unsubstituted alkyl); or
b. R⁹ together with R¹⁰ and a nitrogen atom to which they are bound, and/or R¹¹ together with R¹² and a nitrogen atom to which they are bound form a 3-7 membered ring structure; or
c. R⁹ and/or R¹¹ are independently selected from H and unsubstituted and substituted C₁-C₈ alkyl, C₃-C₈ cycloalkyl, and C₇-C₁₂ alkylaryl; and R¹⁰ together with R² or R³ and the atoms to which they are bound form a 5-7 membered ring structure, and/or R¹² together with R⁴ or R⁵ and the atoms to which they are bound form a 5-7 membered ring structure;
d. R⁹ together with R² and the atoms to which they are bound form a 5-7 membered ring structure, and/or R¹⁰ together with R³ and the atoms to which they are bound form a 5-7 membered ring structure, and/or R¹¹ together with R⁴ and the atoms to which they are bound form a 5-7 membered ring structure, and/or R¹² together with R⁵ and the atoms to which they are bound form a 5-7 membered ring structure;
X is independently selected from:
a. SiR¹⁴R¹⁵ or GeR¹⁴R¹⁵ group, where R¹⁴ and R¹⁵ are each independently selected from unsubstituted and substituted C₁-C₁₂ alkyl, C₃-C₈ cycloalkyl, C₁-C₂₀ alkoxy, C₂-C₂₀ alkylene, C₂-C₂₀ alkylyne and C₇-C₂₀ alkylaryl, phenyl and 5- or 6-membered ring heteroaryl, or a combination thereof,
or where both substituents R¹⁴ and R¹⁵, taken together with the Si or Ge to which they are attached, form a 4-7 membered ring structure;
b. CR¹⁶R¹⁷ group, where R¹⁶ and R¹⁷ are each independently selected from H, F, CF₃, CN, OR¹⁸, COR¹⁸, CO₂R¹⁸, SO₂R¹⁸, CONR¹⁸R¹⁹ (where R¹⁸ and R¹⁹ in COR¹⁸, CO₂R¹⁸, SO₂R¹⁸, and CONR¹⁸R¹⁹ are each independently selected from unsubstituted and substituted C₁-C₁₂ alkyl, C₃-C₈ cycloalkyl, C₁-C₂₀ alkoxy, C₂-C₂₀ alkylene, C₂-C₂₀ alkylyne and C₇-C₂₀ alkylaryl, phenyl and 5- or 6-membered ring heteroaryl, or a combination thereof), unsubstituted and substituted C₁-C₁₂ alkyl, C₃-C₈ cycloalkyl, C₁-C₂₀ alkoxy, C₂-C₂₀ alkylene, C₂-C₂₀ alkylyne and C₇-C₂₀ alkylaryl, phenyl and 5- or 6-membered ring heteroaryl, or a combination thereof,
or where both substituents R¹⁶ and R¹⁷, taken together with the C atom to which they are attached, form a 4-7 membered ring structure;
Y is independently selected from:
a. C═O (carbonyl), C═S (thiocarbonyl) or C═NR²⁰ (iminocarbonyl) group, where R²⁰ is selected from H, unsubstituted and substituted C₁-C₁₂ alkyl, C₃-C₈ cycloalkyl, C₁-C₂₀ alkoxy, C₂-C₂₀ acyl, C₂-C₂₀ alkylsulfonyl, C₂-C₂₀ alkylene, C₂-C₂₀ alkylyne and C₇-C₂₀ alkylaryl, phenyl and 5- or 6-membered ring heteroaryl, or a combination thereof;
b. SO₂ (sulfone) or S(═O)(═NR²⁰) (sulfoximine) group, where R²⁰ is selected from H, unsubstituted and substituted C₁-C₁₂ alkyl, C₃-C₈ cycloalkyl, C₁-C₂₀ alkoxy, C₂-C₂₀ acyl, C₂-C₂₀ alkylsulfonyl, C₂-C₂₀ alkylene, C₂-C₂₀ alkylyne and C₇-C₂₀ alkylaryl, phenyl and 5- or 6-membered ring heteroaryl, or a combination thereof;
c. P(═O)(—OH), P(═O)(—OR²⁰) or P(═O)(—R²⁰), where R²⁰ is selected from H, unsubstituted and substituted C₁-C₁₂ alkyl, C₃-C₈ cycloalkyl, C₁-C₂₀ alkoxy, C₂-C₂₀ acyl, C₂-C₂₀ alkylsulfonyl, C₂-C₂₀ alkylene, C₂-C₂₀ alkylyne and C₇-C₂₀ alkylaryl, phenyl and 5- or 6-membered ring heteroaryl, or a combination thereof;
W is independently selected from O, S or NR²¹, where R²¹ is selected from H, unsubstituted and substituted C₁-C₁₂ alkyl, C₃-C₈ cycloalkyl, C₁-C₂₀ alkoxy, C₂-C₂₀ acyl, C₂-C₂₀ alkylsulfonyl, C₂-C₂₀ alkylene, C₂-C₂₀ alkylyne and C₇-C₂₀ alkylaryl, phenyl and 5- or 6-membered ring heteroaryl, or a combination thereof;
R¹³ is selected from H, unsubstituted and substituted C₁-C₁₂ alkyl, C₃-C₈ cycloalkyl, C₁-C₂₀ alkoxy, C₂-C₂₀ acyl, C₂-C₂₀ alkylsulfonyl, C₂-C₂₀ alkylene, C₂-C₂₀ alkylyne and C₇-C₂₀ alkylaryl, phenyl and 5- or 6-membered ring heteroaryl, or a combination thereof, or where the substituents R¹³ and R²⁰ taken together form a 5-8 membered ring structure.

2. A compound, which has the structural formula II and is obtainable by irradiation with ultraviolet, visible or infrared light through a one-photon absorption process or a multiphoton absorption process from any of the compounds of general formula I of claim 1: 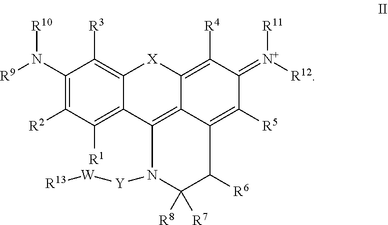
where R¹, R², R³, R⁴, R⁵, R⁶, R⁷, R⁸, R⁹, R¹⁰, R¹¹, R¹², R¹³, X, Y and W are defined as in claim 1.

3. The compound according to claim 1, wherein the compound is covalently linked, particularly through any one of substituents R¹, R², R³, R⁴, R⁵, R⁶, R⁷, R⁸, R⁹, R¹⁰, R¹¹, R¹² and R¹³ or through any of the groups X, Y, W to a binding moiety M selected from:
a. a moiety selectively attachable by covalent bond to a protein or nucleic acid, particularly a moiety able to form an ester bond, a thioester bond, an ether bond, an amide or thioamide bond, a sulfide or disulfide bond, a carbon-carbon bond, a carbon-nitrogen bond such as a Schiff base, or a moiety able to react in a click-chemistry reaction with a corresponding functional group of a protein or nucleic acid,
more particularly a moiety selected from —COCH═CH₂, —SO₂CH═CH₂, —COCH₂I, —COC≡CH, —N═C═S, —CO—NHS or another active ester, biotin, an azide or a tetrazine, a diazoalkane or diazoketone, a diazirine, an alkyne, a strained alkyne such as bicyclo[6.1.0]nonyne or cyclooctyne, a strained alkene such as trans-cyclooctene or norbornene, a maleimide; or from
b. a substrate of a haloalkane transferase, particularly a 1-chlorohexyl or a (3-chloropropyl)aryl moiety as exemplarily shown below: 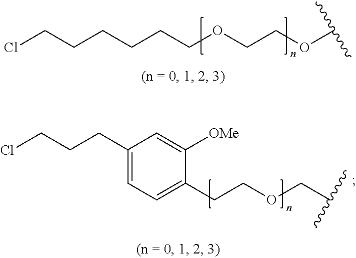
c. a substrate of O⁶-alkylguanine-DNA-alkyltransferase, particularly a (substituted) O⁶-benzylguanine, O²-benzylcytosine or 4-benzyloxy-6-halo- or 4-benzyloxy-6-pseudohalo-pyrimidine-2-amine moiety (where halo group is preferably chloro, and pseudohalo group is selected preferably, but without limitation, from CN and CF₃) as exemplarily shown below: 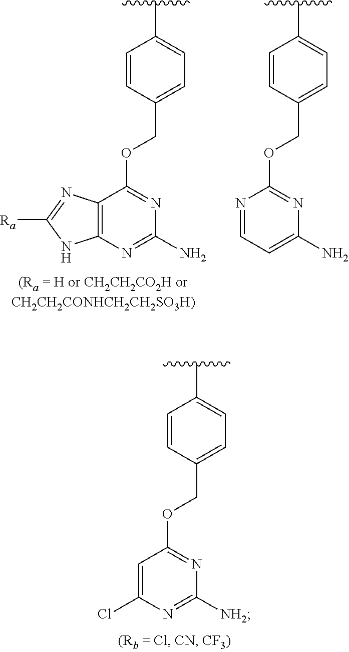
or from
d. a substrate of dihydrofolate reductase, particularly a 4-demethyltrimethoprim moiety as exemplarily shown below: 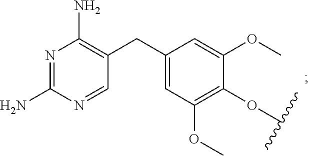 [SMILES: *Oc1c(OC)cc(Cc2cnc(N)nc2N)cc1OC]
or from
e. a moiety capable of selectively interacting non-covalently with a biomolecule, particularly a protein or nucleic acid, wherein said moiety and said biomolecule form a complex having a dissociation constant k_{D} of 10⁻⁶ mol/L or less,
more particularly, M is selected from de-N-Boc-docetaxel, de-N-Boc-cabazitaxel, de-N-Boc-larotaxel or another taxol derivative, a phalloidin derivative, a jasplakinolide derivative, a bis-benzimide DNA stain, pepstatin A or triphenylphosphonium, e.g. as shown below: 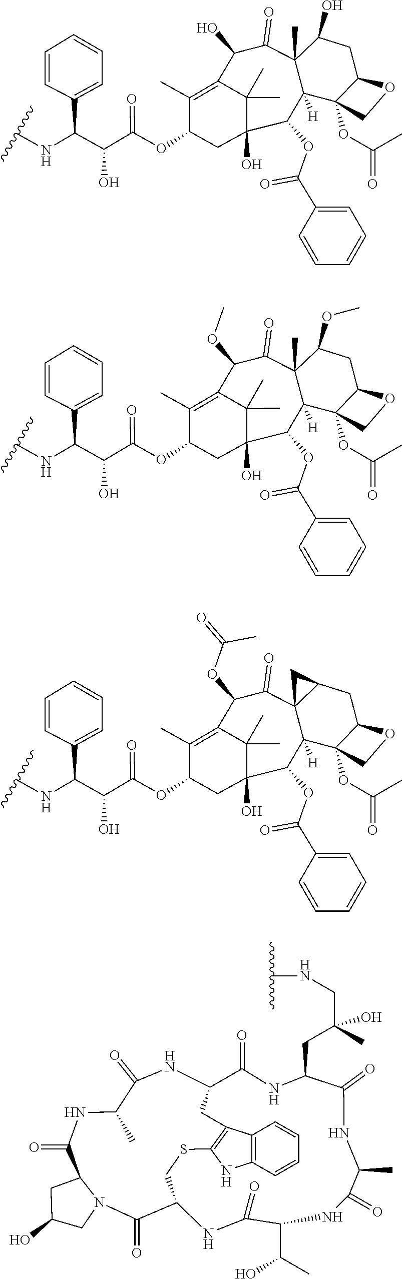 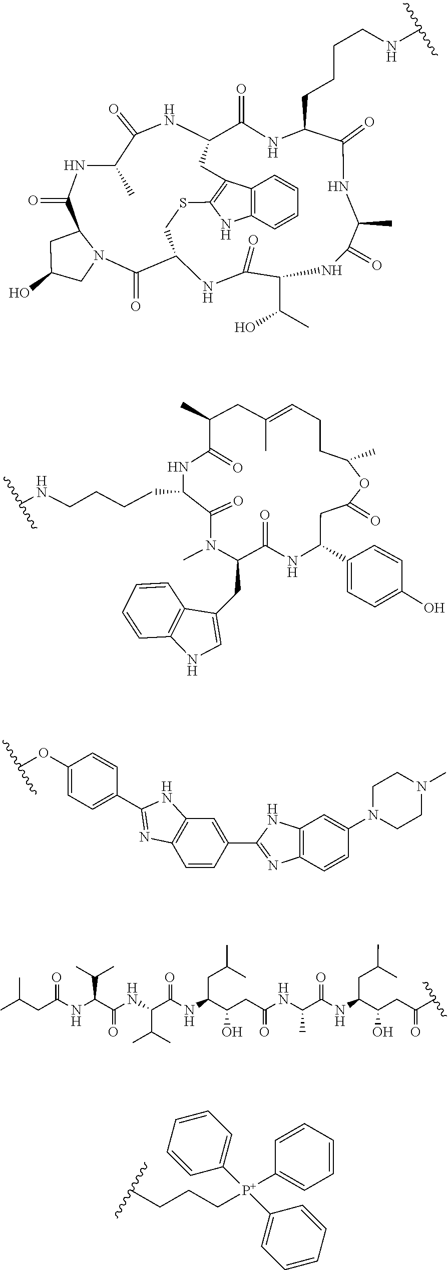
f. or wherein M is an oligonucleotide having a sequence length between 10 and 40 nucleotides;
g. or wherein M is a lipid, particularly a sphingosine derivative such as a ceramide, or a phospholipid such as dioleoylphosphatidylethanolamine (DOPE) or dipalmitoylphosphatidylethanolamine (DPPE), or a fatty acid.

4. The compound according to claim 3, having one of the structural formulas I-1-I-30 or II-1-II-30: 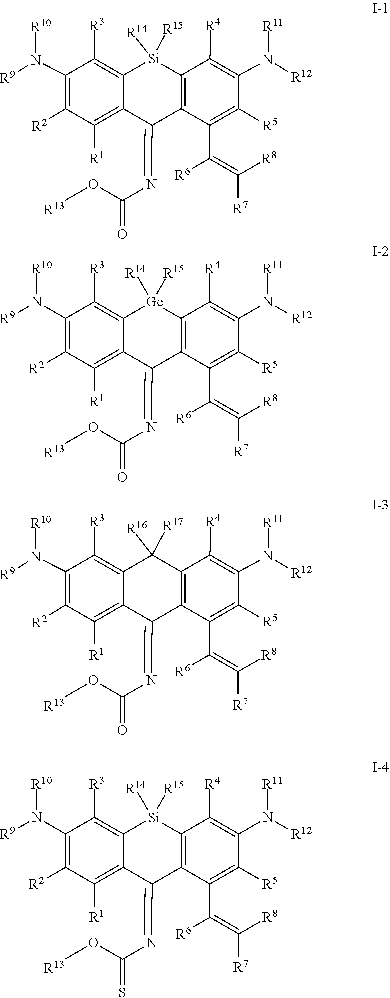 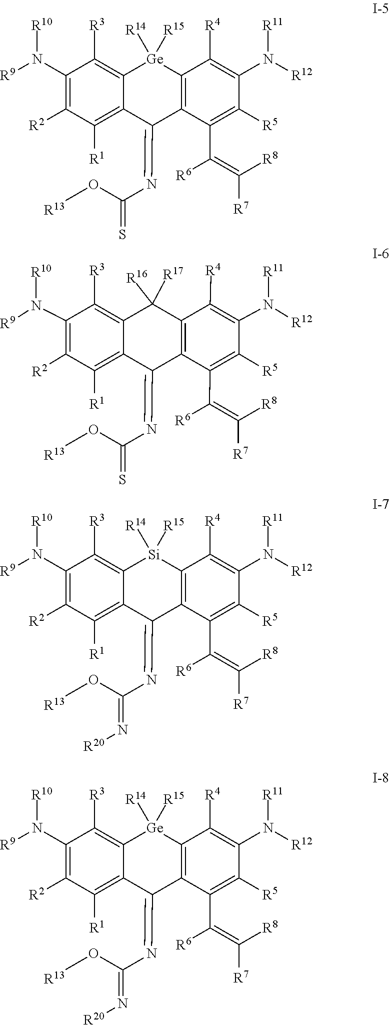 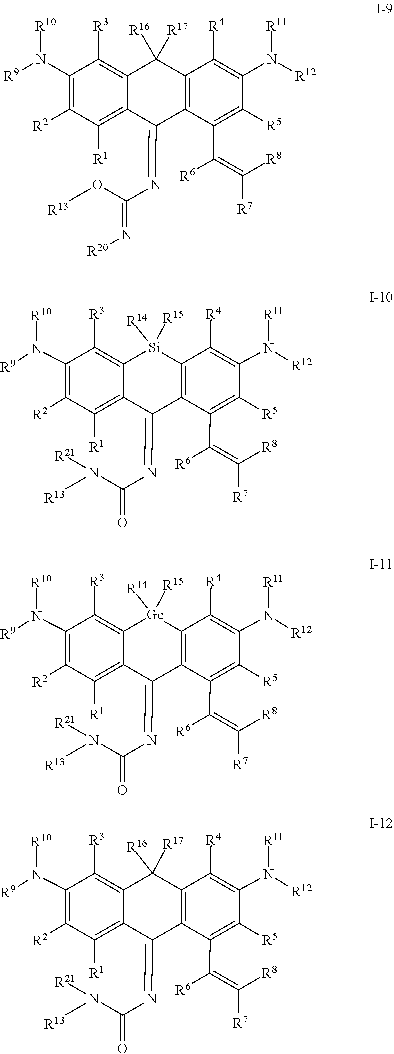 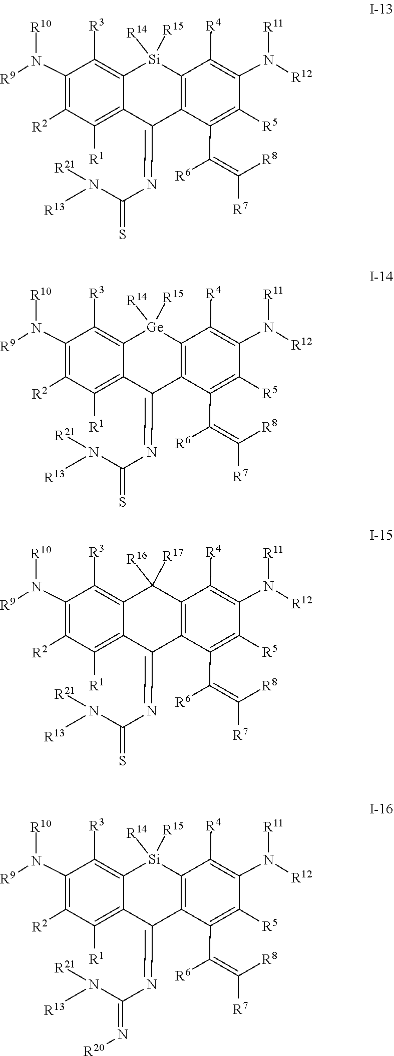 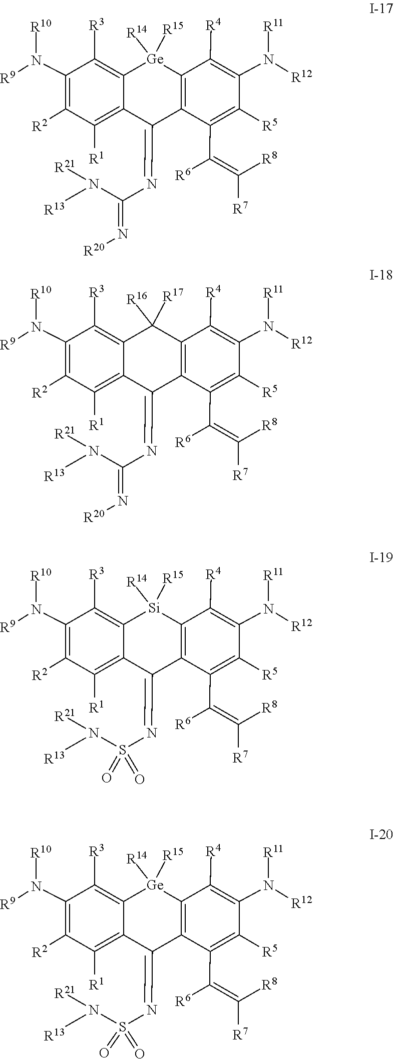 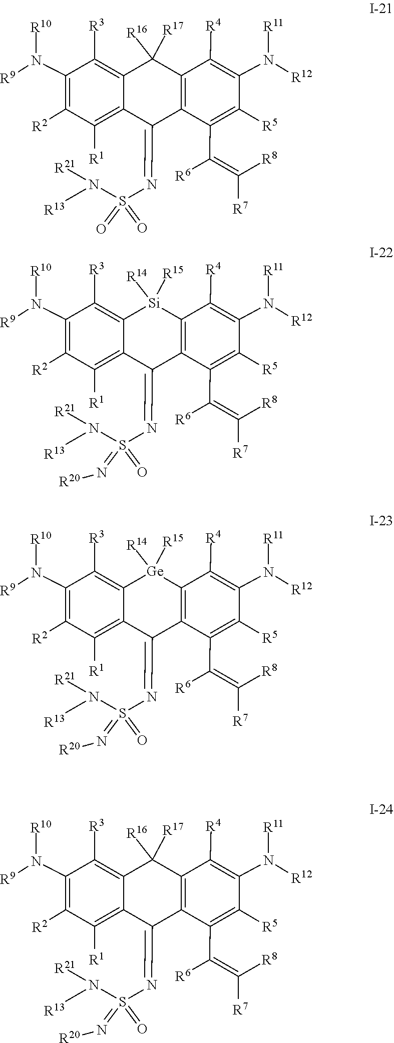 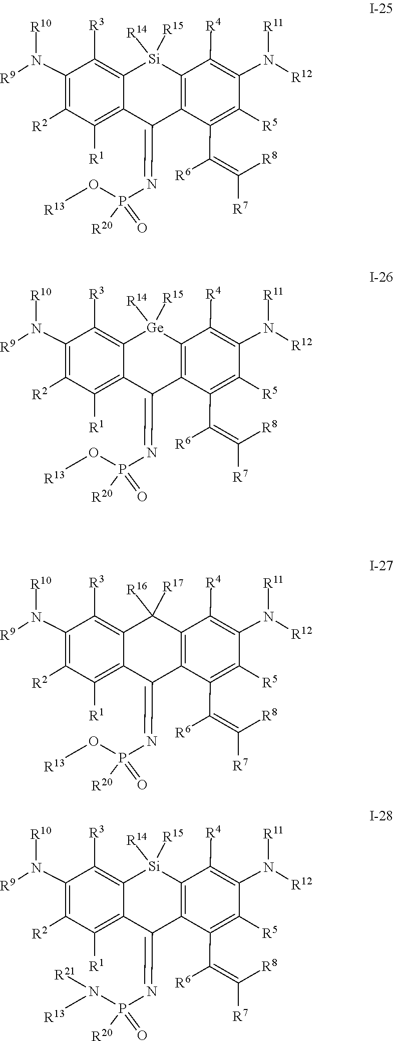 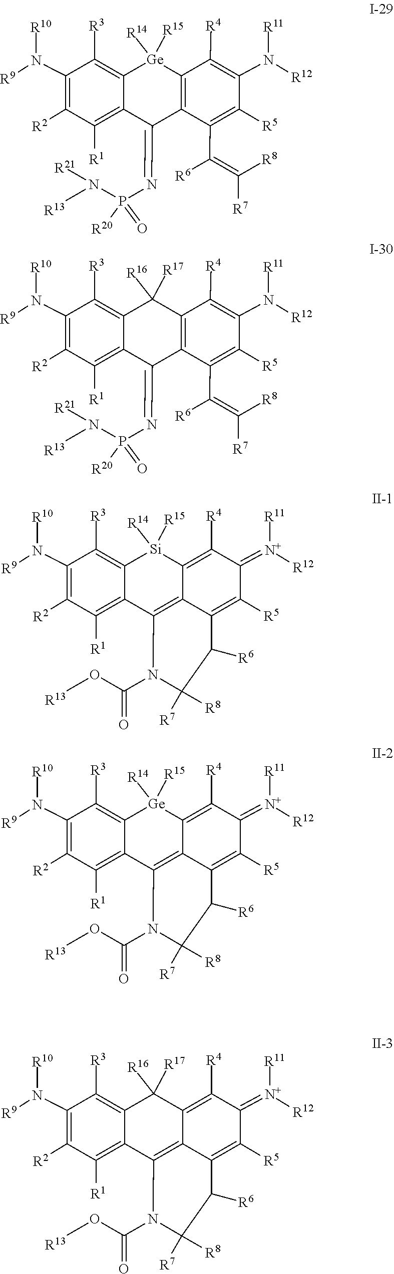 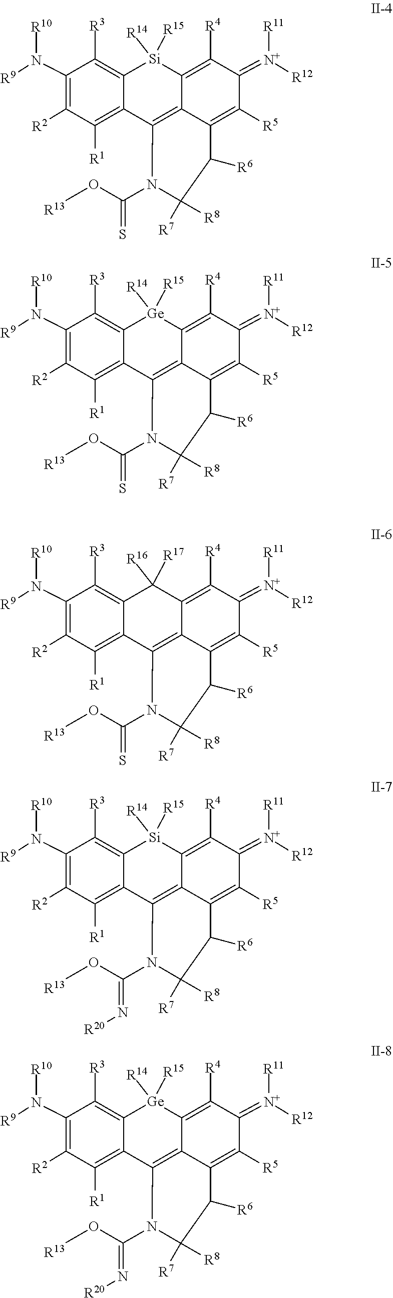 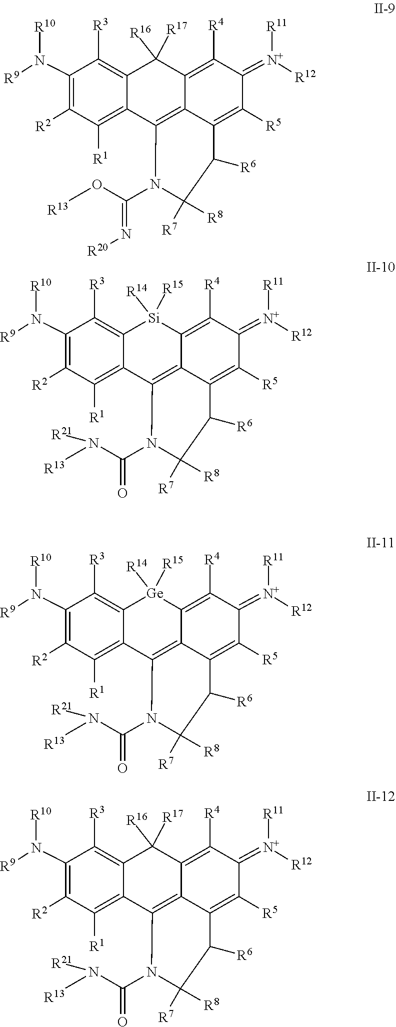 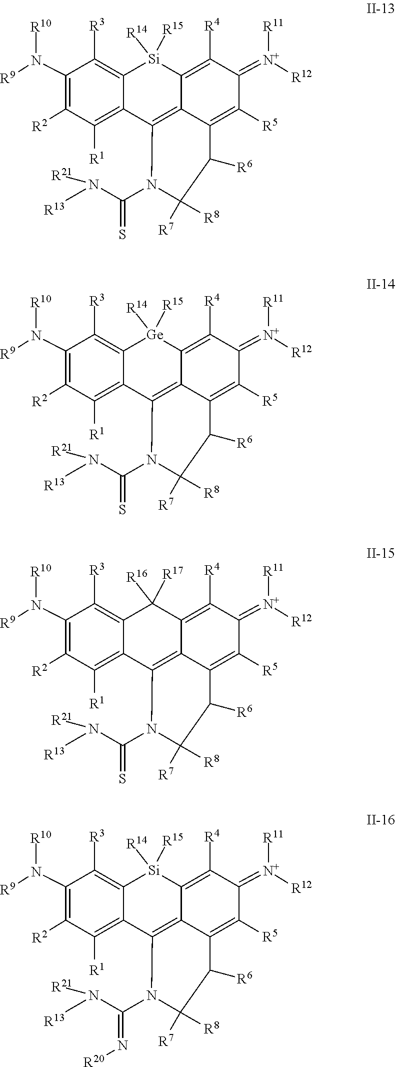 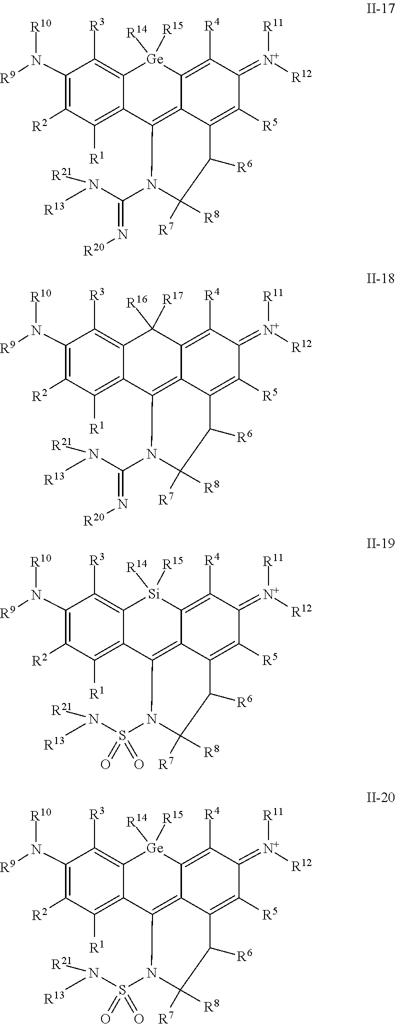 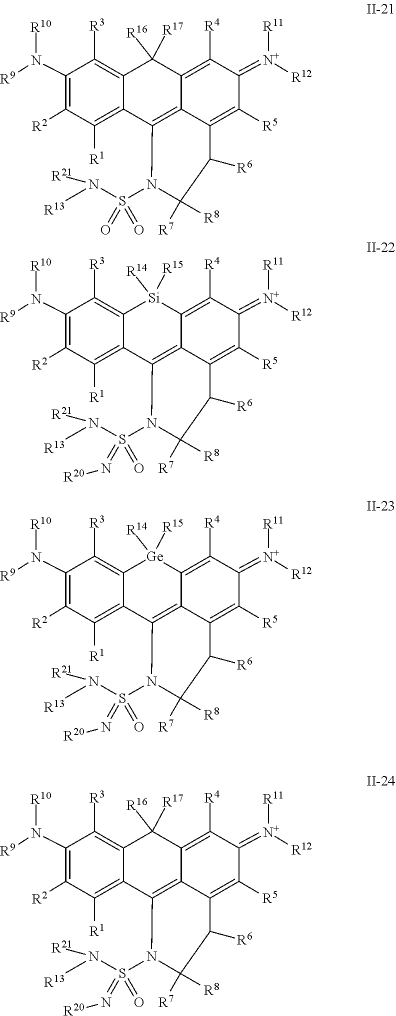 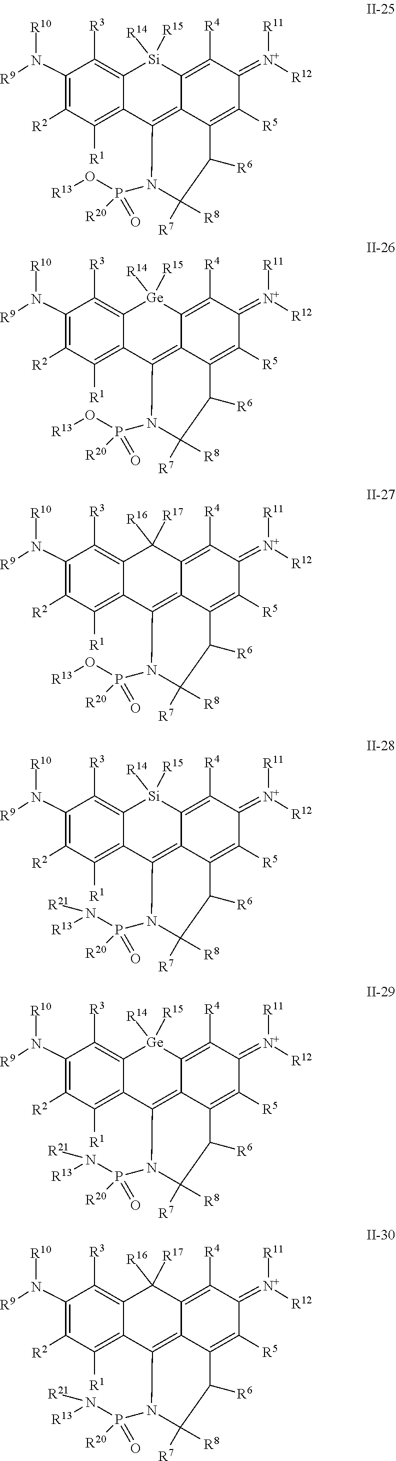
wherein any one of substituents R¹, R², R³, R⁴, R⁵, R⁶, R⁷, R⁸, R⁹, R¹⁰, R¹¹, R¹² or any one of the substituents R¹³, R¹⁴, R¹⁵, R¹⁶, R¹⁷, R¹⁸, R¹⁹, R²⁰, R²¹, if present, independently of any other is H or a moiety having a molecular weight between 15 and 1500 Da;
particularly wherein:
a) the substituents R⁹, R¹⁰, R^{D}, R¹² are selected from H and methyl, or any of the substituents —NR⁹R¹⁰ and —NR¹¹R¹² represents an azetidine ring, and
b) one of substituents R¹, R², R³, R⁴, R⁵, R⁶, R⁷, R⁸ or one of the R¹³, R¹⁴, R¹⁵, R¹⁶, R¹⁷, R¹⁸, R¹⁹, R²⁰, R²¹, if present, is H or a moiety M having a molecular weight between 15 and 1500 Da, and
c) the other substituents R¹, R², R³, R⁴, R⁵ are selected from H and F, and
d) the other substituents R⁶, R⁷, R⁸ are selected from H and methyl, and
e) the other substituents R¹⁴, R¹⁵, if present, are selected from methyl, ethyl, isopropyl or phenyl,
f) the other substituents R¹⁶, R¹⁷, if present, are methyl,
g) the other substituents R²⁰, R²¹, if present, are selected from H, OH, methoxy and methyl.

5. The compound according to claim 4, having a molecular weight between 15 and 1500 Da and is characterized by a general formula -L-Mₛ, where -L- is a covalent bond or a linker consisting of 1 to 50 atoms having an atomic weight of 12 or higher (in addition to the number of hydrogen atoms required to satisfy the valence rules) covalently connecting the compound of structure I-1-I-30 or II-1-II-30 to the binding moiety Mₛ,
particularly wherein said moiety M having a molecular weight between 15 and 1500 Da is characterized by a general formula
-L^{A1}ₘ-L^{J1}_{m′}-L^{A2}ₙ-L^{A2}_{n′}-L^{A3}ₚ-L^{J3}_{p′}-L^{A4}_{q}-L^{J4}_{q′}-Mₛ, wherein
L^{A1} L^{A2} L^{A3} and L^{A4} independently of each other are selected from C₁ to C₁₂ unsubstituted or amino-, hydroxyl-, carboxyl- or fluoro substituted alkyl or cycloalkyl, (CH₂—CH₂—O)ᵣ with r being an integer from 1 to 20, alkylaryl, alkylaryl-alkyl, and unsubstituted or alkyl-, halogen-, amino-, alkylamino-, imido-, nitro-, hydroxyl-, oxyalkyl-, carbonyl-, carboxyl-, sulfonyl- and/or sulfoxyl substituted aryl or heteroaryl;
L^{J1}, L^{J2}, L^{J3} and L^{J4} independently of each other are selected from —NRC(═O)—, —C(═O)N(R)—, —NRC(═O)O—, —OC(═O)N(R)—, —C(R)=N—, —N═C(R)—, —C(═O)—, —OC(═O)—,
—C(═O)O—, —N(R)—, —O—, —P(═O)(OR)—, —P(═O)(OR)O—, —OP(═O)(OR)—, —OP(═O)(OR)O—, —S—, —SO—, —SO₂—, —SO₂N(R)—, —N(R)SO₂N(R)—, —N(R)SO₂— with R selected from H and unsubstituted or amino-, hydroxyl-, carboxyl, sulfonate or fluoro substituted C₁ to C₆ alkyl, particularly when R is selected from H and methyl;
m, m′, n, n′, p, p′, q, q′ and s independently from each other are selected from 0 and 1, and
Mₛ is defined identical to binding moiety M.

6. The compound according to claim 5, wherein said moiety M having a molecular weight between 15 and 1500 Da is represented by one of the following structures:

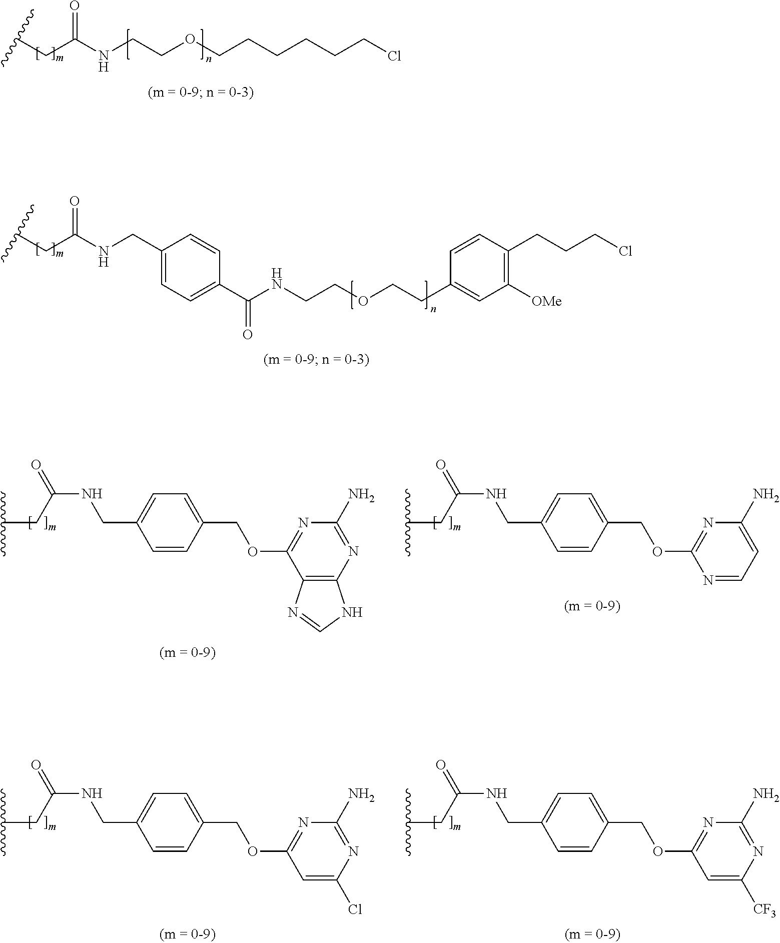

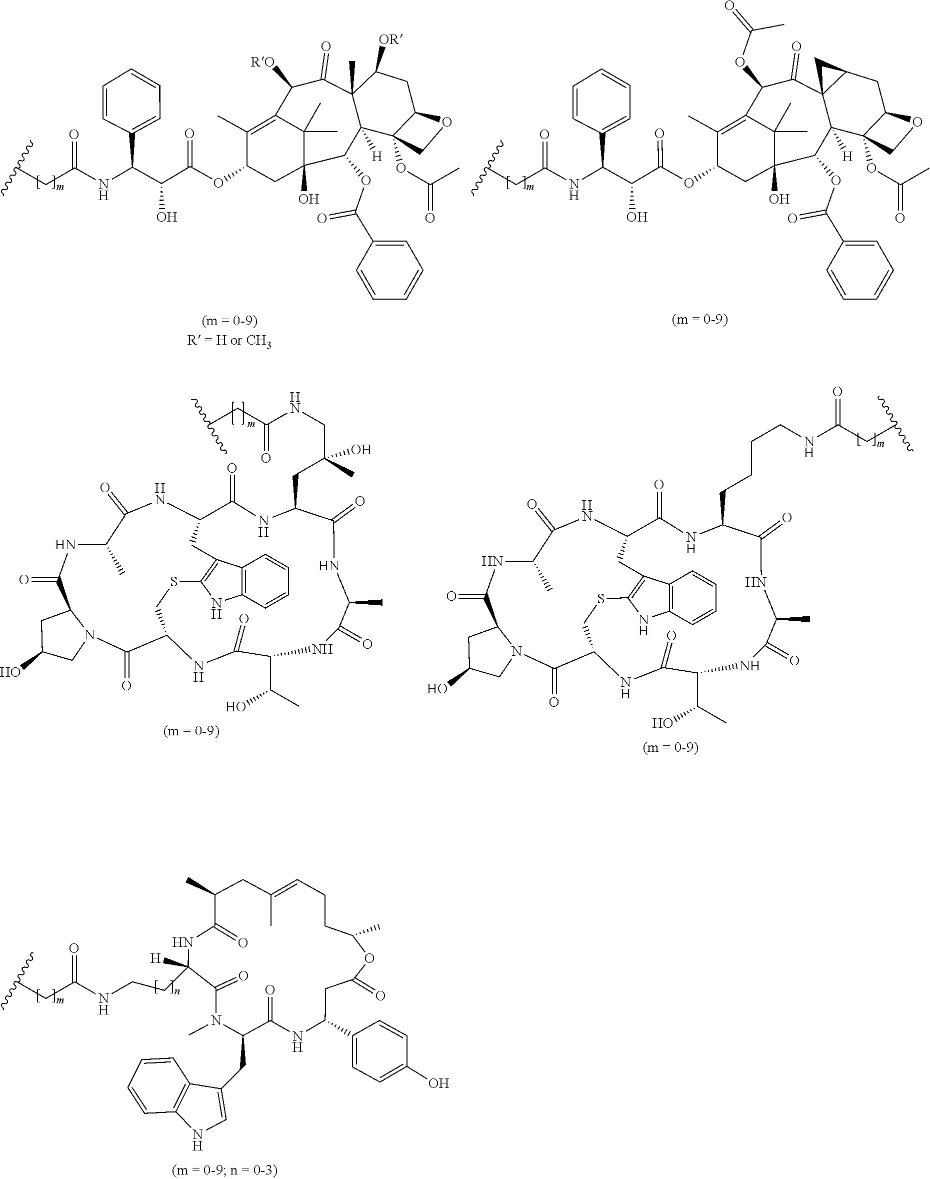

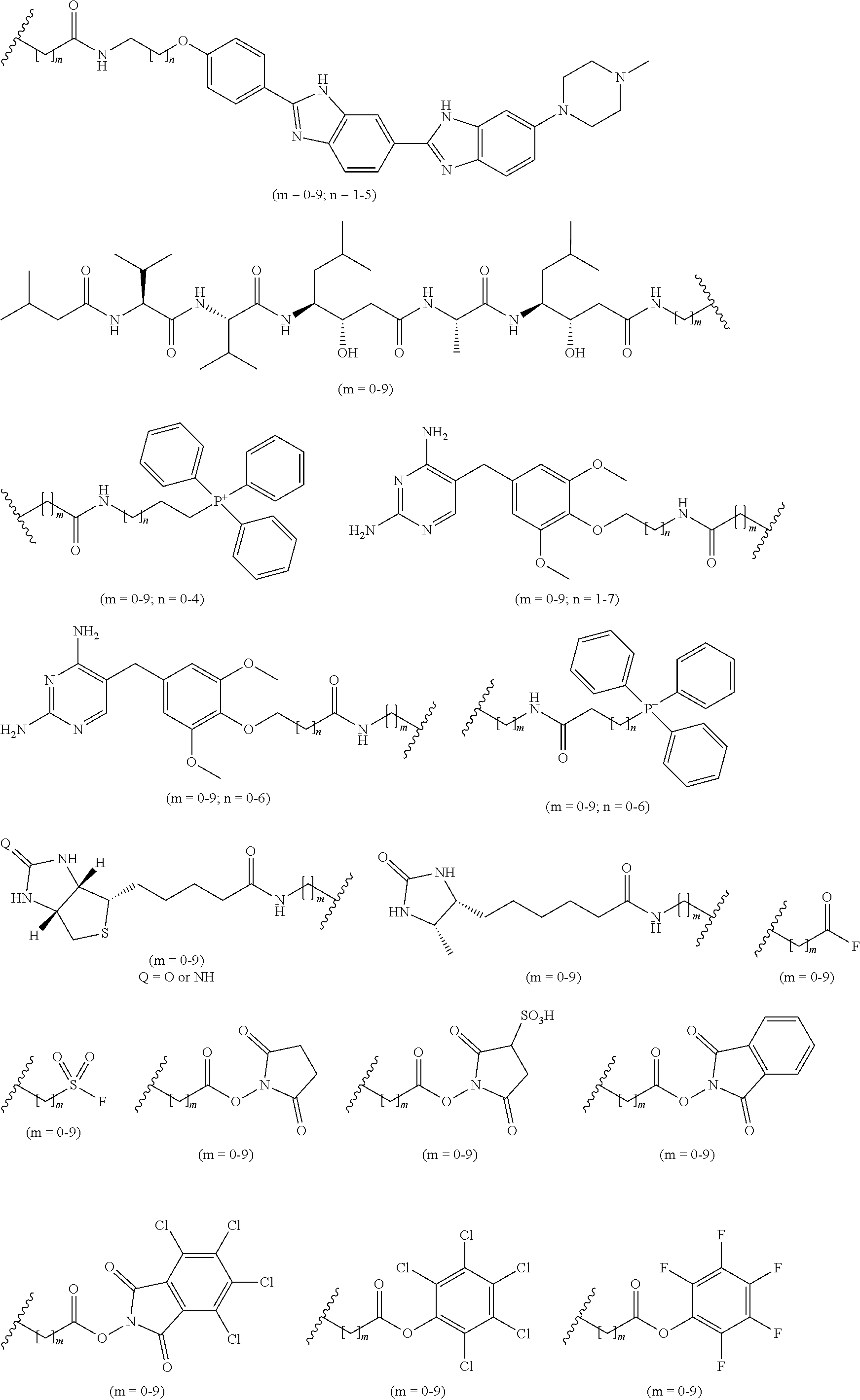

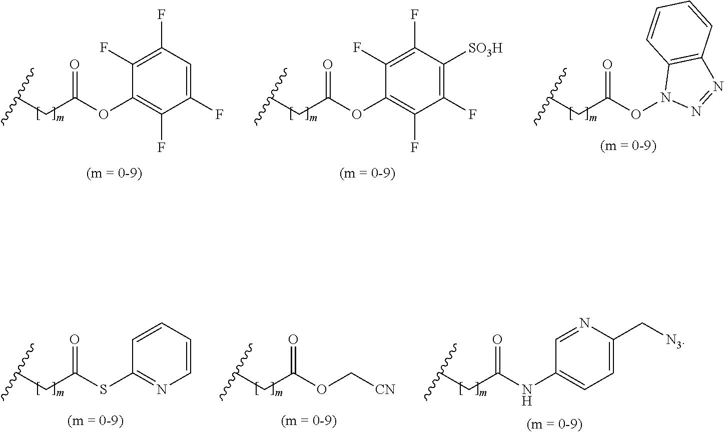

7. The compound according to claim 1, wherein
a. R⁹ and R¹⁰, and/or R¹¹ and R¹², are independently selected from H, unsubstituted and amino-, hydroxy-, carboxy-, sulfonate- and/or fluoro-substituted C₁-C₆ alkyl, C₁-C₄ acyl, C₁-C₄ alkoxycarbonyl, including tert-butyloxycarbonyl or Boc group, and C₃-C₆ cycloalkyl,
particularly R⁹ and R¹⁰, and/or R¹¹ and R¹², are independently selected from H, methyl, ethyl, n-propyl, isopropyl, n-butyl, isobutyl, tert-butyl, allyl and CH₂CF₃,
b. R⁹ together with R¹⁰, and/or R⁹ together with R¹⁰, are independently forming an unsubstituted or alkyl-, amino-, hydroxy-, carboxy-, sulfonate- and/or fluoro-substituted C₃-C₆ alkyl, particularly —(CH₂)₃—, —(CH₂)₄—, —(CH₂)₅—, —(CH₂)₂O(CH₂)₂—, —(CH₂)₂SO₂(CH₂)₂— or —(CH₂)₂NR²²(CH₂)₂— with R²² being selected from H and unsubstituted C₁ to C₄ alkyl, particularly methyl;
c. R⁹ and/or R¹¹ are independently selected from H, unsubstituted and alkyl-substituted, particularly methyl-substituted, amino-, hydroxy-, carboxy-, sulfonate- and/or fluoro-substituted C₁-C₆ alkyl, C₁-C₄ acyl, C₁-C₄ alkoxycarbonyl, including tert-butyloxycarbonyl or Boc group, and C₃-C₆ cycloalkyl, and R¹⁰ together with R² or R³, and/or R¹² together with R⁴ or R⁵, is an alkyl or heteroalkyl bridge selected from —(CH₂)₂—, —(CH₂)₃—, —CH₂CH═CH— or —(CH₂)₄— or —CH₂—O—, —CH₂—NR—, —CH₂—S—, —CH₂—SO₂—, —(CH₂)₂₀—, —(CH₂)₂NR—, —(CH₂)₂S—, —(CH₂)₂SO₂—, —CH₂—O—CH₂—, —CH₂NR—, —CH₂S—CH₂—, —CH₂—SO₂—CH₂—, — with R selected from H and unsubstituted or amino-, hydroxyl-, carboxyl, sulfonate- or fluoro-substituted C₁ to C₆ alkyl, particularly when R is selected from H and methyl-, and a mono- or dimethyl-substituted derivative of any one of the foregoing alkyl or heteroalkyl bridge moieties;
d. R¹⁰ and/or R¹¹ are independently selected from H, unsubstituted and alkyl-, substituted, particularly methyl-substituted-, amino-, hydroxy-, carboxy-, sulfonate- and/or fluoro-substituted C₁-C₆ alkyl, C₁-C₄ acyl, C₁-C₄ alkoxycarbonyl, including tert-butyloxycarbonyl or Boc group, and C₃-C₆ cycloalkyl, and R⁹ together with R², and/or R¹² together with R⁵, form a fused annular structure according to any one of the following substructures: 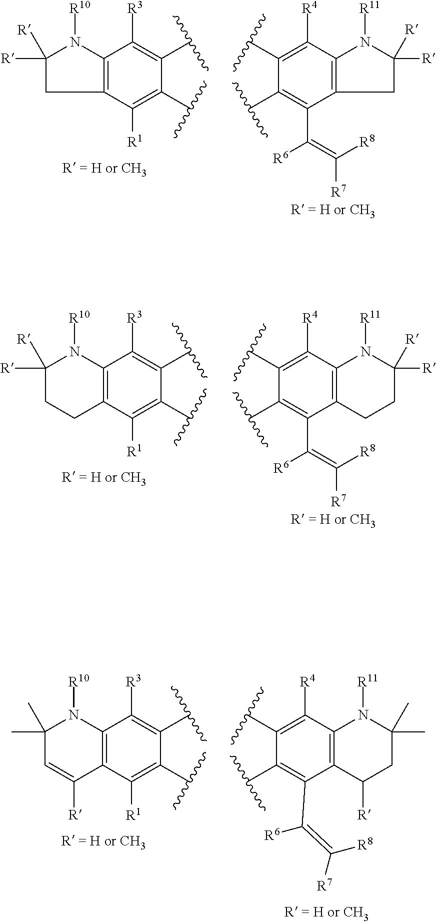
e. R⁹ and/or R¹² are independently selected from H, unsubstituted and alkyl-substituted, particularly methyl-substituted, amino-, hydroxy-, carboxy-, sulfonate- and/or fluoro-substituted C₁-C₆ alkyl, C₁-C₄ acyl, C₁-C₄ alkoxycarbonyl, including tert-butyloxycarbonyl or Boc group, and C₃-C₆ cycloalkyl, and R¹⁰ together with R³, and/or R¹¹ together with R⁴, form a fused annular structure according to any one of the following substructures: 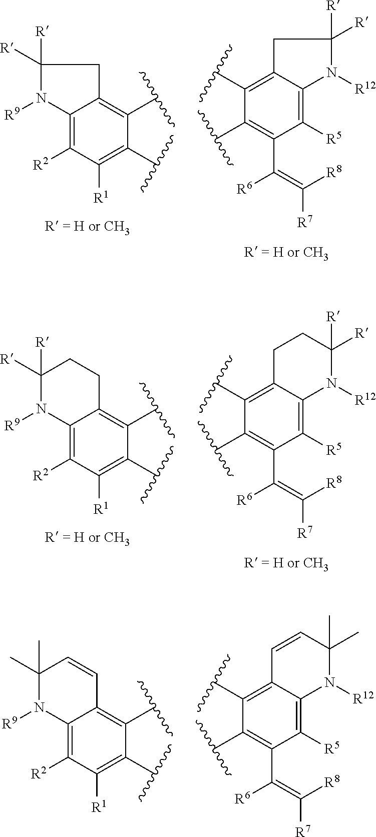
f. R⁹ together with R², and R¹⁰ together with R³, and/or R¹² together with R⁵, and R¹¹ together with R⁴, form a fused biannular structure according to any one of the following substructures:

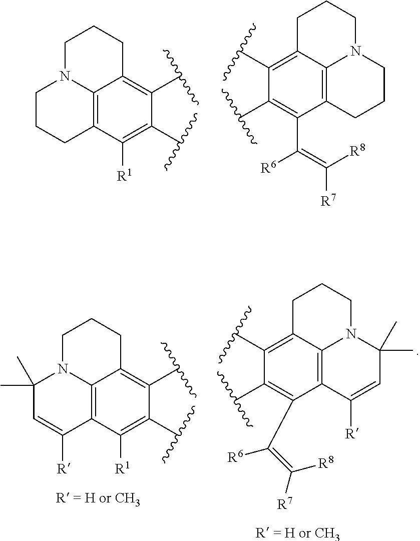

8. The compound according to claim 1, wherein R is structurally identical to the substituent —CR⁶═CR⁷R⁸, in particular when the substituents R² and R⁵ are structurally identical, and/or the substituents —NR⁹R¹⁰ and —NR¹¹R¹² are structurally identical, and/or the substituents R³ and R⁴ are structurally identical.

9. The compound according to claim 5, wherein:
R¹ is H, and/or
R², R³, R⁴ and R⁵ are independently selected from H, halogen, CN, and/or
R⁹, R¹⁰, R¹¹ and R¹² are individually unsubstituted or amino-, hydroxyl- or halogen-substituted C₁ to C₄ alkyl, or C₃ to C₆ cycloalkyl, or R⁹ together with R¹⁰ together with the N atom to which they are bound, and R¹¹ together with R¹² together with the N atom to which they are bound form an unsubstituted or methyl-, hydroxy-, methoxy-, or halogen-substituted aziridine, azetidine, pyrrolidine, piperidine, piperazine, morpholine, thiomorpholine-S,S-dioxide, and/or
R¹³, R¹⁴, R¹⁵, if present, are selected from methyl, ethyl, isopropyl or phenyl,
R¹⁶, R¹⁷, if present, are methyl,
one of the substituents R⁶, R⁷, R⁸ and R²⁰, R²¹, if present, is selected from a) unsubstituted or amino-, hydroxyl-, carboxyl- and/or halogen-substituted C₂ to C₁₂ alkyl or C₃ to C₇ cycloalkyl; or b) -L^{A1}ₘ-L^{J1}_{m′}-L^{A2}ₙ-L^{J2}_{n′}-L^{A3}ₚ-L^{J3}_{p′}-L^{A4}_{q}-L^{J4}_{q′}-Mₛ, wherein L^{A1}, L^{A2}, L^{A3}, L^{A4}, L^{J1}, L^{J2}, L^{J3}, L^{J4} m, m′, n, n′, p, p′, q, q′, s and Mₛ have the definitions recited above in claim 5, and
the other substituents R⁶, R⁷, R⁸ and R²⁰, R²¹, if present, are selected from H or methyl.

10. The compound according to claim 1, wherein the substituents —NR⁹R¹⁰ and/or —NR¹¹R¹² are independently represented by one of the following structures, particularly when the substituents —NR⁹R¹⁰ and —NR¹¹R¹² are structurally identical:

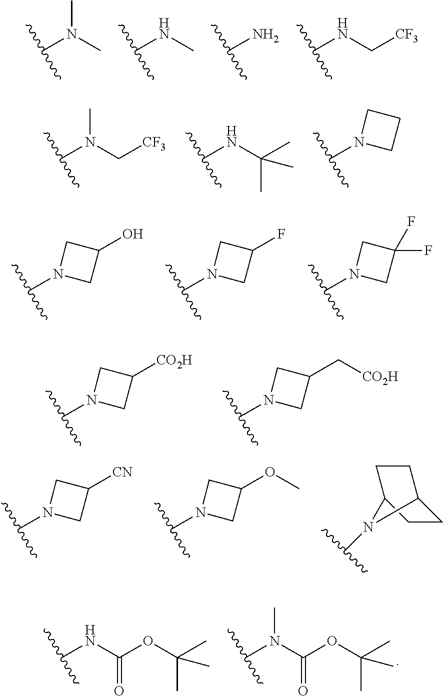

11. The compound according to claim 1, wherein the fragment
—CR⁶═CR⁷R⁸ is represented by one of the following structures:

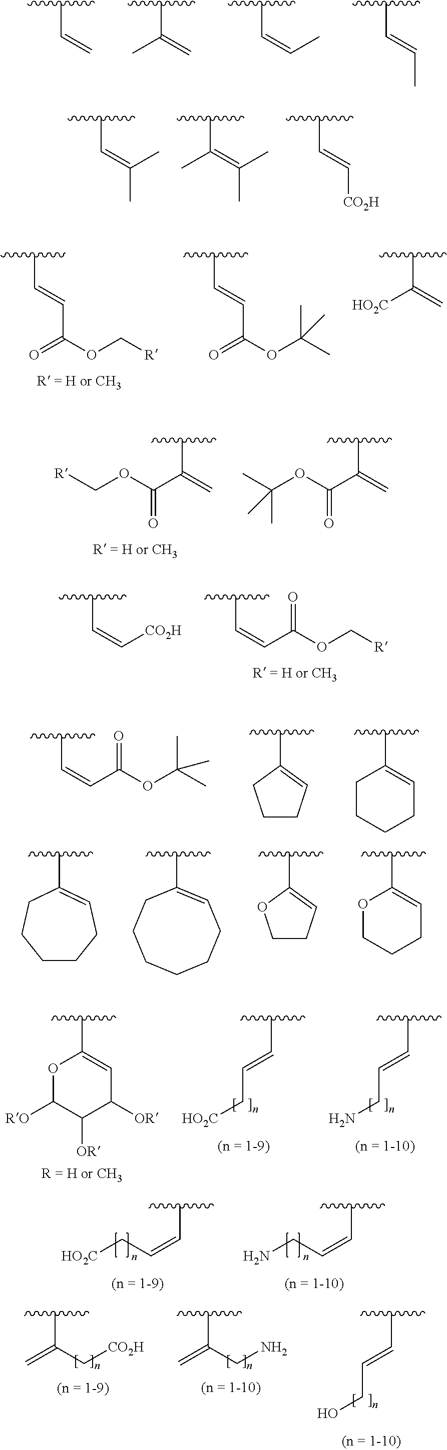

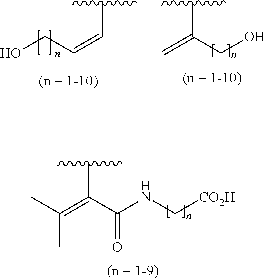

12. The compound according to claim 1, wherein the group
—Y—W—R¹³ is represented by one of the following structures:

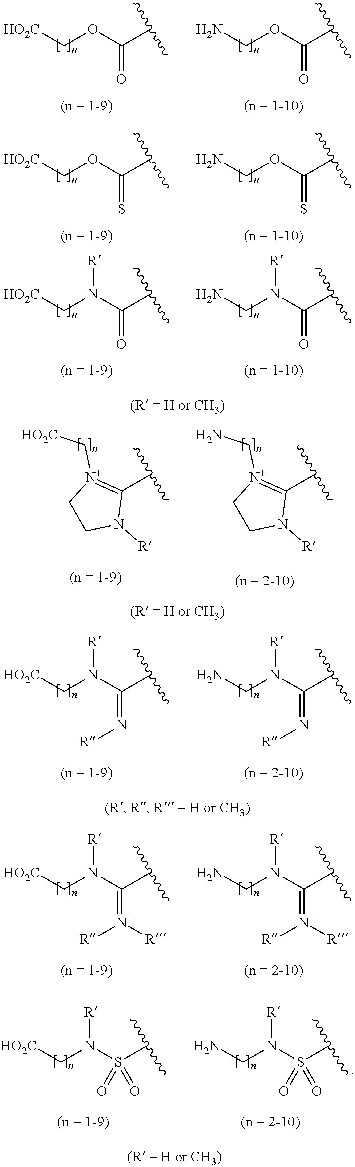

13. The compound according claim 1, wherein the group
—X— is represented by one of the following structures:

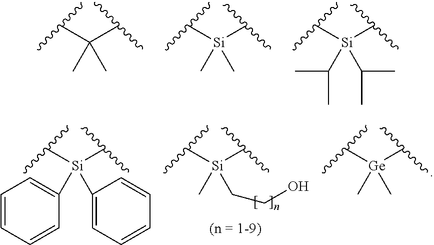

14. The compound according to claim 1, which is selected from the group of compounds below: 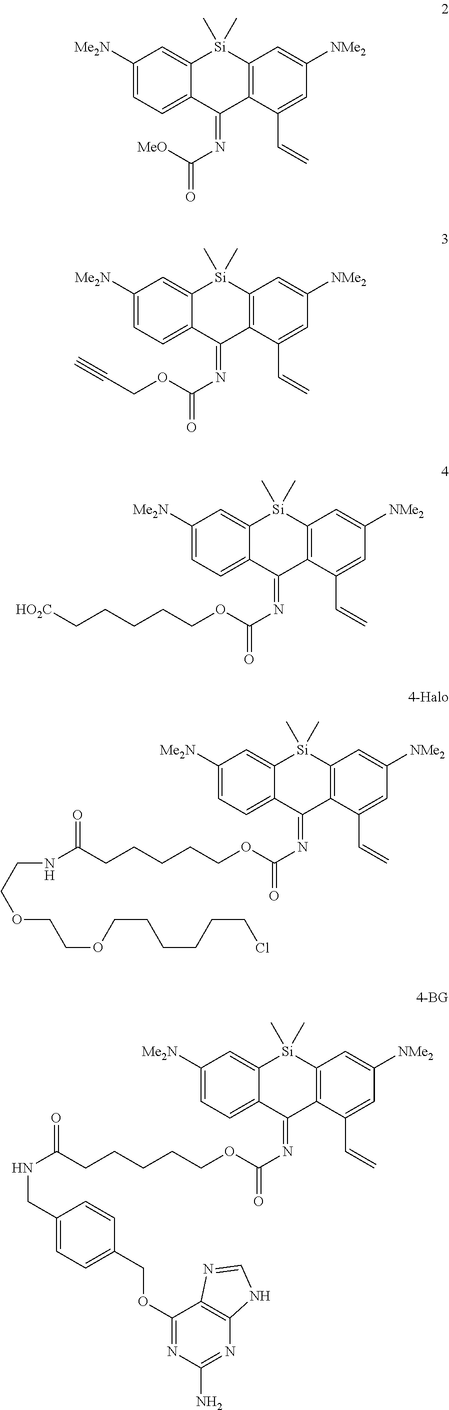 [SMILES: C=Cc1cc(N(C)C)cc2c1/C(=N/C(=O)OC)c1ccc(N(C)C)cc1[Si]2(C)C ; C#CCOC(=O)/N=C1\c2ccc(N(C)C)cc2[Si](C)(C)c2cc(N(C)C)cc(C=C)c21 ; C=Cc1cc(N(C)C)cc2c1/C(=N/C(=O)OCCCCCC(=O)O)c1ccc(N(C)C)cc1[Si]2(C)C ; C=Cc1cc(N(C)C)cc2c1/C(=N/C(=O)OCCCCCC(=O)NCCOCCOCCCCCCCl)c1ccc(N(C)C)cc1[Si]2(C)C ; C=Cc1cc(N(C)C)cc2c1/C(=N/C(=O)OCCCCCC(=O)NCc1ccc(COc3nc(N)nc4[nH]cnc34)cc1)c1ccc(N(C)C)cc1[Si]2(C)C] 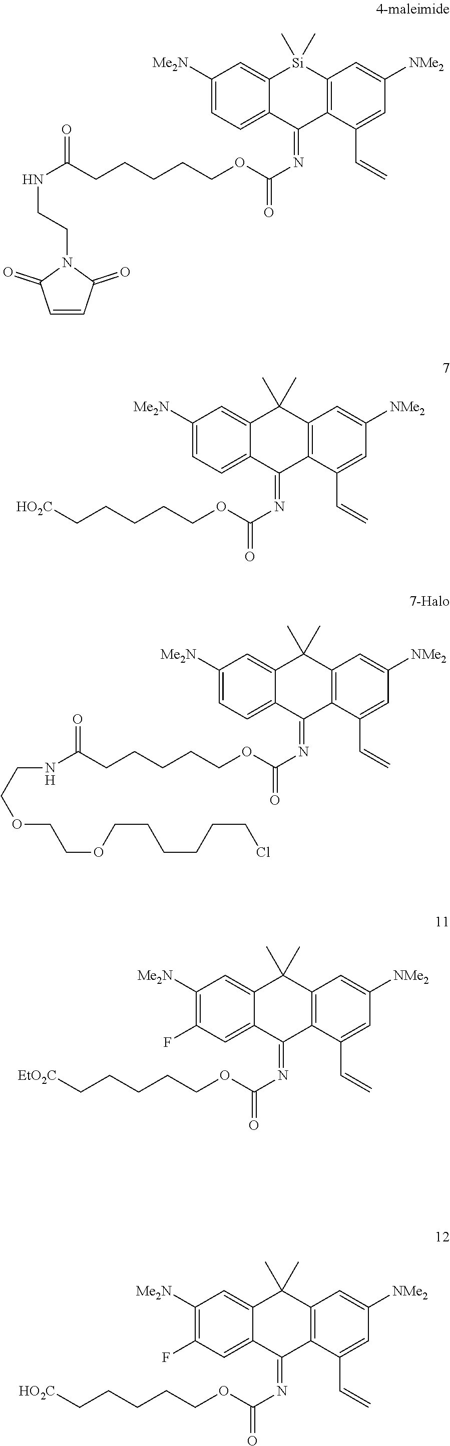 [SMILES: C=Cc1cc(N(C)C)cc2c1/C(=N/C(=O)OCCCCCC(=O)NCCN1C(=O)C=CC1=O)c1ccc(N(C)C)cc1[Si]2(C)C ; C=Cc1cc(N(C)C)cc2c1/C(=N/C(=O)OCCCCCC(=O)O)c1ccc(N(C)C)cc1C2(C)C ; C=Cc1cc(N(C)C)cc2c1/C(=N/C(=O)OCCCCCC(=O)NCCOCCOCCCCCCCl)c1ccc(N(C)C)cc1C2(C)C ; C=Cc1cc(N(C)C)cc2c1/C(=N/C(=O)OCCCCCC(=O)OCC)c1cc(F)c(N(C)C)cc1C2(C)C ; C=Cc1cc(N(C)C)cc2c1/C(=N/C(=O)OCCCCCC(=O)O)c1cc(F)c(N(C)C)cc1C2(C)C] 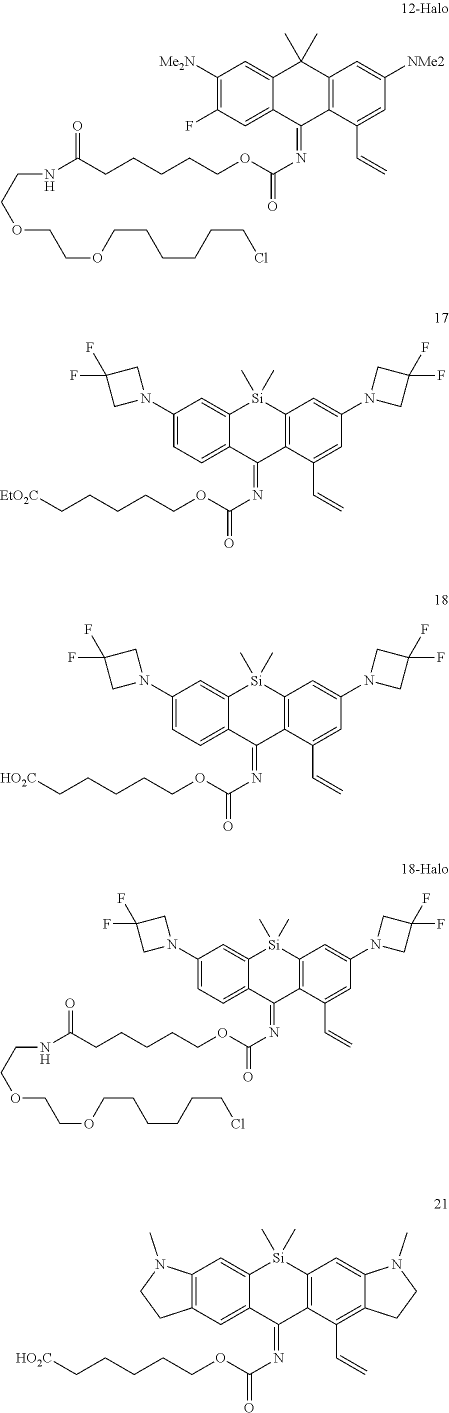 [SMILES: C=Cc1cc(N(C)C)cc2c1/C(=N/C(=O)OCCCCCC(=O)NCCOCCOCCCCCCCl)c1cc(F)c(N(C)C)cc1C2(C)C ; C=Cc1cc(N2CC(F)(F)C2)cc2c1/C(=N/C(=O)OCCCCCC(=O)OCC)c1ccc(N3CC(F)(F)C3)cc1[Si]2(C)C ; C=Cc1cc(N2CC(F)(F)C2)cc2c1/C(=N/C(=O)OCCCCCC(=O)O)c1ccc(N3CC(F)(F)C3)cc1[Si]2(C)C ; C=Cc1cc(N2CC(F)(F)C2)cc2c1/C(=N/C(=O)OCCCCCC(=O)NCCOCCOCCCCCCCl)c1ccc(N3CC(F)(F)C3)cc1[Si]2(C)C ; C=Cc1c2c(cc3c1/C(=N/C(=O)OCCCCCC(=O)O)c1cc4c(cc1[Si]3(C)C)N(C)CC4)N(C)CC2] 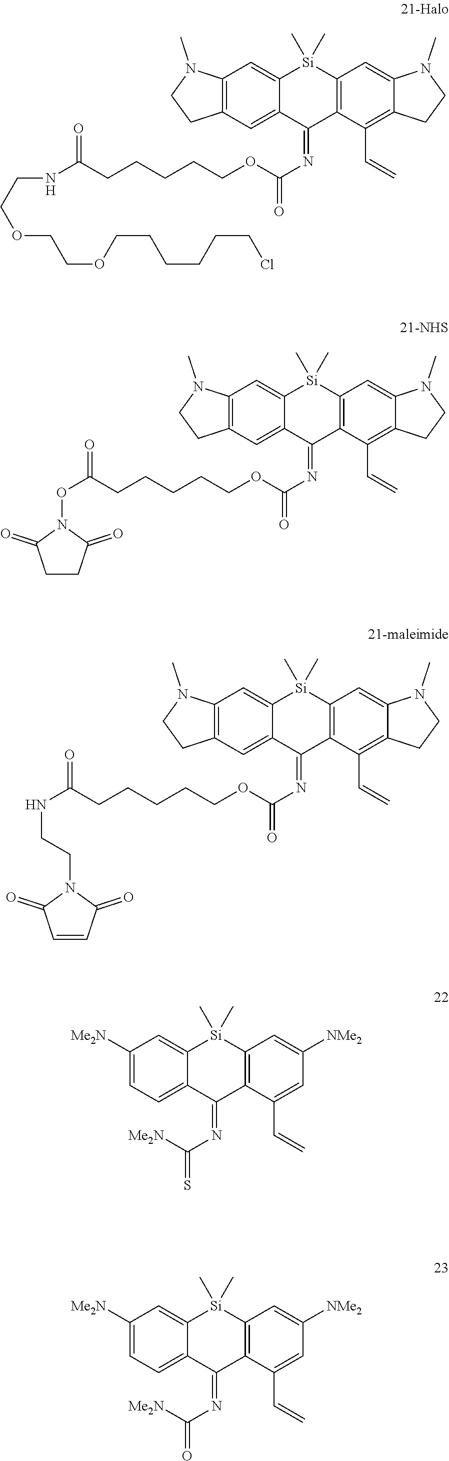 [SMILES: C=Cc1c2c(cc3c1/C(=N/C(=O)OCCCCCC(=O)NCCOCCOCCCCCCCl)c1cc4c(cc1[Si]3(C)C)N(C)CC4)N(C)CC2 ; C=Cc1c2c(cc3c1/C(=N/C(=O)OCCCCCC(=O)ON1C(=O)CCC1=O)c1cc4c(cc1[Si]3(C)C)N(C)CC4)N(C)CC2 ; C=Cc1c2c(cc3c1/C(=N/C(=O)OCCCCCC(=O)NCCN1C(=O)C=CC1=O)c1cc4c(cc1[Si]3(C)C)N(C)CC4)N(C)CC2 ; C=Cc1cc(N(C)C)cc2c1/C(=N/C(=S)N(C)C)c1ccc(N(C)C)cc1[Si]2(C)C ; C=Cc1cc(N(C)C)cc2c1/C(=N/C(=O)N(C)C)c1ccc(N(C)C)cc1[Si]2(C)C] [chemical structure]
